(19) United States
(12) Patent Application Publication
(10) Pub. No.: US 2025/0267434 A1
(43) Pub. Date: Aug. 21, 2025

(54) NETWORK-ASSISTED DAA FOR AERIAL UES

(71) Applicant: QUALCOMM Incorporated, San Diego, CA (US)

(72) Inventors: Stefano FACCIN, San Ysidro, CA (US); Drew Foster VAN DUREN, Templeton, CA (US); Sunghoon KIM, San Diego, CA (US)

(21) Appl. No.: 19/039,613

(22) Filed: Jan. 28, 2025

Related U.S. Application Data
(60) Provisional application No. 63/554,457, filed on Feb. 16, 2024.

(51) Int. Cl. H04W 4/40; G08G 5/26; G08G 5/57; G08G 5/58; H04W 60/00; H04W 76/10

(52) U.S. Cl. CPC H04W 4/40; G08G 5/26; G08G 5/57; G08G 5/58; H04W 60/00; H04W 76/10

(57) ABSTRACT

Network-assisted DAA for AUEs is described. An apparatus is configured to establish a connection with a mobile network. The apparatus is configured to provide, for a first network entity of the mobile network, a capability indication of the AUE for support of NWDAA services. The apparatus is configured to communicate, with a second network entity of the mobile network, information associated with the NWDAA services. Another apparatus is configured to obtain local awareness information associated with an AUE based on an indication of support associated with the AUE for NWDAA services. The apparatus is configured to identify a confliction condition, associated with the NWDAA services, for the AUE based on the local awareness information. The apparatus is configured to communicate, with the AUE via a mobile network associated with the at least one network entity, information associated with the NWDAA services.

### CROSS REFERENCE TO RELATED APPLICATION(S)

This application claims the benefit of and priority to U.S. Provisional Application Ser. No. 63/554,457, entitled “NETWORK-ASSISTED DAA FOR AERIAL UEs” and filed on Feb. 16, 2024, which is expressly incorporated by reference herein in its entirety.

### TECHNICAL FIELD

The present disclosure relates generally to communication systems, and more particularly, to wireless communications for aerial user equipment (UE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may comprise an aerial user equipment (AUE), and the method may be performed at/by an AUE. The apparatus is configured to establish a connection with a mobile network. The apparatus is also configured to provide, for a first network entity of the mobile network, a capability indication of the AUE for support of network-based detect and avoid (NWDAA) services. The apparatus is also configured to communicate, with a second network entity of the mobile network, information associated with the NWDAA services.

In the aspect, the method includes establishing a connection with a mobile network. The method also includes providing, for a first network entity of the mobile network, a capability indication of the AUE for support of NWDAA services. The method also includes communicating, with a second network entity of the mobile network, information associated with the NWDAA services.

In an aspect of the disclosure, a method, a computer-readable medium, and an apparatus are provided. The apparatus is configured to establish, with an AUE, a connection to a mobile network associated with the at least one network entity. The apparatus is also configured to receive, from the AUE, a capability indication of the AUE for support of NWDAA services. The apparatus is also configured to provide, for the AUE and based on the capability indication, an NWDAA services indication that is indicative of an availability of the NWDAA services at the mobile network. The apparatus is also configured to communicate, with the AUE via the mobile network, information associated with the NWDAA services.

In the aspect, the method includes establishing, with an AUE, a connection to a mobile network associated with the at least one network entity. The method also includes receiving, from the AUE, a capability indication of the AUE for support of NWDAA services. The method also includes providing, for the AUE and based on the capability indication, an NWDAA services indication that is indicative of an availability of the NWDAA services at the mobile network. The method also includes communicating, with the AUE via the mobile network, information associated with the NWDAA services.

In an aspect of the disclosure, a method, a computer-readable medium, and an apparatus are provided. The apparatus is configured to establish, with an AUE, a connection to a mobile network associated with the at least one network entity. The apparatus is also configured to receive, from the AUE, a capability indication of the AUE for support of NWDAA services. The apparatus is also configured to provide, for the AUE and based on the capability indication, an NWDAA services indication that is indicative of an availability of the NWDAA services at the mobile network.

In the aspect, the method includes establishing, with an AUE, a connection to a mobile network associated with the at least one network entity. The method also includes receiving, from the AUE, a capability indication of the AUE for support of NWDAA services. The method also includes providing, for the AUE and based on the capability indication, an NWDAA services indication that is indicative of an availability of the NWDAA services at the mobile network.

In an aspect of the disclosure, a method, a computer-readable medium, and an apparatus are provided. The apparatus is configured to obtain local awareness information associated with an AUE based on an indication of support associated with the AUE for NWDAA services. The apparatus is also configured to identify a confliction condition, associated with the NWDAA services, for the AUE based on the local awareness information. The apparatus is also configured to communicate, with the AUE via a mobile network associated with the at least one network entity, information associated with the NWDAA services.

In the aspect, the method includes obtaining local awareness information associated with an AUE based on an indication of support associated with the AUE for NWDAA services. The method also includes identifying a confliction condition, associated with the NWDAA services, for the AUE based on the local awareness information. The method also includes communicating, with the AUE via a mobile network associated with the at least one network entity, information associated with the NWDAA services.

In an aspect of the disclosure, a method, a computer-readable medium, and an apparatus are provided. The apparatus may be, or may comprise, an AUE. The apparatus is configured to receive, from a network entity supporting NWDAA services in a mobile network, at least one of: a confliction warning associated with the AUE for a confliction condition, local awareness information associated with the AUE for the confliction condition, or a set of deconfliction strategies associated with the confliction condition. The apparatus is configured to identify a set of actions based on at least one of the confliction warning or the local awareness information. The apparatus is configured to execute at least one of the set of actions or at least one of the set of deconfliction strategies.

In the aspect, the method includes receiving, from a network entity supporting NWDAA services in a mobile network, at least one of: a confliction warning associated with the AUE for a confliction condition, local awareness information associated with the AUE for the confliction condition, or a set of deconfliction strategies associated with the confliction condition. The method includes identifying a set of actions based on at least one of the confliction warning or the local awareness information. The method includes executing at least one of the set of actions or at least one of the set of deconfliction strategies.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a call flow diagram for wireless communications, in accordance with various aspects of the present disclosure.

FIG. 5 is a call flow diagram for wireless communications, in accordance with various aspects of the present disclosure.

FIG. 6 is a call flow diagram for wireless communications, in accordance with various aspects of the present disclosure.

FIG. 7 is a call flow diagram for wireless communications, in accordance with various aspects of the present disclosure.

FIG. 8 is a diagram illustrating an example of an architecture for NWDAA for AUEs, in accordance with various aspects of the present disclosure.

FIG. 9 is a diagram illustrating an example of an architecture and services for NWDAA for AUEs, in accordance with various aspects of the present disclosure.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a flowchart of a method of wireless communication.

FIG. 20 is a diagram illustrating an example of a hardware implementation for an example apparatus and/or network entity.

FIG. 21 is a diagram illustrating an example of a hardware implementation for an example network entity.

FIG. 22 is a diagram illustrating an example of a hardware implementation for an example network entity.

### DETAILED DESCRIPTION

Wireless communication networks may be designed to support communications between mobile networks (e.g., base stations, gNBs, core network (CN) entities, etc.) and UEs, including aerial UEs (AUEs). AUEs may also use other technologies or systems, such as sense and avoid (SAA) or detect and avoid (DAA) systems that help unmanned aerial vehicles (UAVs) and drones (as examples of AUEs) to integrate safely into civilian airspace, avoiding collisions with other aircraft, buildings, power lines, birds and other obstacles. These systems observe the environment surrounding the drone, decide whether a collision is imminent, and generate a new flight path in order to avoid collision. UAV sense and avoid systems may combine data from a number of sensors, using sensor fusion algorithms, image recognition and artificial intelligence to provide the best outcome. Data is fed back to the drone on-board computer and/or drone flight controller, which can then decide on the best evasive maneuver or flight path correction to avoid collision. A reliable onboard DAA system can be a basis for obtaining a waiver for flight operations in many jurisdictions that may otherwise require human observers or ground-based observation systems along the entire flight path. DAA systems may thus be utilized to unlock commercially viable flight operations beyond visual line-of-sight (BVLOS) drone operations, e.g., to enable services such as inspection and cargo delivery over extremely long distances.

Common DAA solutions may include sensor-based implementations, e.g., having two main types of sensors: active and passive. Passive sensors may include electro-optical sensors (e.g., cameras), acoustic sensors, etc. Active sensors may include light detection and ranging (LIDAR), radio assisted detection and ranging (RADAR), sound navigation and ranging (SONAR), etc. Some solutions may be communication based. For instance, an AUE may, in theory, use systems originally designed for manned aviation, such as traffic collision and avoidance systems (TCAS) or automatic dependent surveillance-broadcast (ADS-B), that periodically broadcast and receive identity, position and other information. Airborne Collision Avoidance Systems (ACAS) may be associated with standards that define DAA policies/regulations. For an unmanned aircraft system (UAS), ACAS may include different versions that are defined or in development for fixed wing UAS (ACAS-Xu), for rotorcraft (ACAS-Xr), and for DAA systems of small UAS (ACAS-sXu). However, such DAA policies/regulations target narrow/specific scenarios and do not provide an overall, network-assisted solution for AUE DAA.

Various aspects relate generally to wireless communications for AUEs. Some aspects more specifically relate to network-assisted DAA for AUEs. In one example, an AUE may establish a connection with a mobile network and provide, for a first network entity (e.g., an access and mobility management function (AMF) or a session management function (SMF)) of the mobile network, a capability indication of the AUE for support of NWDAA services. Subsequently, the AUE may communicate, with a second network entity (e.g., a localized detect and avoid (DAA) server (LDS)) of the mobile network, information associated with the NWDAA services. In one example, an SMF may establish, with an AUE, a connection to a mobile network. The SMF may receive, from the AUE, a capability indication of the AUE for support of NWDAA services and provide, for the AUE and based on the capability indication, an NWDAA services indication that is indicative of an availability of the NWDAA services at the mobile network. The SMF may subsequently communicate, with the AUE via the mobile network, information associated with the NWDAA services. In one example, an AMF may establish, with an AUE, a connection to a mobile network and receive, from the AUE, a capability indication of the AUE for support of NWDAA services. The AMF may subsequently provide, for the AUE and based on the capability indication, an NWDAA services indication that is indicative of an availability of the NWDAA services at the mobile network. In one example, an LDS may obtain local awareness information associated with an AUE based on an indication of support associated with the AUE for NWDAA services. The LDS may identify a confliction condition, associated with the NWDAA services, for the AUE based on the local awareness information. The LDS may subsequently communicate, with the AUE via a mobile network associated with the at least one network entity, information associated with the NWDAA services.

Particular aspects of the subject matter described in this disclosure can be implemented to realize one or more of the following potential advantages. In some examples, by providing NWDAA services a network-based LDS, the described techniques can be used to enable DAA for AUEs that is independent of a RPS (remote pilot station), a UAVC (UAV controller), a GCS (ground control station), a human pilot, and/or the like. In some examples, by providing NWDAA services a network-based LDS, the described techniques can be used to enable DAA for AUEs that utilizes a degree of automation in an AUE, but does not rely solely on AUE awareness of surrounding traffic. In some examples, by providing NWDAA services a network-based LDS, the described techniques can be used to enable DAA for AUEs to leverage ground network ability to have higher spatial awareness of air traffic.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

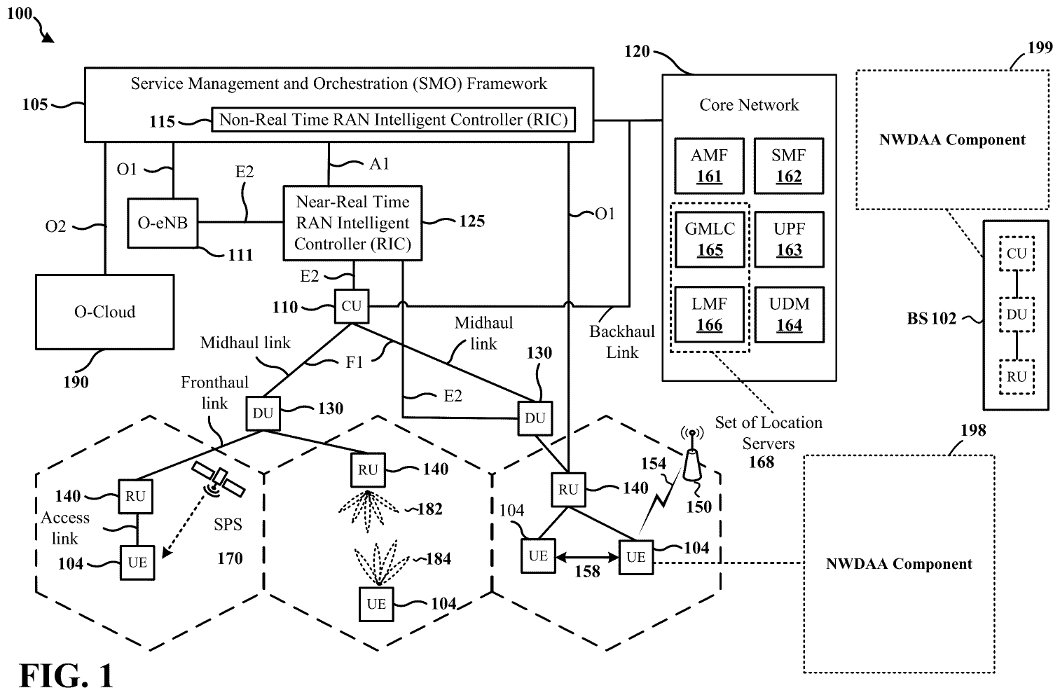

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogenous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 702.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell identifier (ID) (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an NWDAA component 198 (“component 198”) that may be configured to establish a connection with a mobile network. The component 198 may also be configured to provide, for a first network entity of the mobile network, a capability indication of the AUE for support of NWDAA services. The component 198 may also be configured to communicate, with a second network entity of the mobile network, information associated with the NWDAA services. The component 198 may be configured to receive, from the first network entity and prior to communicating the information associated with the NWDAA services, an NWDAA services indication that is indicative of an availability of the NWDAA services at the mobile network. The component 198 may be configured to receive an AUE authorization for an UAS service supplier (USS) authentication and authorization (UUAA) procedure based at least in part on the capability indication. The component 198 may be configured to receive, from a network node and prior to the communicating, an additional NWDAA services indication that is indicative of an availability of the NWDAA services at the mobile network, where the additional NWDAA services indication comprises at least one of a system information block (SIB) or radio resource control (RRC) establishment signaling. The component 198 may be configured to obtain local awareness information associated with the AUE. The component 198 may be configured to identify a confliction condition, associated with the NWDAA services, for the AUE based on the local awareness information. The component 198 may be configured to receive, from the second network entity, a reporting configuration that indicates at least one of a continuous reporting operation or a conditional reporting operation, where communicating the information associated with the NWDAA services is based on the reporting configuration. The component 198 may be configured to identify a set of actions based on at least one of the confliction warning or the local awareness information. The component 198 may be configured to execute the planned deconfliction strategy or the guided deconfliction strategy. The component 198 may be configured to provide, subsequently for the second network entity, an indication of a clearance of the confliction condition. The component 198 may be configured to establish a connectivity session with the LDS for the Layer 3 communications based on an LDS discovery procedure. The component 198 may be configured to move an established connectivity session with the LDS for the Layer 3 communications based on an edge server reallocation procedure associated with an instance of LDS that is an edge node. The component 198 may be configured to receive, from a network entity supporting NWDAA services in a mobile network, at least one of: a confliction warning associated with the AUE for a confliction condition, local awareness information associated with the AUE for the confliction condition, or a set of deconfliction strategies associated with the confliction condition. The component 198 may be configured to identify a set of actions based on at least one of the confliction warning or the local awareness information. The component 198 may be configured to execute at least one of the set of actions or at least one of the set of deconfliction strategies. The component 198 may be configured to communicate, with the network entity and based on a reporting configuration, information associated with the NWDAA services prior to the set of actions being identified. The component 198 may be configured to provide, for the network entity and subsequent to at least one of the set of actions or at least one of the set of deconfliction strategies, an indication of a clearance of the confliction condition. In certain aspects, the base station 102 may have an NWDAA component 199 (“component 199”) that may be configured to establish, with an AUE, a connection to a mobile network associated with the at least one network entity. The component 199 may also be configured to receive, from the AUE, a capability indication of the AUE for support of NWDAA services. The component 199 may also be configured to provide, for the AUE and based on the capability indication, an NWDAA services indication that is indicative of an availability of the NWDAA services at the mobile network. The component 199 may also be configured to communicate, with the AUE via the mobile network, information associated with the NWDAA services. The component 199 may be configured to provide, for the AUE and prior to communicate the information associated with the NWDAA services, the NWDAA services indication that is indicative of the availability of the NWDAA services at the mobile network. The component 199 may be configured to provide an AUE authorization for an UAS service supplier (USS) authentication and authorization (UUAA) procedure based at least in part on the capability indication. The component 199 may be configured to provide, for at least one network node in a radio access network (RAN) portion of the mobile network and based on the AUE authorization, an additional indication that is indicative of an authorization of the LDS for the AUE, where the additional indication comprises a 5G access network (AN) to SMF (N2 SM) message. The component 199 may also be configured to establish, with an AUE, a connection to a mobile network associated with the at least one network entity. The component 199 may also be configured to receive, from the AUE, a capability indication of the AUE for support of NWDAA services. The component 199 may also be configured to provide, for the AUE and based on the capability indication, an NWDAA services indication that is indicative of an availability of the NWDAA services at the mobile network. The component 199 may be configured to authenticate the AUE in association with an LDS of the mobile network based on at least one of the mobility management registration of the AUE or an AUE subscription associated with the NWDAA services. The component 199 may also be configured to obtain local awareness information associated with an AUE based on an indication of support associated with the AUE for NWDAA services. The component 199 may also be configured to identify a confliction condition, associated with the NWDAA services, for the AUE based on the local awareness information. The component 199 may also be configured to communicate, with the AUE via a mobile network associated with the at least one network entity, information associated with the NWDAA services. The component 199 may be configured to receive, from at least one of an AMF or a SMF, an activation indication for the AUE that is associated with a capability indication of the AUE for support of the NWDAA services. The component 199 may be configured to provide, for the AUE, a reporting configuration that indicates at least one of a continuous reporting operation or a conditional reporting operation, where communicating the information associated with the NWDAA services is based on the reporting configuration. The component 199 may be configured to obtain at least one of sensor information associated with the NWDAA services from a RAN portion of the mobile network or location information associated with the AUE, where obtaining the local awareness information includes generating the local awareness information based on at least one of the sensor information or the location information. The component 199 may be configured to identify the set of deconfliction strategies based on at least one of the confliction warning or the local awareness information. The component 199 may be configured to detect the confliction condition based on the local awareness information, where the confliction condition is based on a threshold condition associated with a severity of the confliction condition. The component 199 may be configured to generate a deconfliction directive for the AUE based on the local awareness information and the confliction condition, where the deconfliction directive is an emergency directive or a path directive. The component 199 may be configured to receive, from the AUE, an indication of a clearance of the confliction condition. The component 199 may be configured to move an established connectivity session of the LDS with the AUE for Layer 3 communications based on an edge server reallocation procedure associated with an instance of the LDS that is an edge node. The component 199 may be configured to communicate with at least one of an UAS network function (NF) or a UAS network exposure function (NEF), where at least one of the UAS NF or the UAS NEF are associated with the NWDAA services. The component 199 may be configured to receive, from the AUE, a service layer identifier of the AUE. The component 199 may be configured to identify the UAS NF that serves the AUE based on the service layer identifier of the AUE. The component 199 may be configured to receive, from the USS via a UDM, at least one of a type indication or a category indication of the AUE. Accordingly, aspects herein for network-assisted DAA for AUEs provide improved DAA by enabling an AUE to report NWDAA capabilities and be authenticated for utilization of a network-based LDS with predictive deconfliction and multi-source information gathering capabilities.

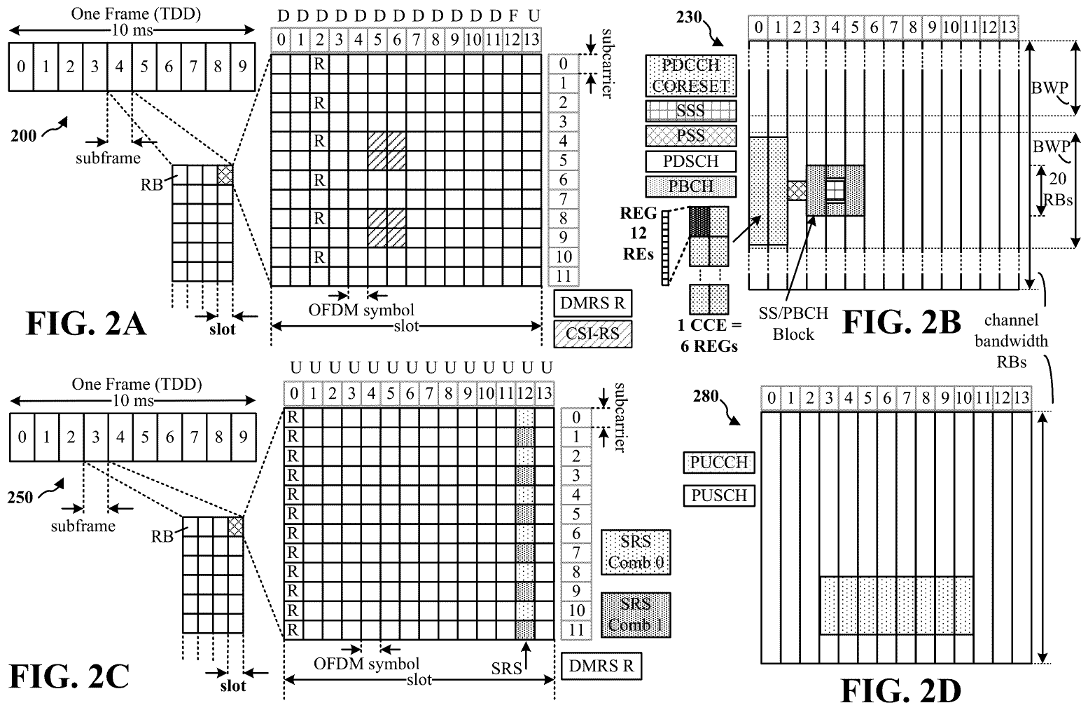

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δƒ = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 860 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

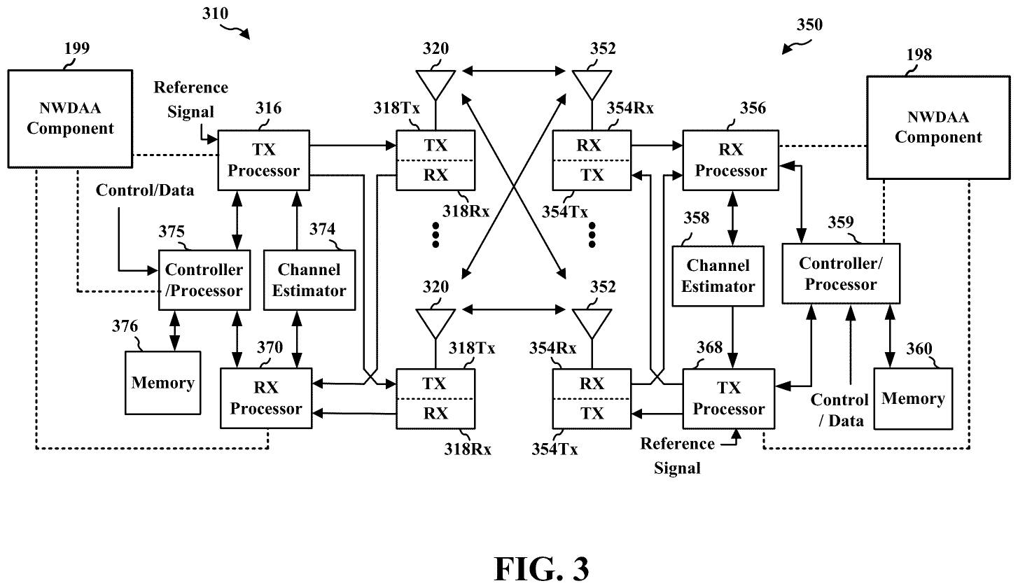

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

Communication networks may support wireless communication between a network entity (e.g., base stations, gNBs, CN entities, etc.) and UEs, such as AUEs. As an example, UAVs, drones, or other aerial devices may correspond to, or include, an AUE. SAA or DAA systems are technologies that allow UAVs and drones to integrate safely into civilian airspace, avoiding collisions with other aircraft, buildings, power lines, birds and other obstacles. These systems observe the environment surrounding the drone, decide whether a collision is imminent, and generate a new flight path in order to avoid collision. UAV sense and avoid systems may combine data from a number of sensors, using sensor fusion algorithms, image recognition and artificial intelligence to provide the best outcome. Data is fed back to the drone on-board computer and/or drone flight controller, which can then decide on the best evasive maneuver or flight path correction to avoid collision. A reliable onboard DAA system can be a basis for obtaining a waiver for flight operations in many jurisdictions that may otherwise require human observers or ground-based observation systems along the entire flight path. DAA systems may thus be utilized to unlock commercially viable BVLOS drone operations that provide services such as inspection and cargo delivery over extremely long distances. Common DAA solutions may include sensor-based implementations, e.g., having two main types of sensors: active and passive. Passive sensors may include electro-optical sensors (e.g., cameras), acoustic sensors, etc. Active sensors may include LIDAR, RADAR, SONAR, etc. Some solutions may be communication based. For instance, an AUE may, in theory, use systems originally designed for manned aviation, such as TCAS or ADS-B, that periodically broadcast and receive identity, position and other information. ACAS may be associated with standards that define DAA policies/regulations. For a UAS, ACAS may include different versions that are defined or in development for fixed wing UAS (ACAS-Xu), for rotorcraft (ACAS-Xr), and for DAA systems of small UAS (ACAS-sXu). However, such DAA policies/regulations target narrow/specific scenarios and do not provide an overall, network-assisted solution for AUE DAA.

Aspects herein for network-assisted DAA for AUEs provide improved DAA by enabling an AUE to report NWDAA capabilities and be authenticated for utilization of a network-based LDS with predictive deconfliction and multi-source information gathering capabilities. Aspects enable DAA for AUEs that is independent of a RPS, a UAVC, a GCS, a human pilot, and/or the like, enable DAA for AUEs that utilizes a degree of automation in an AUE, but does not rely solely on AUE awareness of surrounding traffic (e.g., on-board sensors and information collection for the AUE may still be leveraged with UAV-to-UAV (U2U) communications to collect information (e.g. as for ACAS sXu)), and enable DAA for AUEs to leverage ground network ability to have higher spatial awareness of air traffic, by providing NWDAA services via an LDS.

Conceptually, aspects herein for network-assisted DAA for AUEs provide for a computational function-based (e.g., (AI- or ML-based) localized unmanned aerial vehicle (UAV) traffic management (UTM) system or node and/or a UAS service supplier (USS) system or node (e.g., a UTM node and/or a USS node) tailored specifically for DAA to be placed in a RAN or implemented as an edge node. In aspects, such a UTM node and/or a USS node may be referred to as an LDS or a localized DAA server for predictive de-confliction. An LDS may be configured to provide a subscription-based traffic separation service, and LDS nodes may be configured to elaborate spatial awareness based on information collected on AUEs (and other aerial vehicles, UAVs, etc.). As one example, network nodes such as base stations or components of base stations (e.g., RU, DU, and/or CU), and/or other sources of information may feed data to an LDS, and the LDS may be configured to implement traffic separation algorithms and collision notification features across one or more cells. An AUE may be visible to and/or communicate with multiple LDSs.

Aspects may utilize an architecture herein, as described in further detail below, for which devices/systems/components such as an AUE and an LDS exchange express/explicit communications. For instance, an AUE may be registered with a wireless communication system (such as a 5G system (or another type of system described herein, or advanced systems such as 5G derivatives, 6G, etc.)) in order to communicate with an LDS. In aspects, an AUE may send information to an LDS (e.g., via two options: layer 2 (@L2) or layer 3 (@L3), as noted above. Information about the AUE itself and/or other AUEs that the AUE has detected, and may be configured to request deconfliction when the AUE detects a possible conflict/confliction. In aspects, the LDS may be configured to send information to a AUE (@L2 or @L3) as a warning and/or deconfliction information. In aspects, the LDS may be configured to interact via a NEF (also a “UAS NEF”) with a USS system. For instance, the LDS may be configured to provide aerial congestion/confliction information to an external application function (AF) (e.g., the NEF) acting as the USS system to support flight planning in the USS system. As another example, the LDS may be configured to retrieve AUE “public information” (e.g., an AUE category, a mission type, etc.) from the USS system via the NEF, e.g., as soon as the LDS detects the AUE and information on this AUE is not available locally.

Aspects herein for network-assisted DAA for AUEs may utilize sensing data collection and analysis, which may leverage a sensing network capability, data analysis (e.g., within the LDS or leveraged capability of a network data analytics function (NWDAF), etc., for obtaining/calculating/generating sensing data analysis results, as would be understood by persons of skill in the relevant art(s) having the benefit of this disclosure. Aspects herein for network-assisted DAA for AUEs are also described for communications (e.g., UAV-LDS, LDS-USS, with the NEF, etc.), as well as discovery functionality for aspects and various configurations. Additionally, as used herein, the term “AUE” may encompass devices for unmanned, powered flight, such as but without limitation, UAVs, drones, and/or the like, which may include a UE.

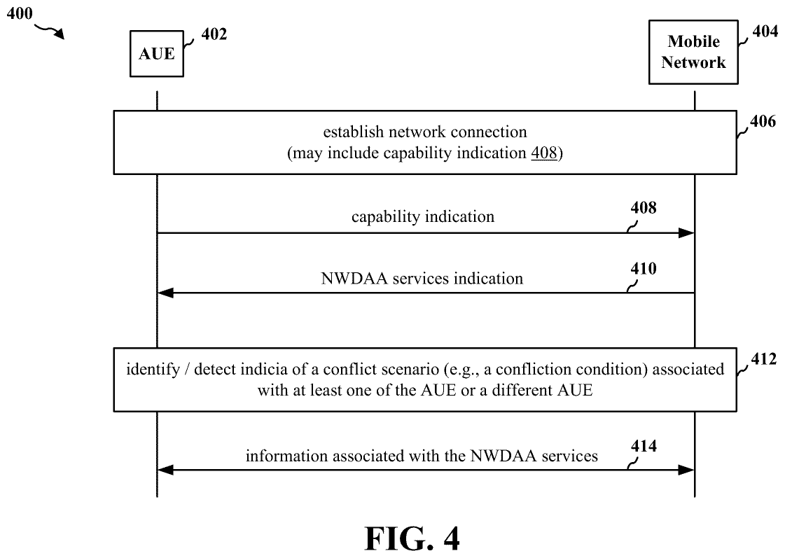

FIG. 4 is a call flow diagram 400 for wireless communications, in various aspects. Call flow diagram 400 illustrates network-assisted DAA for AUEs (an AUE 402, by way of example) that communicates with a mobile network 404 (e.g., a network node such as a base station, such as a gNB or other type of base station, by way of example, a network entity such as an AMF, an SMF, an LDS, an NEF, a USS system, a UTM system etc.), in various aspects. Aspects described for the mobile network 404, and for any components thereof described herein, generally, may be performed by one or more of such components in aggregated form, by one or more components in disaggregated form, and/or by any combination of such components. Additionally, or alternatively, the aspects may be performed by the AUE 402 autonomously, in addition to, and/or in lieu of, operations of the mobile network 404.

The AUE 402 may be configured to establish (at 406) a network connection with the mobile network 404. Additionally or conversely, the mobile network 404 may be configured to establish (at 406) a network connection with the AUE 402. In aspects, the AUE 402 may be configured to establish (at 406) a network connection with the mobile network 404 via a base station, gNB, etc., for an AMF/SMF of the mobile network 404, as would be understood by persons of skill in the relevant art(s) having the benefit of this disclosure. In aspects, establishment (at 406) of the connection to the mobile network may include performance of the provision of a capability indication 408 (described below), e.g., as part of mobility and access management (MM) signaling for the AMF, such as a registration request. That is, in some aspects, the AUE 402 may be configured to transmit/provide the capability indication 408 about support for the NWDAA services in a registration message as a part of establishing (at 406) a network connection.

The AUE 402 may be configured to transmit/provide, and the mobile network 404 may be configured to receive, a capability indication 408. In aspects, the capability indication 408 of the AUE 402 for support of NWDAA services. In aspects, an LDS herein may comprise the NWDAA services, or vice versa, the LDS may be configured to provide at least a portion of the NWDAA services, and/or the like. The transmission/provision of the capability indication 408 may be a portion of a discover of support for an LDS/NWDAA services. In aspects, when the AUE 402 is capable of utilizing an LDS, the AUE 402 indicates its support for the LDS (or network-assisted DAA, generally). In some aspects, the transmission/provision of the capability indication 408 may be via non-access stratum (NAS) signaling. As one example, the transmission/provision of the capability indication 408 may be for an AMF using MM signaling, such as a registration request in 5GMM capabilities. In such aspects, performance of the provision of the capability indication 408 may be included as a portion of the establishment (at 406) of the connection to the mobile network, e.g., as part of the MM signaling for the AMF, such as the registration request. That is, in some aspects, the AUE 402 may be configured to transmit/provide the capability indication 408 about support for the NWDAA services in a registration message as a part of establishing (at 406) a network connection. In another example, the transmission/provision of the capability indication 408 may be for an SMF using session management (SM) signaling, such as a PDU session request for establishment of a PDU session for layer 3 implementations, in 5GSM capabilities, or an express/explicit indication.

The mobile network 404 may be configured to transmit/provide, and the AUE 402 may be configured to receive, an NWDAA services indication 410. For instance, the mobile network 404 may be configured to indicate its LDS support. In aspects at layer 3, upon the AUE 402 indicating support for the LDS and/or a UDM subscription indicating that the LDS service is enabled for the AUE 402, upon registration the CN of the mobile network 404 indicates (e.g., by an SMF) that LDS service is supported in the AUE 402 registration procedure. In aspects, the CN of the mobile network 404 may indicate that LDS service is supported upon establishment of the PDU session for layer 3 procedures. In aspects, LDS availability may be indicated per PLMN, per registration area, per tracking area, per cells, per geographical area, etc. An AMF also may generate one or more registration areas so that LDS service is uniformly available within a registration area (e.g., so that the AUE 402 is not in a cell of the registration area(s) where there is no LDS service). For instance, the AUE 402 may utilize NWDAA services, according to aspects herein, from any cell within a registration area, which may be enabled by the AMF creating/generating a homogeneous registration area (e.g., an area where the LDS service is available in all the cells) that contains cells where the LDS is available. In some aspects, the CN of the mobile network 404 may provide a new service restriction area indicative of no LDS support (e.g., “No LDS support”) and containing the tracking area(s) where LDS service is not supported. In some aspects, the AUE 402 may perform mobility management in such a way as to avoid entering tracking area(s) where LDS service is not supported; or the AUE 402 may inform the LDS service of imminent loss of the LDS service before entering an area where the LDS service is not supported; and/or the AUE 402 may take action(s) such as relying wholly, or alternatively at least in part, on alternative DAA solutions.

In the context layer 2 and layer 3 operations, which may be alternative or complementary in various aspects, the LDS service may not be available in all locations, so either a cell SIB may have an indication of the LDS availability (e.g., “LDS available”) when the LDS service is available, and/or an indication may be sent in RRC establishment signaling and a base station/gNB may be configured to know whether the LDS service is available.

Further, the mobile network 404 may be configured to transmit/provide, and the AUE 402 may be configured to receive, addressing information associated with the NWDAA services and the LDS of the mobile network 404. In one example, in a registration acceptance (“Registration Accept”) such as by an AMF, in a PDU session establishment acceptance (“PDU Session Establishment Accept”) such as by an SMF, in an AUE 402 configuration update procedure, and/or the like, the mobile network 404 may transmit/provide the addressing information for the AUE 402. The LDS addressing information may include, but is not limited to, an LDS address (e.g., actual IP address), a uniform resource locator (URL) (which the AUE 402 may be configure to utilize to discover the LDS, e.g. using DNS), a fully qualified domain name (FQDN), an anycast address of the LDS, and/or the like.

The mobile network 404 and/or the AUE 402 may be configured to identify/detect (at 412) indicia of a conflict scenario (e.g., a confliction condition) associated with the AUE 402 and/or with a different AUE. In one example, the AUE 402 may be configured to obtain local awareness information associated with the AUE 402 (e.g., from the LDS and/or from sensors, etc., of the AUE 402, and to identify a confliction condition, associated with the NWDAA services, for the AUE 402 based on the local awareness information.

For instance, the AUE 402 may be configured to trigger an early detection indication to the LDS of the mobile network 404. The AUE 402 may comprise onboard processing/intelligence (e.g., a computational function) for conflict/confliction detection and/or awareness, and may be configured to report such conflict/confliction detection and/or awareness to the LDS. In aspects, the AUE 402 may perform continuous reporting or conditional reporting (e.g., the AUE 402 may be configured by the LDS to do one and/or the other, under what conditions, etc.). The AUE 402 may receive, from the LDS, configuration information on reporting to the LDS when a session is established with the LDS. Additionally, the AUE 402 may request deconfliction from the LDS.

As another example, the LDS of the mobile network 404 may be configured to trigger warnings to the AUE 402. The LDS may be configured to create local awareness (e.g., local awareness information) based on RAN sensing information, listening to DAA messages, BRID (Broadcast remote ID) messages, having access to sensors (e.g. ADS-B, RADAR, LIDAR, SONAR, AUE 402 positioning, NR) sensing information, etc.). In aspects, a BRID coverage area may provide coverage for a beacon-like set of BRID messages that the AUE 402 may be configured to send/transmit/provide (e.g., over Wi-Fi™ (Wi-Fi is a trademark of the Wi-Fi Alliance), Bluetooth™ (Bluetooth is a trademark of the Bluetooth Special Interest Group (SIG)), 6GPP LTE-V2X (PC5), etc.) containing a UAV ID of the AUE 402, a vector of movement, a position, and/or the like. In aspects, the LDS may be configured to receive information from multiple sources, including BRID receivers of a BRID coverage area, and utilize such information in associated with NWDAA services for the AUE 402.

The LDS may send such information to the AUE 402 to enhance situational awareness of AUE 402, yet detection and deconfliction may be performed in AUE 402 for warnings (e.g., the LDS may provide deconfliction suggestions/strategies, and the AUE 402 chooses the appropriate one by implementation or configuration information/policies provided by either a UAS operator or a USS system, e.g., depending on geographic regulations).

As another example, the LDS may be configured to trigger emergency directives/path directives (e.g., deconfliction directives, generally) to the AUE 402 and/or a UAVC (or the AUE 402 may inform the UAVC itself). In such aspects, the detection and deconfliction may be performed in the LDS. In some aspects, detection may be based on the AUE 402 request for the deconfliction, or may be based on the LDS's intelligence (e.g., local awareness), or both. In some aspects, the AUE 402 and the UAVC follow the command for deconfliction from the LDS in the case of an emergency directive.

The mobile network 404 (e.g., by an LDS(s) thereof) and/or the AUE 402 may be configured to communicate communication information 414 associated with the NWDAA services. In aspects, the communication information 414 may be any information associated with the NWDAA services and/or an LDS, as described herein. In aspects for AUE-LDS communications, an LDS may operate as a passive LDS receiver or as an active LDS receiver.

As a passive LDS receiver, LDS nodes may receive U2X information (e.g. DAA, BRID) sent by AUEs such as the AUE 402: sidelink receivers in a base station/gNB may be configured to receive such information; a base station/gNB (RAN) may report received BRID and/or DAA signaling sent by AUEs to the LDS(s) covering the base station/gNB area. In such aspects, a RAN node may be configured with the identity/address of the one or more LDS(s) serving the area of the RAN node. Such configurations may leverage information already available via LTE/NR aerial features (e.g., path reporting). The LDS may receive ADS-B information from manned aviation: this may leverage receivers in the base station/gNB that report ADS-B traffic to the LDS.

As an active LDS receiver, the AUE 402 may be configured to send information directly and explicitly to the LDS (e.g., location, flight path, etc.). The AUE 402 may be configured to trigger an early detection indication to the LDS, e.g., the AUE 402 may be configured to detect locally a possible conflict and report it to the LDS (e.g., including information received from other AUEs, including AUE ID(s), path, etc.), and either: (i) includes its planned deconfliction strategy (e.g., a trajectory change) that the UAS may compute autonomously, or (ii) includes a request for a “guided” trajectory change, which the LDS may compute and report back. The AUE 402 may also be configured to report to the LDS that the conflict is cleared subsequent to the conflict being cleared.

In aspects for LDS-AUE communications, the LDS may be configured to trigger warnings to the AUE 402. A potential conflict detection in the LDS may trigger a warning and potential confliction resolution/de-escalation/de-confliction instructions to the AUE 402, if requested, or if proximity thresholds are violated (e.g., are met). In aspects, the LDS may be configured to trigger an emergency directive to the AUE 402. A conflict/confliction detection (e.g., a critical conflict/confliction detection) in the LDS may trigger a path directive (e.g., a non-emergency deconfliction) or an emergency directive (e.g., an urgent emergency deconfliction) to the AUE 402. A path directive may include information associated with a new flight path that the LDS may have received from the UTM system/the USS system. An emergency directive may include an imminent collision status message with basic metadata about the other aircraft(s)/UAV(s) and may include multiple deconfliction solutions/strategies that are presented. In aspects, such a set of deconfliction solutions/strategies may be scored (e.g., prioritized) and may be provided to the UAS. The UAS, or its controller, may then consider the options and execute one (or more) based on its own knowledge and sensor status, by way of example.

Based on local policies or USS configuration, a warning may be sent under specific conditions (e.g. an AUE category like drone AUE size or mission type, e.g. public safety versus package delivery), an AUE size, an AUE class, a mission type, a public safety priority, or a delivery priority. The LDS may be configured to receive configuration information for the specific AUE or class of AUE (e.g., either by the AUE 402 providing its AUE ID explicitly, or the LDS, based on the received AUE ID broadcasted by the AUE, may derive the specific AUE information, or the LDS may receive the information from the UAS NF, which receives the information during the AUE 402 registration with the mobile network operator (MNO) from the USS).

In aspects for LDS-AUE communications, model of communication may be direct or indirect. In a direct model, a command and control (C2) link may be sent by the LDS to the AUE 402. In an indirect model, if the LDS is aware of the UAVC, either the LDS informs UAVC, or the AUE 402 informs the UAVC over the C2 link.

In aspects for AUE-LDS connectivity, the LDS connectivity may be layer 3 connectivity at the application layer, e.g., the user plane. For example, the AUE 402 may be configured to establish a session with the LDS upon (i) discovering the LDS is supported, and (ii) discovering LDS information, as noted herein. The AUE 402 may be provided, in NAS registration messages, with information regarding the LDS server discovery (e.g., the server address), or the AUE 402 may be pre-configured with information regarding the LDS(s) such as, but without limitation, an IP address, a URL, a FQDN, or an anycast address of the LDS (e.g., FQDNs may be used to discover the IP address of the LDS).

In aspects, an AMF may provide such information upon determining that the AUE 402 has an aerial subscription, has indicated its NWDAA/LDS capability, and is an authorized AUE (e.g., an UAS service supplier (USS) authentication and authorization (UUAA)/procedure has been performed successfully, when UUAA is supported and/or mandated). The LDS server address may be provided via a PDU session establishment/PDN connection establishment procedure upon successful UUAA-SM by an SMF when LDS information is in the UDM (e.g., provided by the LDS provider, whether it is the MNO or a third party, and is configured via an API via the NEF). In aspects, the LDS server address may be configured by a policy control function (PCF), and the AUE 402 may be configured with an LDS anycast address that the AUE 402 may utilize to discover the LDS.

In aspects, a session may be moved to a new LDS (e.g., LDS instance) based on edge server re-allocation procedures. In some aspects, a dedicated access point name (APN)/data network name (DNN) may be defined for this service, and/or the AUE 402 may be configured by the USS and/or the MNO with respect to the APN/DNN to use upon successful authorization.

As described herein, the LDS may be deployed as an edge-node (e.g., as an edge application server), in aspects.

In aspects for AUE-LDS connectivity, the LDS connectivity may be layer 3 connectivity at the application layer, e.g., the user plane. For example, the LDS may be deployed as a RAN node/function. The AUE 402 may be configured to communicate with the LDS via RAN signaling (e.g., by RRC transport messages) to report/warn, as well as to receive warnings and deconfliction directives. For RRC messages containing LDS-related data, the AUE 402 may be configured to send RRC signaling with an explicit indication for LDS/DWDAA services, so that the RAN routes the signaling payload to the correct server (e.g., via a new value for “payload type” specific to this scenario for the AUE 402).

In aspects for LDS-AUE communication with respect to a serving cell(s), the LDS may be configured to determine the serving cell(s) of the AUE 402. For layer 2 communications, in aspects, the LDS may be configured to utilize a “paging area” concept, e.g., the LDS may be configured to send the information to the AUE 402 in multiple cells, which may be identified based on configuration information or corresponding to the paging area. In other layer 2 aspects, as long as the LDS knows or is aware of the serving base station/gNB of the AUE 402, the LDS may be configured to send the information to the base station/gNB that sends the information to all the serving cells (e.g., not a specific cell, but a specific RAN node).

In aspects for AUE-LDS connectivity, the LDS connectivity may be layer 3 connectivity at the control plane. For example, the LDS may be deployed as a local application server that is integrated with a local NEF. The AUE 402 may be configured to communicate with the LDS via control plane Cellular Internet of Things (CIoT) communications to report/warn, as well as to receive warning and deconfliction directives. As an example, the communications may start at the AUE 402 and be sent via the AMF to a local NEF/the LDS. In aspects, an existing NEF API (e.g., a non-IP data delivery) may be utilized. The data payload may be defined, e.g., XML schema for DAA operation, and the local NEF concept can be utilized, e.g., to reduce delay. In aspects, when a serving NEF/LDS changes, a Non-IP Data Delivery (NIDD) connection path may be established with the serving AMF.

In some aspects, the AMF may support control plane CIoT and NIDD APIs, and the NEF-LDS interface may not have to be specified, e.g., it may be integrated. Additionally, there may be no impact on L2 signaling in such aspects, which may be used for access by the AUE 402 to other services using data traffic, and hop-by-hop security may be guaranteed, in such aspects.

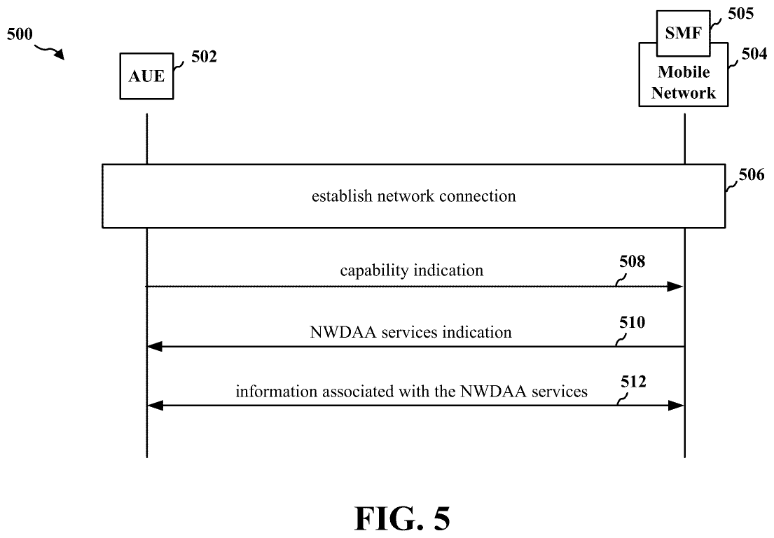

FIG. 5 is a call flow diagram 500 for wireless communications, in various aspects. Call flow diagram 500 illustrates network-assisted DAA for AUEs (an AUE 502, by way of example) that communicates with a mobile network 504 (e.g., a network node such as a base station, such as a gNB or other type of base station, by way of example, a network entity such as an AMF, an SMF 505, an LDS, an NEF, a USS system, a UTM system etc.), in various aspects. Aspects described for the mobile network 504 and the SMF 505, and for any components thereof described herein, generally, may be performed by one or more of such components in aggregated form, by one or more components in disaggregated form, and/or by any combination of such components. Additionally, or alternatively, the aspects may be performed by the AUE 502 autonomously, in addition to, and/or in lieu of, operations of the mobile network 504/the SMF 505.

The AUE 502 may be configured to establish (at 506) a network connection with the mobile network 504 and the SMF 505. Additionally or conversely, the mobile network 504 and the SMF 505 may be configured to establish (at 506) a network connection with the AUE 502. In aspects, the AUE 502 may be configured to establish (at 506) a network connection with the mobile network 504 via a base station, gNB, etc., for the SMF 505 of the mobile network 504, as would be understood by persons of skill in the relevant art(s) having the benefit of this disclosure.

The AUE 502 may be configured to transmit/provide, and the mobile network 504 and the SMF 505 may be configured to receive, a capability indication 508. In aspects, the capability indication 508 of the AUE 502 for support of NWDAA services. In aspects, an LDS herein may comprise the NWDAA services, or vice versa, the LDS may be configured to provide at least a portion of the NWDAA services, and/or the like. The transmission/provision of the capability indication 508 may be a portion of a discover of support for an LDS/NWDAA services. In aspects, when the AUE 502 is capable of utilizing an LDS, the AUE 502 indicates its support for the LDS (or network-assisted DAA, generally). In some aspects, the transmission/provision of the capability indication 508 may be via NAS signaling. As one example, the transmission/provision of the capability indication 508 may be for the SMF 505 using session management (SM) signaling, such as a PDU session request for establishment of a PDU session for layer 3 implementations, in 5GSM capabilities, or an express/explicit indication. In aspects, the SMF 505 may be configured to provide, e.g., for a UAS NF, an AUE authorization for a UUAA procedure based at least in part on the capability indication. For a UUAA-MM performed by an AMF, the AMF may be configured to provide information associated with the LDS, as the serving LDS, directly to the UAS NF. For a UUAA-SM, if the AMF selects the serving LDS the AMF may provide such information to the SMF 505, and the SMF 505 may provide or relay the information in the UUAA-SM signaling to the UAS NF.

The mobile network 504 and the SMF 505 may be configured to transmit/provide, and the AUE 502 may be configured to receive, an NWDAA services indication 510. For instance, the mobile network 504 and the SMF 505 may be configured to indicate its LDS support. In aspects at layer 3, upon the AUE 502 indicating support for the LDS and/or a UDM subscription indicating that the LDS service is enabled for the AUE 502, upon registration the CN of the mobile network 504 indicates (e.g., by the SMF 505) that LDS service is supported in the AUE 502 registration procedure. In aspects, the CN of the mobile network 504 may indicate via the SMF 505 that LDS service is supported upon establishment of the PDU session for layer 3 procedures. In aspects, LDS availability may be indicated per PLMN, per registration area, per tracking area, per cells, per geographical area, etc. An AMF also may generate a registration area(s) so that LDS service is uniformly available in registration area(s) (e.g., so that the AUE 502 is not in a cell of the registration area(s) where there is no LDS service). In some aspects, the CN of the mobile network 504 may provide a new service restriction area indicative of no LDS support (e.g., “No LDS support”) and containing the tracking area(s) where LDS service is not supported. In some aspects, the AUE 502 may perform mobility management in such a way as to avoid entering tracking area(s) where LDS service is not supported; or the AUE 502 may inform the LDS service of imminent loss of the LDS service before entering an area where the LDS service is not supported; and/or the AUE 502 may take action(s) such as relying wholly, or alternatively at least in part, on alternative DAA solutions.

In the context of layer 2 and layer 3 operations associated with the SMF 505, which may be alternative and/or complementary in various aspects, the LDS service may not be available in all locations, so either a cell SIB may have an indication of the LDS availability (e.g., “LDS available”) when the LDS service is available, and/or an indication may be sent in RRC establishment signaling and a base station/gNB may be configured to know whether the LDS service is available.

Further, the mobile network 504 and the SMF 505 may be configured to transmit/provide, and the AUE 502 may be configured to receive, addressing information associated with the NWDAA services and the LDS of the mobile network 504. In one example, in a PDU session establishment acceptance (“PDU Session Establishment Accept”) such as by the SMF 505, in an AUE 502 configuration update procedure, and/or the like, the mobile network 504 and the SMF 505 may transmit/provide the addressing information for the AUE 502. The LDS addressing information may include, but is not limited to, an LDS address (e.g., actual IP address), a URL (which the AUE 502 may be configure to utilize to discover the LDS, e.g. using DNS), a FQDN, an anycast address of the LDS, and/or the like.

In the mobile network 504, for the CN to RAN communications associated with LDS/NWDAA services support, layer 2 communications may be utilized to activate RAN-LDS connectivity, and layer 2/layer 3 communications may be utilized to activate the RAN to report to the LDS. For instance, in cases for which a UUAA-SM is performed, the SMF 505 may be configured to indicate to the RAN by adding a new indication in 5G access network (AN) to SMF (N2 SM) messaging whether the LDS is authorized for the AUE 502 after UUAA-SM completion.

When the LDS service is activated in the RAN, the RAN may generate information from sensors and provide the information to the LDS based on an operations administration and maintenance (OAM) configuration. Sensors may be RAN sensing capabilities, BRID receivers, ADS-B receivers, DAA broadcast receivers, weather sensors, LIDAR, RADAR, SONAR, NR sensing capabilities, and/or the like. For layer 2 implementations, the RAN may be preconfigured with the serving LDS information and have connectivity with the LDS. In aspects, such a configuration may be performed by the OAM, where the OAM provides to each RAN node the address of the LDS to be used.

The mobile network 504 (e.g., by an LDS(s) thereof) and/or the AUE 502 may be configured to communicate communication information 512 associated with the NWDAA services. In aspects, the communication information 512 may be any information associated with the NWDAA services and/or an LDS, as described herein. In aspects for AUE-LDS communications, an LDS may operate as a passive LDS receiver or as an active LDS receiver.

In aspects for AUE-LDS connectivity, the LDS connectivity may be layer 3 connectivity at the application layer, e.g., the user plane. For example, the AUE 502 may be configured to establish a session with the LDS upon (i) discovering the LDS is supported, and (ii) discovering LDS information, as noted herein. The AUE 502 may be provided, in NAS registration messages, with information regarding the LDS server discovery (e.g., the server address), or the AUE 502 may be pre-configured with information regarding the LDS(s) such as, but without limitation, an IP address a URL, a FQDN, or an anycast address of the LDS (e.g., FQDNs may be used to discover the IP address of the LDS). In aspects, the LDS server address may be provided via a PDU session establishment/PDN connection establishment procedure by the SMF 505 upon successful UUAA-SM when LDS information is in the UDM (e.g., provided by the LDS provider, whether it is the MNO or a third party, and is configured via an API via the NEF). In aspects, the LDS server address may be configured by a PCF, and the AUE 502 may be configured with an LDS anycast address that the AUE 502 may utilize to discover the LDS.

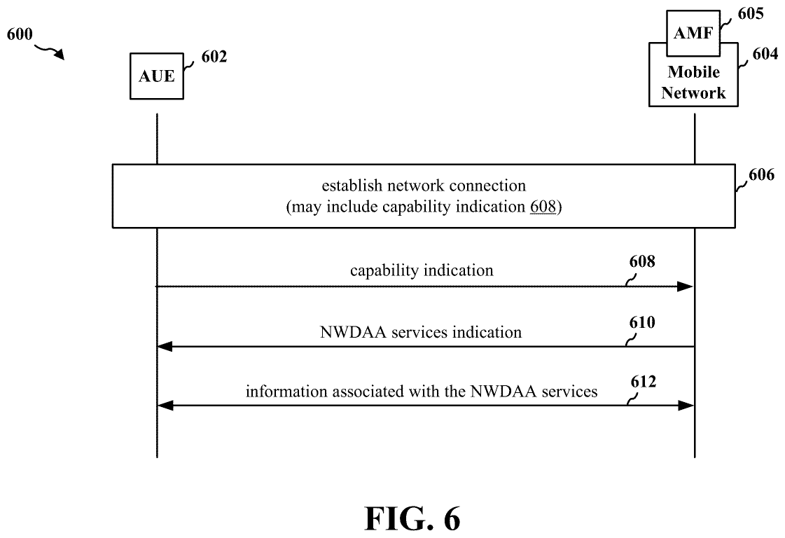

FIG. 6 is a call flow diagram 600 for wireless communications, in various aspects. Call flow diagram 600 illustrates network-assisted DAA for AUEs (an AUE 602, by way of example) that communicates with a mobile network 604 (e.g., a network node such as a base station, such as a gNB or other type of base station, by way of example, a network entity such as an AMF 605, an SMF, an LDS, an NEF, a USS system, a UTM system etc.), in various aspects. Aspects described for the mobile network 604 and the AMF 605, and for any components thereof described herein, generally, may be performed by one or more of such components in aggregated form, by one or more components in disaggregated form, and/or by any combination of such components. Additionally, or alternatively, the aspects may be performed by the AUE 602 autonomously, in addition to, and/or in lieu of, operations of the mobile network 604/the AMF 605.

The AUE 602 may be configured to establish (at 606) a network connection with the mobile network 604 and the AMF 605. Additionally or conversely, the mobile network 604 and the AMF 605 may be configured to establish (at 606) a network connection with the AUE 602. In aspects, the AUE 602 may be configured to establish (at 606) a network connection with the mobile network 604 via a base station, gNB, etc., for the AMF 605 of the mobile network 604, as would be understood by persons of skill in the relevant art(s) having the benefit of this disclosure. In aspects, establishment (at 606) of the connection to the mobile network may include performance of the provision of a capability indication 608 (described below), e.g., as part of MM signaling for the AMF 605, such as the registration request. That is, in some aspects, the AUE 602 may be configured to transmit/provide the capability indication 608 about support for the NWDAA services in a registration message as a part of establishing (at 606) a network connection.

The AUE 602 may be configured to transmit/provide, and the mobile network 604 and the AMF 605 may be configured to receive, a capability indication 608. In aspects, the capability indication 608 of the AUE 602 for support of NWDAA services. In aspects, an LDS herein may comprise the NWDAA services, or vice versa, the LDS may be configured to provide at least a portion of the NWDAA services, and/or the like. The transmission/provision of the capability indication 608 may be a portion of a discover of support for an LDS/NWDAA services. In aspects, when the AUE 602 is capable of utilizing an LDS, the AUE 602 indicates its support for the LDS (or network-assisted DAA, generally). In some aspects, the transmission/provision of the capability indication 608 may be via NAS signaling. As one example, the transmission/provision of the capability indication 608 may be for the AMF 605 using MM signaling, such as a registration request in 5GMM capabilities. In such aspects, performance of the provision of the capability indication 608 may be included as a portion of the establishment (at 606) of the connection to the mobile network, e.g., as part of the MM signaling for the AMF 605, such as the registration request. That is, in some aspects, the AUE 602 may be configured to transmit/provide the capability indication 608 about support for the NWDAA services in a registration message as a part of establishing (at 606) a network connection.

The mobile network 604 and the AMF 605 may be configured to transmit/provide, and the AUE 602 may be configured to receive, an NWDAA services indication 610. For instance, the mobile network 604 and the AMF 605 may be configured to indicate its LDS support. In aspects, LDS availability may be indicated per PLMN, per registration area, per tracking area, per cells, per geographical area, etc. The AMF 605 also may generate a registration area(s) so that LDS service is uniformly available in registration area(s) (e.g., so that the AUE 602 is not in a cell of the registration area(s) where there is no LDS service). In some aspects, the CN of the mobile network 604 may provide a new service restriction area indicative of no LDS support (e.g., “No LDS support”) and containing the tracking area(s) where LDS service is not supported. In some aspects, the AUE 602 may perform mobility management in such a way as to avoid entering tracking area(s) where LDS service is not supported; or the AUE 602 may inform the LDS service of imminent loss of the LDS service before entering an area where the LDS service is not supported; and/or the AUE 602 may take action(s) such as relying wholly, or alternatively at least in part, on alternative DAA solutions.

In the context of layer 2 and layer 3 operations associated with the AMF 605, which may be alternative and/or complementary in various aspects, the LDS service may not be available in all locations, so either a cell SIB may have an indication of the LDS availability (e.g., “LDS available”) when the LDS service is available, and/or an indication may be sent in RRC establishment signaling and a base station/gNB may be configured to know whether the LDS service is available.

Further, the mobile network 604 and the AMF 605 may be configured to transmit/provide, and the AUE 602 may be configured to receive, addressing information associated with the NWDAA services and the LDS of the mobile network 604. In one example, in a registration acceptance (“Registration Accept”) such as by the AMF 605, in an AUE 602 configuration update procedure, and/or the like, the mobile network 604 and the AMF 605 may transmit/provide the addressing information for the AUE 602. The LDS addressing information may include, but is not limited to, an LDS address (e.g., actual IP address), a URL (which the AUE 602 may be configure to utilize to discover the LDS, e.g. using DNS), a FQDN, an anycast address of the LDS, and/or the like.

In aspects, the AMF 605 may provide such information upon determining that the AUE 402 has an aerial subscription, has indicated its NWDAA/LDS capability, and is an authorized AUE (e.g., an UAS service supplier (USS) authentication and authorization (UUAA)/procedure has been performed successfully, when UUAA is supported and/or mandated).

In the mobile network 604, for the CN to RAN communications associated with LDS/NWDAA services support, layer 2 communications may be utilized to activate RAN-LDS connectivity, and layer 2/layer 3 communications may be utilized to activate the RAN to report to the LDS. For instance, upon AUE 602 registration, if the AUE 602 subscription is for an aerial UE and the AMF 605 successfully authenticates the AUE 602, then the AMF 605 may indicate to the RAN whether the LDS is authorized for the AUE 602. In aspects, the indication by the AMF 605 of the LDS authorization for the AUE 602 may be based on a successful UUAA authentication/authorization, and/or if the AUE 602 has indicated in 5GMM capabilities that it supports the LDS service.

When the LDS service is activated in the RAN, the RAN may generate information from sensors and provide the information to the LDS based on an operations administration and maintenance (OAM) configuration. Sensors may be RAN sensing capabilities, BRID receivers, ADS-B receivers, DAA broadcast receivers, weather sensors, LIDAR, RADAR, SONAR, NR sensing capabilities, and/or the like. For layer 2 implementations, the RAN may be preconfigured with the serving LDS information and have connectivity with the LDS. In aspects, such a configuration may be performed by the OAM, where the OAM provides to each RAN node the address of the LDS to be used.

The mobile network 604 (e.g., by an LDS(s) thereof) and/or the AUE 602 may be configured to communicate communication information 612 associated with the NWDAA services. In aspects, the communication information 612 may be any information associated with the NWDAA services and/or an LDS, as described herein. In aspects for AUE-LDS communications, an LDS may operate as a passive LDS receiver or as an active LDS receiver.

In aspects for AUE-LDS connectivity, the LDS connectivity may be layer 3 connectivity at the application layer, e.g., the user plane. For example, the AUE 602 may be configured to establish a session with the LDS upon (i) discovering the LDS is supported, and (ii) discovering LDS information, as noted herein. The AUE 602 may be provided, in NAS registration messages, with information regarding the LDS server discovery (e.g., the server address), or the AUE 602 may be pre-configured with information regarding the LDS(s) such as, but without limitation, an IP address, a URL, a FQDN, or an anycast address of the LDS (e.g., FQDNs may be used to discover the IP address of the LDS). In aspects, the LDS server address may be configured by a PCF, and the AUE 602 may be configured with an LDS anycast address that the AUE 602 may utilize to discover the LDS.

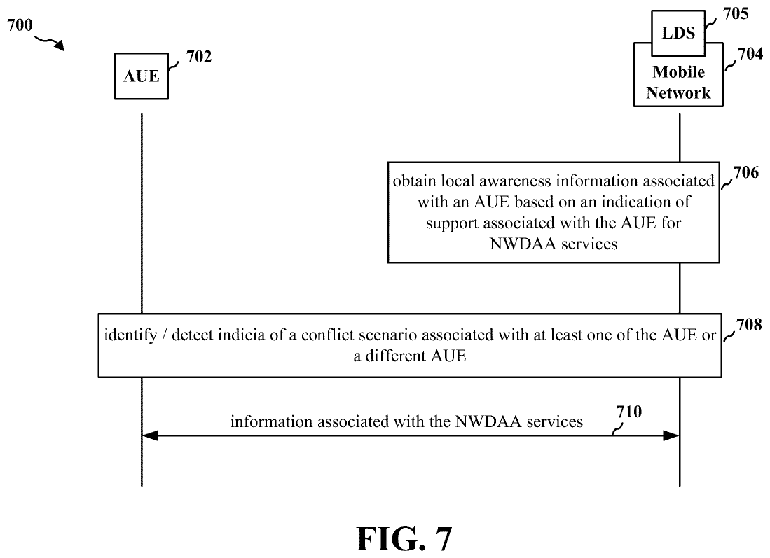

FIG. 7 is a call flow diagram 700 for wireless communications, in various aspects. Call flow diagram 700 illustrates network-assisted DAA for AUEs (an AUE 702, by way of example) that communicates with a mobile network 704 (e.g., a network node such as a base station, such as a gNB or other type of base station, by way of example, a network entity such as an AMF, an SMF, an LDS 705, an NEF, a USS system, a UTM system etc.), in various aspects. Aspects described for the mobile network 704 and the LDS 705, and for any components thereof described herein, generally, may be performed by one or more of such components in aggregated form, by one or more components in disaggregated form, and/or by any combination of such components. Additionally, or alternatively, the aspects may be performed by the AUE 702 autonomously, in addition to, and/or in lieu of, operations of the mobile network 704/the LDS 705.

The LDS 705 may be configured to obtain (at 706) local awareness information associated with the AUE 702 based on an indication of support associated with the AUE 702 for NWDAA services. As described herein, an AUE, e.g., the AUE 702, may be configured to establish a network connection with a mobile network, e.g., the mobile network 704, and be authenticated for an LDS/NWDAA services via an AMF/SMF based on a capability indication (e.g., 408 in FIG. 4; 508 in FIG. 5; 608 in FIG. 6).

In the mobile network 704, for the CN to RAN communications associated with LDS/NWDAA services support, layer 2 communications may be utilized to activate RAN-LDS connectivity, and layer 2/layer 3 communications may be utilized to activate the RAN to report to the LDS 705. For instance, upon AUE 702 registration, if the AUE 702 subscription is for an aerial UE and the AMF successfully authenticates the AUE 702, then the AMF may indicate to the RAN whether the LDS 705 is authorized for the AUE 702. In aspects, the indication by the AMF of the LDS 705 authorization for the AUE 702 may be based on a successful UUAA authentication/authorization, and/or if the AUE 702 has indicated in 5GMM capabilities that it supports the LDS 705 service. In cases for which a UUAA-SM is performed, the SMF may be configured to indicate to the RAN by adding a new indication in 5G access network (AN) to SMF (N2 SM) messaging whether the LDS 705 is authorized for the AUE 702 after UUAA-SM completion. When the LDS 705 service is activated in the RAN, the RAN may generate information from sensors and provide the information to the LDS 705 based on an operations administration and maintenance (OAM) configuration. Sensors may be RAN sensing capabilities, BRID receivers, ADS-B receivers, DAA broadcast receivers, weather sensors, LIDAR, RADAR, SONAR, NR sensing capabilities, and/or the like. For layer 2 implementations, the RAN may be preconfigured with the serving LDS information and have connectivity with the LDS 705. In aspects, such a configuration may be performed by the OAM, where the OAM provides to each RAN node the address of the LDS 705 to be used.

The LDS 705 may be configured to create local awareness (e.g., local awareness information associated with the AUE 702) based on RAN sensing information from one or more of the sensors noted herein, e.g., listening to DAA messages, BRID (Broadcast remote ID) messages, having access to other sensors (e.g. ADS-B, RADAR, LIDAR, SONAR, AUE 702 positioning, NR) sensing information, etc.). In aspects, obtaining (at 706) the local awareness information by the LDS 705 may include receiving information from the AUE 702. In other words, the local awareness (e.g., local awareness information associated with the AUE 702) obtained (at 706) by the LDS 705 may be a network-based aggregation of sensor and other information from a wide variety of sources both within the mobile network 704 and outside of it.

The mobile network 704 and the LDS 705, and/or the AUE 702, may be configured to identify/detect (at 708) indicia of a conflict scenario (e.g., a confliction condition) associated with the AUE 702 and/or with a different AUE. That is, the LDS 705 may be configured to identify a confliction condition, associated with the NWDAA services, for the AUE 702 based on the local awareness information. In one example, the AUE 702 may be configured to obtain local awareness information associated with the AUE 702 (e.g., from the LDS 705 and/or from sensors, etc., of the AUE 702, and to identify a confliction condition, associated with the NWDAA services, for the AUE 702 based on the local awareness information.

For instance, the AUE 702 may be configured to trigger an early detection to the LDS 705 of the mobile network 704. The AUE 702 may comprise onboard processing/intelligence (e.g., a computational function) for conflict/confliction detection and/or awareness, and may be configured to report such conflict/confliction detection and/or awareness to the LDS 705. In aspects, the AUE 702 may perform continuous reporting or conditional reporting (e.g., the AUE 702 may be configured by the LDS 705 to do one and/or the other, under what conditions, etc.). The AUE 702 may receive, from the LDS 705, configuration information on reporting to the LDS 705 when a session is established with the LDS 705. Additionally, the AUE 702 may request deconfliction from the LDS 705.

As another example, the LDS 705 of the mobile network 704 may be configured to trigger warnings to the AUE 702. The LDS 705 may be configured to create local awareness (e.g., local awareness information) based on RAN sensing information, listening to DAA messages, BRID (Broadcast remote ID) messages, having access to sensors (e.g. ADS-B, RADAR, LIDAR, SONAR, AUE 702 positioning, NR) sensing information, etc.). The LDS 705 may send such information to the AUE 702 to enhance situational awareness of AUE 702, yet detection and deconfliction may be performed in AUE 702 for warnings (e.g., the LDS 705 may provide deconfliction suggestions/strategies, and the AUE 702 chooses the appropriate one by implementation or configuration information/policies provided by either a UAS operator or a USS system, e.g., depending on geographic regulations).

As another example, the LDS 705 may be configured to trigger emergency directives/path directives (e.g., deconfliction directives, generally) to the AUE 702 and/or a UAVC (or the AUE 702 may inform the UAVC itself). In such aspects, the detection and deconfliction may be performed in the LDS 705. In some aspects, detection may be based on the AUE 702 request for the deconfliction, or may be based on the intelligence (e.g., local awareness) of the LDS 705, or both. In some aspects, the AUE 702 and the UAVC follow the command for deconfliction from the LDS 705 in the case of an emergency directive.

The mobile network 704 (e.g., by at least one instance of the LDS 705) and/or the AUE 702 may be configured to communicate communication information 710 associated with the NWDAA services. In aspects, the communication information 710 may be any information associated with the NWDAA services and/or the LDS 705, as described herein. In aspects for AUE-LDS communications, the LDS 705 may operate as a passive LDS receiver or as an active LDS receiver.

As a passive LDS receiver, LDS nodes such as the LDS 705 may receive U2X information (e.g. DAA, BRID) sent by AUEs such as the AUE 702: sidelink receivers in a base station/gNB may be configured to receive such information; a base station/gNB (RAN) may report received BRID and/or DAA signaling sent by AUEs to the LDS 705 covering the base station/gNB area. In such aspects, a RAN node may be configured with the identity/address of the one or more of the LDS 705 serving the area of the RAN node. Such configurations may leverage information already available via LTE/NR aerial features (e.g., path reporting). The LDS 705 may receive ADS-B information from manned aviation: this may leverage receivers in the base station/gNB that report ADS-B traffic to the LDS 705.

As an active LDS receiver, the AUE 702 may be configured to send information directly and explicitly to the LDS 705 (e.g., location, flight path, etc.). The AUE 702 may be configured to trigger an early detection to the LDS 705, e.g., the AUE 702 may be configured to detect locally a possible conflict and report it to the LDS 705 (e.g., including information received from other AUEs, including AUE ID(s), path, etc.), and either: (i) includes its planned deconfliction strategy (e.g., a trajectory change) that the UAS may compute autonomously, or (ii) includes a request for a “guided” trajectory change, which the LDS 705 may compute and report back. The AUE 702 may also be configured to report to the LDS 705 that the conflict is cleared subsequent to the conflict being cleared.

In aspects for LDS-AUE communications, the LDS 705 may be configured to trigger warnings to the AUE 702. A potential conflict detection in the LDS 705 may trigger a warning and potential de-escalation/de-conflictions instructions to the AUE 702, if requested, or if proximity thresholds are violated (e.g., are met). In aspects, the LDS 705 may be configured to trigger an emergency directive to the AUE 702. A conflict/confliction detection (e.g., a critical conflict/confliction detection) in the LDS 705 may trigger a path directive (e.g., a non-emergency deconfliction) or an emergency directive (e.g., an urgent emergency deconfliction) to the AUE 702. A path directive may include information associated with a new flight path that the LDS 705 may have received from the UTM system/the USS system. An emergency directive may include an imminent collision status message with basic metadata about the other aircraft(s)/UAV(s) and may include multiple deconfliction solutions/strategies that are presented. In aspects, such a set of deconfliction solutions/strategies may be scored (e.g., prioritized) and may be provided to the UAS. The UAS, or its controller, may then consider the options and execute one (or more) based on its own knowledge and sensor status, by way of example.

Based on local policies or USS configuration, a warning may be sent under specific conditions (e.g. an AUE category like drone AUE size or mission type, e.g. public safety versus package delivery), an AUE size, an AUE class, a mission type, a public safety priority, or a delivery priority. The LDS 705 may be configured to receive configuration information for the specific AUE or class of AUE (e.g., either by the AUE 702 providing its AUE ID explicitly, or the LDS 705, based on the received AUE ID broadcasted by the AUE, may derive the specific AUE information, or the LDS 705 may receive the information from the UAS NF, which receives the information during the AUE 702 registration with the mobile network operator (MNO) from the USS).

In aspects for LDS-AUE communications, model of communication may be direct or indirect. In a direct model, a C2 link may be sent by the LDS 705 to the AUE 702. In an indirect model, if the LDS 705 is aware of the UAVC, either the LDS 705 informs UAVC, or the AUE 702 informs the UAVC over the C2 link.

In aspects for AUE-LDS connectivity, the LDS 705 connectivity may be layer 3 connectivity at the application layer, e.g., the user plane. For example, the AUE 702 may be configured to establish a session with the LDS 705 upon (i) discovering the LDS 705 is supported, and (ii) discovering LDS 705 information, as noted herein. The AUE 702 may be provided, in NAS registration messages, with information regarding the LDS 705 server discovery (e.g., the server address), or the AUE 702 may be pre-configured with information regarding the LDS 705 such as, but without limitation, an IP address, a URL, a FQDN, or an anycast address of the LDS 705 (e.g., FQDNs may be used to discover the IP address of the LDS 705).

In aspects, an AMF may provide such information upon determining that the AUE 702 has an aerial subscription, has indicated its NWDAA/LDS 705 capability, and is an authorized AUE (e.g., an UAS service supplier (USS) authentication and authorization (UUAA)/procedure has been performed successfully, when UUAA is supported and/or mandated). The LDS 705 server address may be provided via a PDU session establishment/PDN connection establishment procedure upon successful UUAA-SM by an SMF when LDS 705 information is in the UDM (e.g., provided by the LDS 705 provider, whether it is the MNO or a third party, and is configured via an API via the NEF). In aspects, the LDS 705 server address may be configured by a policy control function (PCF), and the AUE 702 may be configured with an LDS anycast address that the AUE 702 may utilize to discover the LDS 705.

In aspects, a session may be moved to a new LDS (e.g., an LDS instance similar to the LDS 705) based on edge server re-allocation procedures. In some aspects, a dedicated access point name (APN)/data network name (DNN) may be defined for this service, and/or the AUE 702 may be configured by the USS and/or the MNO with respect to the APN/DNN to use upon successful authorization.

As described herein, the LDS 705 may be deployed as an edge-node (e.g., as an edge application server), in aspects.

In aspects for AUE-LDS connectivity, the LDS 705 connectivity may be layer 2 connectivity at the application layer, e.g., the user plane. For example, the LDS 705 may be deployed as a RAN node/function. The AUE 702 may be configured to communicate with the LDS 705 via RAN signaling (e.g., by RRC transport messages) to report/warn, as well as to receive warnings and deconfliction directives. For RRC messages containing LDS-related data, the AUE 702 may be configured to send RRC signaling with an explicit indication for LDS 705/DWDAA services, so that the RAN routes the signaling payload to the correct server (e.g., via a new value for “payload type” specific to this scenario for the AUE 702).

In aspects for LDS-AUE communication with respect to a serving cell(s), the LDS 705 may be configured to determine the serving cell(s) of the AUE 702. For layer 2 communications, in aspects, the LDS 705 may be configured to utilize a “paging area” concept, e.g., the LDS 705 may be configured to send the information to the AUE 702 in multiple cells, which may be identified based on configuration information or corresponding to the paging area. In other layer 2 aspects, as long as the LDS 705 knows or is aware of the serving base station/gNB of the AUE 702, the LDS 705 may be configured to send the information to the base station/gNB that sends the information to all the serving cells (e.g., not a specific cell, but a specific RAN node).

In aspects for AUE-LDS connectivity, the LDS 705 connectivity may be layer 3 connectivity at the control plane. For example, the LDS 705 may be deployed as a local application server that is integrated with a local NEF. The AUE 702 may be configured to communicate with the LDS 705 via control plane Cellular Internet of Things (CIoT) communications to report/warn, as well as to receive warning and deconfliction directives. As an example, the communications may start at the AUE 702 and be sent via the AMF to a local NEF/the LDS 705. In aspects, an existing NEF API (e.g., a non-IP data delivery) may be utilized. The data payload may be defined, e.g., XML schema for DAA operation, and the local NEF concept can be utilized, e.g., to reduce delay. In aspects, when a serving NEF/LDS changes, a Non-IP Data Delivery (NIDD) connection path may be established with the serving AMF.

In some aspects, the AMF may support control plane CIoT and NIDD APIs, and the NEF-LDS interface may not have to be specified, e.g., it may be integrated. Additionally, there may be no impact on L2 signaling in such aspects, which may be used for access by the AUE 702 to other services using data traffic, and hop-by-hop security may be guaranteed, in such aspects.

Aspects further provide for additional enhancements to the UAS NF/NEF services to support NWDAA and the LDS 705. The AUE 702 may be capable of NWDAA support, and may provide an indication of its support at the application layer during a UUAA procedure to the USS system, as described herein, and the AUE 702 may be configured to include its LDS capability indication to the USS system. Upon a successful UUAA procedure, the USS system may provide to the UAS NF an indication that NWDAA services are authorized. The LDS 705 may also interact with the USS system to report detected UAS conflicts, e.g., as for the AUE 702, and corrective action to the USS system. An interface may be defined between the LDS 705 to the NEF/UAS NF to trigger signaling to the USS system.

Even when the LDS 705 is not aware of the serving USS system (e.g., no information about the serving USS system is provided to the LDS, nor has the LDS 705 discovered the serving USS system), and given that the USS system may not be aware of the LDS 705 serving a given AUE (e.g., the AUE 702), the LDS 705 may be configured to communicate with the UAS NF, which communicates with the USS system.

The AUE 702 may be configured to communicate with the LDS 705 by providing the current clear channel assessment (CAA)-Level UAV ID for the AUE 702, and the LDS 705 may be configured to utilize the CAA-Level UAV ID to discover the serving UAS NF and provide the information together with the CAA-level UAV ID(s) of the AUEs in conflict, e.g., the AUE 702. The UAS NF may then forward such information to the USS system(s) serving the AUE 702 associated with the CAA-Level UAV ID(s) received from the LDS 705. The USS system may be configured to leverage the NEF to push information and policies, and/or the like, to the LDS 705. Accordingly, a new Nnef service is introduced, in aspects.

Regarding the relationship between the LDS 705 and the USS system, the USS system, upon authorization of a flight plan for the AUE 702 in a UUAA procedure, may provide the approved flight-related information to the MNO to the UAS NF in the authorization response. The LDS 705 may be configured, at any time, to retrieve at least a portion, or all, of the approved flight plan relevant to the LDS 705 coverage area, a wider portion thereof, to assist the LDS 705 in obtaining a fuller awareness in addition to what the AUE 702 reports to the LDS 705. The LDS 705 may utilize an NEF service to request the flight plan by providing, as examples, the AUE 702 location or an “area of interest” (e.g., expressed in serving Cell IDs or geographic coordinates, etc.) to retrieve the portion relevant to the AUE 702 location. In aspects, the LDS 705 may be configured to report to the USS if the LDS 705 was not, but becomes, the serving LDS for the AUE 702. In aspects, the cardinality for the LDS: USS relationship associated with the AUE 702 may be N:1.

In aspects, the new Nnef service noted above may be associate with a service description. The service description may be to enable the consumer to report information or to subscribe to notification for the Service Level Device Identity. In case of UAS, the service is used report information or to subscribe to notification for the UAV identified by a CAA-Level UAV ID. The Nnef service may include service operations, such as but not limited to, an Nnef authentication report (“Nnef_Authentication_Report”) service operation and an Nnef authentication register (“Nnef_Authentication_Register”) service operation. In aspects, the Nnef authentication report service operation may have a service operation name: Nnef_Authentication_Report, and may provide the LDS-related information related to one or more Service Level Device Identity(s). As input, the Nnef authentication report service operation may receive one or more of: one or more <Service Level Device Identity (i.e. CAA-Level UAV ID), generic public subscription identifier (GPSI)> pairs; an NF Type; conflict information; a notification endpoint (e.g., for an initial authentication request); a DNN; a single network slice selection assistance information (S-NSSAI) (e.g., in case the consumer NF is an SMF); an information container provided by UE; or a UAV location. As output, the Nnef authentication report service operation may provide: a success/failure indication. In aspects, the Nnef authentication register service operation may have a service operation name: Nnef_Authentication_Register, and may provide consumer registration with the NEF for a service level device identity. As input, the Nnef authentication register service may receive one or more of: a service level device identity, a GPSI, or a registration reason (e.g. serving LDS registering first time). As output, the Nnef authentication register service may output an acknowledge indication.

In aspects for discovery of the LDS 705 by the UAS NF, the UAS NF may be configured to discover the LDS 705 as the serving LDS for the AUE 702. This may be performed, by way of example, based on the AUE 702 location tracking, with mapping between the cell ID and the serving LDS; or when the LDS 705 is serving the AUE 702, the LDS 705, as the serving LDS, may be configured to register with the UAS NF for a specific AUE, e.g., the AUE 702 (the AUE 702 may indicate to the LDS 705 the Service Layer ID of the AUE 702, e.g. the CAA-Level UAV ID). In some aspects, if a UUAA is performed for the AUE 702, the entity running the UUAA procedure may provide the serving LDS information (e.g., information associated with the LDS 705) to the UAS NF. For a UUAA-MM performed by an AMF, the AMF may be configured to provide information associated with the LDS 705, as the serving LDS, directly to the UAS NF. For a UUAA-SM, if the AMF selects the serving LDS, e.g., the LDS 705, the AMF may provide such information to an SMF, and the SMF may provide or relay the information in the UUAA-SM signaling to the UAS NF.

In aspects, USS provisioning of LDS information to a UDM may be configured/performed. For example, a new service may be provided for a USS system to provide a drone/AUE “category” or “type” to the UDM, so that this information may be utilized, in addition to other mechanisms, to decide whether to activate the LDS 705 or not. In aspects, this information may be propagated in the mobile network 704 (e.g., to an AMF, to a RAN, to the LDS 705, etc.) to enable the LDS 705 to have the correct information when activating and executing DAA operations, as described herein.

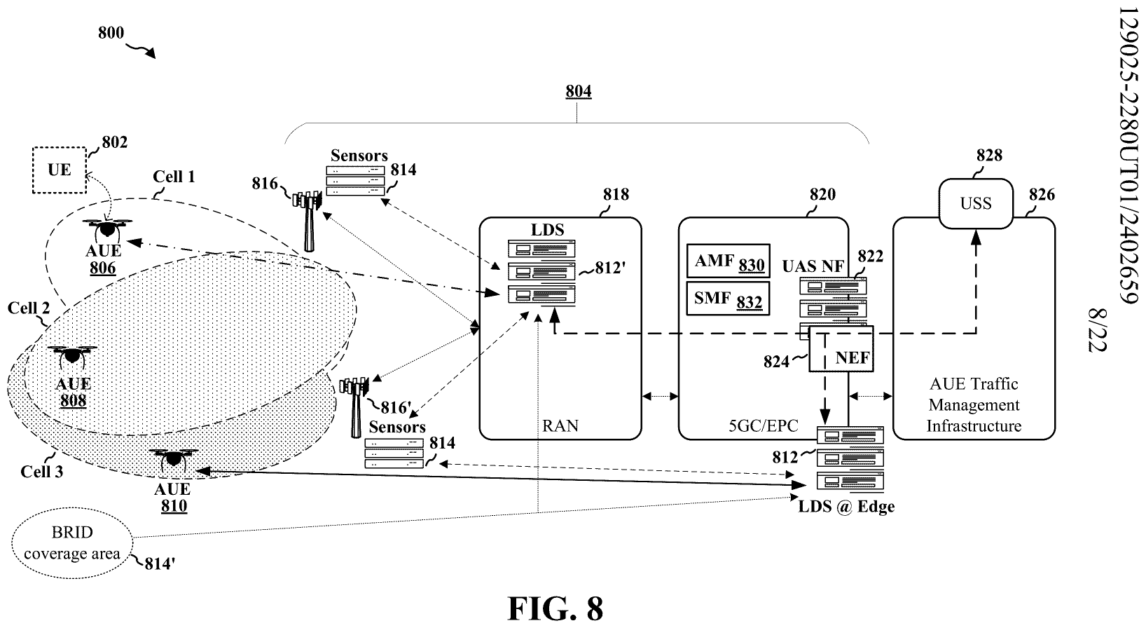

FIG. 8 is a diagram 800 illustrating an example of an architecture for NWDAA for AUEs, in various aspects. The diagram 800 may be an aspect of the call flow diagrams in FIGS. 4, 5, 6, 7, and FIG. 10 (as described above/below), and is shown in the context of an AUE 806 (in cell 1), an AUE 808 (in cell 2), and an AUE 810 (in cell 3), each of which may include a UE 802 or equivalent functionality, as a portion thereof, as well as an LDS 812 as an edge node/application and an LDS 812′ in a RAN 818 of a mobile network 804.

As described herein, an AUE, e.g., the AUE 806, the AUE 808, the AUE 810, may be configured to establish a network connection with a mobile network, e.g., the mobile network 804, and be authenticated for an LDS, e.g., the LDS 812, the LDS 812′, and NWDAA services via an AMF 830/an SMF 832 based on a capability indication (e.g., 408 in FIG. 4; 508 in FIG. 5; 608 in FIG. 6). Subsequent to the network connection with the mobile network 804 being established and authentication for an LDS/NWDAA services, an AUE may be configured to communicate with an LDS, as described herein. As illustrated, the AUE 806 may be configured to communicate with the LDS 812′ in the RAN 818 for NWDAA services, and the AUE 810 may be configured to communicate with the LDS 812 at the edge for NWDAA services. While the AUEs are shown as being in communication with a single LDS for brevity and clarity of illustration, the AUEs may be in communication with more than one LDS.

Also shown in diagram 800 are a base station 816 (or, e.g., a gNB) and a base station 816′ (or, e.g., a gNB) associated with cell 1, cell 2, and/or cell 3, as well as the RAN 818. The base station 816 and/or the base station 816′ may comprise, be associated with, or otherwise have access to instances of sensors 814, which may be any type of sensor, such as those described herein (e.g., RAN sensing capabilities, BRID receivers associated with a BRID coverage area 814′ (e.g., as similarly described above with respect to FIG. 4), ADS-B receivers, DAA broadcast receivers, weather sensors, LIDAR, RADAR, SONAR, NR sensing capabilities, and/or the like). The LDS 812/the LDS 812′ may also be configured to communicate with and/or access data/information associated with the sensors 814. The base station 816 and/or the base station 816′ may communicate with the RAN 818 and with a CN 820 (e.g., a 5G CN (5GC)/evolved packet core (EPC)) via the RAN 818, including communications with components/entities therein, e.g., the LDS 812/the LDS 812′ and/or the AMF 830/the SMF 832.

The CN 820 may be an aspect of core network 120, and may include a UAS NF 822 with an NEF 824. The NEF 824 may be utilized to facilitate communications of information associated with the LDS 812/the LDS 812′ and a USS system 828 of an AUE traffic management infrastructure 826 (also a UAV traffic management infrastructure or UTM), as described herein.

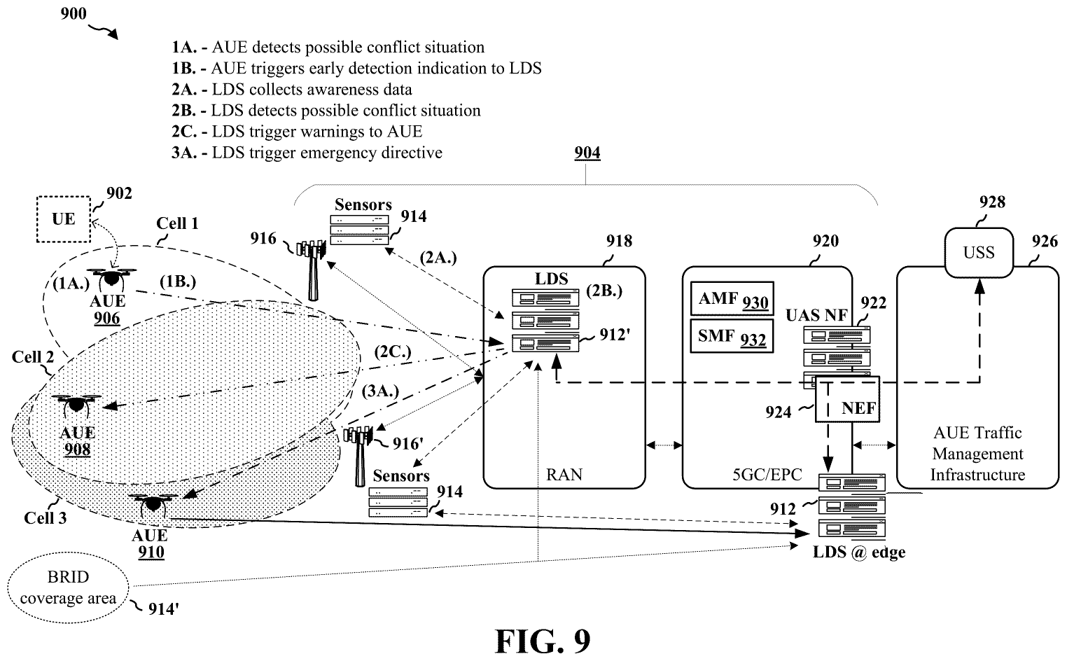

FIG. 9 is a diagram 900 illustrating an example of an architecture and services for NWDAA for AUEs, in various aspects. The diagram 900 may be an aspect of the call flow diagrams in FIGS. 4, 5, 6, 7, and FIG. 8 (as described above), and is shown in the context of an AUE 906 (in cell 1), an AUE 908 (in cell 2), and an AUE 910 (in cell 3), each of which may include a UE 902 or equivalent functionality, as a portion thereof, as well as an LDS 912 as an edge node/application and an LDS 912′ in a RAN 918 of a mobile network 904.

As described herein, an AUE, e.g., the AUE 906, the AUE 908, the AUE 910, may be configured to establish a network connection with a mobile network, e.g., the mobile network 904, and be authenticated for an LDS, e.g., the LDS 912, the LDS 912′, and NWDAA services via an AMF 930/an SMF 932 based on a capability indication (e.g., 408 in FIG. 4; 508 in FIG. 5; 608 in FIG. 6). Subsequent to the network connection with the mobile network 904 being established and authentication for an LDS/NWDAA services, an AUE may be configured to communicate with an LDS, as described herein. As illustrated, the AUE 906 may be configured to communicate with the LDS 912′ in the RAN 918 for NWDAA services, and the AUE 910 may be configured to communicate with the LDS 912 at the edge for NWDAA services. While the AUEs are shown as being in communication with a single LDS for brevity and clarity of illustration, the AUEs may be in communication with more than one LDS.

Also shown in diagram 900 are a base station 916 (or, e.g., a gNB) and a base station 916′ (or, e.g., a gNB) associated with cell 1, cell 2, and/or cell 3, as well as the RAN 918. The base station 916 and/or the base station 916′ may comprise, be associated with, or otherwise have access to instances of sensors 914, which may be any type of sensor, such as those described herein (e.g., RAN sensing capabilities, BRID receivers associated with a BRID coverage area 914′ (e.g., as similarly described above with respect to FIG. 4), ADS-B receivers, DAA broadcast receivers, weather sensors, LIDAR, RADAR, SONAR, NR sensing capabilities, and/or the like). The LDS 912/the LDS 912′ may also be configured to communicate with and/or access data/information associated with the sensors 914. The base station 916 and/or the base station 916′ may communicate with the RAN 918 and with a CN 920 (e.g., a 5G CN (5GC)/evolved packet core (EPC)) via the RAN 918, including communications with components/entities therein, e.g., the LDS 912/the LDS 912′ and/or the AMF 930/the SMF 932.

The CN 920 may be an aspect of core network 120, and may include a UAS NF 922 with an NEF 924. The NEF 924 may be utilized to facilitate communications of information associated with the LDS 912/the LDS 912′ and a USS system 928 of an AUE traffic management infrastructure 926 (also a UAV traffic management infrastructure or UTM), as described herein.

The diagram 900 also illustrates an example flow of NWDAA services associated with the LDS 912/the LDS 912′ and the AUE 906/the AUE 908/the AUE 910, although aspects are not so limited to this illustrated example and may include at least the aspects described herein for NWDAA services. For instance, at 1A, the AUE 906 may be configured to detect a possible conflict situation, e.g., a confliction condition, as described herein. The confliction condition may be associated with the AUE 908/the AUE 910, e.g., a potential confliction/collision with the AUE 910. At 1B, the AUE 906 may be configured to trigger an early detection indication to the LDS 912′ (as shown by way of example, while aspects also contemplate and provide for such communications with the LDS 912 at the edge). At 2A, the LDS 912′ may be configured to collect awareness data/local awareness information associated with the early detection indication, and at 2B, the LDS 912′ may be configured to detect a possible conflict situation/confliction condition. At 2C, the LDS 912′ may be configured to trigger warnings/directives to the AUE 908. For example, the LDS 912′ may trigger and provide a warning to the AUE 908 in association with the early detection indication (at 2A) and the confliction condition (at 2B). At 3A, the LDS 912′ may be configured to trigger an emergency directive. For example, the LDS 912′ may trigger and provide an emergency directive to the AUE 910 in association with the early detection indication (at 2A) and the confliction condition (at 2B).

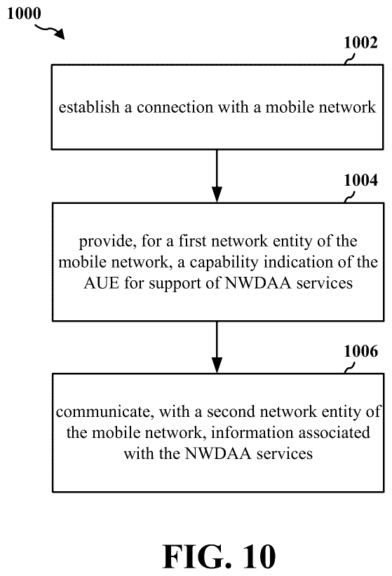

Aspects described for FIGS. 4-10 are provided as illustrative examples, and are not intended to be mutually exclusive of each other. Such aspects may be combined or used in conjunction with others of such aspects in any way and without limitation. Additionally, the flowcharts described below for FIGS. 10, 11, 12, 13, 14, 15, 16, 17 may be performed in conjunction with one or more aspects described above for the call flow diagrams in FIGS. 4, 5, 6, 7, and diagrams in FIGS. 8, 9, and vice versa.

FIG. 10 is a flowchart 1000 of a method of wireless communication. The method may be performed by a UE and/or an AUE (e.g., the UE 104; the AUE 402, the AUE 502, the AUE 602, the AUE 502, the AUE 806, the AUE 808, the AUE 810, the AUE 906, the AUE 908, the AUE 910; the apparatus 2004). In some aspects, the method may include aspects described in connection with the communication flows in FIGS. 4, 5, 6, 7, and/or aspects described in FIGS. 8, 9. The method may be for network-assisted DAA for AUEs. The method may provide for improved DAA by enabling an AUE to report NWDAA capabilities and be authenticated for utilization of a network-based LDS with predictive deconfliction and multi-source information gathering capabilities.

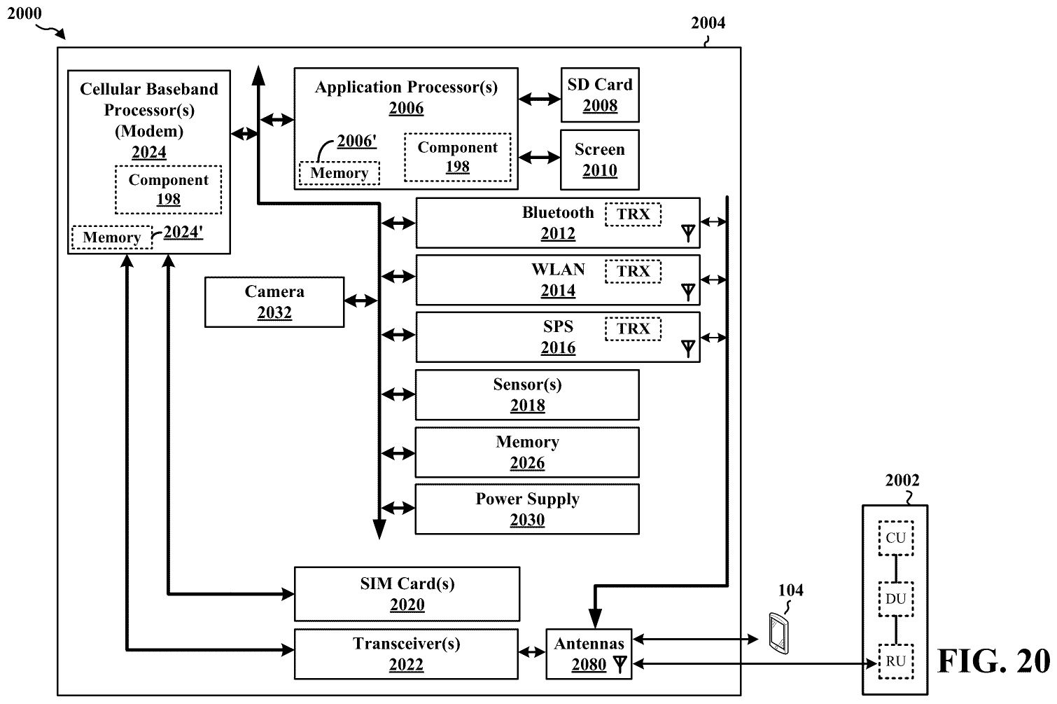

At 1002, the AUE establishes a connection with a mobile network. As an example, the establishment may be performed by one or more of the component 198, the transceiver(s) 2022, and/or the antenna 2080 in FIG. 20. FIG. 4 illustrates, in the context of FIGS. 5-9, an example of the AUE 402 establishing such a connection with a mobile network (e.g., the mobile network 404).

The AUE 402 (e.g., 502 in FIG. 5; 602 in FIG. 6; 702 in FIG. 7; 806, 810 in FIG. 8; 906, 910 in FIG. 9) may be configured to establish (at 406) a network connection with the mobile network 404 (e.g., 504 in FIG. 5; 604 in FIG. 6; 704 in FIG. 7; 804 in FIG. 8; 904 in FIG. 9). Additionally or conversely, the mobile network 404 (e.g., 504 in FIG. 5; 604 in FIG. 6; 704 in FIG. 7; 804 in FIG. 8; 904 in FIG. 9) may be configured to establish (at 406) a network connection with the AUE 402 (e.g., 502 in FIG. 5; 602 in FIG. 6; 702 in FIG. 7; 806, 810 in FIG. 8; 906, 910 in FIG. 9). In aspects, the AUE 402 (e.g., 502 in FIG. 5; 602 in FIG. 6; 702 in FIG. 7; 806, 810 in FIG. 8; 906, 910 in FIG. 9) may be configured to establish (at 406) a network connection with the mobile network 404 (e.g., 504 in FIG. 5; 604 in FIG. 6; 704 in FIG. 7; 804 in FIG. 8; 904 in FIG. 9) via a base station, gNB, etc. (e.g., 816, 816′ in FIG. 8; 916, 916′ in FIG. 9), for an AMF (e.g., 605 in FIG. 6; 830 in FIG. 8; 930 in FIG. 9)/SMF (e.g., 505 in FIG. 5; 832 in FIG. 8; 932 in FIG. 9) of the mobile network 404 (e.g., 504 in FIG. 5; 604 in FIG. 6; 704 in FIG. 7; 804 in FIG. 8; 904 in FIG. 9), as would be understood by persons of skill in the relevant art(s) having the benefit of this disclosure. In aspects, establishment of the connection to the mobile network (e.g., 404 in FIG. 4; 504 in FIG. 5; 604 in FIG. 6; 704 in FIG. 7; 818 in FIG. 8; 918 in FIG. 9) at 1002 may include performance of the provision of the capability indication at 1004 (e.g., 408 in FIG. 4; 508 in FIG. 5; 608 in FIG. 6), e.g., as part of the MM signaling for the AMF (e.g., 605 in FIG. 6; 830 in FIG. 8; 930 in FIG. 9), such as a registration request (as illustrated in connection with the examples in FIGS. 4, 6).

At 1004, the AUE provides, for a first network entity of the mobile network, a capability indication of the AUE for support of NWDAA services. As an example, the provision may be performed by one or more of the component 198, the transceiver(s) 2022, and/or the antenna 2080 in FIG. 20. FIG. 4 illustrates, in the context of FIGS. 5-9, an example of the AUE 402 providing such a capability indication for a network entity of a mobile network (e.g., the mobile network 404).

The AUE 402 (e.g., 502 in FIG. 5; 602 in FIG. 6; 702 in FIG. 7; 806, 810 in FIG. 8; 906, 910 in FIG. 9) may be configured to transmit/provide, and the mobile network 404 (e.g., 504 in FIG. 5; 604 in FIG. 6; 704 in FIG. 7; 804 in FIG. 8; 904 in FIG. 9) may be configured to receive, a capability indication 408 (e.g., 508 in FIG. 5; 608 in FIG. 6). In aspects, the capability indication 408 (e.g., 508 in FIG. 5; 608 in FIG. 6) of the AUE 402 (e.g., 502 in FIG. 5; 602 in FIG. 6; 702 in FIG. 7; 806, 810 in FIG. 8; 906, 910 in FIG. 9) for support of NWDAA services. In aspects, an LDS (e.g., 705 in FIG. 7; 812, 812′ in FIG. 8; 912, 912′ in FIG. 9) herein may comprise the NWDAA services, or vice versa, the LDS (e.g., 705 in FIG. 7; 812, 812′ in FIG. 8; 912, 912′ in FIG. 9) may be configured to provide at least a portion of the NWDAA services, and/or the like. The transmission/provision of the capability indication 408 (e.g., 508 in FIG. 5; 608 in FIG. 6) may be a portion of a discover of support for an LDS (e.g., 705 in FIG. 7; 812, 812′ in FIG. 8; 912, 912′ in FIG. 9)/NWDAA services. In aspects, when the AUE 402 (e.g., 502 in FIG. 5; 602 in FIG. 6; 702 in FIG. 7; 806, 810 in FIG. 8; 906, 910 in FIG. 9) is capable of utilizing an LDS (e.g., 705 in FIG. 7; 812, 812′ in FIG. 8; 912, 912′ in FIG. 9), the AUE 402 (e.g., 502 in FIG. 5; 602 in FIG. 6; 702 in FIG. 7; 806, 810 in FIG. 8; 906, 910 in FIG. 9) indicates its support for the LDS (e.g., 705 in FIG. 7; 812, 812′ in FIG. 8; 912, 912′ in FIG. 9) (or network-assisted DAA, generally). In some aspects, the transmission/provision of the capability indication 408 (e.g., 508 in FIG. 5; 608 in FIG. 6) may be via NAS signaling. As one example, the transmission/provision of the capability indication 408 (e.g., 508 in FIG. 5; 608 in FIG. 6) may be for an AMF (e.g., 605 in FIG. 6; 830 in FIG. 8; 930 in FIG. 9) using mobility and access management (MM) signaling, such as a registration request in 5GMM capabilities. In such aspects, establishment of the connection to the mobile network (e.g., 504 in FIG. 5; 604 in FIG. 6; 704 in FIG. 7; 804 in FIG. 8; 904 in FIG. 9) at 1002 may include performance of the provision of the capability indication at 1004, e.g., as part of the MM signaling for the AMF 605 (e.g., 605 in FIG. 6; 830 in FIG. 8; 930 in FIG. 9), such as the registration request (as illustrated in connection with the examples in FIGS. 4, 6). In another example, the transmission/provision of the capability indication 408 (e.g., 508 in FIG. 5; 608 in FIG. 6) may be for an SMF (e.g., 505 in FIG. 5; 832 in FIG. 8; 932 in FIG. 9) using session management (SM) signaling, such as a PDU session request for establishment of a PDU session for layer 3 implementations, in 5GSM capabilities, or an express/explicit indication.

The mobile network 404 (e.g., 504 in FIG. 5; 604 in FIG. 6; 704 in FIG. 7; 804 in FIG. 8; 904 in FIG. 9) may be configured to transmit/provide, and the AUE 402 (e.g., 502 in FIG. 5; 602 in FIG. 6; 702 in FIG. 7; 806, 810 in FIG. 8; 906, 910 in FIG. 9) may be configured to receive, an NWDAA services indication 410. For instance, the mobile network 404 (e.g., 504 in FIG. 5; 604 in FIG. 6; 704 in FIG. 7; 804 in FIG. 8; 904 in FIG. 9) may be configured to indicate its LDS (e.g., 705 in FIG. 7; 812, 812′ in FIG. 8; 912, 912′ in FIG. 9) support. In aspects at layer 3, upon the AUE 402 (e.g., 502 in FIG. 5; 602 in FIG. 6; 702 in FIG. 7; 806, 810 in FIG. 8; 906, 910 in FIG. 9) indicating support for the LDS (e.g., 705 in FIG. 7; 812, 812′ in FIG. 8; 912, 912′ in FIG. 9) and/or a UDM subscription indicating that the LDS (e.g., 705 in FIG. 7; 812, 812′ in FIG. 8; 912, 912′ in FIG. 9) service is enabled for the AUE 402 (e.g., 502 in FIG. 5; 602 in FIG. 6; 702 in FIG. 7; 806, 810 in FIG. 8; 906, 910 in FIG. 9), upon registration, the CN (e.g., 820 in FIG. 8; 920 in FIG. 9) of the mobile network 404 (e.g., 504 in FIG. 5; 604 in FIG. 6; 704 in FIG. 7; 804 in FIG. 8; 904 in FIG. 9) indicates (e.g., by an SMF (e.g., 505 in FIG. 5; 832 in FIG. 8; 932 in FIG. 9)) that LDS (e.g., 705 in FIG. 7; 812, 812′ in FIG. 8; 912, 912′ in FIG. 9) service is supported in the AUE 402 (e.g., 502 in FIG. 5; 602 in FIG. 6; 702 in FIG. 7; 806, 810 in FIG. 8; 906, 910 in FIG. 9) registration procedure. In aspects, the CN (e.g., 820 in FIG. 8; 920 in FIG. 9) of the mobile network 404 (e.g., 504 in FIG. 5; 604 in FIG. 6; 704 in FIG. 7; 804 in FIG. 8; 904 in FIG. 9) may indicate that LDS (e.g., 705 in FIG. 7; 812, 812′ in FIG. 8; 912, 912′ in FIG. 9) service is supported upon establishment of the PDU session for layer 3 procedures. In aspects, LDS (e.g., 705 in FIG. 7; 812, 812′ in FIG. 8; 912, 912′ in FIG. 9) availability may be indicated per PLMN, per registration area, per tracking area, per cells (e.g., Cell 1, Cell 2, Cell 3 in FIGS. 8, 9), per geographical area, etc. An AMF (e.g., 605 in FIG. 6; 830 in FIG. 8; 930 in FIG. 9) also may generate a registration area(s) so that LDS (e.g., 705 in FIG. 7; 812, 812′ in FIG. 8; 912, 912′ in FIG. 9) service is uniformly available in registration area(s) (e.g., so that the AUE 402 (e.g., 502 in FIG. 5; 602 in FIG. 6; 702 in FIG. 7; 806, 810 in FIG. 8; 906, 910 in FIG. 9) is not in a cell (e.g., Cell 1, Cell 2, Cell 3 in FIGS. 8, 9) of the registration area(s) where there is no LDS (e.g., 705 in FIG. 7; 812, 812′ in FIG. 8; 912, 912′ in FIG. 9) service). In some aspects, the CN (e.g., 820 in FIG. 8; 920 in FIG. 9) of the mobile network 404 (e.g., 504 in FIG. 5; 604 in FIG. 6; 704 in FIG. 7; 804 in FIG. 8; 904 in FIG. 9) may provide a new service restriction area indicative of no LDS (e.g., 705 in FIG. 7; 812, 812′ in FIG. 8; 912, 912′ in FIG. 9) support (e.g., “No LDS support”) and containing the tracking area(s) where LDS (e.g., 705 in FIG. 7; 812, 812′ in FIG. 8; 912, 912′ in FIG. 9) service is not supported. In some aspects, the AUE 402 (e.g., 502 in FIG. 5; 602 in FIG. 6; 702 in FIG. 7; 806, 810 in FIG. 8; 906, 910 in FIG. 9) may perform mobility management in such a way as to avoid entering tracking area(s) where LDS (e.g., 705 in FIG. 7; 812, 812′ in FIG. 8; 912, 912′ in FIG. 9) service is not supported; or the AUE 402 (e.g., 502 in FIG. 5; 602 in FIG. 6; 702 in FIG. 7; 806, 810 in FIG. 8; 906, 910 in FIG. 9) may inform the LDS (e.g., 705 in FIG. 7; 812, 812′ in FIG. 8; 912, 912′ in FIG. 9) service of imminent loss of the LDS (e.g., 705 in FIG. 7; 812, 812′ in FIG. 8; 912, 912′ in FIG. 9) service before entering an area where the LDS (e.g., 705 in FIG. 7; 812, 812′ in FIG. 8; 912, 912′ in FIG. 9) service is not supported; and/or the AUE 402 (e.g., 502 in FIG. 5; 602 in FIG. 6; 702 in FIG. 7; 806, 810 in FIG. 8; 906, 910 in FIG. 9) may take action(s) such as relying wholly, or alternatively at least in part, on alternative DAA solutions.

In the context of layer 2 and layer 3 operations, which may be alternative or complementary in various aspects, the LDS (e.g., 705 in FIG. 7; 812, 812′ in FIG. 8; 912, 912′ in FIG. 9) service may not be available in all locations, so either a cell (e.g., Cell 1, Cell 2, Cell 3 in FIGS. 8, 9) SIB may have an indication of the LDS (e.g., 705 in FIG. 7; 812, 812′ in FIG. 8; 912, 912′ in FIG. 9) availability (e.g., “LDS available”) when the LDS (e.g., 705 in FIG. 7; 812, 812′ in FIG. 8; 912, 912′ in FIG. 9) service is available, and/or an indication may be sent in RRC establishment signaling and a base station/gNB (e.g., 816, 816′ in FIG. 8; 916, 916′ in FIG. 9) may be configured to know whether the LDS (e.g., 705 in FIG. 7; 812, 812′ in FIG. 8; 912, 912′ in FIG. 9) service is available.

Further, the mobile network 404 (e.g., 504 in FIG. 5; 604 in FIG. 6; 704 in FIG. 7; 804 in FIG. 8; 904 in FIG. 9) may be configured to transmit/provide, and the AUE 402 (e.g., 502 in FIG. 5; 602 in FIG. 6; 702 in FIG. 7; 806, 810 in FIG. 8; 906, 910 in FIG. 9) may be configured to receive, addressing information associated with the NWDAA services and the LDS (e.g., 705 in FIG. 7; 812, 812′ in FIG. 8; 912, 912′ in FIG. 9) of the mobile network 404 (e.g., 504 in FIG. 5; 604 in FIG. 6; 704 in FIG. 7; 804 in FIG. 8; 904 in FIG. 9). In one example, in a registration acceptance (“Registration Accept”) such as by an AMF (e.g., 605 in FIG. 6; 830 in FIG. 8; 930 in FIG. 9), in a PDU session establishment acceptance (“PDU Session Establishment Accept”) such as by an SMF (e.g., 505 in FIG. 5; 832 in FIG. 8; 932 in FIG. 9), in an AUE 402 (e.g., 502 in FIG. 5; 602 in FIG. 6; 702 in FIG. 7; 806, 810 in FIG. 8; 906, 910 in FIG. 9) configuration update procedure, and/or the like, the mobile network 404 (e.g., 504 in FIG. 5; 604 in FIG. 6; 704 in FIG. 7; 804 in FIG. 8; 904 in FIG. 9) may transmit/provide the addressing information for the AUE 402 (e.g., 502 in FIG. 5; 602 in FIG. 6; 702 in FIG. 7; 806, 810 in FIG. 8; 906, 910 in FIG. 9). The LDS (e.g., 705 in FIG. 7; 812, 812′ in FIG. 8; 912, 912′ in FIG. 9) addressing information may include, but is not limited to, an LDS (e.g., 705 in FIG. 7; 812, 812′ in FIG. 8; 912, 912′ in FIG. 9) address (e.g., actual IP address), a URL (which the AUE 402 (e.g., 502 in FIG. 5; 602 in FIG. 6; 702 in FIG. 7; 806, 810 in FIG. 8; 906, 910 in FIG. 9) may be configure to utilize to discover the LDS (e.g., 705 in FIG. 7; 812, 812′ in FIG. 8; 912, 912′ in FIG. 9), e.g. using DNS), a FQDN, an anycast address of the LDS (e.g., 705 in FIG. 7; 812, 812′ in FIG. 8; 912, 912′ in FIG. 9), and/or the like.

The mobile network 404 (e.g., 504 in FIG. 5; 604 in FIG. 6; 704 in FIG. 7; 804 in FIG. 8; 904 in FIG. 9) and/or the AUE 402 (e.g., 502 in FIG. 5; 602 in FIG. 6; 702 in FIG. 7; 806, 810 in FIG. 8; 906, 910 in FIG. 9) may be configured to identify/detect (at 412) indicia of a conflict scenario (e.g., a confliction condition) associated with the AUE 402 (e.g., 502 in FIG. 5; 602 in FIG. 6; 702 in FIG. 7; 806, 810 in FIG. 8; 906, 910 in FIG. 9) and/or with a different AUE. In one example, the AUE 402 may be configured to obtain local awareness information associated with the AUE 402 (e.g., 502 in FIG. 5; 602 in FIG. 6; 702 in FIG. 7; 806, 810 in FIG. 8; 906, 910 in FIG. 9) (e.g., from the LDS (e.g., 705 in FIG. 7; 812, 812′ in FIG. 8; 912, 912′ in FIG. 9) and/or from sensors (e.g., 814 in FIG. 8; 914 in FIG. 9), etc., of the AUE 402 (e.g., 502 in FIG. 5; 602 in FIG. 6; 702 in FIG. 7; 806, 810 in FIG. 8; 906, 910 in FIG. 9), and to identify a confliction condition, associated with the NWDAA services, for the AUE 402 (e.g., 502 in FIG. 5; 602 in FIG. 6; 702 in FIG. 7; 806, 810 in FIG. 8; 906, 910 in FIG. 9) based on the local awareness information.

For instance, the AUE 402 (e.g., 502 in FIG. 5; 602 in FIG. 6; 702 in FIG. 7; 806, 810 in FIG. 8; 906, 910 in FIG. 9) may be configured to trigger an early detection to the LDS (e.g., 705 in FIG. 7; 812, 812′ in FIG. 8; 912, 912′ in FIG. 9) of the mobile network 404 (e.g., 504 in FIG. 5; 604 in FIG. 6; 704 in FIG. 7; 804 in FIG. 8; 904 in FIG. 9). The AUE 402 (e.g., 502 in FIG. 5; 602 in FIG. 6; 702 in FIG. 7; 806, 810 in FIG. 8; 906, 910 in FIG. 9) may comprise onboard processing/intelligence (e.g., a computational function) for conflict/confliction detection and/or awareness, and may be configured to report such conflict/confliction detection and/or awareness to the LDS (e.g., 705 in FIG. 7; 812, 812′ in FIG. 8; 912, 912′ in FIG. 9). In aspects, the AUE 402 (e.g., 502 in FIG. 5; 602 in FIG. 6; 702 in FIG. 7; 806, 810 in FIG. 8; 906, 910 in FIG. 9) may perform continuous reporting or conditional reporting (e.g., the AUE 402 (e.g., 502 in FIG. 5; 602 in FIG. 6; 702 in FIG. 7; 806, 810 in FIG. 8; 906, 910 in FIG. 9) may be configured by the LDS (e.g., 705 in FIG. 7; 812, 812′ in FIG. 8; 912, 912′ in FIG. 9) to do one and/or the other, under what conditions, etc.). The AUE 402 (e.g., 502 in FIG. 5; 602 in FIG. 6; 702 in FIG. 7; 806, 810 in FIG. 8; 906, 910 in FIG. 9) may receive, from the LDS (e.g., 705 in FIG. 7; 812, 812′ in FIG. 8; 912, 912′ in FIG. 9), configuration information on reporting to the LDS (e.g., 705 in FIG. 7; 812, 812′ in FIG. 8; 912, 912′ in FIG. 9) when a session is established with the LDS (e.g., 705 in FIG. 7; 812, 812′ in FIG. 8; 912, 912′ in FIG. 9). Additionally, the AUE 402 (e.g., 502 in FIG. 5; 602 in FIG. 6; 702 in FIG. 7; 806, 810 in FIG. 8; 906, 910 in FIG. 9) may request deconfliction from the LDS (e.g., 705 in FIG. 7; 812, 812′ in FIG. 8; 912, 912′ in FIG. 9).

As another example, the LDS (e.g., 705 in FIG. 7; 812, 812′ in FIG. 8; 912, 912′ in FIG. 9) of the mobile network 404 (e.g., 504 in FIG. 5; 604 in FIG. 6; 704 in FIG. 7; 804 in FIG. 8; 904 in FIG. 9) may be configured to trigger warnings to the AUE 402 (e.g., 502 in FIG. 5; 602 in FIG. 6; 702 in FIG. 7; 806, 810 in FIG. 8; 906, 910 in FIG. 9). The LDS (e.g., 705 in FIG. 7; 812, 812′ in FIG. 8; 912, 912′ in FIG. 9) may be configured to create local awareness (e.g., local awareness information) based on RAN (e.g., 404 in FIG. 4; 504 in FIG. 5; 604 in FIG. 6; 704 in FIG. 7; 818 in FIG. 8; 918 in FIG. 9) sensing information, listening to DAA messages, BRID (Broadcast remote ID) messages, having access to sensors (e.g., 814 in FIG. 8; 914 in FIG. 9) (e.g. ADS-B, RADAR, LIDAR, SONAR, AUE 402 (e.g., 502 in FIG. 5; 602 in FIG. 6; 702 in FIG. 7; 806, 810 in FIG. 8; 906, 910 in FIG. 9) positioning, NR) sensing information, etc.). The LDS (e.g., 705 in FIG. 7; 812, 812′ in FIG. 8; 912, 912′ in FIG. 9) may send such information to the AUE 402 (e.g., 502 in FIG. 5; 602 in FIG. 6; 702 in FIG. 7; 806, 810 in FIG. 8; 906, 910 in FIG. 9) to enhance situational awareness of AUE 402 (e.g., 502 in FIG. 5; 602 in FIG. 6; 702 in FIG. 7; 806, 810 in FIG. 8; 906, 910 in FIG. 9), yet detection and deconfliction may be performed in AUE 402 (e.g., 502 in FIG. 5; 602 in FIG. 6; 702 in FIG. 7; 806, 810 in FIG. 8; 906, 910 in FIG. 9) for warnings (e.g., the LDS (e.g., 705 in FIG. 7; 812, 812′ in FIG. 8; 912, 912′ in FIG. 9) may provide deconfliction suggestions/strategies, and the AUE 402 (e.g., 502 in FIG. 5; 602 in FIG. 6; 702 in FIG. 7; 806, 810 in FIG. 8; 906, 910 in FIG. 9) chooses the appropriate one by implementation or configuration information/policies provided by either a UAS operator or a USS system (e.g., 828 in FIG. 8; 928 in FIG. 9), e.g., depending on geographic regulations).

As another example, the LDS (e.g., 705 in FIG. 7; 812, 812′ in FIG. 8; 912, 912′ in FIG. 9) may be configured to trigger emergency directives/path directives (e.g., deconfliction directives, generally) to the AUE 402 (e.g., 502 in FIG. 5; 602 in FIG. 6; 702 in FIG. 7; 806, 810 in FIG. 8; 906, 910 in FIG. 9) and/or a UAVC (or the AUE 402 (e.g., 502 in FIG. 5; 602 in FIG. 6; 702 in FIG. 7; 806, 810 in FIG. 8; 906, 910 in FIG. 9)) may inform the UAVC itself. In such aspects, the detection and deconfliction may be performed in the LDS (e.g., 705 in FIG. 7; 812, 812′ in FIG. 8; 912, 912′ in FIG. 9). In some aspects, detection may be based on the AUE 402 (e.g., 502 in FIG. 5; 602 in FIG. 6; 702 in FIG. 7; 806, 810 in FIG. 8; 906, 910 in FIG. 9) request for the deconfliction, or may be based on the LDS's (e.g., 705 in FIG. 7; 812, 812′ in FIG. 8; 912, 912′ in FIG. 9) intelligence (e.g., local awareness), or both. In some aspects, the AUE 402 (e.g., 502 in FIG. 5; 602 in FIG. 6; 702 in FIG. 7; 806, 810 in FIG. 8; 906, 910 in FIG. 9) and the UAVC follow the command for deconfliction from the LDS (e.g., 705 in FIG. 7; 812, 812′ in FIG. 8; 912, 912′ in FIG. 9) in the case of an emergency directive.

At 1006, the AUE communicates, with a second network entity of the mobile network, information associated with the NWDAA services. As an example, the communication may be performed by one or more of the component 198, the transceiver(s) 2022, and/or the antenna 2080 in FIG. 20. FIG. 4 illustrates, in the context of FIGS. 5-9, an example of the AUE 402 communicating such information with a network entity of a mobile network (e.g., the mobile network 404).

The mobile network 404 (e.g., 504 in FIG. 5; 604 in FIG. 6; 704 in FIG. 7; 804 in FIG. 8; 904 in FIG. 9) (e.g., by an LDS(s) (e.g., 705 in FIG. 7; 812, 812′ in FIG. 8; 912, 912′ in FIG. 9) thereof) and/or the AUE 402 (e.g., 502 in FIG. 5; 602 in FIG. 6; 702 in FIG. 7; 806, 810 in FIG. 8; 906, 910 in FIG. 9) may be configured to communicate communication information 414 associated with the NWDAA services. In aspects, the communication information 414 may be any information associated with the NWDAA services and/or an LDS (e.g., 705 in FIG. 7; 812, 812′ in FIG. 8; 912, 912′ in FIG. 9), as described herein. In aspects for AUE-LDS communications, an LDS (e.g., 705 in FIG. 7; 812, 812′ in FIG. 8; 912, 912′ in FIG. 9) may operate as a passive LDS receiver or as an active LDS receiver.

As a passive LDS receiver, LDS nodes (e.g., 705 in FIG. 7; 812, 812′ in FIG. 8; 912, 912′ in FIG. 9) may receive U2X information (e.g. DAA, BRID) sent by AUEs such as the AUE 402 (e.g., 502 in FIG. 5; 602 in FIG. 6; 702 in FIG. 7; 806, 810 in FIG. 8; 906, 910 in FIG. 9): sidelink receivers in a base station/gNB (e.g., 816, 816′ in FIG. 8; 916, 916′ in FIG. 9) may be configured to receive such information; a base station/gNB (e.g., 816, 816′ in FIG. 8; 916, 916′ in FIG. 9) (RAN (e.g., 404 in FIG. 4; 504 in FIG. 5; 604 in FIG. 6; 704 in FIG. 7; 818 in FIG. 8; 918 in FIG. 9)) may report received BRID and/or DAA signaling sent by AUEs (e.g., 502 in FIG. 5; 602 in FIG. 6; 702 in FIG. 7; 806, 810 in FIG. 8; 906, 910 in FIG. 9) to the LDS(s) (e.g., 705 in FIG. 7; 812, 812′ in FIG. 8; 912, 912′ in FIG. 9) covering the base station/gNB (e.g., 816, 816′ in FIG. 8; 916, 916′ in FIG. 9) area. In such aspects, a RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9) may be configured with the identity/address of the one or more LDS(s) (e.g., 705 in FIG. 7; 812, 812′ in FIG. 8; 912, 912′ in FIG. 9) serving the area of the RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9). Such configurations may leverage information already available via LTE/NR aerial features (e.g., path reporting). The LDS (e.g., 705 in FIG. 7; 812, 812′ in FIG. 8; 912, 912′ in FIG. 9) may receive ADS-B information from manned aviation: this may leverage receivers in the base station/gNB (e.g., 816, 816′ in FIG. 8; 916, 916′ in FIG. 9) that report ADS-B traffic to the LDS (e.g., 705 in FIG. 7; 812, 812′ in FIG. 8; 912, 912′ in FIG. 9).

As an active LDS receiver, the AUE 402 (e.g., 502 in FIG. 5; 602 in FIG. 6; 702 in FIG. 7; 806, 810 in FIG. 8; 906, 910 in FIG. 9) may be configured to send information directly and explicitly to the LDS (e.g., 705 in FIG. 7; 812, 812′ in FIG. 8; 912, 912′ in FIG. 9) (e.g., location, flight path, etc.). The AUE 402 (e.g., 502 in FIG. 5; 602 in FIG. 6; 702 in FIG. 7; 806, 810 in FIG. 8; 906, 910 in FIG. 9) may be configured to trigger an early detection to the LDS (e.g., 705 in FIG. 7; 812, 812′ in FIG. 8; 912, 912′ in FIG. 9), e.g., the AUE 402 (e.g., 502 in FIG. 5; 602 in FIG. 6; 702 in FIG. 7; 806, 810 in FIG. 8; 906, 910 in FIG. 9) may be configured to detect locally a possible conflict and report it to the LDS (e.g., 705 in FIG. 7; 812, 812′ in FIG. 8; 912, 912′ in FIG. 9) (e.g., including information received from other AUEs (e.g., 806, 808, 810 in FIG. 8; 906, 908, 910 in FIG. 9), including AUE ID(s), path, etc.), and either: (i) includes its planned deconfliction strategy (e.g., a trajectory change) that the UAS may compute autonomously, or (ii) includes a request for a “guided” trajectory change, which the LDS (e.g., 705 in FIG. 7; 812, 812′ in FIG. 8; 912, 912′ in FIG. 9) may compute and report back. The AUE 402 (e.g., 502 in FIG. 5; 602 in FIG. 6; 702 in FIG. 7; 806, 810 in FIG. 8; 906, 910 in FIG. 9) may also be configured to report to the LDS (e.g., 705 in FIG. 7; 812, 812′ in FIG. 8; 912, 912′ in FIG. 9) that the conflict is cleared subsequent to the conflict being cleared.

In aspects for LDS-AUE communications, the LDS (e.g., 705 in FIG. 7; 812, 812′ in FIG. 8; 912, 912′ in FIG. 9) may be configured to trigger warnings to the AUE 402 (e.g., 502 in FIG. 5; 602 in FIG. 6; 702 in FIG. 7; 806, 810 in FIG. 8; 906, 910 in FIG. 9). A potential conflict detection in the LDS (e.g., 705 in FIG. 7; 812, 812′ in FIG. 8; 912, 912′ in FIG. 9) may trigger a warning and potential de-escalation/de-conflictions instructions to the AUE 402 (e.g., 502 in FIG. 5; 602 in FIG. 6; 702 in FIG. 7; 806, 810 in FIG. 8; 906, 910 in FIG. 9), if requested, or if proximity thresholds are violated (e.g., are met). In aspects, the LDS (e.g., 705 in FIG. 7; 812, 812′ in FIG. 8; 912, 912′ in FIG. 9) may be configured to trigger an emergency directive to the AUE 402 (e.g., 502 in FIG. 5; 602 in FIG. 6; 702 in FIG. 7; 806, 810 in FIG. 8; 906, 910 in FIG. 9). A conflict/confliction detection (e.g., a critical conflict/confliction detection) in the LDS (e.g., 705 in FIG. 7; 812, 812′ in FIG. 8; 912, 912′ in FIG. 9) may trigger a path directive (e.g., a non-emergency deconfliction) or an emergency directive (e.g., an urgent emergency deconfliction) to the AUE 402 (e.g., 502 in FIG. 5; 602 in FIG. 6; 702 in FIG. 7; 806, 810 in FIG. 8; 906, 910 in FIG. 9). A path directive may include information associated with a new flight path that the LDS (e.g., 705 in FIG. 7; 812, 812′ in FIG. 8; 912, 912′ in FIG. 9) may have received from the UTM system (e.g., 826 in FIG. 8; 926 in FIG. 9)/the USS system (e.g., 828 in FIG. 8; 928 in FIG. 9). An emergency directive may include an imminent collision status message with basic metadata about the other aircraft(s)/UAV(s) and may include multiple deconfliction solutions/strategies that are presented. In aspects, such a set of deconfliction solutions/strategies may be scored (e.g., prioritized) and may be provided to the UAS. The UAS, or its controller, may then consider the options and execute one (or more) based on its own knowledge and sensor (e.g., 814 in FIG. 8; 914 in FIG. 9) status, by way of example.

Based on local policies or USS (e.g., 828 in FIG. 8; 928 in FIG. 9) configuration, a warning may be sent under specific conditions (e.g. an AUE category like drone AUE size or mission type, e.g. public safety versus package delivery), an AUE size, an AUE class, a mission type, a public safety priority, or a delivery priority. The LDS (e.g., 705 in FIG. 7; 812, 812′ in FIG. 8; 912, 912′ in FIG. 9) may be configured to receive configuration information for the specific AUE or class of AUE (e.g., either by the AUE 402 (e.g., 502 in FIG. 5; 602 in FIG. 6; 702 in FIG. 7; 806, 810 in FIG. 8; 906, 910 in FIG. 9) providing its AUE ID explicitly, or the LDS (e.g., 705 in FIG. 7; 812, 812′ in FIG. 8; 912, 912′ in FIG. 9), based on the received AUE ID broadcasted by the AUE, may derive the specific AUE information, or the LDS (e.g., 705 in FIG. 7; 812, 812′ in FIG. 8; 912, 912′ in FIG. 9) may receive the information from the UAS NF (e.g., 822 in FIG. 8; 922 in FIG. 9), which receives the information during the AUE 402 (e.g., 502 in FIG. 5; 602 in FIG. 6; 702 in FIG. 7; 806, 810 in FIG. 8; 906, 910 in FIG. 9) registration with the mobile network operator (MNO) from the USS (e.g., 828 in FIG. 8; 928 in FIG. 9)).

In aspects for LDS-AUE communications, a model of communication may be direct or indirect. In a direct model, a C2 link may be sent by the LDS (e.g., 705 in FIG. 7; 812, 812′ in FIG. 8; 912, 912′ in FIG. 9) to the AUE 402 (e.g., 502 in FIG. 5; 602 in FIG. 6; 702 in FIG. 7; 806, 810 in FIG. 8; 906, 910 in FIG. 9). In an indirect model, if the LDS (e.g., 705 in FIG. 7; 812, 812′ in FIG. 8; 912, 912′ in FIG. 9) is aware of the UAVC, either the LDS (e.g., 705 in FIG. 7; 812, 812′ in FIG. 8; 912, 912′ in FIG. 9) informs UAVC, or the AUE 402 (e.g., 502 in FIG. 5; 602 in FIG. 6; 702 in FIG. 7; 806, 810 in FIG. 8; 906, 910 in FIG. 9) informs the UAVC over the C2 link.

In aspects for AUE-LDS connectivity, the LDS (e.g., 705 in FIG. 7; 812, 812′ in FIG. 8; 912, 912′ in FIG. 9) connectivity may be layer 3 connectivity at the application layer, e.g., the user plane. For example, the AUE 402 (e.g., 502 in FIG. 5; 602 in FIG. 6; 702 in FIG. 7; 806, 810 in FIG. 8; 906, 910 in FIG. 9) may be configured to establish a session with the LDS (e.g., 705 in FIG. 7; 812, 812′ in FIG. 8; 912, 912′ in FIG. 9) upon (i) discovering the LDS (e.g., 705 in FIG. 7; 812, 812′ in FIG. 8; 912, 912′ in FIG. 9) is supported, and (ii) discovering LDS (e.g., 705 in FIG. 7; 812, 812′ in FIG. 8; 912, 912′ in FIG. 9) information, as noted herein. The AUE 402 (e.g., 502 in FIG. 5; 602 in FIG. 6; 702 in FIG. 7; 806, 810 in FIG. 8; 906, 910 in FIG. 9) may be provided, in NAS registration messages, with information regarding the LDS (e.g., 705 in FIG. 7; 812, 812′ in FIG. 8; 912, 912′ in FIG. 9) server discovery (e.g., the server address), or the AUE 402 (e.g., 502 in FIG. 5; 602 in FIG. 6; 702 in FIG. 7; 806, 810 in FIG. 8; 906, 910 in FIG. 9) may be pre-configured with information regarding the LDS(s) (e.g., 705 in FIG. 7; 812, 812′ in FIG. 8; 912, 912′ in FIG. 9) such as, but without limitation, an IP address, a URL, a FQDN, or an anycast address of the LDS (e.g., 705 in FIG. 7; 812, 812′ in FIG. 8; 912, 912′ in FIG. 9) (e.g., FQDNs may be used to discover the IP address of the LDS (e.g., 705 in FIG. 7; 812, 812′ in FIG. 8; 912, 912′ in FIG. 9)).

In aspects, an AMF (e.g., 605 in FIG. 6; 830 in FIG. 8; 930 in FIG. 9) may provide such information upon determining that the AUE 402 (e.g., 502 in FIG. 5; 602 in FIG. 6; 702 in FIG. 7; 806, 810 in FIG. 8; 906, 910 in FIG. 9) has an aerial subscription, has indicated its NWDAA/LDS (e.g., 705 in FIG. 7; 812, 812′ in FIG. 8; 912, 912′ in FIG. 9) capability, and is an authorized AUE (e.g., an UAS service supplier (USS) authentication and authorization (UUAA)/procedure has been performed successfully, when UUAA is supported and/or mandated). In aspects, the AUE 402 (e.g., 502 in FIG. 5; 602 in FIG. 6; 702 in FIG. 7; 806, 810 in FIG. 8; 906, 910 in FIG. 9) may be configured to receive an AUE authorization for a UUAA procedure based at least in part on the capability indication 408 (e.g., 508 in FIG. 5; 608 in FIG. 6). The LDS (e.g., 705 in FIG. 7; 812, 812′ in FIG. 8; 912, 912′ in FIG. 9) server address may be provided via a PDU session establishment/PDN connection establishment procedure upon successful UUAA-SM by an SMF (e.g., 505 in FIG. 5; 832 in FIG. 8; 932 in FIG. 9) when LDS (e.g., 705 in FIG. 7; 812, 812′ in FIG. 8; 912, 912′ in FIG. 9) information is in the UDM (e.g., provided by the LDS (e.g., 705 in FIG. 7; 812, 812′ in FIG. 8; 912, 912′ in FIG. 9) provider, whether it is the MNO or a third party, and is configured via an API via the NEF (e.g., 824 in FIG. 8; 924 in FIG. 9)). In aspects, the LDS (e.g., 705 in FIG. 7; 812, 812′ in FIG. 8; 912, 912′ in FIG. 9) server address may be configured by a policy control function (PCF), and the AUE 402 (e.g., 502 in FIG. 5; 602 in FIG. 6; 702 in FIG. 7; 806, 810 in FIG. 8; 906, 910 in FIG. 9) may be configured with an LDS (e.g., 705 in FIG. 7; 812, 812′ in FIG. 8; 912, 912′ in FIG. 9) anycast address that the AUE 402 (e.g., 502 in FIG. 5; 602 in FIG. 6; 702 in FIG. 7; 806, 810 in FIG. 8; 906, 910 in FIG. 9) may utilize to discover the LDS (e.g., 705 in FIG. 7; 812, 812′ in FIG. 8; 912, 912′ in FIG. 9).

In aspects, a session may be moved to a new LDS (e.g., 705 in FIG. 7; 812, 812′ in FIG. 8; 912, 912′ in FIG. 9) (e.g., LDS instance) based on edge server re-allocation procedures. In some aspects, a dedicated access point name (APN)/data network name (DNN) may be defined for this service, and/or the AUE 402 (e.g., 502 in FIG. 5; 602 in FIG. 6; 702 in FIG. 7; 806, 810 in FIG. 8; 906, 910 in FIG. 9) may be configured by the USS (e.g., 828 in FIG. 8; 928 in FIG. 9) and/or the MNO with respect to the APN/DNN to use upon successful authorization.

As described herein, the LDS (e.g., 705 in FIG. 7; 812, 812′ in FIG. 8; 912, 912′ in FIG. 9) may be deployed as an edge-node (e.g., as an edge application server), in aspects.

In aspects for AUE-LDS connectivity, the LDS (e.g., 705 in FIG. 7; 812, 812′ in FIG. 8; 912, 912′ in FIG. 9) connectivity may be layer 2 connectivity at the application layer, e.g., the user plane. For example, the LDS (e.g., 705 in FIG. 7; 812, 812′ in FIG. 8; 912, 912′ in FIG. 9) may be deployed as a RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9)/function (e.g., 505 in FIG. 5; 605 in FIG. 6; 822, 824, 830, 832 in FIG. 8; 922, 924, 930, 932 in FIG. 9). The AUE 402 (e.g., 502 in FIG. 5; 602 in FIG. 6; 702 in FIG. 7; 806, 810 in FIG. 8; 906, 910 in FIG. 9) may be configured to communicate with the LDS (e.g., 705 in FIG. 7; 812, 812′ in FIG. 8; 912, 912′ in FIG. 9) via RAN (e.g., 404 in FIG. 4; 504 in FIG. 5; 604 in FIG. 6; 704 in FIG. 7; 818 in FIG. 8; 918 in FIG. 9) signaling (e.g., by RRC transport messages) to report/warn, as well as to receive warnings and deconfliction directives. For RRC messages containing LDS-related data, the AUE 402 (e.g., 502 in FIG. 5; 602 in FIG. 6; 702 in FIG. 7; 806, 810 in FIG. 8; 906, 910 in FIG. 9) may be configured to send RRC signaling with an explicit indication for LDS (e.g., 705 in FIG. 7; 812, 812′ in FIG. 8; 912, 912′ in FIG. 9)/DWDAA services, so that the RAN (e.g., 404 in FIG. 4; 504 in FIG. 5; 604 in FIG. 6; 704 in FIG. 7; 818 in FIG. 8; 918 in FIG. 9) routes the signaling payload to the correct server (e.g., via a new value for “payload type” specific to this scenario for the AUE 402 (e.g., 502 in FIG. 5; 602 in FIG. 6; 702 in FIG. 7; 806, 810 in FIG. 8; 906, 910 in FIG. 9)).

In aspects for LDS-AUE communication with respect to a serving cell(s) (e.g., Cell 1, Cell 2, Cell 3 in FIGS. 8, 9), the LDS (e.g., 705 in FIG. 7; 812, 812′ in FIG. 8; 912, 912′ in FIG. 9) may be configured to determine the serving cell(s) (e.g., Cell 1, Cell 2, Cell 3 in FIGS. 8, 9) of the AUE 402 (e.g., 502 in FIG. 5; 602 in FIG. 6; 702 in FIG. 7; 806, 810 in FIG. 8; 906, 910 in FIG. 9). For layer 2 communications, in aspects, the LDS (e.g., 705 in FIG. 7; 812, 812′ in FIG. 8; 912, 912′ in FIG. 9) may be configured to utilize a “paging area” concept, e.g., the LDS (e.g., 705 in FIG. 7; 812, 812′ in FIG. 8; 912, 912′ in FIG. 9) may be configured to send the information to the AUE 402 (e.g., 502 in FIG. 5; 602 in FIG. 6; 702 in FIG. 7; 806, 810 in FIG. 8; 906, 910 in FIG. 9) in multiple cells (e.g., Cell 1, Cell 2, Cell 3 in FIGS. 8, 9), which may be identified based on configuration information or corresponding to the paging area. In other layer 2 aspects, as long as the LDS (e.g., 705 in FIG. 7; 812, 812′ in FIG. 8; 912, 912′ in FIG. 9) knows or is aware of the serving base station/gNB (e.g., 816, 816′ in FIG. 8; 916, 916′ in FIG. 9) of the AUE 402 (e.g., 502 in FIG. 5; 602 in FIG. 6; 702 in FIG. 7; 806, 810 in FIG. 8; 906, 910 in FIG. 9), the LDS (e.g., 705 in FIG. 7; 812, 812′ in FIG. 8; 912, 912′ in FIG. 9) may be configured to send the information to the base station/gNB (e.g., 816, 816′ in FIG. 8; 916, 916′ in FIG. 9) that sends the information to all the serving cells (e.g., Cell 1, Cell 2, Cell 3 in FIGS. 8, 9) (e.g., not a specific cell, but a specific RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9)).

In aspects for AUE-LDS connectivity, the LDS (e.g., 705 in FIG. 7; 812, 812′ in FIG. 8; 912, 912′ in FIG. 9) connectivity may be layer 3 connectivity at the control plane. For example, the LDS (e.g., 705 in FIG. 7; 812, 812′ in FIG. 8; 912, 912′ in FIG. 9) may be deployed as a local application server that is integrated with a local NEF (e.g., 824 in FIG. 8; 924 in FIG. 9). The AUE 402 (e.g., 502 in FIG. 5; 602 in FIG. 6; 702 in FIG. 7; 806, 810 in FIG. 8; 906, 910 in FIG. 9) may be configured to communicate with the LDS (e.g., 705 in FIG. 7; 812, 812′ in FIG. 8; 912, 912′ in FIG. 9) via control plane Cellular Internet of Things (CIoT) communications to report/warn, as well as to receive warning and deconfliction directives. As an example, the communications may start at the AUE 402 (e.g., 502 in FIG. 5; 602 in FIG. 6; 702 in FIG. 7; 806, 810 in FIG. 8; 906, 910 in FIG. 9) and be sent via the AMF (e.g., 605 in FIG. 6; 830 in FIG. 8; 930 in FIG. 9) to a local NEF (e.g., 824 in FIG. 8; 924 in FIG. 9)/the LDS (e.g., 705 in FIG. 7; 812, 812′ in FIG. 8; 912, 912′ in FIG. 9). In aspects, an existing NEF (e.g., 824 in FIG. 8; 924 in FIG. 9) API (e.g., a non-IP data delivery) may be utilized. The data payload may be defined, e.g., XML schema for DAA operation, and the local NEF (e.g., 824 in FIG. 8; 924 in FIG. 9) concept can be utilized, e.g., to reduce delay. In aspects, when a serving NEF (e.g., 824 in FIG. 8; 924 in FIG. 9)/LDS (e.g., 705 in FIG. 7; 812, 812′ in FIG. 8; 912, 912′ in FIG. 9) changes, a Non-IP Data Delivery (NIDD) connection path may be established with the serving AMF (e.g., 605 in FIG. 6; 830 in FIG. 8; 930 in FIG. 9).

In some aspects, the AMF (e.g., 605 in FIG. 6; 830 in FIG. 8; 930 in FIG. 9) may support control plane CIOT and NIDD APIs, and the NEF-LDS interface may not have to be specified, e.g., it may be integrated. Additionally, there may be no impact on L2 signaling in such aspects, which may be used for access by the AUE 402 (e.g., 502 in FIG. 5; 602 in FIG. 6; 702 in FIG. 7; 806, 810 in FIG. 8; 906, 910 in FIG. 9) to other services using data traffic, and hop-by-hop security may be guaranteed, in such aspects.

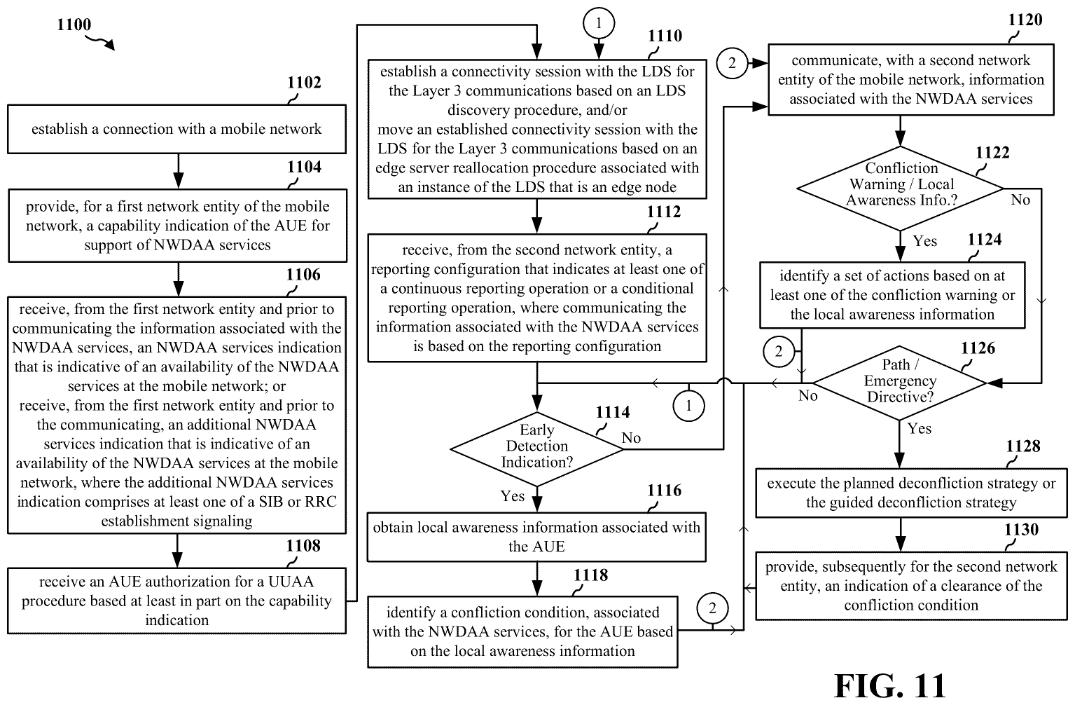

FIG. 11 is a flowchart 1100 of a method of wireless communication. The method may be performed by a UE and/or an AUE (e.g., the UE 104; the AUE 402, the AUE 502, the AUE 602, the AUE 502, the AUE 806, the AUE 808, the AUE 810, the AUE 906, the AUE 908, the AUE 910; the apparatus 2004). In some aspects, the method may include aspects described in connection with the communication flows in FIGS. 4, 5, 6, 7, and/or aspects described in FIGS. 8, 9. The method may be for network-assisted DAA for AUEs. The method may provide for improved DAA by enabling an AUE to report NWDAA capabilities and be authenticated for utilization of a network-based LDS with predictive deconfliction and multi-source information gathering capabilities.

At 1102, the AUE establishes a connection with a mobile network. As an example, the establishment may be performed by one or more of the component 198, the transceiver(s) 2022, and/or the antenna 2080 in FIG. 20. FIG. 4 illustrates, in the context of FIGS. 5-9, an example of the AUE 402 establishing such a connection with a mobile network (e.g., the mobile network 404).

The AUE 402 (e.g., 502 in FIG. 5; 602 in FIG. 6; 702 in FIG. 7; 806, 810 in FIG. 8; 906, 910 in FIG. 9) may be configured to establish (at 406) a network connection with the mobile network 404 (e.g., 504 in FIG. 5; 604 in FIG. 6; 704 in FIG. 7; 804 in FIG. 8; 904 in FIG. 9). Additionally or conversely, the mobile network 404 (e.g., 504 in FIG. 5; 604 in FIG. 6; 704 in FIG. 7; 804 in FIG. 8; 904 in FIG. 9) may be configured to establish (at 406) a network connection with the AUE 402 (e.g., 502 in FIG. 5; 602 in FIG. 6; 702 in FIG. 7; 806, 810 in FIG. 8; 906, 910 in FIG. 9). In aspects, the AUE 402 (e.g., 502 in FIG. 5; 602 in FIG. 6; 702 in FIG. 7; 806, 810 in FIG. 8; 906, 910 in FIG. 9) may be configured to establish (at 406) a network connection with the mobile network 404 (e.g., 504 in FIG. 5; 604 in FIG. 6; 704 in FIG. 7; 804 in FIG. 8; 904 in FIG. 9) via a base station, gNB, etc. (e.g., 816, 816′ in FIG. 8; 916, 916′ in FIG. 9), for an AMF (e.g., 605 in FIG. 6; 830 in FIG. 8; 930 in FIG. 9)/SMF (e.g., 505 in FIG. 5; 832 in FIG. 8; 932 in FIG. 9) of the mobile network 404 (e.g., 504 in FIG. 5; 604 in FIG. 6; 704 in FIG. 7; 804 in FIG. 8; 904 in FIG. 9), as would be understood by persons of skill in the relevant art(s) having the benefit of this disclosure. In aspects, establishment of the connection to the mobile network (e.g., 404 in FIG. 4; 504 in FIG. 5; 604 in FIG. 6; 704 in FIG. 7; 818 in FIG. 8; 918 in FIG. 9) at 1002 may include performance of the provision of the capability indication at 1004 (e.g., 408 in FIG. 4; 508 in FIG. 5; 608 in FIG. 6), e.g., as part of the MM signaling for the AMF (e.g., 605 in FIG. 6; 830 in FIG. 8; 930 in FIG. 9), such as a registration request (as illustrated in connection with the examples in FIGS. 4, 6).

At 1104, the AUE provides, for a first network entity of the mobile network, a capability indication of the AUE for support of NWDAA services. As an example, the provision may be performed by one or more of the component 198, the transceiver(s) 2022, and/or the antenna 2080 in FIG. 20. FIG. 4 illustrates, in the context of FIGS. 5-9, an example of the AUE 402 providing such a capability indication for a network entity of a mobile network (e.g., the mobile network 404).

The AUE 402 (e.g., 502 in FIG. 5; 602 in FIG. 6; 702 in FIG. 7; 806, 810 in FIG. 8; 906, 910 in FIG. 9) may be configured to transmit/provide, and the mobile network 404 (e.g., 504 in FIG. 5; 604 in FIG. 6; 704 in FIG. 7; 804 in FIG. 8; 904 in FIG. 9) may be configured to receive, a capability indication 408 (e.g., 508 in FIG. 5; 608 in FIG. 6). In aspects, the capability indication 408 (e.g., 508 in FIG. 5; 608 in FIG. 6) of the AUE 402 (e.g., 502 in FIG. 5; 602 in FIG. 6; 702 in FIG. 7; 806, 810 in FIG. 8; 906, 910 in FIG. 9) for support of NWDAA services. In aspects, an LDS (e.g., 705 in FIG. 7; 812, 812′ in FIG. 8; 912, 912′ in FIG. 9) herein may comprise the NWDAA services, or vice versa, the LDS (e.g., 705 in FIG. 7; 812, 812′ in FIG. 8; 912, 912′ in FIG. 9) may be configured to provide at least a portion of the NWDAA services, and/or the like. The transmission/provision of the capability indication 408 (e.g., 508 in FIG. 5; 608 in FIG. 6) may be a portion of a discover of support for an LDS (e.g., 705 in FIG. 7; 812, 812′ in FIG. 8; 912, 912′ in FIG. 9)/NWDAA services. In aspects, when the AUE 402 (e.g., 502 in FIG. 5; 602 in FIG. 6; 702 in FIG. 7; 806, 810 in FIG. 8; 906, 910 in FIG. 9) is capable of utilizing an LDS (e.g., 705 in FIG. 7; 812, 812′ in FIG. 8; 912, 912′ in FIG. 9), the AUE 402 (e.g., 502 in FIG. 5; 602 in FIG. 6; 702 in FIG. 7; 806, 810 in FIG. 8; 906, 910 in FIG. 9) indicates its support for the LDS (e.g., 705 in FIG. 7; 812, 812′ in FIG. 8; 912, 912′ in FIG. 9) (or network-assisted DAA, generally). In some aspects, the transmission/provision of the capability indication 408 (e.g., 508 in FIG. 5; 608 in FIG. 6) may be via NAS signaling. As one example, the transmission/provision of the capability indication 408 (e.g., 508 in FIG. 5; 608 in FIG. 6) may be for an AMF (e.g., 605 in FIG. 6; 830 in FIG. 8; 930 in FIG. 9) using mobility and access management (MM) signaling, such as a registration request in 5GMM capabilities. In such aspects, establishment of the connection to the mobile network (e.g., 504 in FIG. 5; 604 in FIG. 6; 704 in FIG. 7; 804 in FIG. 8; 904 in FIG. 9) at 1002 may include performance of the provision of the capability indication at 1004, e.g., as part of the MM signaling for the AMF 605 (e.g., 605 in FIG. 6; 830 in FIG. 8; 930 in FIG. 9), such as the registration request (as illustrated in connection with the examples in FIGS. 4, 6). In another example, the transmission/provision of the capability indication 408 (e.g., 508 in FIG. 5; 608 in FIG. 6) may be for an SMF (e.g., 505 in FIG. 5; 832 in FIG. 8; 932 in FIG. 9) using session management (SM) signaling, such as a PDU session request for establishment of a PDU session for layer 3 implementations, in 5GSM capabilities, or an express/explicit indication.

At 1106, the AUE receives, from the first network entity and prior to communicating the information associated with the NWDAA services, an NWDAA services indication that is indicative of an availability of the NWDAA services at the mobile network and/or an additional NWDAA services indication that is indicative of an availability of the NWDAA services at the mobile network, where the additional NWDAA services indication comprises at least one of a SIB or RRC establishment signaling. As an example, the reception may be performed by one or more of the component 198, the transceiver(s) 2022, and/or the antenna 2080 in FIG. 20. FIG. 4 illustrates, in the context of FIGS. 5-9, an example of the AUE 402 receiving such an indication(s) from a network entity of a mobile network (e.g., the mobile network 404).

The mobile network 404 (e.g., 504 in FIG. 5; 604 in FIG. 6; 704 in FIG. 7; 804 in FIG. 8; 904 in FIG. 9) may be configured to transmit/provide, and the AUE 402 (e.g., 502 in FIG. 5; 602 in FIG. 6; 702 in FIG. 7; 806, 810 in FIG. 8; 906, 910 in FIG. 9) may be configured to receive, an NWDAA services indication 410. For instance, the mobile network 404 (e.g., 504 in FIG. 5; 604 in FIG. 6; 704 in FIG. 7; 804 in FIG. 8; 904 in FIG. 9) may be configured to indicate its LDS (e.g., 705 in FIG. 7; 812, 812′ in FIG. 8; 912, 912′ in FIG. 9) support. In aspects at layer 3, upon the AUE 402 (e.g., 502 in FIG. 5; 602 in FIG. 6; 702 in FIG. 7; 806, 810 in FIG. 8; 906, 910 in FIG. 9) indicating support for the LDS (e.g., 705 in FIG. 7; 812, 812′ in FIG. 8; 912, 912′ in FIG. 9) and/or a UDM subscription indicating that the LDS (e.g., 705 in FIG. 7; 812, 812′ in FIG. 8; 912, 912′ in FIG. 9) service is enabled for the AUE 402 (e.g., 502 in FIG. 5; 602 in FIG. 6; 702 in FIG. 7; 806, 810 in FIG. 8; 906, 910 in FIG. 9), upon registration, the CN (e.g., 820 in FIG. 8; 920 in FIG. 9) of the mobile network 404 (e.g., 504 in FIG. 5; 604 in FIG. 6; 704 in FIG. 7; 804 in FIG. 8; 904 in FIG. 9) indicates (e.g., by an SMF (e.g., 505 in FIG. 5; 832 in FIG. 8; 932 in FIG. 9)) that LDS (e.g., 705 in FIG. 7; 812, 812′ in FIG. 8; 912, 912′ in FIG. 9) service is supported in the AUE 402 (e.g., 502 in FIG. 5; 602 in FIG. 6; 702 in FIG. 7; 806, 810 in FIG. 8; 906, 910 in FIG. 9) registration procedure. In aspects, the CN (e.g., 820 in FIG. 8; 920 in FIG. 9) of the mobile network 404 (e.g., 504 in FIG. 5; 604 in FIG. 6; 704 in FIG. 7; 804 in FIG. 8; 904 in FIG. 9) may indicate that LDS (e.g., 705 in FIG. 7; 812, 812′ in FIG. 8; 912, 912′ in FIG. 9) service is supported upon establishment of the PDU session for layer 3 procedures. In aspects, LDS (e.g., 705 in FIG. 7; 812, 812′ in FIG. 8; 912, 912′ in FIG. 9) availability may be indicated per PLMN, per registration area, per tracking area, per cells (e.g., Cell 1, Cell 2, Cell 3 in FIGS. 8, 9), per geographical area, etc. An AMF (e.g., 605 in FIG. 6; 830 in FIG. 8; 930 in FIG. 9) also may generate a registration area(s) so that LDS (e.g., 705 in FIG. 7; 812, 812′ in FIG. 8; 912, 912′ in FIG. 9) service is uniformly available in registration area(s) (e.g., so that the AUE 402 (e.g., 502 in FIG. 5; 602 in FIG. 6; 702 in FIG. 7; 806, 810 in FIG. 8; 906, 910 in FIG. 9) is not in a cell (e.g., Cell 1, Cell 2, Cell 3 in FIGS. 8, 9) of the registration area(s) where there is no LDS (e.g., 705 in FIG. 7; 812, 812′ in FIG. 8; 912, 912′ in FIG. 9) service). In some aspects, the CN (e.g., 820 in FIG. 8; 920 in FIG. 9) of the mobile network 404 (e.g., 504 in FIG. 5; 604 in FIG. 6; 704 in FIG. 7; 804 in FIG. 8; 904 in FIG. 9) may provide a new service restriction area indicative of no LDS (e.g., 705 in FIG. 7; 812, 812′ in FIG. 8; 912, 912′ in FIG. 9) support (e.g., “No LDS support”) and containing the tracking area(s) where LDS (e.g., 705 in FIG. 7; 812, 812′ in FIG. 8; 912, 912′ in FIG. 9) service is not supported. In some aspects, the AUE 402 (e.g., 502 in FIG. 5; 602 in FIG. 6; 702 in FIG. 7; 806, 810 in FIG. 8; 906, 910 in FIG. 9) may perform mobility management in such a way as to avoid entering tracking area(s) where LDS (e.g., 705 in FIG. 7; 812, 812′ in FIG. 8; 912, 912′ in FIG. 9) service is not supported; or the AUE 402 (e.g., 502 in FIG. 5; 602 in FIG. 6; 702 in FIG. 7; 806, 810 in FIG. 8; 906, 910 in FIG. 9) may inform the LDS (e.g., 705 in FIG. 7; 812, 812′ in FIG. 8; 912, 912′ in FIG. 9) service of imminent loss of the LDS (e.g., 705 in FIG. 7; 812, 812′ in FIG. 8; 912, 912′ in FIG. 9) service before entering an area where the LDS (e.g., 705 in FIG. 7; 812, 812′ in FIG. 8; 912, 912′ in FIG. 9) service is not supported; and/or the AUE 402 (e.g., 502 in FIG. 5; 602 in FIG. 6; 702 in FIG. 7; 806, 810 in FIG. 8; 906, 910 in FIG. 9) may take action(s) such as relying wholly, or alternatively at least in part, on alternative DAA solutions.

In the context layer 2 and layer 3 operations, which may be alternative or complementary in various aspects, the LDS (e.g., 705 in FIG. 7; 812, 812′ in FIG. 8; 912, 912′ in FIG. 9) service may not be available in all locations, so either a cell (e.g., Cell 1, Cell 2, Cell 3 in FIGS. 8, 9) SIB may have an indication of the LDS (e.g., 705 in FIG. 7; 812, 812′ in FIG. 8; 912, 912′ in FIG. 9) availability (e.g., “LDS available”) when the LDS (e.g., 705 in FIG. 7; 812, 812′ in FIG. 8; 912, 912′ in FIG. 9) service is available, and/or an indication may be sent in RRC establishment signaling and a base station/gNB (e.g., 816, 816′ in FIG. 8; 916, 916′ in FIG. 9) may be configured to know whether the LDS (e.g., 705 in FIG. 7; 812, 812′ in FIG. 8; 912, 912′ in FIG. 9) service is available.

Further, the mobile network 404 (e.g., 504 in FIG. 5; 604 in FIG. 6; 704 in FIG. 7; 804 in FIG. 8; 904 in FIG. 9) may be configured to transmit/provide, and the AUE 402 (e.g., 502 in FIG. 5; 602 in FIG. 6; 702 in FIG. 7; 806, 810 in FIG. 8; 906, 910 in FIG. 9) may be configured to receive, addressing information associated with the NWDAA services and the LDS (e.g., 705 in FIG. 7; 812, 812′ in FIG. 8; 912, 912′ in FIG. 9) of the mobile network 404 (e.g., 504 in FIG. 5; 604 in FIG. 6; 704 in FIG. 7; 804 in FIG. 8; 904 in FIG. 9). In one example, in a registration acceptance (“Registration Accept”) such as by an AMF (e.g., 605 in FIG. 6; 830 in FIG. 8; 930 in FIG. 9), in a PDU session establishment acceptance (“PDU Session Establishment Accept”) such as by an SMF (e.g., 505 in FIG. 5; 832 in FIG. 8; 932 in FIG. 9), in an AUE 402 (e.g., 502 in FIG. 5; 602 in FIG. 6; 702 in FIG. 7; 806, 810 in FIG. 8; 906, 910 in FIG. 9) configuration update procedure, and/or the like, the mobile network 404 (e.g., 504 in FIG. 5; 604 in FIG. 6; 704 in FIG. 7; 804 in FIG. 8; 904 in FIG. 9) may transmit/provide the addressing information for the AUE 402 (e.g., 502 in FIG. 5; 602 in FIG. 6; 702 in FIG. 7; 806, 810 in FIG. 8; 906, 910 in FIG. 9). The LDS (e.g., 705 in FIG. 7; 812, 812′ in FIG. 8; 912, 912′ in FIG. 9) addressing information may include, but is not limited to, an LDS (e.g., 705 in FIG. 7; 812, 812′ in FIG. 8; 912, 912′ in FIG. 9) address (e.g., actual IP address), a URL (which the AUE 402 (e.g., 502 in FIG. 5; 602 in FIG. 6; 702 in FIG. 7; 806, 810 in FIG. 8; 906, 910 in FIG. 9) may be configure to utilize to discover the LDS (e.g., 705 in FIG. 7; 812, 812′ in FIG. 8; 912, 912′ in FIG. 9), e.g. using DNS), a FQDN, an anycast address of the LDS (e.g., 705 in FIG. 7; 812, 812′ in FIG. 8; 912, 912′ in FIG. 9), and/or the like.

At 1108, the AUE receives an AUE authorization for a UUAA procedure based at least in part on the capability indication. As an example, the reception may be performed by one or more of the component 198, the transceiver(s) 2022, and/or the antenna 2080 in FIG. 20. FIG. 4 illustrates, in the context of FIGS. 5-9, an example of the AUE 402 receiving such an authorization.

In aspects, the AUE 402 (e.g., 502 in FIG. 5; 602 in FIG. 6; 702 in FIG. 7; 806, 810 in FIG. 8; 906, 910 in FIG. 9) may be configured to receive an AUE authorization for a UUAA procedure based at least in part on the capability indication 408 (e.g., 508 in FIG. 5; 608 in FIG. 6). The LDS (e.g., 705 in FIG. 7; 812, 812′ in FIG. 8; 912, 912′ in FIG. 9) server address may be provided via a PDU session establishment/PDN connection establishment procedure upon successful UUAA-SM by an SMF (e.g., 505 in FIG. 5; 832 in FIG. 8; 932 in FIG. 9) when LDS (e.g., 705 in FIG. 7; 812, 812′ in FIG. 8; 912, 912′ in FIG. 9) information is in the UDM (e.g., provided by the LDS (e.g., 705 in FIG. 7; 812, 812′ in FIG. 8; 912, 912′ in FIG. 9) provider, whether it is the MNO or a third party, and is configured via an API via the NEF (e.g., 824 in FIG. 8; 924 in FIG. 9)). In aspects, the LDS (e.g., 705 in FIG. 7; 812, 812′ in FIG. 8; 912, 912′ in FIG. 9) server address may be configured by a policy control function (PCF), and the AUE 402 (e.g., 502 in FIG. 5; 602 in FIG. 6; 702 in FIG. 7; 806, 810 in FIG. 8; 906, 910 in FIG. 9) may be configured with an LDS (e.g., 705 in FIG. 7; 812, 812′ in FIG. 8; 912, 912′ in FIG. 9) anycast address that the AUE 402 (e.g., 502 in FIG. 5; 602 in FIG. 6; 702 in FIG. 7; 806, 810 in FIG. 8; 906, 910 in FIG. 9) may utilize to discover the LDS (e.g., 705 in FIG. 7; 812, 812′ in FIG. 8; 912, 912′ in FIG. 9).

At 1110, the AUE establishes a connectivity session with the LDS for the Layer 3 communications based on an LDS discovery procedure, and/or moves an established connectivity session with the LDS for the Layer 3 communications based on an edge server reallocation procedure associated with an instance of the LDS that is an edge node. As an example, the establishment/movement may be performed by one or more of the component 198, the transceiver(s) 2022, and/or the antenna 2080 in FIG. 20. FIG. 4 illustrates, in the context of FIGS. 5-9, an example of the AUE 402 establishing/moving such a connectivity session.

In aspects for AUE-LDS connectivity, the LDS (e.g., 705 in FIG. 7; 812, 812′ in FIG. 8; 912, 912′ in FIG. 9) connectivity may be layer 3 connectivity at the application layer, e.g., the user plane. For example, the AUE 402 (e.g., 502 in FIG. 5; 602 in FIG. 6; 702 in FIG. 7; 806, 810 in FIG. 8; 906, 910 in FIG. 9) may be configured to establish a session with the LDS (e.g., 705 in FIG. 7; 812, 812′ in FIG. 8; 912, 912′ in FIG. 9) upon (i) discovering the LDS (e.g., 705 in FIG. 7; 812, 812′ in FIG. 8; 912, 912′ in FIG. 9) is supported, and (ii) discovering LDS (e.g., 705 in FIG. 7; 812, 812′ in FIG. 8; 912, 912′ in FIG. 9) information, as noted herein. The AUE 402 (e.g., 502 in FIG. 5; 602 in FIG. 6; 702 in FIG. 7; 806, 810 in FIG. 8; 906, 910 in FIG. 9) may be provided, in NAS registration messages, with information regarding the LDS (e.g., 705 in FIG. 7; 812, 812′ in FIG. 8; 912, 912′ in FIG. 9) server discovery (e.g., the server address), or the AUE 402 (e.g., 502 in FIG. 5; 602 in FIG. 6; 702 in FIG. 7; 806, 810 in FIG. 8; 906, 910 in FIG. 9) may be pre-configured with information regarding the LDS(s) (e.g., 705 in FIG. 7; 812, 812′ in FIG. 8; 912, 912′ in FIG. 9) such as, but without limitation, an IP address, a URL, an FQDN, or an anycast address of the LDS (e.g., 705 in FIG. 7; 812, 812′ in FIG. 8; 912, 912′ in FIG. 9) (e.g., FQDNs may be used to discover the IP address of the LDS (e.g., 705 in FIG. 7; 812, 812′ in FIG. 8; 912, 912′ in FIG. 9)).

In aspects, an AMF (e.g., 605 in FIG. 6; 830 in FIG. 8; 930 in FIG. 9) may provide such information upon determining that the AUE 402 (e.g., 502 in FIG. 5; 602 in FIG. 6; 702 in FIG. 7; 806, 810 in FIG. 8; 906, 910 in FIG. 9) has an aerial subscription, has indicated its NWDAA/LDS (e.g., 705 in FIG. 7; 812, 812′ in FIG. 8; 912, 912′ in FIG. 9) capability, and is an authorized AUE (e.g., an UAS service supplier (USS) authentication and authorization (UUAA)/procedure has been performed successfully, when UUAA is supported and/or mandated).

In aspects, a session may be moved to a new LDS (e.g., 705 in FIG. 7; 812, 812′ in FIG. 8; 912, 912′ in FIG. 9) (e.g., LDS instance) based on edge server re-allocation procedures. In some aspects, a dedicated access point name (APN)/data network name (DNN) may be defined for this service, and/or the AUE 402 (e.g., 502 in FIG. 5; 602 in FIG. 6; 702 in FIG. 7; 806, 810 in FIG. 8; 906, 910 in FIG. 9) may be configured by the USS (e.g., 828 in FIG. 8; 928 in FIG. 9) and/or the MNO with respect to the APN/DNN to use upon successful authorization. As described herein, the LDS (e.g., 705 in FIG. 7; 812, 812′ in FIG. 8; 912, 912′ in FIG. 9) may be deployed as an edge-node (e.g., as an edge application server), in aspects.

In aspects for AUE-LDS connectivity, the LDS (e.g., 705 in FIG. 7; 812, 812′ in FIG. 8; 912, 912′ in FIG. 9) connectivity may be layer 2 connectivity at the application layer, e.g., the user plane. For example, the LDS (e.g., 705 in FIG. 7; 812, 812′ in FIG. 8; 912, 912′ in FIG. 9) may be deployed as a RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9)/function (e.g., 505 in FIG. 5; 605 in FIG. 6; 822, 824, 830, 832 in FIG. 8; 922, 924, 930, 932 in FIG. 9). The AUE 402 (e.g., 502 in FIG. 5; 602 in FIG. 6; 702 in FIG. 7; 806, 810 in FIG. 8; 906, 910 in FIG. 9) may be configured to communicate with the LDS (e.g., 705 in FIG. 7; 812, 812′ in FIG. 8; 912, 912′ in FIG. 9) via RAN (e.g., 404 in FIG. 4; 504 in FIG. 5; 604 in FIG. 6; 704 in FIG. 7; 818 in FIG. 8; 918 in FIG. 9) signaling (e.g., by RRC transport messages) to report/warn, as well as to receive warnings and deconfliction directives. For RRC messages containing LDS-related data, the AUE 402 (e.g., 502 in FIG. 5; 602 in FIG. 6; 702 in FIG. 7; 806, 810 in FIG. 8; 906, 910 in FIG. 9) may be configured to send RRC signaling with an explicit indication for LDS (e.g., 705 in FIG. 7; 812, 812′ in FIG. 8; 912, 912′ in FIG. 9)/DWDAA services, so that the RAN (e.g., 404 in FIG. 4; 504 in FIG. 5; 604 in FIG. 6; 704 in FIG. 7; 818 in FIG. 8; 918 in FIG. 9) routes the signaling payload to the correct server (e.g., via a new value for “payload type” specific to this scenario for the AUE 402 (e.g., 502 in FIG. 5; 602 in FIG. 6; 702 in FIG. 7; 806, 810 in FIG. 8; 906, 910 in FIG. 9)).

In aspects for LDS-AUE communication with respect to a serving cell(s) (e.g., Cell 1, Cell 2, Cell 3 in FIGS. 8, 9), the LDS (e.g., 705 in FIG. 7; 812, 812′ in FIG. 8; 912, 912′ in FIG. 9) may be configured to determine the serving cell(s) (e.g., Cell 1, Cell 2, Cell 3 in FIGS. 8, 9) of the AUE 402 (e.g., 502 in FIG. 5; 602 in FIG. 6; 702 in FIG. 7; 806, 810 in FIG. 8; 906, 910 in FIG. 9). For layer 2 communications, in aspects, the LDS (e.g., 705 in FIG. 7; 812, 812′ in FIG. 8; 912, 912′ in FIG. 9) may be configured to utilize a “paging area” concept, e.g., the LDS (e.g., 705 in FIG. 7; 812, 812′ in FIG. 8; 912, 912′ in FIG. 9) may be configured to send the information to the AUE 402 (e.g., 502 in FIG. 5; 602 in FIG. 6; 702 in FIG. 7; 806, 810 in FIG. 8; 906, 910 in FIG. 9) in multiple cells (e.g., Cell 1, Cell 2, Cell 3 in FIGS. 8, 9), which may be identified based on configuration information or corresponding to the paging area. In other layer 2 aspects, as long as the LDS (e.g., 705 in FIG. 7; 812, 812′ in FIG. 8; 912, 912′ in FIG. 9) knows or is aware of the serving base station/gNB (e.g., 816, 816′ in FIG. 8; 916, 916′ in FIG. 9) of the AUE 402 (e.g., 502 in FIG. 5; 602 in FIG. 6; 702 in FIG. 7; 806, 810 in FIG. 8; 906, 910 in FIG. 9), the LDS (e.g., 705 in FIG. 7; 812, 812′ in FIG. 8; 912, 912′ in FIG. 9) may be configured to send the information to the base station/gNB (e.g., 816, 816′ in FIG. 8; 916, 916′ in FIG. 9) that sends the information to all the serving cells (e.g., Cell 1, Cell 2, Cell 3 in FIGS. 8, 9) (e.g., not a specific cell, but a specific RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9)).

In aspects for AUE-LDS connectivity, the LDS (e.g., 705 in FIG. 7; 812, 812′ in FIG. 8; 912, 912′ in FIG. 9) connectivity may be layer 3 connectivity at the control plane. For example, the LDS (e.g., 705 in FIG. 7; 812, 812′ in FIG. 8; 912, 912′ in FIG. 9) may be deployed as a local application server that is integrated with a local NEF (e.g., 824 in FIG. 8; 924 in FIG. 9). The AUE 402 (e.g., 502 in FIG. 5; 602 in FIG. 6; 702 in FIG. 7; 806, 810 in FIG. 8; 906, 910 in FIG. 9) may be configured to communicate with the LDS (e.g., 705 in FIG. 7; 812, 812′ in FIG. 8; 912, 912′ in FIG. 9) via control plane Cellular Internet of Things (CIoT) communications to report/warn, as well as to receive warning and deconfliction directives. As an example, the communications may start at the AUE 402 (e.g., 502 in FIG. 5; 602 in FIG. 6; 702 in FIG. 7; 806, 810 in FIG. 8; 906, 910 in FIG. 9) and be sent via the AMF (e.g., 605 in FIG. 6; 830 in FIG. 8; 930 in FIG. 9) to a local NEF (e.g., 824 in FIG. 8; 924 in FIG. 9)/the LDS (e.g., 705 in FIG. 7; 812, 812′ in FIG. 8; 912, 912′ in FIG. 9). In aspects, an existing NEF (e.g., 824 in FIG. 8; 924 in FIG. 9) API (e.g., a non-IP data delivery) may be utilized. The data payload may be defined, e.g., XML schema for DAA operation, and the local NEF (e.g., 824 in FIG. 8; 924 in FIG. 9) concept can be utilized, e.g., to reduce delay. In aspects, when a serving NEF (e.g., 824 in FIG. 8; 924 in FIG. 9)/LDS (e.g., 705 in FIG. 7; 812, 812′ in FIG. 8; 912, 912′ in FIG. 9) changes, a Non-IP Data Delivery (NIDD) connection path may be established with the serving AMF (e.g., 605 in FIG. 6; 830 in FIG. 8; 930 in FIG. 9).

In some aspects, the AMF (e.g., 605 in FIG. 6; 830 in FIG. 8; 930 in FIG. 9) may support control plane CIoT and NIDD APIs, and the NEF-LDS interface may not have to be specified, e.g., it may be integrated. Additionally, there may be no impact on L2 signaling in such aspects, which may be used for access by the AUE 402 (e.g., 502 in FIG. 5; 602 in FIG. 6; 702 in FIG. 7; 806, 810 in FIG. 8; 906, 910 in FIG. 9) to other services using data traffic, and hop-by-hop security may be guaranteed, in such aspects.

At 1112, the AUE receives, from the second network entity, a reporting configuration that indicates at least one of a continuous reporting operation or a conditional reporting operation, where communicating the information associated with the NWDAA services is based on the reporting configuration. As an example, the reception may be performed by one or more of the component 198, the transceiver(s) 2022, and/or the antenna 2080 in FIG. 20. FIG. 4 illustrates, in the context of FIGS. 5-9, an example of the AUE 402 receiving such a configuration from a second network entity (e.g., an LDS associated with the mobile network 404).

In aspects, the AUE 402 (e.g., 502 in FIG. 5; 602 in FIG. 6; 702 in FIG. 7; 806, 810 in FIG. 8; 906, 910 in FIG. 9) may perform continuous reporting or conditional reporting (e.g., the AUE 402 (e.g., 502 in FIG. 5; 602 in FIG. 6; 702 in FIG. 7; 806, 810 in FIG. 8; 906, 910 in FIG. 9) may be configured by the LDS (e.g., 705 in FIG. 7; 812, 812′ in FIG. 8; 912, 912′ in FIG. 9) to do one and/or the other, under what conditions, etc.). The AUE 402 (e.g., 502 in FIG. 5; 602 in FIG. 6; 702 in FIG. 7; 806, 810 in FIG. 8; 906, 910 in FIG. 9) may receive, from the LDS (e.g., 705 in FIG. 7; 812, 812′ in FIG. 8; 912, 912′ in FIG. 9), configuration information on reporting to the LDS (e.g., 705 in FIG. 7; 812, 812′ in FIG. 8; 912, 912′ in FIG. 9) when a session is established with the LDS (e.g., 705 in FIG. 7; 812, 812′ in FIG. 8; 912, 912′ in FIG. 9). Additionally, the AUE 402 (e.g., 502 in FIG. 5; 602 in FIG. 6; 702 in FIG. 7; 806, 810 in FIG. 8; 906, 910 in FIG. 9) may request deconfliction from the LDS (e.g., 705 in FIG. 7; 812, 812′ in FIG. 8; 912, 912′ in FIG. 9).

At 1114, if early detection is to be performed, flowchart 1100 may proceed to 1116; if not, flowchart 1100 may proceed to 1120. As an example, the obtainment may be performed by one or more of the component 198, the transceiver(s) 2022, and/or the antenna 2080 in FIG. 20.

At 1116, the AUE obtains local awareness information associated with the AUE. As an example, the obtainment may be performed by one or more of the component 198, the transceiver(s) 2022, and/or the antenna 2080 in FIG. 20. FIG. 4 illustrates, in the context of FIGS. 5-9, an example of the AUE 402 obtaining such local awareness information.

The mobile network 404 (e.g., 504 in FIG. 5; 604 in FIG. 6; 704 in FIG. 7; 804 in FIG. 8; 904 in FIG. 9) and/or the AUE 402 (e.g., 502 in FIG. 5; 602 in FIG. 6; 702 in FIG. 7; 806, 810 in FIG. 8; 906, 910 in FIG. 9) may be configured to identify/detect (at 412) indicia of a conflict scenario (e.g., a confliction condition) associated with the AUE 402 (e.g., 502 in FIG. 5; 602 in FIG. 6; 702 in FIG. 7; 806, 810 in FIG. 8; 906, 910 in FIG. 9) and/or with a different AUE. In one example, the AUE 402 may be configured to obtain local awareness information associated with the AUE 402 (e.g., 502 in FIG. 5; 602 in FIG. 6; 702 in FIG. 7; 806, 810 in FIG. 8; 906, 910 in FIG. 9) (e.g., from the LDS (e.g., 705 in FIG. 7; 812, 812′ in FIG. 8; 912, 912′ in FIG. 9) and/or from sensors (e.g., 814 in FIG. 8; 914 in FIG. 9), etc., of the AUE 402 (e.g., 502 in FIG. 5; 602 in FIG. 6; 702 in FIG. 7; 806, 810 in FIG. 8; 906, 910 in FIG. 9), and to identify a confliction condition, associated with the NWDAA services, for the AUE 402 (e.g., 502 in FIG. 5; 602 in FIG. 6; 702 in FIG. 7; 806, 810 in FIG. 8; 906, 910 in FIG. 9) based on the local awareness information.

At 1118, the AUE identifies a confliction condition, associated with the NWDAA services, for the AUE based on the local awareness information. As an example, the identification may be performed by one or more of the component 198, the transceiver(s) 2022, and/or the antenna 2080 in FIG. 20. FIG. 4 illustrates, in the context of FIGS. 5-9, an example of the AUE 402 identifying such a confliction condition.

The mobile network 404 (e.g., 504 in FIG. 5; 604 in FIG. 6; 704 in FIG. 7; 804 in FIG. 8; 904 in FIG. 9) and/or the AUE 402 (e.g., 502 in FIG. 5; 602 in FIG. 6; 702 in FIG. 7; 806, 810 in FIG. 8; 906, 910 in FIG. 9) may be configured to identify/detect (at 412) indicia of a conflict scenario (e.g., a confliction condition) associated with the AUE 402 (e.g., 502 in FIG. 5; 602 in FIG. 6; 702 in FIG. 7; 806, 810 in FIG. 8; 906, 910 in FIG. 9) and/or with a different AUE. In one example, the AUE 402 may be configured to obtain local awareness information associated with the AUE 402 (e.g., 502 in FIG. 5; 602 in FIG. 6; 702 in FIG. 7; 806, 810 in FIG. 8; 906, 910 in FIG. 9) (e.g., from the LDS (e.g., 705 in FIG. 7; 812, 812′ in FIG. 8; 912, 912′ in FIG. 9)) and/or from sensors (e.g., 814 in FIG. 8; 914 in FIG. 9), etc., of the AUE 402 (e.g., 502 in FIG. 5; 602 in FIG. 6; 702 in FIG. 7; 806, 810 in FIG. 8; 906, 910 in FIG. 9), and to identify a confliction condition, associated with the NWDAA services, for the AUE 402 (e.g., 502 in FIG. 5; 602 in FIG. 6; 702 in FIG. 7; 806, 810 in FIG. 8; 906, 910 in FIG. 9) based on the local awareness information.

For instance, the AUE 402 (e.g., 502 in FIG. 5; 602 in FIG. 6; 702 in FIG. 7; 806, 810 in FIG. 8; 906, 910 in FIG. 9) may be configured to trigger an early detection to the LDS (e.g., 705 in FIG. 7; 812, 812′ in FIG. 8; 912, 912′ in FIG. 9) of the mobile network 404 (e.g., 504 in FIG. 5; 604 in FIG. 6; 704 in FIG. 7; 804 in FIG. 8; 904 in FIG. 9). The AUE 402 (e.g., 502 in FIG. 5; 602 in FIG. 6; 702 in FIG. 7; 806, 810 in FIG. 8; 906, 910 in FIG. 9) may comprise onboard processing/intelligence (e.g., a computational function) for conflict/confliction detection and/or awareness, and may be configured to report such conflict/confliction detection and/or awareness to the LDS (e.g., 705 in FIG. 7; 812, 812′ in FIG. 8; 912, 912′ in FIG. 9).

From 1118, flowchart 1100 may continue to the communication at 1120 and then return to 1114 or 1110.

At 1120, the AUE communicates, with a second network entity of the mobile network, information associated with the NWDAA services. As an example, the communication may be performed by one or more of the component 198, the transceiver(s) 2022, and/or the antenna 2080 in FIG. 20. FIG. 4 illustrates, in the context of FIGS. 5-9, an example of the AUE 402 communicating such information with a network entity of a mobile network (e.g., the mobile network 404).

The mobile network 404 (e.g., 504 in FIG. 5; 604 in FIG. 6; 704 in FIG. 7; 804 in FIG. 8; 904 in FIG. 9) (e.g., by an LDS(s) (e.g., 705 in FIG. 7; 812, 812′ in FIG. 8; 912, 912′ in FIG. 9) thereof) and/or the AUE 402 (e.g., 502 in FIG. 5; 602 in FIG. 6; 702 in FIG. 7; 806, 810 in FIG. 8; 906, 910 in FIG. 9) may be configured to communicate communication information 414 associated with the NWDAA services. In aspects, the communication information 414 may be any information associated with the NWDAA services and/or an LDS (e.g., 705 in FIG. 7; 812, 812′ in FIG. 8; 912, 912′ in FIG. 9), as described herein. In aspects for AUE-LDS communications, an LDS (e.g., 705 in FIG. 7; 812, 812′ in FIG. 8; 912, 912′ in FIG. 9) may operate as a passive LDS receiver or as an active LDS receiver.

As a passive LDS receiver, LDS nodes (e.g., 705 in FIG. 7; 812, 812′ in FIG. 8; 912, 912′ in FIG. 9) may receive U2X information (e.g. DAA, BRID) sent by AUEs such as the AUE 402 (e.g., 502 in FIG. 5; 602 in FIG. 6; 702 in FIG. 7; 806, 810 in FIG. 8; 906, 910 in FIG. 9): sidelink receivers in a base station/gNB (e.g., 816, 816′ in FIG. 8; 916, 916′ in FIG. 9) may be configured to receive such information; a base station/gNB (e.g., 816, 816′ in FIG. 8; 916, 916′ in FIG. 9) (RAN (e.g., 404 in FIG. 4; 504 in FIG. 5; 604 in FIG. 6; 704 in FIG. 7; 818 in FIG. 8; 918 in FIG. 9)) may report received BRID and/or DAA signaling sent by AUEs (e.g., 502 in FIG. 5; 602 in FIG. 6; 702 in FIG. 7; 806, 810 in FIG. 8; 906, 910 in FIG. 9) to the LDS(s) (e.g., 705 in FIG. 7; 812, 812′ in FIG. 8; 912, 912′ in FIG. 9) covering the base station/gNB (e.g., 816, 816′ in FIG. 8; 916, 916′ in FIG. 9) area. In such aspects, a RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9) may be configured with the identity/address of the one or more LDS(s) (e.g., 705 in FIG. 7; 812, 812′ in FIG. 8; 912, 912′ in FIG. 9) serving the area of the RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9). Such configurations may leverage information already available via LTE/NR aerial features (e.g., path reporting). The LDS (e.g., 705 in FIG. 7; 812, 812′ in FIG. 8; 912, 912′ in FIG. 9) may receive ADS-B information from manned aviation: this may leverage receivers in the base station/gNB (e.g., 816, 816′ in FIG. 8; 916, 916′ in FIG. 9) that report ADS-B traffic to the LDS (e.g., 705 in FIG. 7; 812, 812′ in FIG. 8; 912, 912′ in FIG. 9).

As an active LDS receiver, the AUE 402 (e.g., 502 in FIG. 5; 602 in FIG. 6; 702 in FIG. 7; 806, 810 in FIG. 8; 906, 910 in FIG. 9) may be configured to send information directly and explicitly to the LDS (e.g., 705 in FIG. 7; 812, 812′ in FIG. 8; 912, 912′ in FIG. 9) (e.g., location, flight path, etc.). The AUE 402 (e.g., 502 in FIG. 5; 602 in FIG. 6; 702 in FIG. 7; 806, 810 in FIG. 8; 906, 910 in FIG. 9) may be configured to trigger an early detection to the LDS (e.g., 705 in FIG. 7; 812, 812′ in FIG. 8; 912, 912′ in FIG. 9), e.g., the AUE 402 (e.g., 502 in FIG. 5; 602 in FIG. 6; 702 in FIG. 7; 806, 810 in FIG. 8; 906, 910 in FIG. 9) may be configured to detect locally a possible conflict and report it to the LDS (e.g., 705 in FIG. 7; 812, 812′ in FIG. 8; 912, 912′ in FIG. 9) (e.g., including information received from other AUEs (e.g., 806, 808, 810 in FIG. 8; 906, 908, 910 in FIG. 9), including AUE ID(s), path, etc.), and either: (i) includes its planned deconfliction strategy (e.g., a trajectory change) that the UAS may compute autonomously, or (ii) includes a request for a “guided” trajectory change, which the LDS (e.g., 705 in FIG. 7; 812, 812′ in FIG. 8; 912, 912′ in FIG. 9) may compute and report back. The AUE 402 (e.g., 502 in FIG. 5; 602 in FIG. 6; 702 in FIG. 7; 806, 810 in FIG. 8; 906, 910 in FIG. 9) may also be configured to report to the LDS (e.g., 705 in FIG. 7; 812, 812′ in FIG. 8; 912, 912′ in FIG. 9) that the conflict is cleared subsequent to the conflict being cleared.

In aspects for LDS-AUE communications, the LDS (e.g., 705 in FIG. 7; 812, 812′ in FIG. 8; 912, 912′ in FIG. 9) may be configured to trigger warnings to the AUE 402 (e.g., 502 in FIG. 5; 602 in FIG. 6; 702 in FIG. 7; 806, 810 in FIG. 8; 906, 910 in FIG. 9). A potential conflict detection in the LDS (e.g., 705 in FIG. 7; 812, 812′ in FIG. 8; 912, 912′ in FIG. 9) may trigger a warning and potential de-escalation/de-conflictions instructions to the AUE 402 (e.g., 502 in FIG. 5; 602 in FIG. 6; 702 in FIG. 7; 806, 810 in FIG. 8; 906, 910 in FIG. 9), if requested, or if proximity thresholds are violated (e.g., are met). In aspects, the LDS (e.g., 705 in FIG. 7; 812, 812′ in FIG. 8; 912, 912′ in FIG. 9) may be configured to trigger an emergency directive to the AUE 402 (e.g., 502 in FIG. 5; 602 in FIG. 6; 702 in FIG. 7; 806, 810 in FIG. 8; 906, 910 in FIG. 9). A conflict/confliction detection (e.g., a critical conflict/confliction detection) in the LDS (e.g., 705 in FIG. 7; 812, 812′ in FIG. 8; 912, 912′ in FIG. 9) may trigger a path directive (e.g., a non-emergency deconfliction) or an emergency directive (e.g., an urgent emergency deconfliction) to the AUE 402 (e.g., 502 in FIG. 5; 602 in FIG. 6; 702 in FIG. 7; 806, 810 in FIG. 8; 906, 910 in FIG. 9). A path directive may include information associated with a new flight path that the LDS (e.g., 705 in FIG. 7; 812, 812′ in FIG. 8; 912, 912′ in FIG. 9) may have received from the UTM system (e.g., 826 in FIG. 8; 926 in FIG. 9)/the USS system (e.g., 828 in FIG. 8; 928 in FIG. 9). An emergency directive may include an imminent collision status message with basic metadata about the other aircraft(s)/UAV(s) and may include multiple deconfliction solutions/strategies that are presented. In aspects, such a set of deconfliction solutions/strategies may be scored (e.g., prioritized) and may be provided to the UAS. The UAS, or its controller, may then consider the options and execute one (or more) based on its own knowledge and sensor (e.g., 814 in FIG. 8; 914 in FIG. 9) status, by way of example.

Based on local policies or USS (e.g., 828 in FIG. 8; 928 in FIG. 9) configuration, a warning may be sent under specific conditions (e.g. an AUE category like drone AUE size or mission type, e.g. public safety versus package delivery), an AUE size, an AUE class, a mission type, a public safety priority, or a delivery priority. The LDS (e.g., 705 in FIG. 7; 812, 812′ in FIG. 8; 912, 912′ in FIG. 9) may be configured to receive configuration information for the specific AUE or class of AUE (e.g., either by the AUE 402 (e.g., 502 in FIG. 5; 602 in FIG. 6; 702 in FIG. 7; 806, 810 in FIG. 8; 906, 910 in FIG. 9) providing its AUE ID explicitly, or the LDS (e.g., 705 in FIG. 7; 812, 812′ in FIG. 8; 912, 912′ in FIG. 9), based on the received AUE ID broadcasted by the AUE, may derive the specific AUE information, or the LDS (e.g., 705 in FIG. 7; 812, 812′ in FIG. 8; 912, 912′ in FIG. 9) may receive the information from the UAS NF (e.g., 822 in FIG. 8; 922 in FIG. 9), which receives the information during the AUE 402 (e.g., 502 in FIG. 5; 602 in FIG. 6; 702 in FIG. 7; 806, 810 in FIG. 8; 906, 910 in FIG. 9) registration with the mobile network operator (MNO) from the USS (e.g., 828 in FIG. 8; 928 in FIG. 9)).

In aspects for LDS-AUE communications, a model of communication may be direct or indirect. In a direct model, a C2 link may be sent by the LDS (e.g., 705 in FIG. 7; 812, 812′ in FIG. 8; 912, 912′ in FIG. 9) to the AUE 402 (e.g., 502 in FIG. 5; 602 in FIG. 6; 702 in FIG. 7; 806, 810 in FIG. 8; 906, 910 in FIG. 9). In an indirect model, if the LDS (e.g., 705 in FIG. 7; 812, 812′ in FIG. 8; 912, 912′ in FIG. 9) is aware of the UAVC, either the LDS (e.g., 705 in FIG. 7; 812, 812′ in FIG. 8; 912, 912′ in FIG. 9) informs UAVC, or the AUE 402 (e.g., 502 in FIG. 5; 602 in FIG. 6; 702 in FIG. 7; 806, 810 in FIG. 8; 906, 910 in FIG. 9) informs the UAVC over the C2 link.

As noted (e.g., at 1118), the AUE 402 (e.g., 502 in FIG. 5; 602 in FIG. 6; 702 in FIG. 7; 806, 810 in FIG. 8; 906, 910 in FIG. 9) may be configured to trigger an early detection to the LDS (e.g., 705 in FIG. 7; 812, 812′ in FIG. 8; 912, 912′ in FIG. 9) of the mobile network 404 (e.g., 504 in FIG. 5; 604 in FIG. 6; 704 in FIG. 7; 804 in FIG. 8; 904 in FIG. 9). The AUE 402 (e.g., 502 in FIG. 5; 602 in FIG. 6; 702 in FIG. 7; 806, 810 in FIG. 8; 906, 910 in FIG. 9) may comprise onboard processing/intelligence (e.g., a computational function) for conflict/confliction detection and/or awareness, and may be configured to report such conflict/confliction detection and/or awareness to the LDS (e.g., 705 in FIG. 7; 812, 812′ in FIG. 8; 912, 912′ in FIG. 9).

In aspects, the AUE 402 (e.g., 502 in FIG. 5; 602 in FIG. 6; 702 in FIG. 7; 806, 810 in FIG. 8; 906, 910 in FIG. 9) may perform continuous reporting or conditional reporting (e.g., the AUE 402 (e.g., 502 in FIG. 5; 602 in FIG. 6; 702 in FIG. 7; 806, 810 in FIG. 8; 906, 910 in FIG. 9) may be configured by the LDS (e.g., 705 in FIG. 7; 812, 812′ in FIG. 8; 912, 912′ in FIG. 9) to do one and/or the other, under what conditions, etc.). The AUE 402 (e.g., 502 in FIG. 5; 602 in FIG. 6; 702 in FIG. 7; 806, 810 in FIG. 8; 906, 910 in FIG. 9) may receive, from the LDS (e.g., 705 in FIG. 7; 812, 812′ in FIG. 8; 912, 912′ in FIG. 9), configuration information on reporting to the LDS (e.g., 705 in FIG. 7; 812, 812′ in FIG. 8; 912, 912′ in FIG. 9) when a session is established with the LDS (e.g., 705 in FIG. 7; 812, 812′ in FIG. 8; 912, 912′ in FIG. 9). Additionally, the AUE 402 (e.g., 502 in FIG. 5; 602 in FIG. 6; 702 in FIG. 7; 806, 810 in FIG. 8; 906, 910 in FIG. 9) may request deconfliction from the LDS (e.g., 705 in FIG. 7; 812, 812′ in FIG. 8; 912, 912′ in FIG. 9).

At 1122, if a confliction warning and/or local awareness information is received via the communication at 1120, flowchart 1100 may proceed to 1124; if not, flowchart 1100 may proceed to 1126. As an example, the obtainment may be performed by one or more of the component 198, the transceiver(s) 2022, and/or the antenna 2080 in FIG. 20.

At 1124, the AUE identifies a set of actions based on at least one of the confliction warning or the local awareness information. As an example, the identification may be performed by one or more of the component 198, the transceiver(s) 2022, and/or the antenna 2080 in FIG. 20. FIG. 4 illustrates, in the context of FIGS. 5-9, an example of the AUE 402 identifying such an action(s).

As another example, the LDS (e.g., 705 in FIG. 7; 812, 812′ in FIG. 8; 912, 912′ in FIG. 9) of the mobile network 404 (e.g., 504 in FIG. 5; 604 in FIG. 6; 704 in FIG. 7; 804 in FIG. 8; 904 in FIG. 9) may be configured to trigger warnings to the AUE 402 (e.g., 502 in FIG. 5; 602 in FIG. 6; 702 in FIG. 7; 806, 810 in FIG. 8; 906, 910 in FIG. 9). The LDS (e.g., 705 in FIG. 7; 812, 812′ in FIG. 8; 912, 912′ in FIG. 9) may be configured to create local awareness (e.g., local awareness information) based on RAN (e.g., 404 in FIG. 4; 504 in FIG. 5; 604 in FIG. 6; 704 in FIG. 7; 818 in FIG. 8; 918 in FIG. 9) sensing information, listening to DAA messages, BRID (Broadcast remote ID) messages, having access to sensors (e.g., 814 in FIG. 8; 914 in FIG. 9) (e.g. ADS-B, RADAR, LIDAR, SONAR, AUE 402 (e.g., 502 in FIG. 5; 602 in FIG. 6; 702 in FIG. 7; 806, 810 in FIG. 8; 906, 910 in FIG. 9) positioning, NR) sensing information, etc.). The LDS (e.g., 705 in FIG. 7; 812, 812′ in FIG. 8; 912, 912′ in FIG. 9) may send such information to the AUE 402 (e.g., 502 in FIG. 5; 602 in FIG. 6; 702 in FIG. 7; 806, 810 in FIG. 8; 906, 910 in FIG. 9) to enhance situational awareness of AUE 402 (e.g., 502 in FIG. 5; 602 in FIG. 6; 702 in FIG. 7; 806, 810 in FIG. 8; 906, 910 in FIG. 9), yet detection and deconfliction may be performed in AUE 402 (e.g., 502 in FIG. 5; 602 in FIG. 6; 702 in FIG. 7; 806, 810 in FIG. 8; 906, 910 in FIG. 9) for warnings (e.g., the LDS (e.g., 705 in FIG. 7; 812, 812′ in FIG. 8; 912, 912′ in FIG. 9) may provide deconfliction suggestions/strategies, and the AUE 402 (e.g., 502 in FIG. 5; 602 in FIG. 6; 702 in FIG. 7; 806, 810 in FIG. 8; 906, 910 in FIG. 9) chooses the appropriate one by implementation or configuration information/policies provided by either a UAS operator or a USS system (e.g., 828 in FIG. 8; 928 in FIG. 9), e.g., depending on geographic regulations).

From 1124, flowchart 1100 may continue to the return to 1120 and then return to 1114 or 1110.

At 1126, if a path directive and/or an emergency directive is/are received via the communication at 1120, flowchart 1100 may proceed to 1128; if not, flowchart 1100 may return to 1114 (or to 1110, not shown for illustrative clarity). As an example, the obtainment may be performed by one or more of the component 198, the transceiver(s) 2022, and/or the antenna 2080 in FIG. 20.

At 1128, the AUE executes the planned deconfliction strategy or the guided deconfliction strategy. As an example, the execution may be performed by one or more of the component 198, the transceiver(s) 2022, and/or the antenna 2080 in FIG. 20. FIG. 4 illustrates, in the context of FIGS. 5-9, an example of the AUE 402 executing such strategies.

As another example, the LDS (e.g., 705 in FIG. 7; 812, 812′ in FIG. 8; 912, 912′ in FIG. 9) may be configured to trigger emergency directives/path directives (e.g., deconfliction directives, generally) to the AUE 402 (e.g., 502 in FIG. 5; 602 in FIG. 6; 702 in FIG. 7; 806, 810 in FIG. 8; 906, 910 in FIG. 9) and/or a UAVC (or the AUE 402 (e.g., 502 in FIG. 5; 602 in FIG. 6; 702 in FIG. 7; 806, 810 in FIG. 8; 906, 910 in FIG. 9)) may inform the UAVC itself. In such aspects, the detection and deconfliction may be performed in the LDS (e.g., 705 in FIG. 7; 812, 812′ in FIG. 8; 912, 912′ in FIG. 9). In some aspects, detection may be based on the AUE 402 (e.g., 502 in FIG. 5; 602 in FIG. 6; 702 in FIG. 7; 806, 810 in FIG. 8; 906, 910 in FIG. 9) request for the deconfliction, or may be based on the LDS's (e.g., 705 in FIG. 7; 812, 812′ in FIG. 8; 912, 912′ in FIG. 9) intelligence (e.g., local awareness), or both. In some aspects, the AUE 402 (e.g., 502 in FIG. 5; 602 in FIG. 6; 702 in FIG. 7; 806, 810 in FIG. 8; 906, 910 in FIG. 9) and the UAVC follow the command for deconfliction from the LDS (e.g., 705 in FIG. 7; 812, 812′ in FIG. 8; 912, 912′ in FIG. 9) in the case of an emergency directive.

At 1130, the AUE provides, subsequently for the second network entity, an indication of a clearance of the confliction condition. As an example, the provision may be performed by one or more of the component 198, the transceiver(s) 2022, and/or the antenna 2080 in FIG. 20. FIG. 4 illustrates, in the context of FIGS. 5-9, an example of the AUE 402 providing such an indication to a second network entity (e.g., an LDS).

As noted herein, the AUE 402 (e.g., 502 in FIG. 5; 602 in FIG. 6; 702 in FIG. 7; 806, 810 in FIG. 8; 906, 910 in FIG. 9) may also be configured to report to the LDS (e.g., 705 in FIG. 7; 812, 812′ in FIG. 8; 912, 912′ in FIG. 9) that the conflict is cleared subsequent to the conflict being cleared. In aspects, provision of the clearance may be performed as a subsequent aspect of the communication at 1120.

Aspects illustrated for FIG. 11 include connectors, shown as circles “1” and “2,” for illustrative clarity of connections. For example, from 1118 and/or 1124, flowchart 1100 may continue to 1110 (e.g., via connector “1”), to 1114, and/or to 1120 (e.g., via connector “2”), etc. In aspects, connector “1” and connector “2” may be flowchart 1100 options based on scenarios and/or real-time environmental events associated with an AUE/UAV. In aspects, connector “1” and connector “2” may be disjunctive options, or may be concurrent/partially-concurrent options, based on such scenarios and/or real-time environmental events for the AUE/UAV.

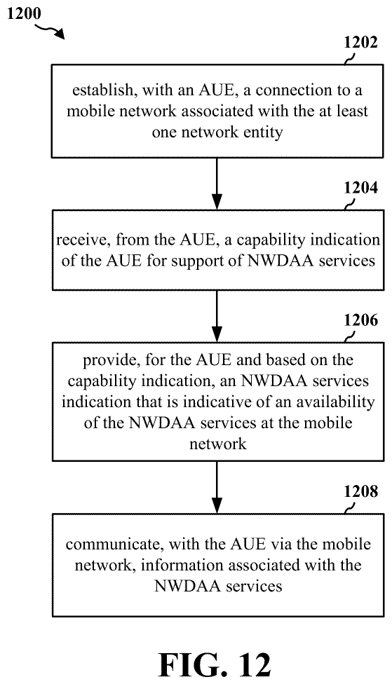

FIG. 12 is a flowchart 1200 of a method of wireless communication. The method may be performed by a network entity(ies)/a network node(s) (e.g., the base station 102, 816, 816′, 916, 916′; network entities of the mobile network 404; the SMF 162, 505, 832, 932; the AMF 161, 605, 830, 930; the LDS 705, 812, 812′, 912, 912′; the network entity 1902, 2060) of a mobile network. In some aspects, the method may include aspects described in connection with the communication flows in FIGS. 4, 5, 6, 7, and/or aspects described in FIGS. 8, 9. The method may be for network-assisted DAA for AUEs. The method may provide for improved DAA by enabling an AUE to report NWDAA capabilities and be authenticated for utilization of a network-based LDS with predictive deconfliction and multi-source information gathering capabilities.

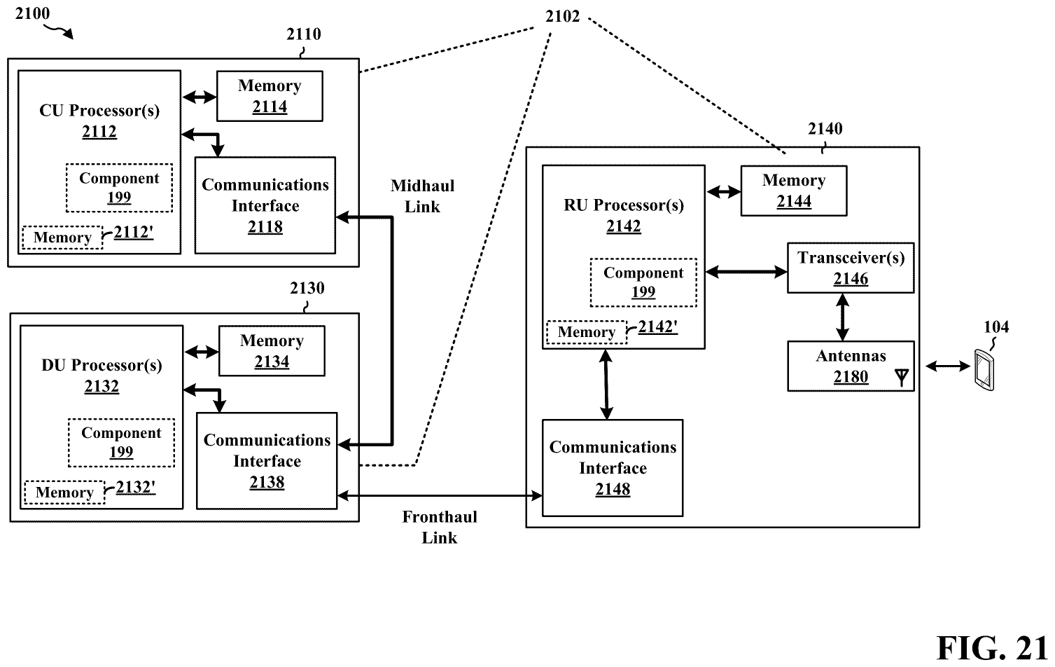

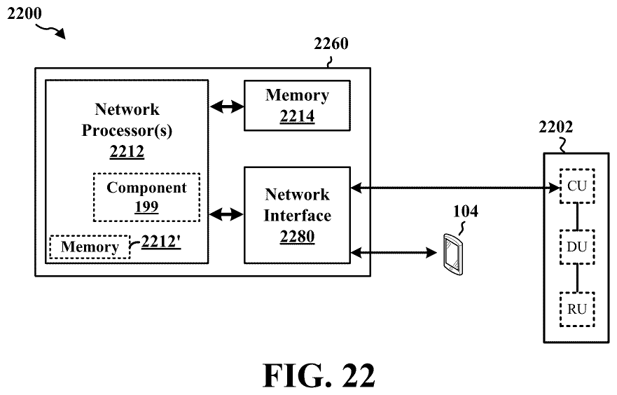

At 1202, the at least one network entity establishes, with an AUE, a connection to a mobile network associated with the at least one network entity. As an example, the establishment may be performed by one or more of the component 199, the transceiver 2146, and/or the antenna 2180 in FIG. 21, the network interface 2280 in FIG. 22. FIG. 5 illustrates, in the context of FIGS. 4, 6-9, an example of the SMF 505 establishing such a connection to a mobile network (e.g., the mobile network 504) with an AUE (e.g., the AUE 502).

The AUE 502 (e.g., 402 in FIG. 4; 602 in FIG. 6; 702 in FIG. 7; 806, 810 in FIG. 8; 906, 910 in FIG. 9) may be configured to establish (at 506) a network connection with the mobile network 504 (e.g., 404 in FIG. 4; 604 in FIG. 6; 704 in FIG. 7; 818 in FIG. 8; 918 in FIG. 9) and the SMF 505 (e.g., 832 in FIG. 8; 932 in FIG. 9). Additionally or conversely, the mobile network 504 (e.g., 404 in FIG. 4; 604 in FIG. 6; 704 in FIG. 7; 818 in FIG. 8; 918 in FIG. 9) and the SMF 505 (e.g., 832 in FIG. 8; 932 in FIG. 9) may be configured to establish (at 506) a network connection with the AUE 502 (e.g., 402 in FIG. 4; 602 in FIG. 6; 702 in FIG. 7; 806, 810 in FIG. 8; 906, 910 in FIG. 9). In aspects, the AUE 502 (e.g., 402 in FIG. 4; 602 in FIG. 6; 702 in FIG. 7; 806, 810 in FIG. 8; 906, 910 in FIG. 9) may be configured to establish (at 506) a network connection with the mobile network 504 (e.g., 404 in FIG. 4; 604 in FIG. 6; 704 in FIG. 7; 818 in FIG. 8; 918 in FIG. 9) via a base station, gNB, etc. (e.g., 816, 816′ in FIG. 8; 916, 916′ in FIG. 9), for the SMF 505 (e.g., 832 in FIG. 8; 932 in FIG. 9) of the mobile network 504 (e.g., 404 in FIG. 4; 604 in FIG. 6; 704 in FIG. 7; 818 in FIG. 8; 918 in FIG. 9), as would be understood by persons of skill in the relevant art(s) having the benefit of this disclosure.

At 1204, the at least one network entity receives, from the AUE, a capability indication of the AUE for support of NWDAA services. As an example, the reception may be performed by one or more of the component 199, the transceiver 2146, and/or the antenna 2180 in FIG. 21, the network interface 2280 in FIG. 22. FIG. 5 illustrates, in the context of FIGS. 4, 6-9, an example of the SMF 505 receiving such a capability indication from an AUE (e.g., the AUE 502).

The AUE 502 (e.g., 402 in FIG. 4; 602 in FIG. 6; 702 in FIG. 7; 806, 810 in FIG. 8; 906, 910 in FIG. 9) may be configured to transmit/provide, and the mobile network 504 (e.g., 404 in FIG. 4; 604 in FIG. 6; 704 in FIG. 7; 818 in FIG. 8; 918 in FIG. 9) and the SMF 505 (e.g., 832 in FIG. 8; 932 in FIG. 9) may be configured to receive, a capability indication 508 (e.g., 408 in FIG. 4; 608 in FIG. 6). In aspects, the capability indication 508 (e.g., 408 in FIG. 4; 608 in FIG. 6) of the AUE 502 (e.g., 402 in FIG. 4; 602 in FIG. 6; 702 in FIG. 7; 806, 810 in FIG. 8; 906, 910 in FIG. 9) for support of NWDAA services. In aspects, an LDS (e.g., 705 in FIG. 7; 812, 812′ in FIG. 8; 912, 912′ in FIG. 9) herein may comprise the NWDAA services, or vice versa, the LDS (e.g., 705 in FIG. 7; 812, 812′ in FIG. 8; 912, 912′ in FIG. 9) may be configured to provide at least a portion of the NWDAA services, and/or the like. The transmission/provision of the capability indication 508 (e.g., 408 in FIG. 4; 608 in FIG. 6) may be a portion of a discover of support for an LDS (e.g., 705 in FIG. 7; 812, 812′ in FIG. 8; 912, 912′ in FIG. 9)/NWDAA services. In aspects, when the AUE 502 (e.g., 402 in FIG. 4; 602 in FIG. 6; 702 in FIG. 7; 806, 810 in FIG. 8; 906, 910 in FIG. 9) is capable of utilizing an LDS (e.g., 705 in FIG. 7; 812, 812′ in FIG. 8; 912, 912′ in FIG. 9), the AUE 502 (e.g., 402 in FIG. 4; 602 in FIG. 6; 702 in FIG. 7; 806, 810 in FIG. 8; 906, 910 in FIG. 9) indicates its support for the LDS (e.g., 705 in FIG. 7; 812, 812′ in FIG. 8; 912, 912′ in FIG. 9) (or network-assisted DAA, generally). In some aspects, the transmission/provision of the capability indication 508 (e.g., 408 in FIG. 4; 608 in FIG. 6) may be via NAS signaling. As one example, the transmission/provision of the capability indication 508 (e.g., 408 in FIG. 4; 608 in FIG. 6) may be for the SMF 505 (e.g., 832 in FIG. 8; 932 in FIG. 9) using session management (SM) signaling, such as a PDU session request for establishment of a PDU session for layer 3 implementations, in 5GSM capabilities, or an express/explicit indication.

At 1206, the at least one network entity provides, for the AUE and based on the capability indication, an NWDAA services indication that is indicative of an availability of the NWDAA services at the mobile network. As an example, the provision may be performed by one or more of the component 199, the transceiver 2146, and/or the antenna 2180 in FIG. 21, the network interface 2280 in FIG. 22. FIG. 5 illustrates, in the context of FIGS. 4, 6-9, an example of the SMF 505 providing/transmitting such an NWDAA services indication for an AUE (e.g., the AUE 502).

The mobile network 504 (e.g., 404 in FIG. 4; 604 in FIG. 6; 704 in FIG. 7; 818 in FIG. 8; 918 in FIG. 9) and the SMF 505 (e.g., 832 in FIG. 8; 932 in FIG. 9) may be configured to transmit/provide, and the AUE 502 (e.g., 402 in FIG. 4; 602 in FIG. 6; 702 in FIG. 7; 806, 810 in FIG. 8; 906, 910 in FIG. 9) may be configured to receive, an NWDAA services indication 510. For instance, the mobile network 504 (e.g., 404 in FIG. 4; 604 in FIG. 6; 704 in FIG. 7; 818 in FIG. 8; 918 in FIG. 9) and the SMF 505 (e.g., 832 in FIG. 8; 932 in FIG. 9) may be configured to indicate its LDS (e.g., 705 in FIG. 7; 812, 812′ in FIG. 8; 912, 912′ in FIG. 9) support. In aspects at layer 3, upon the AUE 502 (e.g., 402 in FIG. 4; 602 in FIG. 6; 702 in FIG. 7; 806, 810 in FIG. 8; 906, 910 in FIG. 9) indicating support for the LDS (e.g., 705 in FIG. 7; 812, 812′ in FIG. 8; 912, 912′ in FIG. 9) and/or a UDM subscription indicating that the LDS (e.g., 705 in FIG. 7; 812, 812′ in FIG. 8; 912, 912′ in FIG. 9) service is enabled for the AUE 502 (e.g., 402 in FIG. 4; 602 in FIG. 6; 702 in FIG. 7; 806, 810 in FIG. 8; 906, 910 in FIG. 9), upon registration the CN (e.g., 820 in FIG. 8; 920 in FIG. 9) of the mobile network 504 (e.g., 404 in FIG. 4; 604 in FIG. 6; 704 in FIG. 7; 818 in FIG. 8; 918 in FIG. 9) indicates (e.g., by the SMF 505 (e.g., 832 in FIG. 8; 932 in FIG. 9)) that LDS (e.g., 705 in FIG. 7; 812, 812′ in FIG. 8; 912, 912′ in FIG. 9) service is supported in the AUE 502 (e.g., 402 in FIG. 4; 602 in FIG. 6; 702 in FIG. 7; 806, 810 in FIG. 8; 906, 910 in FIG. 9) registration procedure. In aspects, the CN (e.g., 820 in FIG. 8; 920 in FIG. 9) of the mobile network 504 (e.g., 404 in FIG. 4; 604 in FIG. 6; 704 in FIG. 7; 818 in FIG. 8; 918 in FIG. 9) may indicate via the SMF 505 (e.g., 832 in FIG. 8; 932 in FIG. 9) that LDS (e.g., 705 in FIG. 7; 812, 812′ in FIG. 8; 912, 912′ in FIG. 9) service is supported upon establishment of the PDU session for layer 3 procedures. In aspects, LDS (e.g., 705 in FIG. 7; 812, 812′ in FIG. 8; 912, 912′ in FIG. 9) availability may be indicated per PLMN, per registration area, per tracking area, per cells (e.g., Cell 1, Cell 2, Cell 3 in FIGS. 8, 9), per geographical area, etc. An AMF (e.g., 605 in FIG. 6; 830 in FIG. 8; 930 in FIG. 9) also may generate a registration area(s) so that LDS (e.g., 705 in FIG. 7; 812, 812′ in FIG. 8; 912, 912′ in FIG. 9) service is uniformly available in registration area(s) (e.g., so that the AUE 502 (e.g., 402 in FIG. 4; 602 in FIG. 6; 702 in FIG. 7; 806, 810 in FIG. 8; 906, 910 in FIG. 9) is not in a cell (e.g., Cell 1, Cell 2, Cell 3 in FIGS. 8, 9) of the registration area(s) where there is no LDS (e.g., 705 in FIG. 7; 812, 812′ in FIG. 8; 912, 912′ in FIG. 9) service). In some aspects, the CN (e.g., 820 in FIG. 8; 920 in FIG. 9) of the mobile network 504 (e.g., 404 in FIG. 4; 604 in FIG. 6; 704 in FIG. 7; 818 in FIG. 8; 918 in FIG. 9) may provide a new service restriction area indicative of no LDS (e.g., 705 in FIG. 7; 812, 812′ in FIG. 8; 912, 912′ in FIG. 9) support (e.g., “No LDS support”) and containing the tracking area(s) where LDS (e.g., 705 in FIG. 7; 812, 812′ in FIG. 8; 912, 912′ in FIG. 9) service is not supported. In some aspects, the AUE 502 (e.g., 402 in FIG. 4; 602 in FIG. 6; 702 in FIG. 7; 806, 810 in FIG. 8; 906, 910 in FIG. 9) may perform mobility management in such a way as to avoid entering tracking area(s) where LDS (e.g., 705 in FIG. 7; 812, 812′ in FIG. 8; 912, 912′ in FIG. 9) service is not supported; or the AUE 502 (e.g., 402 in FIG. 4; 602 in FIG. 6; 702 in FIG. 7; 806, 810 in FIG. 8; 906, 910 in FIG. 9) may inform the LDS (e.g., 705 in FIG. 7; 812, 812′ in FIG. 8; 912, 912′ in FIG. 9) service of imminent loss of the LDS (e.g., 705 in FIG. 7; 812, 812′ in FIG. 8; 912, 912′ in FIG. 9) service before entering an area where the LDS (e.g., 705 in FIG. 7; 812, 812′ in FIG. 8; 912, 912′ in FIG. 9) service is not supported; and/or the AUE 502 (e.g., 402 in FIG. 4; 602 in FIG. 6; 702 in FIG. 7; 806, 810 in FIG. 8; 906, 910 in FIG. 9) may take action(s) such as relying wholly, or alternatively at least in part, on alternative DAA solutions.

In the context layer 2 and layer 3 operations associated with the SMF 505 (e.g., 832 in FIG. 8; 932 in FIG. 9), which may be alternative and/or complementary in various aspects, the LDS (e.g., 705 in FIG. 7; 812, 812′ in FIG. 8; 912, 912′ in FIG. 9) service may not be available in all locations, so either a cell (e.g., Cell 1, Cell 2, Cell 3 in FIGS. 8, 9) SIB may have an indication of the LDS (e.g., 705 in FIG. 7; 812, 812′ in FIG. 8; 912, 912′ in FIG. 9) availability (e.g., “LDS available”) when the LDS (e.g., 705 in FIG. 7; 812, 812′ in FIG. 8; 912, 912′ in FIG. 9) service is available, and/or an indication may be sent in RRC establishment signaling and a base station/gNB (e.g., 816, 816′ in FIG. 8; 916, 916′ in FIG. 9) may be configured to know whether the LDS (e.g., 705 in FIG. 7; 812, 812′ in FIG. 8; 912, 912′ in FIG. 9) service is available. Further, the mobile network 504 (e.g., 404 in FIG. 4; 604 in FIG. 6; 704 in FIG. 7; 818 in FIG. 8; 918 in FIG. 9) and the SMF 505 (e.g., 832 in FIG. 8; 932 in FIG. 9) may be configured to transmit/provide, and the AUE 502 (e.g., 402 in FIG. 4; 602 in FIG. 6; 702 in FIG. 7; 806, 810 in FIG. 8; 906, 910 in FIG. 9) may be configured to receive, addressing information associated with the NWDAA services and the LDS (e.g., 705 in FIG. 7; 812, 812′ in FIG. 8; 912, 912′ in FIG. 9) of the mobile network 504 (e.g., 404 in FIG. 4; 604 in FIG. 6; 704 in FIG. 7; 818 in FIG. 8; 918 in FIG. 9). In one example, in a PDU session establishment acceptance (“PDU Session Establishment Accept”) such as by the SMF 505 (e.g., 832 in FIG. 8; 932 in FIG. 9), in an AUE 502 (e.g., 402 in FIG. 4; 602 in FIG. 6; 702 in FIG. 7; 806, 810 in FIG. 8; 906, 910 in FIG. 9) configuration update procedure, and/or the like, the mobile network 504 (e.g., 404 in FIG. 4; 604 in FIG. 6; 704 in FIG. 7; 818 in FIG. 8; 918 in FIG. 9) and the SMF 505 (e.g., 832 in FIG. 8; 932 in FIG. 9) may transmit/provide the addressing information for the AUE 502 (e.g., 402 in FIG. 4; 602 in FIG. 6; 702 in FIG. 7; 806, 810 in FIG. 8; 906, 910 in FIG. 9). The LDS (e.g., 705 in FIG. 7; 812, 812′ in FIG. 8; 912, 912′ in FIG. 9) addressing information may include, but is not limited to, an LDS (e.g., 705 in FIG. 7; 812, 812′ in FIG. 8; 912, 912′ in FIG. 9) address (e.g., actual IP address), a URL (which the AUE 502 (e.g., 402 in FIG. 4; 602 in FIG. 6; 702 in FIG. 7; 806, 810 in FIG. 8; 906, 910 in FIG. 9) may be configure to utilize to discover the LDS (e.g., 705 in FIG. 7; 812, 812′ in FIG. 8; 912, 912′ in FIG. 9), e.g. using DNS), an FQDN, an anycast address of the LDS (e.g., 705 in FIG. 7; 812, 812′ in FIG. 8; 912, 912′ in FIG. 9), and/or the like.

In the mobile network 504 (e.g., 404 in FIG. 4; 604 in FIG. 6; 704 in FIG. 7; 818 in FIG. 8; 918 in FIG. 9), for the CN (e.g., 820 in FIG. 8; 920 in FIG. 9) to RAN (e.g., 404 in FIG. 4; 504 in FIG. 5; 604 in FIG. 6; 704 in FIG. 7; 818 in FIG. 8; 918 in FIG. 9) communications associated with LDS (e.g., 705 in FIG. 7; 812, 812′ in FIG. 8; 912, 912′ in FIG. 9)/NWDAA services support, layer 2 communications may be utilized to activate RAN-LDS (e.g., 705 in FIG. 7; 812, 812′ in FIG. 8; 912, 912′ in FIG. 9) connectivity, and layer 2/layer 3 communications may be utilized to activate the RAN (e.g., 404 in FIG. 4; 504 in FIG. 5; 604 in FIG. 6; 704 in FIG. 7; 818 in FIG. 8; 918 in FIG. 9) to report to the LDS (e.g., 705 in FIG. 7; 812, 812′ in FIG. 8; 912, 912′ in FIG. 9). For instance, in cases for which a UUAA-SM is performed, the SMF 505 (e.g., 832 in FIG. 8; 932 in FIG. 9) may be configured to indicate to the RAN (e.g., 404 in FIG. 4; 504 in FIG. 5; 604 in FIG. 6; 704 in FIG. 7; 818 in FIG. 8; 918 in FIG. 9) by adding a new indication in 5G access network (AN) (e.g., 404 in FIG. 4; 504 in FIG. 5; 604 in FIG. 6; 704 in FIG. 7; 818 in FIG. 8; 918 in FIG. 9) to SMF (e.g., 832 in FIG. 8; 932 in FIG. 9) (N2 SM) messaging whether the LDS (e.g., 705 in FIG. 7; 812, 812′ in FIG. 8; 912, 912′ in FIG. 9) is authorized for the AUE 502 (e.g., 402 in FIG. 4; 602 in FIG. 6; 702 in FIG. 7; 806, 810 in FIG. 8; 906, 910 in FIG. 9) after UUAA-SM completion.

When the LDS (e.g., 705 in FIG. 7; 812, 812′ in FIG. 8; 912, 912′ in FIG. 9) service is activated in the RAN (e.g., 404 in FIG. 4; 504 in FIG. 5; 604 in FIG. 6; 704 in FIG. 7; 818 in FIG. 8; 918 in FIG. 9), the RAN (e.g., 404 in FIG. 4; 504 in FIG. 5; 604 in FIG. 6; 704 in FIG. 7; 818 in FIG. 8; 918 in FIG. 9) may generate information from sensors (e.g., 814 in FIG. 8; 914 in FIG. 9) and provide the information to the LDS (e.g., 705 in FIG. 7; 812, 812′ in FIG. 8; 912, 912′ in FIG. 9) based on an operations administration and maintenance (OAM) configuration. Sensors (e.g., 814 in FIG. 8; 914 in FIG. 9) may be RAN (e.g., 404 in FIG. 4; 504 in FIG. 5; 604 in FIG. 6; 704 in FIG. 7; 818 in FIG. 8; 918 in FIG. 9) sensing capabilities, BRID receivers, ADS-B receivers, DAA broadcast receivers, weather sensors, LIDAR, RADAR, SONAR, NR sensing capabilities, and/or the like. For layer 2 implementations, the RAN (e.g., 404 in FIG. 4; 504 in FIG. 5; 604 in FIG. 6; 704 in FIG. 7; 818 in FIG. 8; 918 in FIG. 9) may be preconfigured with the serving LDS (e.g., 705 in FIG. 7; 812, 812′ in FIG. 8; 912, 912′ in FIG. 9) information and have connectivity with the LDS (e.g., 705 in FIG. 7; 812, 812′ in FIG. 8; 912, 912′ in FIG. 9). In aspects, such a configuration may be performed by the OAM, where the OAM provides to each RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9) the address of the LDS (e.g., 705 in FIG. 7; 812, 812′ in FIG. 8; 912, 912′ in FIG. 9) to be used.

At 1208, the at least one network entity communicates, with the AUE via the mobile network, information associated with the NWDAA services. As an example, the communication may be performed by one or more of the component 199, the transceiver 2146, and/or the antenna 2180 in FIG. 21, the network interface 2280 in FIG. 22. FIG. 5 illustrates, in the context of FIGS. 4, 6-9, an example of such communicating via a mobile network (e.g., the mobile network 504) with an AUE (e.g., the AUE 502).

The mobile network 504 (e.g., 404 in FIG. 4; 604 in FIG. 6; 704 in FIG. 7; 818 in FIG. 8; 918 in FIG. 9) (e.g., by an LDS(s) thereof) and/or the AUE 502 (e.g., 402 in FIG. 4; 602 in FIG. 6; 702 in FIG. 7; 806, 810 in FIG. 8; 906, 910 in FIG. 9) may be configured to communicate communication information 512 associated with the NWDAA services. In aspects, the communication information 512 may be any information associated with the NWDAA services and/or an LDS (e.g., 705 in FIG. 7; 812, 812′ in FIG. 8; 912, 912′ in FIG. 9), as described herein. In aspects for AUE-LDS communications, an LDS (e.g., 705 in FIG. 7; 812, 812′ in FIG. 8; 912, 912′ in FIG. 9) may operate as a passive LDS receiver or as an active LDS receiver.

In aspects for AUE-LDS connectivity, the LDS (e.g., 705 in FIG. 7; 812, 812′ in FIG. 8; 912, 912′ in FIG. 9) connectivity may be layer 3 connectivity at the application layer, e.g., the user plane. For example, the AUE 502 (e.g., 402 in FIG. 4; 602 in FIG. 6; 702 in FIG. 7; 806, 810 in FIG. 8; 906, 910 in FIG. 9) may be configured to establish a session with the LDS (e.g., 705 in FIG. 7; 812, 812′ in FIG. 8; 912, 912′ in FIG. 9) upon (i) discovering the LDS (e.g., 705 in FIG. 7; 812, 812′ in FIG. 8; 912, 912′ in FIG. 9) is supported, and (ii) discovering LDS information, as noted herein. The AUE 502 (e.g., 402 in FIG. 4; 602 in FIG. 6; 702 in FIG. 7; 806, 810 in FIG. 8; 906, 910 in FIG. 9) may be provided, in NAS registration messages, with information regarding the LDS (e.g., 705 in FIG. 7; 812, 812′ in FIG. 8; 912, 912′ in FIG. 9) server discovery (e.g., the server address), or the AUE 502 (e.g., 402 in FIG. 4; 602 in FIG. 6; 702 in FIG. 7; 806, 810 in FIG. 8; 906, 910 in FIG. 9) may be pre-configured with information regarding the LDS(s) (e.g., 705 in FIG. 7; 812, 812′ in FIG. 8; 912, 912′ in FIG. 9) such as, but without limitation, an IP address a URL, a FQDN, or an anycast address of the LDS (e.g., 705 in FIG. 7; 812, 812′ in FIG. 8; 912, 912′ in FIG. 9) (e.g., FQDNs may be used to discover the IP address of the LDS (e.g., 705 in FIG. 7; 812, 812′ in FIG. 8; 912, 912′ in FIG. 9)). In aspects, the LDS (e.g., 705 in FIG. 7; 812, 812′ in FIG. 8; 912, 912′ in FIG. 9) server address may be provided via a PDU session establishment/PDN connection establishment procedure by the SMF 505 (e.g., 832 in FIG. 8; 932 in FIG. 9) upon successful UUAA-SM when LDS (e.g., 705 in FIG. 7; 812, 812′ in FIG. 8; 912, 912′ in FIG. 9) information is in the UDM (e.g., provided by the LDS (e.g., 705 in FIG. 7; 812, 812′ in FIG. 8; 912, 912′ in FIG. 9) provider, whether it is the MNO or a third party, and is configured via an API via the NEF (e.g., 824 in FIG. 8; 924 in FIG. 9)). In aspects, the LDS (e.g., 705 in FIG. 7; 812, 812′ in FIG. 8; 912, 912′ in FIG. 9) server address may be configured by a PCF, and the AUE 502 (e.g., 402 in FIG. 4; 602 in FIG. 6; 702 in FIG. 7; 806, 810 in FIG. 8; 906, 910 in FIG. 9) may be configured with an LDS (e.g., 705 in FIG. 7; 812, 812′ in FIG. 8; 912, 912′ in FIG. 9) anycast address that the AUE 502 (e.g., 402 in FIG. 4; 602 in FIG. 6; 702 in FIG. 7; 806, 810 in FIG. 8; 906, 910 in FIG. 9) may utilize to discover the LDS (e.g., 705 in FIG. 7; 812, 812′ in FIG. 8; 912, 912′ in FIG. 9).

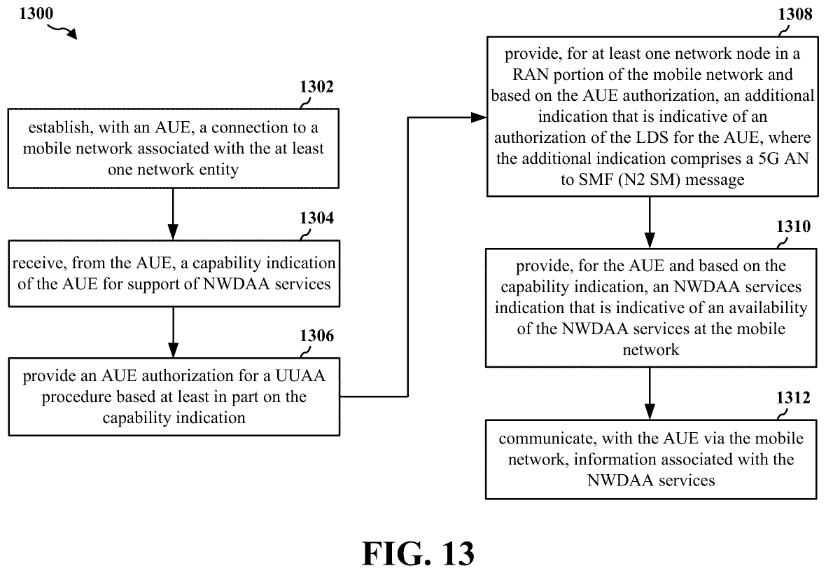

FIG. 13 is a flowchart 1300 of a method of wireless communication. The method may be performed by a network entity(ies)/a network node(s) (e.g., the base station 102, 816, 816′, 916, 916′; network entities of the mobile network 404; the SMF 162, 505, 832, 932; the AMF 161, 605, 830, 930; the LDS 705, 812, 812′, 912, 912′; the network entity 1902, 2060) of a mobile network. In some aspects, the method may include aspects described in connection with the communication flows in FIGS. 4, 5, 6, 7, and/or aspects described in FIGS. 8, 9. The method may be for network-assisted DAA for AUEs. The method may provide for improved DAA by enabling an AUE to report NWDAA capabilities and be authenticated for utilization of a network-based LDS with predictive deconfliction and multi-source information gathering capabilities.

At 1302, the at least one network entity establishes, with an AUE, a connection to a mobile network associated with the at least one network entity. As an example, the establishment may be performed by one or more of the component 199, the transceiver 2146, and/or the antenna 2180 in FIG. 21, the network interface 2280 in FIG. 22. FIG. 5 illustrates, in the context of FIGS. 4, 6-9, an example of the SMF 505 establishing such a connection to a mobile network (e.g., the mobile network 504) with an AUE (e.g., the AUE 502).

The AUE 502 (e.g., 402 in FIG. 4; 602 in FIG. 6; 702 in FIG. 7; 806, 810 in FIG. 8; 906, 910 in FIG. 9) may be configured to establish (at 506) a network connection with the mobile network 504 (e.g., 404 in FIG. 4; 604 in FIG. 6; 704 in FIG. 7; 818 in FIG. 8; 918 in FIG. 9) and the SMF 505 (e.g., 832 in FIG. 8; 932 in FIG. 9). Additionally or conversely, the mobile network 504 (e.g., 404 in FIG. 4; 604 in FIG. 6; 704 in FIG. 7; 818 in FIG. 8; 918 in FIG. 9) and the SMF 505 (e.g., 832 in FIG. 8; 932 in FIG. 9) may be configured to establish (at 506) a network connection with the AUE 502 (e.g., 402 in FIG. 4; 602 in FIG. 6; 702 in FIG. 7; 806, 810 in FIG. 8; 906, 910 in FIG. 9). In aspects, the AUE 502 (e.g., 402 in FIG. 4; 602 in FIG. 6; 702 in FIG. 7; 806, 810 in FIG. 8; 906, 910 in FIG. 9) may be configured to establish (at 506) a network connection with the mobile network 504 (e.g., 404 in FIG. 4; 604 in FIG. 6; 704 in FIG. 7; 818 in FIG. 8; 918 in FIG. 9) via a base station, gNB, etc. (e.g., 816, 816′ in FIG. 8; 916, 916′ in FIG. 9), for the SMF 505 (e.g., 832 in FIG. 8; 932 in FIG. 9) of the mobile network 504 (e.g., 404 in FIG. 4; 604 in FIG. 6; 704 in FIG. 7; 818 in FIG. 8; 918 in FIG. 9), as would be understood by persons of skill in the relevant art(s) having the benefit of this disclosure.

At 1304, the at least one network entity receives, from the AUE, a capability indication of the AUE for support of NWDAA services. As an example, the reception may be performed by one or more of the component 199, the transceiver 1921, and/or the antenna 1921 in FIG. 21, the network interface 2280 in FIG. 22. FIG. 5 illustrates, in the context of FIGS. 4, 6-9, an example of the SMF 505 receiving such a capability indication from an AUE (e.g., the AUE 502).

The AUE 502 (e.g., 402 in FIG. 4; 602 in FIG. 6; 702 in FIG. 7; 806, 810 in FIG. 8; 906, 910 in FIG. 9) may be configured to transmit/provide, and the mobile network 504 (e.g., 404 in FIG. 4; 604 in FIG. 6; 704 in FIG. 7; 818 in FIG. 8; 918 in FIG. 9) and the SMF 505 (e.g., 832 in FIG. 8; 932 in FIG. 9) may be configured to receive, a capability indication 508 (e.g., 408 in FIG. 4; 608 in FIG. 6). In aspects, the capability indication 508 (e.g., 408 in FIG. 4; 608 in FIG. 6) of the AUE 502 (e.g., 402 in FIG. 4; 602 in FIG. 6; 702 in FIG. 7; 806, 810 in FIG. 8; 906, 910 in FIG. 9) for support of NWDAA services. In aspects, an LDS (e.g., 705 in FIG. 7; 812, 812′ in FIG. 8; 912, 912′ in FIG. 9) herein may comprise the NWDAA services, or vice versa, the LDS (e.g., 705 in FIG. 7; 812, 812′ in FIG. 8; 912, 912′ in FIG. 9) may be configured to provide at least a portion of the NWDAA services, and/or the like. The transmission/provision of the capability indication 508 (e.g., 408 in FIG. 4; 608 in FIG. 6) may be a portion of a discover of support for an LDS (e.g., 705 in FIG. 7; 812, 812′ in FIG. 8; 912, 912′ in FIG. 9)/NWDAA services. In aspects, when the AUE 502 (e.g., 402 in FIG. 4; 602 in FIG. 6; 702 in FIG. 7; 806, 810 in FIG. 8; 906, 910 in FIG. 9) is capable of utilizing an LDS (e.g., 705 in FIG. 7; 812, 812′ in FIG. 8; 912, 912′ in FIG. 9), the AUE 502 (e.g., 402 in FIG. 4; 602 in FIG. 6; 702 in FIG. 7; 806, 810 in FIG. 8; 906, 910 in FIG. 9) indicates its support for the LDS (e.g., 705 in FIG. 7; 812, 812′ in FIG. 8; 912, 912′ in FIG. 9) (or network-assisted DAA, generally). In some aspects, the transmission/provision of the capability indication 508 (e.g., 408 in FIG. 4; 608 in FIG. 6) may be via NAS signaling. As one example, the transmission/provision of the capability indication 508 (e.g., 408 in FIG. 4; 608 in FIG. 6) may be for the SMF 505 (e.g., 832 in FIG. 8; 932 in FIG. 9) using session management (SM) signaling, such as a PDU session request for establishment of a PDU session for layer 3 implementations, in 5GSM capabilities, or an express/explicit indication.

At 1306, the at least one network entity provides an AUE authorization for a UUAA procedure based at least in part on the capability indication. As an example, the provision may be performed by one or more of the component 199, the transceiver 2146, and/or the antenna 2180 in FIG. 21, the network interface 2280 in FIG. 22. FIG. 5 illustrates, in the context of FIGS. 4, 6-9, an example of the SMF 505 providing such an AUE authorization (e.g., for a UAS NF in a CN of the mobile network 504).

In aspects, the SMF 505 (e.g., 832 in FIG. 8; 932 in FIG. 9) may be configured to provide, e.g., for a UAS NF (e.g., 822 in FIG. 8; 922 in FIG. 9), an AUE authorization for a UUAA procedure based at least in part on the capability indication. For a UUAA-MM performed by an AMF (e.g., 605 in FIG. 6; 830 in FIG. 8; 930 in FIG. 9), the AMF (e.g., 605 in FIG. 6; 830 in FIG. 8; 930 in FIG. 9) may be configured to provide information associated with the LDS (e.g., 705 in FIG. 7; 812, 812′ in FIG. 8; 912, 912′ in FIG. 9), as the serving LDS (e.g., 705 in FIG. 7; 812, 812′ in FIG. 8; 912, 912′ in FIG. 9), directly to the UAS NF (e.g., 822 in FIG. 8; 922 in FIG. 9). For a UUAA-SM, if the AMF selects the serving LDS (e.g., 705 in FIG. 7; 812, 812′ in FIG. 8; 912, 912′ in FIG. 9), the AMF (e.g., 605 in FIG. 6; 830 in FIG. 8; 930 in FIG. 9) may provide such information to the SMF 505 (e.g., 832 in FIG. 8; 932 in FIG. 9), and the SMF 505 (e.g., 832 in FIG. 8; 932 in FIG. 9) may provide or relay the information in the UUAA-SM signaling to the UAS NF (e.g., 822 in FIG. 8; 922 in FIG. 9). In the mobile network 504 (e.g., 404 in FIG. 4; 604 in FIG. 6; 704 in FIG. 7; 818 in FIG. 8; 918 in FIG. 9), for the CN (e.g., 820 in FIG. 8; 920 in FIG. 9) to RAN (e.g., 404 in FIG. 4; 504 in FIG. 5; 604 in FIG. 6; 704 in FIG. 7; 818 in FIG. 8; 918 in FIG. 9) communications associated with LDS (e.g., 705 in FIG. 7; 812, 812′ in FIG. 8; 912, 912′ in FIG. 9)/NWDAA services support, layer 2 communications may be utilized to activate RAN-LDS (e.g., 705 in FIG. 7; 812, 812′ in FIG. 8; 912, 912′ in FIG. 9) connectivity, and layer 2/layer 3 communications may be utilized to activate the RAN (e.g., 404 in FIG. 4; 504 in FIG. 5; 604 in FIG. 6; 704 in FIG. 7; 818 in FIG. 8; 918 in FIG. 9) to report to the LDS (e.g., 705 in FIG. 7; 812, 812′ in FIG. 8; 912, 912′ in FIG. 9). For instance, in cases for which a UUAA-SM is performed, the SMF 505 (e.g., 832 in FIG. 8; 932 in FIG. 9) may be configured to indicate to the RAN (e.g., 404 in FIG. 4; 504 in FIG. 5; 604 in FIG. 6; 704 in FIG. 7; 818 in FIG. 8; 918 in FIG. 9) by adding a new indication in 5G access network (AN) (e.g., 404 in FIG. 4; 504 in FIG. 5; 604 in FIG. 6; 704 in FIG. 7; 818 in FIG. 8; 918 in FIG. 9) to SMF (e.g., 505 in FIG. 5; 832 in FIG. 8; 932 in FIG. 9) (N2 SM) messaging whether the LDS (e.g., 705 in FIG. 7; 812, 812′ in FIG. 8; 912, 912′ in FIG. 9) is authorized for the AUE 502 (e.g., 402 in FIG. 4; 602 in FIG. 6; 702 in FIG. 7; 806, 810 in FIG. 8; 906, 910 in FIG. 9) after UUAA-SM completion. Referring also to FIG. 7, for a UUAA-MM performed by an AMF (e.g., 605 in FIG. 6; 830 in FIG. 8; 930 in FIG. 9), the AMF (e.g., 605 in FIG. 6; 830 in FIG. 8; 930 in FIG. 9) may be configured to provide information associated with the LDS (e.g., 705 in FIG. 7; 812, 812′ in FIG. 8; 912, 912′ in FIG. 9), as the serving LDS (e.g., 705 in FIG. 7; 812, 812′ in FIG. 8; 912, 912′ in FIG. 9), directly to the UAS NF (e.g., 822 in FIG. 8; 922 in FIG. 9). For a UUAA-SM, if the AMF (e.g., 605 in FIG. 6; 830 in FIG. 8; 930 in FIG. 9) selects the serving LDS (e.g., 705 in FIG. 7; 812, 812′ in FIG. 8; 912, 912′ in FIG. 9) the AMF (e.g., 605 in FIG. 6; 830 in FIG. 8; 930 in FIG. 9) may provide such information to the SMF (e.g., 505 in FIG. 5; 832 in FIG. 8; 932 in FIG. 9), and the SMF (e.g., 505 in FIG. 5; 832 in FIG. 8; 932 in FIG. 9) may provide or relay the information in the UUAA-SM signaling to the UAS NF (e.g., 822 in FIG. 8; 922 in FIG. 9).

At 1308, the at least one network entity provides, for at least one network node in a RAN portion of the mobile network and based on the AUE authorization, an additional indication that is indicative of an authorization of the LDS for the AUE, where the additional indication comprises a 5G AN to SMF (N2 SM) message. As an example, the provision may be performed by one or more of the component 199, the transceiver 2146, and/or the antenna 2180 in FIG. 21, the network interface 2280 in FIG. 22. FIG. 5 illustrates, in the context of FIGS. 4, 6-9, an example of the SMF 505 providing such an indication for a RAN/network node (e.g., of the mobile network 504).

In the mobile network 504 (e.g., 404 in FIG. 4; 604 in FIG. 6; 704 in FIG. 7; 818 in FIG. 8; 918 in FIG. 9), for the CN (e.g., 820 in FIG. 8; 920 in FIG. 9) to RAN (e.g., 404 in FIG. 4; 504 in FIG. 5; 604 in FIG. 6; 704 in FIG. 7; 818 in FIG. 8; 918 in FIG. 9) communications associated with LDS (e.g., 705 in FIG. 7; 812, 812′ in FIG. 8; 912, 912′ in FIG. 9)/NWDAA services support, layer 2 communications may be utilized to activate RAN-LDS (e.g., 705 in FIG. 7; 812, 812′ in FIG. 8; 912, 912′ in FIG. 9) connectivity, and layer 2/layer 3 communications may be utilized to activate the RAN (e.g., 404 in FIG. 4; 504 in FIG. 5; 604 in FIG. 6; 704 in FIG. 7; 818 in FIG. 8; 918 in FIG. 9) to report to the LDS (e.g., 705 in FIG. 7; 812, 812′ in FIG. 8; 912, 912′ in FIG. 9). For instance, in cases for which a UUAA-SM is performed, the SMF 505 (e.g., 832 in FIG. 8; 932 in FIG. 9) may be configured to indicate to the RAN (e.g., 404 in FIG. 4; 504 in FIG. 5; 604 in FIG. 6; 704 in FIG. 7; 818 in FIG. 8; 918 in FIG. 9) by adding a new indication in 5G access network (AN) (e.g., 404 in FIG. 4; 504 in FIG. 5; 604 in FIG. 6; 704 in FIG. 7; 818 in FIG. 8; 918 in FIG. 9) to SMF (e.g., 832 in FIG. 8; 932 in FIG. 9) (N2 SM) messaging whether the LDS (e.g., 705 in FIG. 7; 812, 812′ in FIG. 8; 912, 912′ in FIG. 9) is authorized for the AUE 502 (e.g., 402 in FIG. 4; 602 in FIG. 6; 702 in FIG. 7; 806, 810 in FIG. 8; 906, 910 in FIG. 9) after UUAA-SM completion.

At 1310, the at least one network entity provides, for the AUE and based on the capability indication, an NWDAA services indication that is indicative of an availability of the NWDAA services at the mobile network. As an example, the provision may be performed by one or more of the component 199, the transceiver 2146, and/or the antenna 2180 in FIG. 21, the network interface 2280 in FIG. 22. FIG. 5 illustrates, in the context of FIGS. 4, 6-9, an example of the SMF 505 providing/transmitting such an NWDAA services indication for an AUE (e.g., the AUE 502).

The mobile network 504 (e.g., 404 in FIG. 4; 604 in FIG. 6; 704 in FIG. 7; 818 in FIG. 8; 918 in FIG. 9) and the SMF 505 (e.g., 832 in FIG. 8; 932 in FIG. 9) may be configured to transmit/provide, and the AUE 502 (e.g., 402 in FIG. 4; 602 in FIG. 6; 702 in FIG. 7; 806, 810 in FIG. 8; 906, 910 in FIG. 9) may be configured to receive, an NWDAA services indication 510. For instance, the mobile network 504 (e.g., 404 in FIG. 4; 604 in FIG. 6; 704 in FIG. 7; 818 in FIG. 8; 918 in FIG. 9) and the SMF 505 (e.g., 832 in FIG. 8; 932 in FIG. 9) may be configured to indicate its LDS (e.g., 705 in FIG. 7; 812, 812′ in FIG. 8; 912, 912′ in FIG. 9) support. In aspects at layer 3, upon the AUE 502 (e.g., 402 in FIG. 4; 602 in FIG. 6; 702 in FIG. 7; 806, 810 in FIG. 8; 906, 910 in FIG. 9) indicating support for the LDS (e.g., 705 in FIG. 7; 812, 812′ in FIG. 8; 912, 912′ in FIG. 9) and/or a UDM subscription indicating that the LDS (e.g., 705 in FIG. 7; 812, 812′ in FIG. 8; 912, 912′ in FIG. 9) service is enabled for the AUE 502 (e.g., 402 in FIG. 4; 602 in FIG. 6; 702 in FIG. 7; 806, 810 in FIG. 8; 906, 910 in FIG. 9), upon registration the CN (e.g., 820 in FIG. 8; 920 in FIG. 9) of the mobile network 504 (e.g., 404 in FIG. 4; 604 in FIG. 6; 704 in FIG. 7; 818 in FIG. 8; 918 in FIG. 9) indicates (e.g., by the SMF 505 (e.g., 832 in FIG. 8; 932 in FIG. 9)) that LDS (e.g., 705 in FIG. 7; 812, 812′ in FIG. 8; 912, 912′ in FIG. 9) service is supported in the AUE 502 (e.g., 402 in FIG. 4; 602 in FIG. 6; 702 in FIG. 7; 806, 810 in FIG. 8; 906, 910 in FIG. 9) registration procedure. In aspects, the CN (e.g., 820 in FIG. 8; 920 in FIG. 9) of the mobile network 504 (e.g., 404 in FIG. 4; 604 in FIG. 6; 704 in FIG. 7; 818 in FIG. 8; 918 in FIG. 9) may indicate via the SMF 505 (e.g., 832 in FIG. 8; 932 in FIG. 9) that LDS (e.g., 705 in FIG. 7; 812, 812′ in FIG. 8; 912, 912′ in FIG. 9) service is supported upon establishment of the PDU session for layer 3 procedures. In aspects, LDS (e.g., 705 in FIG. 7; 812, 812′ in FIG. 8; 912, 912′ in FIG. 9) availability may be indicated per PLMN, per registration area, per tracking area, per cells (e.g., Cell 1, Cell 2, Cell 3 in FIGS. 8, 9), per geographical area, etc. An AMF (e.g., 605 in FIG. 6; 830 in FIG. 8; 930 in FIG. 9) also may generate a registration area(s) so that LDS (e.g., 705 in FIG. 7; 812, 812′ in FIG. 8; 912, 912′ in FIG. 9) service is uniformly available in registration area(s) (e.g., so that the AUE 502 (e.g., 402 in FIG. 4; 602 in FIG. 6; 702 in FIG. 7; 806, 810 in FIG. 8; 906, 910 in FIG. 9) is not in a cell (e.g., Cell 1, Cell 2, Cell 3 in FIGS. 8, 9) of the registration area(s) where there is no LDS (e.g., 705 in FIG. 7; 812, 812′ in FIG. 8; 912, 912′ in FIG. 9) service). In some aspects, the CN (e.g., 820 in FIG. 8; 920 in FIG. 9) of the mobile network 504 (e.g., 404 in FIG. 4; 604 in FIG. 6; 704 in FIG. 7; 818 in FIG. 8; 918 in FIG. 9) may provide a new service restriction area indicative of no LDS (e.g., 705 in FIG. 7; 812, 812′ in FIG. 8; 912, 912′ in FIG. 9) support (e.g., “No LDS support”) and containing the tracking area(s) where LDS (e.g., 705 in FIG. 7; 812, 812′ in FIG. 8; 912, 912′ in FIG. 9) service is not supported. In some aspects, the AUE 502 (e.g., 402 in FIG. 4; 602 in FIG. 6; 702 in FIG. 7; 806, 810 in FIG. 8; 906, 910 in FIG. 9) may perform mobility management in such a way as to avoid entering tracking area(s) where LDS (e.g., 705 in FIG. 7; 812, 812′ in FIG. 8; 912, 912′ in FIG. 9) service is not supported; or the AUE 502 (e.g., 402 in FIG. 4; 602 in FIG. 6; 702 in FIG. 7; 806, 810 in FIG. 8; 906, 910 in FIG. 9) may inform the LDS (e.g., 705 in FIG. 7; 812, 812′ in FIG. 8; 912, 912′ in FIG. 9) service of imminent loss of the LDS (e.g., 705 in FIG. 7; 812, 812′ in FIG. 8; 912, 912′ in FIG. 9) service before entering an area where the LDS (e.g., 705 in FIG. 7; 812, 812′ in FIG. 8; 912, 912′ in FIG. 9) service is not supported; and/or the AUE 502 (e.g., 402 in FIG. 4; 602 in FIG. 6; 702 in FIG. 7; 806, 810 in FIG. 8; 906, 910 in FIG. 9) may take action(s) such as relying wholly, or alternatively at least in part, on alternative DAA solutions.

In the context of layer 2 and layer 3 operations associated with the SMF 505 (e.g., 832 in FIG. 8; 932 in FIG. 9), which may be alternative and/or complementary in various aspects, the LDS (e.g., 705 in FIG. 7; 812, 812′ in FIG. 8; 912, 912′ in FIG. 9) service may not be available in all locations, so either a cell (e.g., Cell 1, Cell 2, Cell 3 in FIGS. 8, 9) SIB may have an indication of the LDS (e.g., 705 in FIG. 7; 812, 812′ in FIG. 8; 912, 912′ in FIG. 9) availability (e.g., “LDS available”) when the LDS (e.g., 705 in FIG. 7; 812, 812′ in FIG. 8; 912, 912′ in FIG. 9) service is available, and/or an indication may be sent in RRC establishment signaling and a base station/gNB (e.g., 816, 816′ in FIG. 8; 916, 916′ in FIG. 9) may be configured to know whether the LDS (e.g., 705 in FIG. 7; 812, 812′ in FIG. 8; 912, 912′ in FIG. 9) service is available.

Further, the mobile network 504 (e.g., 404 in FIG. 4; 604 in FIG. 6; 704 in FIG. 7; 818 in FIG. 8; 918 in FIG. 9) and the SMF 505 (e.g., 832 in FIG. 8; 932 in FIG. 9) may be configured to transmit/provide, and the AUE 502 (e.g., 402 in FIG. 4; 602 in FIG. 6; 702 in FIG. 7; 806, 810 in FIG. 8; 906, 910 in FIG. 9) may be configured to receive, addressing information associated with the NWDAA services and the LDS (e.g., 705 in FIG. 7; 812, 812′ in FIG. 8; 912, 912′ in FIG. 9) of the mobile network 504 (e.g., 404 in FIG. 4; 604 in FIG. 6; 704 in FIG. 7; 818 in FIG. 8; 918 in FIG. 9). In one example, in a PDU session establishment acceptance (“PDU Session Establishment Accept”) such as by the SMF 505 (e.g., 832 in FIG. 8; 932 in FIG. 9), in an AUE 502 (e.g., 402 in FIG. 4; 602 in FIG. 6; 702 in FIG. 7; 806, 810 in FIG. 8; 906, 910 in FIG. 9) configuration update procedure, and/or the like, the mobile network 504 (e.g., 404 in FIG. 4; 604 in FIG. 6; 704 in FIG. 7; 818 in FIG. 8; 918 in FIG. 9) and the SMF 505 (e.g., 832 in FIG. 8; 932 in FIG. 9) may transmit/provide the addressing information for the AUE 502 (e.g., 402 in FIG. 4; 602 in FIG. 6; 702 in FIG. 7; 806, 810 in FIG. 8; 906, 910 in FIG. 9). The LDS (e.g., 705 in FIG. 7; 812, 812′ in FIG. 8; 912, 912′ in FIG. 9) addressing information may include, but is not limited to, an LDS (e.g., 705 in FIG. 7; 812, 812′ in FIG. 8; 912, 912′ in FIG. 9) address (e.g., actual IP address), a URL (which the AUE 502 (e.g., 402 in FIG. 4; 602 in FIG. 6; 702 in FIG. 7; 806, 810 in FIG. 8; 906, 910 in FIG. 9) may be configure to utilize to discover the LDS (e.g., 705 in FIG. 7; 812, 812′ in FIG. 8; 912, 912′ in FIG. 9), e.g. using DNS), an FQDN, an anycast address of the LDS (e.g., 705 in FIG. 7; 812, 812′ in FIG. 8; 912, 912′ in FIG. 9), and/or the like.

When the LDS (e.g., 705 in FIG. 7; 812, 812′ in FIG. 8; 912, 912′ in FIG. 9) service is activated in the RAN (e.g., 404 in FIG. 4; 504 in FIG. 5; 604 in FIG. 6; 704 in FIG. 7; 818 in FIG. 8; 918 in FIG. 9), the RAN (e.g., 404 in FIG. 4; 504 in FIG. 5; 604 in FIG. 6; 704 in FIG. 7; 818 in FIG. 8; 918 in FIG. 9) may generate information from sensors (e.g., 814 in FIG. 8; 914 in FIG. 9) and provide the information to the LDS (e.g., 705 in FIG. 7; 812, 812′ in FIG. 8; 912, 912′ in FIG. 9) based on an operations administration and maintenance (OAM) configuration. Sensors (e.g., 814 in FIG. 8; 914 in FIG. 9) may be RAN (e.g., 404 in FIG. 4; 504 in FIG. 5; 604 in FIG. 6; 704 in FIG. 7; 818 in FIG. 8; 918 in FIG. 9) sensing capabilities, BRID receivers, ADS-B receivers, DAA broadcast receivers, weather sensors, LIDAR, RADAR, SONAR, NR sensing capabilities, and/or the like. For layer 2 implementations, the RAN (e.g., 404 in FIG. 4; 504 in FIG. 5; 604 in FIG. 6; 704 in FIG. 7; 818 in FIG. 8; 918 in FIG. 9) may be preconfigured with the serving LDS (e.g., 705 in FIG. 7; 812, 812′ in FIG. 8; 912, 912′ in FIG. 9) information and have connectivity with the LDS (e.g., 705 in FIG. 7; 812, 812′ in FIG. 8; 912, 912′ in FIG. 9). In aspects, such a configuration may be performed by the OAM, where the OAM provides to each RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9) the address of the LDS (e.g., 705 in FIG. 7; 812, 812′ in FIG. 8; 912, 912′ in FIG. 9) to be used.

At 1312, the at least one network entity communicates, with the AUE via the mobile network, information associated with the NWDAA services. As an example, the communication may be performed by one or more of the component 199, the transceiver 2146, and/or the antenna 2180 in FIG. 21, the network interface 2280 in FIG. 22. FIG. 5 illustrates, in the context of FIGS. 4, 6-9, an example of such communicating via a mobile network (e.g., the mobile network 504) with an AUE (e.g., the AUE 502).

The mobile network 504 (e.g., 404 in FIG. 4; 604 in FIG. 6; 704 in FIG. 7; 818 in FIG. 8; 918 in FIG. 9) (e.g., by an LDS(s) thereof) and/or the AUE 502 (e.g., 402 in FIG. 4; 602 in FIG. 6; 702 in FIG. 7; 806, 810 in FIG. 8; 906, 910 in FIG. 9) may be configured to communicate communication information 512 associated with the NWDAA services. In aspects, the communication information 512 may be any information associated with the NWDAA services and/or an LDS (e.g., 705 in FIG. 7; 812, 812′ in FIG. 8; 912, 912′ in FIG. 9), as described herein. In aspects for AUE-LDS communications, an LDS (e.g., 705 in FIG. 7; 812, 812′ in FIG. 8; 912, 912′ in FIG. 9) may operate as a passive LDS receiver or as an active LDS receiver.

In aspects for AUE-LDS connectivity, the LDS (e.g., 705 in FIG. 7; 812, 812′ in FIG. 8; 912, 912′ in FIG. 9) connectivity may be layer 3 connectivity at the application layer, e.g., the user plane. For example, the AUE 502 (e.g., 402 in FIG. 4; 602 in FIG. 6; 702 in FIG. 7; 806, 810 in FIG. 8; 906, 910 in FIG. 9) may be configured to establish a session with the LDS (e.g., 705 in FIG. 7; 812, 812′ in FIG. 8; 912, 912′ in FIG. 9) upon (i) discovering the LDS (e.g., 705 in FIG. 7; 812, 812′ in FIG. 8; 912, 912′ in FIG. 9) is supported, and (ii) discovering LDS information, as noted herein. The AUE 502 (e.g., 402 in FIG. 4; 602 in FIG. 6; 702 in FIG. 7; 806, 810 in FIG. 8; 906, 910 in FIG. 9) may be provided, in NAS registration messages, with information regarding the LDS (e.g., 705 in FIG. 7; 812, 812′ in FIG. 8; 912, 912′ in FIG. 9) server discovery (e.g., the server address), or the AUE 502 (e.g., 402 in FIG. 4; 602 in FIG. 6; 702 in FIG. 7; 806, 810 in FIG. 8; 906, 910 in FIG. 9) may be pre-configured with information regarding the LDS(s) (e.g., 705 in FIG. 7; 812, 812′ in FIG. 8; 912, 912′ in FIG. 9) such as, but without limitation, an IP address a URL, a FQDN, or an anycast address of the LDS (e.g., 705 in FIG. 7; 812, 812′ in FIG. 8; 912, 912′ in FIG. 9) (e.g., FQDNs may be used to discover the IP address of the LDS (e.g., 705 in FIG. 7; 812, 812′ in FIG. 8; 912, 912′ in FIG. 9)). In aspects, the LDS (e.g., 705 in FIG. 7; 812, 812′ in FIG. 8; 912, 912′ in FIG. 9) server address may be provided via a PDU session establishment/PDN connection establishment procedure by the SMF 505 (e.g., 832 in FIG. 8; 932 in FIG. 9) upon successful UUAA-SM when LDS (e.g., 705 in FIG. 7; 812, 812′ in FIG. 8; 912, 912′ in FIG. 9) information is in the UDM (e.g., provided by the LDS (e.g., 705 in FIG. 7; 812, 812′ in FIG. 8; 912, 912′ in FIG. 9) provider, whether it is the MNO or a third party, and is configured via an API via the NEF (e.g., 824 in FIG. 8; 924 in FIG. 9)). In aspects, the LDS (e.g., 705 in FIG. 7; 812, 812′ in FIG. 8; 912, 912′ in FIG. 9) server address may be configured by a PCF, and the AUE 502 (e.g., 402 in FIG. 4; 602 in FIG. 6; 702 in FIG. 7; 806, 810 in FIG. 8; 906, 910 in FIG. 9) may be configured with an LDS (e.g., 705 in FIG. 7; 812, 812′ in FIG. 8; 912, 912′ in FIG. 9) anycast address that the AUE 502 (e.g., 402 in FIG. 4; 602 in FIG. 6; 702 in FIG. 7; 806, 810 in FIG. 8; 906, 910 in FIG. 9) may utilize to discover the LDS (e.g., 705 in FIG. 7; 812, 812′ in FIG. 8; 912, 912′ in FIG. 9).

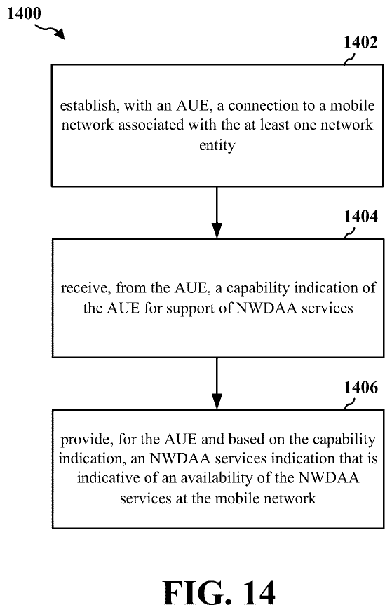

FIG. 14 is a flowchart 1400 of a method of wireless communication. The method may be performed by a network entity(ies)/a network node(s) (e.g., the base station 102, 816, 816′, 916, 916′; network entities of the mobile network 404; the SMF 162, 505, 832, 932; the AMF 161, 605, 830, 930; the LDS 705, 812, 812′, 912, 912′; the network entity 1902, 2060) of a mobile network. In some aspects, the method may include aspects described in connection with the communication flows in FIGS. 4, 5, 6, 7, and/or aspects described in FIGS. 8, 9. The method may be for network-assisted DAA for AUEs. The method may provide for improved DAA by enabling an AUE to report NWDAA capabilities and be authenticated for utilization of a network-based LDS with predictive deconfliction and multi-source information gathering capabilities.

At 1402, the at least one network entity establishes, with an AUE, a connection to a mobile network associated with the at least one network entity. As an example, the establishment may be performed by one or more of the component 199, the transceiver 2146, and/or the antenna 2180 in FIG. 21, the network interface 2280 in FIG. 22. FIG. 6 illustrates, in the context of FIGS. 4, 5, 7-9, an example of the AMF 605 (e.g., 830 in FIG. 8; 930 in FIG. 9) establishing such a connection to a mobile network (e.g., the mobile network 604) with an AUE (e.g., the AUE 602).

The AUE 602 (e.g., 402 in FIG. 4; 502 in FIG. 5; 702 in FIG. 7; 806, 810 in FIG. 8; 906, 910 in FIG. 9) may be configured to establish (at 606) a network connection with the mobile network 604 (e.g., 404 in FIG. 4; 504 in FIG. 5; 704 in FIG. 7; 818 in FIG. 8; 918 in FIG. 9) and the AMF 605 (e.g., 830 in FIG. 8; 930 in FIG. 9). Additionally or conversely, the mobile network 604 (e.g., 404 in FIG. 4; 504 in FIG. 5; 704 in FIG. 7; 818 in FIG. 8; 918 in FIG. 9) and the AMF 605 (e.g., 830 in FIG. 8; 930 in FIG. 9) may be configured to establish (at 606) a network connection with the AUE 602 (e.g., 402 in FIG. 4; 502 in FIG. 5; 702 in FIG. 7; 806, 810 in FIG. 8; 906, 910 in FIG. 9). In aspects, the AUE 602 (e.g., 402 in FIG. 4; 502 in FIG. 5; 702 in FIG. 7; 806, 810 in FIG. 8; 906, 910 in FIG. 9) may be configured to establish (at 606) a network connection with the mobile network 604 (e.g., 404 in FIG. 4; 504 in FIG. 5; 704 in FIG. 7; 818 in FIG. 8; 918 in FIG. 9) via a base station, gNB, etc. (e.g., 816, 816′ in FIG. 8; 916, 916′ in FIG. 9), for the AMF 605 (e.g., 830 in FIG. 8; 930 in FIG. 9) of the mobile network 604 (e.g., 404 in FIG. 4; 504 in FIG. 5; 704 in FIG. 7; 818 in FIG. 8; 918 in FIG. 9), as would be understood by persons of skill in the relevant art(s) having the benefit of this disclosure. In aspects, establishment of the connection to the mobile network (e.g., 404 in FIG. 4; 504 in FIG. 5; 604 in FIG. 6; 704 in FIG. 7; 818 in FIG. 8; 918 in FIG. 9) at 1402 may include performance of the provision of the capability indication (e.g., 408 in FIG. 4; 508 in FIG. 5; 608 in FIG. 6) at 1404, e.g., as part of the MM signaling for the AMF 605 (e.g., 830 in FIG. 8; 930 in FIG. 9), such as the registration request (as illustrated in connection with the examples in FIGS. 4, 6).

At 1404, the at least one network entity receives, from the AUE, a capability indication of the AUE for support of NWDAA services. As an example, the reception may be performed by one or more of the component 199, the transceiver 2146, and/or the antenna 2180 in FIG. 21, the network interface 2280 in FIG. 22. FIG. 6 illustrates, in the context of FIGS. 4, 5, 7-9, an example of the AMF 605 receiving such a capability indication from an AUE (e.g., the AUE 602).

The AUE 602 (e.g., 402 in FIG. 4; 502 in FIG. 5; 702 in FIG. 7; 806, 810 in FIG. 8; 906, 910 in FIG. 9) may be configured to transmit/provide, and the mobile network 604 (e.g., 404 in FIG. 4; 504 in FIG. 5; 704 in FIG. 7; 818 in FIG. 8; 918 in FIG. 9) and the AMF 605 (e.g., 830 in FIG. 8; 930 in FIG. 9) may be configured to receive, a capability indication 608 (e.g., 408 in FIG. 4; 508 in FIG. 5). In aspects, the capability indication 608 (e.g., 408 in FIG. 4; 508 in FIG. 5) of the AUE 602 (e.g., 402 in FIG. 4; 502 in FIG. 5; 702 in FIG. 7; 806, 810 in FIG. 8; 906, 910 in FIG. 9) for support of NWDAA services. In aspects, an LDS (e.g., 705 in FIG. 7; 812, 812′ in FIG. 8; 912, 912′ in FIG. 9) herein may comprise the NWDAA services, or vice versa, the LDS (e.g., 705 in FIG. 7; 812, 812′ in FIG. 8; 912, 912′ in FIG. 9) may be configured to provide at least a portion of the NWDAA services, and/or the like. The transmission/provision of the capability indication 608 (e.g., 408 in FIG. 4; 508 in FIG. 5) may be a portion of a discover of support for an LDS (e.g., 705 in FIG. 7; 812, 812′ in FIG. 8; 912, 912′ in FIG. 9)/NWDAA services. In aspects, when the AUE 602 (e.g., 402 in FIG. 4; 502 in FIG. 5; 702 in FIG. 7; 806, 810 in FIG. 8; 906, 910 in FIG. 9) is capable of utilizing an LDS (e.g., 705 in FIG. 7; 812, 812′ in FIG. 8; 912, 912′ in FIG. 9), the AUE 602 (e.g., 402 in FIG. 4; 502 in FIG. 5; 702 in FIG. 7; 806, 810 in FIG. 8; 906, 910 in FIG. 9) indicates its support for the LDS (e.g., 705 in FIG. 7; 812, 812′ in FIG. 8; 912, 912′ in FIG. 9) (or network-assisted DAA, generally). In some aspects, the transmission/provision of the capability indication 608 (e.g., 408 in FIG. 4; 508 in FIG. 5) may be via NAS signaling. As one example, the transmission/provision of the capability indication 608 (e.g., 408 in FIG. 4; 508 in FIG. 5) may be for the AMF 605 (e.g., 830 in FIG. 8; 930 in FIG. 9) using MM signaling, such as a registration request in 5GMM capabilities. In such aspects, establishment of the connection to the mobile network (e.g., 404 in FIG. 4; 504 in FIG. 5; 604 in FIG. 6; 704 in FIG. 7; 818 in FIG. 8; 918 in FIG. 9) at 1402 may include performance of the provision of the capability indication (e.g., 408 in FIG. 4; 508 in FIG. 5; 608 in FIG. 6) at 1404, e.g., as part of the MM signaling for the AMF 605 (e.g., 830 in FIG. 8; 930 in FIG. 9), such as the registration request (as illustrated in connection with the examples in FIGS. 4, 6).

At 1406, the at least one network entity provides, for the AUE and based on the capability indication, an NWDAA services indication that is indicative of an availability of the NWDAA services at the mobile network. As an example, the provision may be performed by one or more of the component 199, the transceiver 2146, and/or the antenna 2180 in FIG. 21, the network interface 2280 in FIG. 22. FIG. 6 illustrates, in the context of FIGS. 4, 5, 7-9, an example of the AMF 605 (e.g., 830 in FIG. 8; 930 in FIG. 9) providing/transmitting such an NWDAA services indication for an AUE (e.g., the AUE 602).

The mobile network 604 (e.g., 404 in FIG. 4; 504 in FIG. 5; 704 in FIG. 7; 818 in FIG. 8; 918 in FIG. 9) and the AMF 605 (e.g., 830 in FIG. 8; 930 in FIG. 9) may be configured to transmit/provide, and the AUE 602 (e.g., 402 in FIG. 4; 502 in FIG. 5; 702 in FIG. 7; 806, 810 in FIG. 8; 906, 910 in FIG. 9) may be configured to receive, an NWDAA services indication 610. For instance, the mobile network 604 (e.g., 404 in FIG. 4; 504 in FIG. 5; 704 in FIG. 7; 818 in FIG. 8; 918 in FIG. 9) and the AMF 605 (e.g., 830 in FIG. 8; 930 in FIG. 9) may be configured to indicate its LDS (e.g., 705 in FIG. 7; 812, 812′ in FIG. 8; 912, 912′ in FIG. 9) support. In aspects, LDS (e.g., 705 in FIG. 7; 812, 812′ in FIG. 8; 912, 912′ in FIG. 9) availability may be indicated per PLMN, per registration area, per tracking area, per cells (e.g., Cell 1, Cell 2, Cell 3 in FIGS. 8, 9), per geographical area, etc. The AMF 605 (e.g., 830 in FIG. 8; 930 in FIG. 9) also may generate a registration area(s) so that LDS (e.g., 705 in FIG. 7; 812, 812′ in FIG. 8; 912, 912′ in FIG. 9) service is uniformly available in registration area(s) (e.g., so that the AUE 602 (e.g., 402 in FIG. 4; 502 in FIG. 5; 702 in FIG. 7; 806, 810 in FIG. 8; 906, 910 in FIG. 9) is not in a cell (e.g., Cell 1, Cell 2, Cell 3 in FIGS. 8, 9) of the registration area(s) where there is no LDS (e.g., 705 in FIG. 7; 812, 812′ in FIG. 8; 912, 912′ in FIG. 9) service). In some aspects, the CN (e.g., 820 in FIG. 8; 920 in FIG. 9) of the mobile network 604 (e.g., 404 in FIG. 4; 504 in FIG. 5; 704 in FIG. 7; 818 in FIG. 8; 918 in FIG. 9) may provide a new service restriction area indicative of no LDS (e.g., 705 in FIG. 7; 812, 812′ in FIG. 8; 912, 912′ in FIG. 9) support (e.g., “No LDS support”) and containing the tracking area(s) where LDS (e.g., 705 in FIG. 7; 812, 812′ in FIG. 8; 912, 912′ in FIG. 9) service is not supported. In some aspects, the AUE 602 (e.g., 402 in FIG. 4; 502 in FIG. 5; 702 in FIG. 7; 806, 810 in FIG. 8; 906, 910 in FIG. 9) may perform mobility management in such a way as to avoid entering tracking area(s) where LDS (e.g., 705 in FIG. 7; 812, 812′ in FIG. 8; 912, 912′ in FIG. 9) service is not supported; or the AUE 602 (e.g., 402 in FIG. 4; 502 in FIG. 5; 702 in FIG. 7; 806, 810 in FIG. 8; 906, 910 in FIG. 9) may inform the LDS (e.g., 705 in FIG. 7; 812, 812′ in FIG. 8; 912, 912′ in FIG. 9) service of imminent loss of the LDS (e.g., 705 in FIG. 7; 812, 812′ in FIG. 8; 912, 912′ in FIG. 9) service before entering an area where the LDS (e.g., 705 in FIG. 7; 812, 812′ in FIG. 8; 912, 912′ in FIG. 9) service is not supported; and/or the AUE 602 (e.g., 402 in FIG. 4; 502 in FIG. 5; 702 in FIG. 7; 806, 810 in FIG. 8; 906, 910 in FIG. 9) may take action(s) such as relying wholly, or alternatively at least in part, on alternative DAA solutions.

In the context layer 2 and layer 3 operations associated with the AMF 605 (e.g., 830 in FIG. 8; 930 in FIG. 9), which may be alternative and/or complementary in various aspects, the LDS (e.g., 705 in FIG. 7; 812, 812′ in FIG. 8; 912, 912′ in FIG. 9) service may not be available in all locations, so either a cell (e.g., Cell 1, Cell 2, Cell 3 in FIGS. 8, 9) SIB may have an indication of the LDS availability (e.g., “LDS available”) when the LDS (e.g., 705 in FIG. 7; 812, 812′ in FIG. 8; 912, 912′ in FIG. 9) service is available, and/or an indication may be sent in RRC establishment signaling and a base station/gNB (e.g., 816, 816′ in FIG. 8; 916, 916′ in FIG. 9) may be configured to know whether the LDS (e.g., 705 in FIG. 7; 812, 812′ in FIG. 8; 912, 912′ in FIG. 9) service is available.

Further, the mobile network 604 (e.g., 404 in FIG. 4; 504 in FIG. 5; 704 in FIG. 7; 818 in FIG. 8; 918 in FIG. 9) and the AMF 605 (e.g., 830 in FIG. 8; 930 in FIG. 9) may be configured to transmit/provide, and the AUE 602 (e.g., 402 in FIG. 4; 502 in FIG. 5; 702 in FIG. 7; 806, 810 in FIG. 8; 906, 910 in FIG. 9) may be configured to receive, addressing information associated with the NWDAA services and the LDS (e.g., 705 in FIG. 7; 812, 812′ in FIG. 8; 912, 912′ in FIG. 9) of the mobile network 604 (e.g., 404 in FIG. 4; 504 in FIG. 5; 704 in FIG. 7; 818 in FIG. 8; 918 in FIG. 9). In one example, in a registration acceptance (“Registration Accept”) such as by the AMF 605 (e.g., 830 in FIG. 8; 930 in FIG. 9), in an AUE 602 (e.g., 402 in FIG. 4; 502 in FIG. 5; 702 in FIG. 7; 806, 810 in FIG. 8; 906, 910 in FIG. 9) configuration update procedure, and/or the like, the mobile network 604 (e.g., 404 in FIG. 4; 504 in FIG. 5; 704 in FIG. 7; 818 in FIG. 8; 918 in FIG. 9) and the AMF 605 (e.g., 830 in FIG. 8; 930 in FIG. 9) may transmit/provide the addressing information for the AUE 602 (e.g., 402 in FIG. 4; 502 in FIG. 5; 702 in FIG. 7; 806, 810 in FIG. 8; 906, 910 in FIG. 9). The LDS (e.g., 705 in FIG. 7; 812, 812′ in FIG. 8; 912, 912′ in FIG. 9) addressing information may include, but is not limited to, an LDS (e.g., 705 in FIG. 7; 812, 812′ in FIG. 8; 912, 912′ in FIG. 9) address (e.g., actual IP address), a URL (which the AUE 602 (e.g., 402 in FIG. 4; 502 in FIG. 5; 702 in FIG. 7; 806, 810 in FIG. 8; 906, 910 in FIG. 9) may be configure to utilize to discover the LDS (e.g., 705 in FIG. 7; 812, 812′ in FIG. 8; 912, 912′ in FIG. 9), e.g. using DNS), an FQDN, an anycast address of the LDS (e.g., 705 in FIG. 7; 812, 812′ in FIG. 8; 912, 912′ in FIG. 9), and/or the like.

In aspects, the AMF 605 (e.g., 830 in FIG. 8; 930 in FIG. 9) may provide such information upon determining that the AUE 602 (e.g., 402 in FIG. 4; 502 in FIG. 5; 702 in FIG. 7; 806, 810 in FIG. 8; 906, 910 in FIG. 9) has an aerial subscription, has indicated its NWDAA/LDS (e.g., 705 in FIG. 7; 812, 812′ in FIG. 8; 912, 912′ in FIG. 9) capability, and is an authorized AUE (e.g., an UAS service supplier (USS) authentication and authorization (UUAA)/procedure has been performed successfully, when UUAA is supported and/or mandated).

In the mobile network 604 (e.g., 404 in FIG. 4; 504 in FIG. 5; 704 in FIG. 7; 818 in FIG. 8; 918 in FIG. 9), for the CN (e.g., 820 in FIG. 8; 920 in FIG. 9) to RAN (e.g., 404 in FIG. 4; 504 in FIG. 5; 604 in FIG. 6; 704 in FIG. 7; 818 in FIG. 8; 918 in FIG. 9) communications associated with LDS (e.g., 705 in FIG. 7; 812, 812′ in FIG. 8; 912, 912′ in FIG. 9)/NWDAA services support, layer 2 communications may be utilized to activate RAN-LDS connectivity, and layer 2/layer 3 communications may be utilized to activate the RAN (e.g., 404 in FIG. 4; 504 in FIG. 5; 604 in FIG. 6; 704 in FIG. 7; 818 in FIG. 8; 918 in FIG. 9) to report to the LDS (e.g., 705 in FIG. 7; 812, 812′ in FIG. 8; 912, 912′ in FIG. 9). For instance, upon AUE 602 (e.g., 402 in FIG. 4; 502 in FIG. 5; 702 in FIG. 7; 806, 810 in FIG. 8; 906, 910 in FIG. 9) registration, if the AUE 602 (e.g., 402 in FIG. 4; 502 in FIG. 5; 702 in FIG. 7; 806, 810 in FIG. 8; 906, 910 in FIG. 9) subscription is for an aerial UE and the AMF 605 (e.g., 830 in FIG. 8; 930 in FIG. 9) successfully authenticates the AUE 602 (e.g., 402 in FIG. 4; 502 in FIG. 5; 702 in FIG. 7; 806, 810 in FIG. 8; 906, 910 in FIG. 9), then the AMF 605 (e.g., 830 in FIG. 8; 930 in FIG. 9) may indicate to the RAN (e.g., 404 in FIG. 4; 504 in FIG. 5; 604 in FIG. 6; 704 in FIG. 7; 818 in FIG. 8; 918 in FIG. 9) whether the LDS (e.g., 705 in FIG. 7; 812, 812′ in FIG. 8; 912, 912′ in FIG. 9) is authorized for the AUE 602 (e.g., 402 in FIG. 4; 502 in FIG. 5; 702 in FIG. 7; 806, 810 in FIG. 8; 906, 910 in FIG. 9). In aspects, the indication by the AMF 605 (e.g., 830 in FIG. 8; 930 in FIG. 9) of the LDS (e.g., 705 in FIG. 7; 812, 812′ in FIG. 8; 912, 912′ in FIG. 9) authorization for the AUE 602 (e.g., 402 in FIG. 4; 502 in FIG. 5; 702 in FIG. 7; 806, 810 in FIG. 8; 906, 910 in FIG. 9) may be based on a successful UUAA authentication/authorization, and/or if the AUE 602 (e.g., 402 in FIG. 4; 502 in FIG. 5; 702 in FIG. 7; 806, 810 in FIG. 8; 906, 910 in FIG. 9) has indicated in 5GMM capabilities that it supports the LDS (e.g., 705 in FIG. 7; 812, 812′ in FIG. 8; 912, 912′ in FIG. 9) service.

When the LDS (e.g., 705 in FIG. 7; 812, 812′ in FIG. 8; 912, 912′ in FIG. 9) service is activated in the RAN (e.g., 404 in FIG. 4; 504 in FIG. 5; 604 in FIG. 6; 704 in FIG. 7; 818 in FIG. 8; 918 in FIG. 9), the RAN (e.g., 404 in FIG. 4; 504 in FIG. 5; 604 in FIG. 6; 704 in FIG. 7; 818 in FIG. 8; 918 in FIG. 9) may generate information from sensors (e.g., 814 in FIG. 8; 914 in FIG. 9) and provide the information to the LDS (e.g., 705 in FIG. 7; 812, 812′ in FIG. 8; 912, 912′ in FIG. 9) based on an operations administration and maintenance (OAM) configuration. Sensors (e.g., 814 in FIG. 8; 914 in FIG. 9) may be RAN (e.g., 404 in FIG. 4; 504 in FIG. 5; 604 in FIG. 6; 704 in FIG. 7; 818 in FIG. 8; 918 in FIG. 9) sensing capabilities, BRID receivers, ADS-B receivers, DAA broadcast receivers, weather sensors, LIDAR, RADAR, SONAR, NR sensing capabilities, and/or the like. For layer 2 implementations, the RAN (e.g., 404 in FIG. 4; 504 in FIG. 5; 604 in FIG. 6; 704 in FIG. 7; 818 in FIG. 8; 918 in FIG. 9) may be preconfigured with the serving LDS (e.g., 705 in FIG. 7; 812, 812′ in FIG. 8; 912, 912′ in FIG. 9) information and have connectivity with the LDS (e.g., 705 in FIG. 7; 812, 812′ in FIG. 8; 912, 912′ in FIG. 9). In aspects, such a configuration may be performed by the OAM, where the OAM provides to each RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9) the address of the LDS (e.g., 705 in FIG. 7; 812, 812′ in FIG. 8; 912, 912′ in FIG. 9) to be used.

The mobile network 604 (e.g., 404 in FIG. 4; 504 in FIG. 5; 704 in FIG. 7; 818 in FIG. 8; 918 in FIG. 9) (e.g., by an LDS(s) (e.g., 705 in FIG. 7; 812, 812′ in FIG. 8; 912, 912′ in FIG. 9) thereof) and/or the AUE 602 (e.g., 402 in FIG. 4; 502 in FIG. 5; 702 in FIG. 7; 806, 810 in FIG. 8; 906, 910 in FIG. 9) may be configured to communicate communication information 612 associated with the NWDAA services. In aspects, the communication information 612 may be any information associated with the NWDAA services and/or an LDS (e.g., 705 in FIG. 7; 812, 812′ in FIG. 8; 912, 912′ in FIG. 9), as described herein. In aspects for AUE-LDS communications, an LDS (e.g., 705 in FIG. 7; 812, 812′ in FIG. 8; 912, 912′ in FIG. 9) may operate as a passive LDS receiver or as an active LDS receiver.

In aspects for AUE-LDS connectivity, the LDS (e.g., 705 in FIG. 7; 812, 812′ in FIG. 8; 912, 912′ in FIG. 9) connectivity may be layer 3 connectivity at the application layer, e.g., the user plane. For example, the AUE 602 (e.g., 402 in FIG. 4; 502 in FIG. 5; 702 in FIG. 7; 806, 810 in FIG. 8; 906, 910 in FIG. 9) may be configured to establish a session with the LDS (e.g., 705 in FIG. 7; 812, 812′ in FIG. 8; 912, 912′ in FIG. 9) upon (i) discovering the LDS (e.g., 705 in FIG. 7; 812, 812′ in FIG. 8; 912, 912′ in FIG. 9) is supported, and (ii) discovering LDS (e.g., 705 in FIG. 7; 812, 812′ in FIG. 8; 912, 912′ in FIG. 9), as noted herein. The AUE 602 (e.g., 402 in FIG. 4; 502 in FIG. 5; 702 in FIG. 7; 806, 810 in FIG. 8; 906, 910 in FIG. 9) may be provided, in NAS registration messages, with information regarding the LDS (e.g., 705 in FIG. 7; 812, 812′ in FIG. 8; 912, 912′ in FIG. 9) server discovery (e.g., the server address), or the AUE 602 (e.g., 402 in FIG. 4; 502 in FIG. 5; 702 in FIG. 7; 806, 810 in FIG. 8; 906, 910 in FIG. 9) may be pre-configured with information regarding the LDS(s) (e.g., 705 in FIG. 7; 812, 812′ in FIG. 8; 912, 912′ in FIG. 9) such as, but without limitation, an IP address, a URL, a FQDN, or an anycast address of the LDS (e.g., 705 in FIG. 7; 812, 812′ in FIG. 8; 912, 912′ in FIG. 9) (e.g., FQDNs may be used to discover the IP address of the LDS (e.g., 705 in FIG. 7; 812, 812′ in FIG. 8; 912, 912′ in FIG. 9)). In aspects, the LDS (e.g., 705 in FIG. 7; 812, 812′ in FIG. 8; 912, 912′ in FIG. 9) server address may be configured by a PCF, and the AUE 602 (e.g., 402 in FIG. 4; 502 in FIG. 5; 702 in FIG. 7; 806, 810 in FIG. 8; 906, 910 in FIG. 9) may be configured with an LDS (e.g., 705 in FIG. 7; 812, 812′ in FIG. 8; 912, 912′ in FIG. 9) anycast address that the AUE 602 (e.g., 402 in FIG. 4; 502 in FIG. 5; 702 in FIG. 7; 806, 810 in FIG. 8; 906, 910 in FIG. 9) may utilize to discover the LDS (e.g., 705 in FIG. 7; 812, 812′ in FIG. 8; 912, 912′ in FIG. 9).

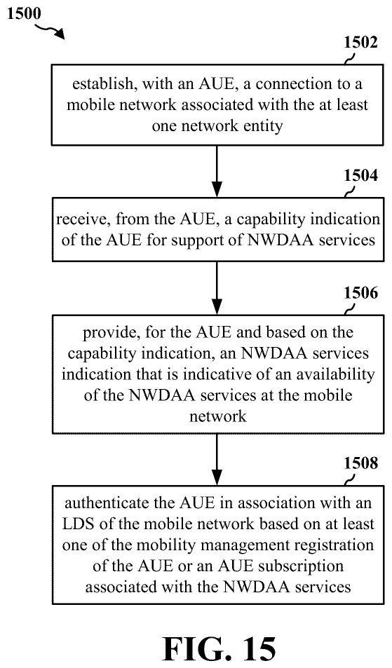

FIG. 15 is a flowchart 1500 of a method of wireless communication. The method may be performed by a network entity(ies)/a network node(s) (e.g., the base station 102, 816, 816′, 916, 916′; network entities of the mobile network 404; the SMF 162, 505, 832, 932; the AMF 161, 605, 830, 930; the LDS 705, 812, 812′, 912, 912′; the network entity 1902, 2060) of a mobile network. In some aspects, the method may include aspects described in connection with the communication flows in FIGS. 4, 5, 6, 7, and/or aspects described in FIGS. 8, 9. The method may be for network-assisted DAA for AUEs. The method may provide for improved DAA by enabling an AUE to report NWDAA capabilities and be authenticated for utilization of a network-based LDS with predictive deconfliction and multi-source information gathering capabilities.

At 1502, the at least one network entity establishes, with an AUE, a connection to a mobile network associated with the at least one network entity. As an example, the establishment may be performed by one or more of the component 199, the transceiver 2146, and/or the antenna 2180 in FIG. 21, the network interface 2280 in FIG. 22. FIG. 6 illustrates, in the context of FIGS. 4, 5, 7-9, an example of the AMF 605 (e.g., 830 in FIG. 8; 930 in FIG. 9) establishing such a connection to a mobile network (e.g., the mobile network 604) with an AUE (e.g., the AUE 602).

The AUE 602 (e.g., 402 in FIG. 4; 502 in FIG. 5; 702 in FIG. 7; 806, 810 in FIG. 8; 906, 910 in FIG. 9) may be configured to establish (at 606) a network connection with the mobile network 604 (e.g., 404 in FIG. 4; 504 in FIG. 5; 704 in FIG. 7; 818 in FIG. 8; 918 in FIG. 9) and the AMF 605 (e.g., 830 in FIG. 8; 930 in FIG. 9). Additionally or conversely, the mobile network 604 (e.g., 404 in FIG. 4; 504 in FIG. 5; 704 in FIG. 7; 818 in FIG. 8; 918 in FIG. 9) and the AMF 605 (e.g., 830 in FIG. 8; 930 in FIG. 9) may be configured to establish (at 606) a network connection with the AUE 602 (e.g., 402 in FIG. 4; 502 in FIG. 5; 702 in FIG. 7; 806, 810 in FIG. 8; 906, 910 in FIG. 9). In aspects, the AUE 602 (e.g., 402 in FIG. 4; 502 in FIG. 5; 702 in FIG. 7; 806, 810 in FIG. 8; 906, 910 in FIG. 9) may be configured to establish (at 606) a network connection with the mobile network 604 (e.g., 404 in FIG. 4; 504 in FIG. 5; 704 in FIG. 7; 818 in FIG. 8; 918 in FIG. 9) via a base station, gNB, etc. (e.g., 816, 816′ in FIG. 8; 916, 916′ in FIG. 9), for the AMF 605 (e.g., 830 in FIG. 8; 930 in FIG. 9) of the mobile network 604 (e.g., 404 in FIG. 4; 504 in FIG. 5; 704 in FIG. 7; 818 in FIG. 8; 918 in FIG. 9), as would be understood by persons of skill in the relevant art(s) having the benefit of this disclosure. In aspects, establishment of the connection to the mobile network (e.g., 404 in FIG. 4; 504 in FIG. 5; 604 in FIG. 6; 704 in FIG. 7; 818 in FIG. 8; 918 in FIG. 9) at 1502 may include performance of the provision of the capability indication (e.g., 408 in FIG. 4; 508 in FIG. 5; 608 in FIG. 6) at 1504, e.g., as part of the MM signaling for the AMF 605 (e.g., 830 in FIG. 8; 930 in FIG. 9), such as the registration request (as illustrated in connection with the examples in FIGS. 4, 6).

At 1504, the at least one network entity receives, from the AUE, a capability indication of the AUE for support of NWDAA services. As an example, the reception may be performed by one or more of the component 199, the transceiver 2146, and/or the antenna 2180 in FIG. 21, the network interface 2280 in FIG. 22. FIG. 6 illustrates, in the context of FIGS. 4, 5, 7-9, an example of the AMF 605 receiving such a capability indication from an AUE (e.g., the AUE 602).

The AUE 602 (e.g., 402 in FIG. 4; 502 in FIG. 5; 702 in FIG. 7; 806, 810 in FIG. 8; 906, 910 in FIG. 9) may be configured to transmit/provide, and the mobile network 604 (e.g., 404 in FIG. 4; 504 in FIG. 5; 704 in FIG. 7; 818 in FIG. 8; 918 in FIG. 9) and the AMF 605 (e.g., 830 in FIG. 8; 930 in FIG. 9) may be configured to receive, a capability indication 608 (e.g., 408 in FIG. 4; 508 in FIG. 5). In aspects, the capability indication 608 (e.g., 408 in FIG. 4; 508 in FIG. 5) of the AUE 602 (e.g., 402 in FIG. 4; 502 in FIG. 5; 702 in FIG. 7; 806, 810 in FIG. 8; 906, 910 in FIG. 9) for support of NWDAA services. In aspects, an LDS (e.g., 705 in FIG. 7; 812, 812′ in FIG. 8; 912, 912′ in FIG. 9) herein may comprise the NWDAA services, or vice versa, the LDS (e.g., 705 in FIG. 7; 812, 812′ in FIG. 8; 912, 912′ in FIG. 9) may be configured to provide at least a portion of the NWDAA services, and/or the like. The transmission/provision of the capability indication 608 (e.g., 408 in FIG. 4; 508 in FIG. 5) may be a portion of a discover of support for an LDS (e.g., 705 in FIG. 7; 812, 812′ in FIG. 8; 912, 912′ in FIG. 9)/NWDAA services. In aspects, when the AUE 602 (e.g., 402 in FIG. 4; 502 in FIG. 5; 702 in FIG. 7; 806, 810 in FIG. 8; 906, 910 in FIG. 9) is capable of utilizing an LDS (e.g., 705 in FIG. 7; 812, 812′ in FIG. 8; 912, 912′ in FIG. 9), the AUE 602 (e.g., 402 in FIG. 4; 502 in FIG. 5; 702 in FIG. 7; 806, 810 in FIG. 8; 906, 910 in FIG. 9) indicates its support for the LDS (e.g., 705 in FIG. 7; 812, 812′ in FIG. 8; 912, 912′ in FIG. 9) (or network-assisted DAA, generally). In some aspects, the transmission/provision of the capability indication 608 (e.g., 408 in FIG. 4; 508 in FIG. 5) may be via NAS signaling. As one example, the transmission/provision of the capability indication 608 (e.g., 408 in FIG. 4; 508 in FIG. 5) may be for the AMF 605 (e.g., 830 in FIG. 8; 930 in FIG. 9) using MM signaling, such as a registration request in 5GMM capabilities. In such aspects, establishment of the connection to the mobile network (e.g., 404 in FIG. 4; 504 in FIG. 5; 604 in FIG. 6; 704 in FIG. 7; 818 in FIG. 8; 918 in FIG. 9) at 1502 may include performance of the provision of the capability indication (e.g., 408 in FIG. 4; 508 in FIG. 5; 608 in FIG. 6) at 1504, e.g., as part of the MM signaling for the AMF 605 (e.g., 830 in FIG. 8; 930 in FIG. 9), such as the registration request (as illustrated in connection with the examples in FIGS. 4, 6).

At 1506, the at least one network entity provides, for the AUE and based on the capability indication, an NWDAA services indication that is indicative of an availability of the NWDAA services at the mobile network. As an example, the provision may be performed by one or more of the component 199, the transceiver 2146, and/or the antenna 2180 in FIG. 21, the network interface 2280 in FIG. 22. FIG. 6 illustrates, in the context of FIGS. 4, 5, 7-9, an example of the AMF 605 (e.g., 830 in FIG. 8; 930 in FIG. 9) providing/transmitting such an NWDAA services indication for an AUE (e.g., the AUE 602).

The mobile network 604 (e.g., 404 in FIG. 4; 504 in FIG. 5; 704 in FIG. 7; 818 in FIG. 8; 918 in FIG. 9) and the AMF 605 (e.g., 830 in FIG. 8; 930 in FIG. 9) may be configured to transmit/provide, and the AUE 602 (e.g., 402 in FIG. 4; 502 in FIG. 5; 702 in FIG. 7; 806, 810 in FIG. 8; 906, 910 in FIG. 9) may be configured to receive, an NWDAA services indication 610. For instance, the mobile network 604 (e.g., 404 in FIG. 4; 504 in FIG. 5; 704 in FIG. 7; 818 in FIG. 8; 918 in FIG. 9) and the AMF 605 (e.g., 830 in FIG. 8; 930 in FIG. 9) may be configured to indicate its LDS (e.g., 705 in FIG. 7; 812, 812′ in FIG. 8; 912, 912′ in FIG. 9) support. In aspects, LDS (e.g., 705 in FIG. 7; 812, 812′ in FIG. 8; 912, 912′ in FIG. 9) availability may be indicated per PLMN, per registration area, per tracking area, per cells (e.g., Cell 1, Cell 2, Cell 3 in FIGS. 8, 9), per geographical area, etc. The AMF 605 (e.g., 830 in FIG. 8; 930 in FIG. 9) also may generate a registration area(s) so that LDS (e.g., 705 in FIG. 7; 812, 812′ in FIG. 8; 912, 912′ in FIG. 9) service is uniformly available in registration area(s) (e.g., so that the AUE 602 (e.g., 402 in FIG. 4; 502 in FIG. 5; 702 in FIG. 7; 806, 810 in FIG. 8; 906, 910 in FIG. 9) is not in a cell (e.g., Cell 1, Cell 2, Cell 3 in FIGS. 8, 9) of the registration area(s) where there is no LDS (e.g., 705 in FIG. 7; 812, 812′ in FIG. 8; 912, 912′ in FIG. 9) service). In some aspects, the CN (e.g., 820 in FIG. 8; 920 in FIG. 9) of the mobile network 604 (e.g., 404 in FIG. 4; 504 in FIG. 5; 704 in FIG. 7; 818 in FIG. 8; 918 in FIG. 9) may provide a new service restriction area indicative of no LDS (e.g., 705 in FIG. 7; 812, 812′ in FIG. 8; 912, 912′ in FIG. 9) support (e.g., “No LDS support”) and containing the tracking area(s) where LDS (e.g., 705 in FIG. 7; 812, 812′ in FIG. 8; 912, 912′ in FIG. 9) service is not supported. In some aspects, the AUE 602 (e.g., 402 in FIG. 4; 502 in FIG. 5; 702 in FIG. 7; 806, 810 in FIG. 8; 906, 910 in FIG. 9) may perform mobility management in such a way as to avoid entering tracking area(s) where LDS (e.g., 705 in FIG. 7; 812, 812′ in FIG. 8; 912, 912′ in FIG. 9) service is not supported; or the AUE 602 (e.g., 402 in FIG. 4; 502 in FIG. 5; 702 in FIG. 7; 806, 810 in FIG. 8; 906, 910 in FIG. 9) may inform the LDS (e.g., 705 in FIG. 7; 812, 812′ in FIG. 8; 912, 912′ in FIG. 9) service of imminent loss of the LDS (e.g., 705 in FIG. 7; 812, 812′ in FIG. 8; 912, 912′ in FIG. 9) service before entering an area where the LDS (e.g., 705 in FIG. 7; 812, 812′ in FIG. 8; 912, 912′ in FIG. 9) service is not supported; and/or the AUE 602 (e.g., 402 in FIG. 4; 502 in FIG. 5; 702 in FIG. 7; 806, 810 in FIG. 8; 906, 910 in FIG. 9) may take action(s) such as relying wholly, or alternatively at least in part, on alternative DAA solutions.

In the context of layer 2 and layer 3 operations associated with the AMF 605 (e.g., 830 in FIG. 8; 930 in FIG. 9), which may be alternative and/or complementary in various aspects, the LDS (e.g., 705 in FIG. 7; 812, 812′ in FIG. 8; 912, 912′ in FIG. 9) service may not be available in all locations, so either a cell (e.g., Cell 1, Cell 2, Cell 3 in FIGS. 8, 9) SIB may have an indication of the LDS availability (e.g., “LDS available”) when the LDS (e.g., 705 in FIG. 7; 812, 812′ in FIG. 8; 912, 912′ in FIG. 9) service is available, and/or an indication may be sent in RRC establishment signaling and a base station/gNB (e.g., 816, 816′ in FIG. 8; 916, 916′ in FIG. 9) may be configured to know whether the LDS (e.g., 705 in FIG. 7; 812, 812′ in FIG. 8; 912, 912′ in FIG. 9) service is available.

Further, the mobile network 604 (e.g., 404 in FIG. 4; 504 in FIG. 5; 704 in FIG. 7; 818 in FIG. 8; 918 in FIG. 9) and the AMF 605 (e.g., 830 in FIG. 8; 930 in FIG. 9) may be configured to transmit/provide, and the AUE 602 (e.g., 402 in FIG. 4; 502 in FIG. 5; 702 in FIG. 7; 806, 810 in FIG. 8; 906, 910 in FIG. 9) may be configured to receive, addressing information associated with the NWDAA services and the LDS (e.g., 705 in FIG. 7; 812, 812′ in FIG. 8; 912, 912′ in FIG. 9) of the mobile network 604 (e.g., 404 in FIG. 4; 504 in FIG. 5; 704 in FIG. 7; 818 in FIG. 8; 918 in FIG. 9). In one example, in a registration acceptance (“Registration Accept”) such as by the AMF 605 (e.g., 830 in FIG. 8; 930 in FIG. 9), in an AUE 602 (e.g., 402 in FIG. 4; 502 in FIG. 5; 702 in FIG. 7; 806, 810 in FIG. 8; 906, 910 in FIG. 9) configuration update procedure, and/or the like, the mobile network 604 (e.g., 404 in FIG. 4; 504 in FIG. 5; 704 in FIG. 7; 818 in FIG. 8; 918 in FIG. 9) and the AMF 605 (e.g., 830 in FIG. 8; 930 in FIG. 9) may transmit/provide the addressing information for the AUE 602 (e.g., 402 in FIG. 4; 502 in FIG. 5; 702 in FIG. 7; 806, 810 in FIG. 8; 906, 910 in FIG. 9). The LDS (e.g., 705 in FIG. 7; 812, 812′ in FIG. 8; 912, 912′ in FIG. 9) addressing information may include, but is not limited to, an LDS (e.g., 705 in FIG. 7; 812, 812′ in FIG. 8; 912, 912′ in FIG. 9) address (e.g., actual IP address), a URL (which the AUE 602 (e.g., 402 in FIG. 4; 502 in FIG. 5; 702 in FIG. 7; 806, 810 in FIG. 8; 906, 910 in FIG. 9) may be configure to utilize to discover the LDS (e.g., 705 in FIG. 7; 812, 812′ in FIG. 8; 912, 912′ in FIG. 9), e.g. using DNS), an FQDN, an anycast address of the LDS (e.g., 705 in FIG. 7; 812, 812′ in FIG. 8; 912, 912′ in FIG. 9), and/or the like.

In aspects, the AMF 605 (e.g., 830 in FIG. 8; 930 in FIG. 9) may provide such information upon determining that the AUE 602 (e.g., 402 in FIG. 4; 502 in FIG. 5; 702 in FIG. 7; 806, 810 in FIG. 8; 906, 910 in FIG. 9) has an aerial subscription, has indicated its NWDAA/LDS (e.g., 705 in FIG. 7; 812, 812′ in FIG. 8; 912, 912′ in FIG. 9) capability, and is an authorized AUE (e.g., an UAS service supplier (USS) authentication and authorization (UUAA)/procedure has been performed successfully, when UUAA is supported and/or mandated).

At 1508, the at least one network entity authenticates the AUE in association with an LDS of the mobile network based on at least one of the mobility management registration of the AUE or an AUE subscription associated with the NWDAA services. As an example, the authentication may be performed by one or more of the component 199, the transceiver 2146, and/or the antenna 2180 in FIG. 21, the network interface 2280 in FIG. 22. FIG. 6 illustrates, in the context of FIGS. 4, 5, 7-9, an example of the AMF 605 (e.g., 830 in FIG. 8; 930 in FIG. 9) authenticating such an AUE (e.g., the AUE 602).

In the mobile network 604 (e.g., 404 in FIG. 4; 504 in FIG. 5; 704 in FIG. 7; 818 in FIG. 8; 918 in FIG. 9), for the CN (e.g., 820 in FIG. 8; 920 in FIG. 9) to RAN (e.g., 404 in FIG. 4; 504 in FIG. 5; 604 in FIG. 6; 704 in FIG. 7; 818 in FIG. 8; 918 in FIG. 9) communications associated with LDS (e.g., 705 in FIG. 7; 812, 812′ in FIG. 8; 912, 912′ in FIG. 9)/NWDAA services support, layer 2 communications may be utilized to activate RAN-LDS connectivity, and layer 2/layer 3 communications may be utilized to activate the RAN (e.g., 404 in FIG. 4; 504 in FIG. 5; 604 in FIG. 6; 704 in FIG. 7; 818 in FIG. 8; 918 in FIG. 9) to report to the LDS (e.g., 705 in FIG. 7; 812, 812′ in FIG. 8; 912, 912′ in FIG. 9). For instance, upon AUE 602 (e.g., 402 in FIG. 4; 502 in FIG. 5; 702 in FIG. 7; 806, 810 in FIG. 8; 906, 910 in FIG. 9) registration, if the AUE 602 (e.g., 402 in FIG. 4; 502 in FIG. 5; 702 in FIG. 7; 806, 810 in FIG. 8; 906, 910 in FIG. 9) subscription is for an aerial UE and the AMF 605 (e.g., 830 in FIG. 8; 930 in FIG. 9) successfully authenticates the AUE 602 (e.g., 402 in FIG. 4; 502 in FIG. 5; 702 in FIG. 7; 806, 810 in FIG. 8; 906, 910 in FIG. 9), then the AMF 605 (e.g., 830 in FIG. 8; 930 in FIG. 9) may indicate to the RAN (e.g., 404 in FIG. 4; 504 in FIG. 5; 604 in FIG. 6; 704 in FIG. 7; 818 in FIG. 8; 918 in FIG. 9) whether the LDS (e.g., 705 in FIG. 7; 812, 812′ in FIG. 8; 912, 912′ in FIG. 9) is authorized for the AUE 602 (e.g., 402 in FIG. 4; 502 in FIG. 5; 702 in FIG. 7; 806, 810 in FIG. 8; 906, 910 in FIG. 9). In aspects, the indication by the AMF 605 (e.g., 830 in FIG. 8; 930 in FIG. 9) of the LDS (e.g., 705 in FIG. 7; 812, 812′ in FIG. 8; 912, 912′ in FIG. 9) authorization for the AUE 602 (e.g., 402 in FIG. 4; 502 in FIG. 5; 702 in FIG. 7; 806, 810 in FIG. 8; 906, 910 in FIG. 9) may be based on a successful UUAA authentication/authorization, and/or if the AUE 602 (e.g., 402 in FIG. 4; 502 in FIG. 5; 702 in FIG. 7; 806, 810 in FIG. 8; 906, 910 in FIG. 9) has indicated in 5GMM capabilities that it supports the LDS (e.g., 705 in FIG. 7; 812, 812′ in FIG. 8; 912, 912′ in FIG. 9) service.

When the LDS (e.g., 705 in FIG. 7; 812, 812′ in FIG. 8; 912, 912′ in FIG. 9) service is activated in the RAN (e.g., 404 in FIG. 4; 504 in FIG. 5; 604 in FIG. 6; 704 in FIG. 7; 818 in FIG. 8; 918 in FIG. 9), the RAN (e.g., 404 in FIG. 4; 504 in FIG. 5; 604 in FIG. 6; 704 in FIG. 7; 818 in FIG. 8; 918 in FIG. 9) may generate information from sensors (e.g., 814 in FIG. 8; 914 in FIG. 9) and provide the information to the LDS (e.g., 705 in FIG. 7; 812, 812′ in FIG. 8; 912, 912′ in FIG. 9) based on an operations administration and maintenance (OAM) configuration. Sensors (e.g., 814 in FIG. 8; 914 in FIG. 9) may be RAN (e.g., 404 in FIG. 4; 504 in FIG. 5; 604 in FIG. 6; 704 in FIG. 7; 818 in FIG. 8; 918 in FIG. 9) sensing capabilities, BRID receivers, ADS-B receivers, DAA broadcast receivers, weather sensors, LIDAR, RADAR, SONAR, NR sensing capabilities, and/or the like. For layer 2 implementations, the RAN (e.g., 404 in FIG. 4; 504 in FIG. 5; 604 in FIG. 6; 704 in FIG. 7; 818 in FIG. 8; 918 in FIG. 9) may be preconfigured with the serving LDS (e.g., 705 in FIG. 7; 812, 812′ in FIG. 8; 912, 912′ in FIG. 9) information and have connectivity with the LDS (e.g., 705 in FIG. 7; 812, 812′ in FIG. 8; 912, 912′ in FIG. 9). In aspects, such a configuration may be performed by the OAM, where the OAM provides to each RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9) the address of the LDS (e.g., 705 in FIG. 7; 812, 812′ in FIG. 8; 912, 912′ in FIG. 9) to be used.

The mobile network 604 (e.g., 404 in FIG. 4; 504 in FIG. 5; 704 in FIG. 7; 818 in FIG. 8; 918 in FIG. 9) (e.g., by an LDS(s) (e.g., 705 in FIG. 7; 812, 812′ in FIG. 8; 912, 912′ in FIG. 9) thereof) and/or the AUE 602 (e.g., 402 in FIG. 4; 502 in FIG. 5; 702 in FIG. 7; 806, 810 in FIG. 8; 906, 910 in FIG. 9) may be configured to communicate communication information 612 associated with the NWDAA services. In aspects, the communication information 612 may be any information associated with the NWDAA services and/or an LDS (e.g., 705 in FIG. 7; 812, 812′ in FIG. 8; 912, 912′ in FIG. 9), as described herein. In aspects for AUE-LDS communications, an LDS (e.g., 705 in FIG. 7; 812, 812′ in FIG. 8; 912, 912′ in FIG. 9) may operate as a passive LDS receiver or as an active LDS receiver.

In aspects for AUE-LDS connectivity, the LDS (e.g., 705 in FIG. 7; 812, 812′ in FIG. 8; 912, 912′ in FIG. 9) connectivity may be layer 3 connectivity at the application layer, e.g., the user plane. For example, the AUE 602 (e.g., 402 in FIG. 4; 502 in FIG. 5; 702 in FIG. 7; 806, 810 in FIG. 8; 906, 910 in FIG. 9) may be configured to establish a session with the LDS (e.g., 705 in FIG. 7; 812, 812′ in FIG. 8; 912, 912′ in FIG. 9) upon (i) discovering the LDS (e.g., 705 in FIG. 7; 812, 812′ in FIG. 8; 912, 912′ in FIG. 9) is supported, and (ii) discovering LDS (e.g., 705 in FIG. 7; 812, 812′ in FIG. 8; 912, 912′ in FIG. 9), as noted herein. The AUE 602 (e.g., 402 in FIG. 4; 502 in FIG. 5; 702 in FIG. 7; 806, 810 in FIG. 8; 906, 910 in FIG. 9) may be provided, in NAS registration messages, with information regarding the LDS (e.g., 705 in FIG. 7; 812, 812′ in FIG. 8; 912, 912′ in FIG. 9) server discovery (e.g., the server address), or the AUE 602 (e.g., 402 in FIG. 4; 502 in FIG. 5; 702 in FIG. 7; 806, 810 in FIG. 8; 906, 910 in FIG. 9) may be pre-configured with information regarding the LDS(s) (e.g., 705 in FIG. 7; 812, 812′ in FIG. 8; 912, 912′ in FIG. 9) such as, but without limitation, an IP address, a URL, a FQDN, or an anycast address of the LDS (e.g., 705 in FIG. 7; 812, 812′ in FIG. 8; 912, 912′ in FIG. 9) (e.g., FQDNs may be used to discover the IP address of the LDS (e.g., 705 in FIG. 7; 812, 812′ in FIG. 8; 912, 912′ in FIG. 9)). In aspects, the LDS (e.g., 705 in FIG. 7; 812, 812′ in FIG. 8; 912, 912′ in FIG. 9) server address may be configured by a PCF, and the AUE 602 (e.g., 402 in FIG. 4; 502 in FIG. 5; 702 in FIG. 7; 806, 810 in FIG. 8; 906, 910 in FIG. 9) may be configured with an LDS (e.g., 705 in FIG. 7; 812, 812′ in FIG. 8; 912, 912′ in FIG. 9) anycast address that the AUE 602 (e.g., 402 in FIG. 4; 502 in FIG. 5; 702 in FIG. 7; 806, 810 in FIG. 8; 906, 910 in FIG. 9) may utilize to discover the LDS (e.g., 705 in FIG. 7; 812, 812′ in FIG. 8; 912, 912′ in FIG. 9).

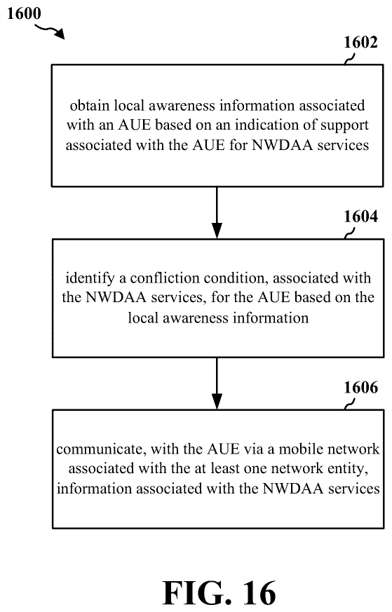

FIG. 16 is a flowchart 1600 of a method of wireless communication. The method may be performed by a network entity(ies)/a network node(s) (e.g., the base station 102, 816, 816′, 916, 916′; network entities of the mobile network 404; the SMF 162, 505, 832, 932; the AMF 161, 605, 830, 930; the LDS 705, 812, 812′, 912, 912′; the network entity 1902, 2060) of a mobile network. In some aspects, the method may include aspects described in connection with the communication flows in FIGS. 4, 5, 6, 7, and/or aspects described in FIGS. 8, 9. The method may be for network-assisted DAA for AUEs. The method may provide for improved DAA by enabling an AUE to report NWDAA capabilities and be authenticated for utilization of a network-based LDS with predictive deconfliction and multi-source information gathering capabilities.

At 1602, the at least one network entity obtains local awareness information associated with an AUE based on an indication of support associated with the AUE for NWDAA services. As an example, the obtainment may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 obtaining such local awareness information for an AUE (e.g., the AUE 702).

The LDS 705 (e.g., 812, 812′ in FIG. 8; 912, 912′ in FIG. 9) may be configured to obtain (at 706) local awareness information associated with the AUE 702 (e.g., 402 in FIG. 4; 502 in FIG. 5; 602 in FIG. 6; 806, 810 in FIG. 8; 906, 910 in FIG. 9) based on an indication of support associated with the AUE 702 (e.g., 402 in FIG. 4; 502 in FIG. 5; 602 in FIG. 6; 806, 810 in FIG. 8; 906, 910 in FIG. 9) for NWDAA services. As described herein, an AUE, e.g., the AUE 702 (e.g., 402 in FIG. 4; 502 in FIG. 5; 602 in FIG. 6; 806, 810 in FIG. 8; 906, 910 in FIG. 9), may be configured to establish a network connection with a mobile network, e.g., the mobile network 704 (e.g., 404 in FIG. 4; 504 in FIG. 5; 604 in FIG. 6; 804 in FIG. 8; 904 in FIG. 9), and be authenticated for an LDS/NWDAA services via an AMF (e.g., 605 in FIG. 6; 830 in FIG. 8; 930 in FIG. 9)/SMF (e.g., 505 in FIG. 5; 832 in FIG. 8; 932 in FIG. 9) based on a capability indication (e.g., 408 in FIG. 4; 508 in FIG. 5; 608 in FIG. 6).

In the mobile network 704 (e.g., 404 in FIG. 4; 504 in FIG. 5; 604 in FIG. 6; 804 in FIG. 8; 904 in FIG. 9), for the CN (e.g., 820 in FIG. 8; 920 in FIG. 9) to RAN (e.g., 404 in FIG. 4; 504 in FIG. 5; 604 in FIG. 6; 704 in FIG. 7; 818 in FIG. 8; 918 in FIG. 9) communications associated with LDS/NWDAA services support, layer 2 communications may be utilized to activate RAN-LDS connectivity, and layer 2/layer 3 communications may be utilized to activate the RAN (e.g., 404 in FIG. 4; 504 in FIG. 5; 604 in FIG. 6; 704 in FIG. 7; 818 in FIG. 8; 918 in FIG. 9) to report to the LDS 705 (e.g., 812, 812′ in FIG. 8; 912, 912′ in FIG. 9). For instance, upon AUE 702 (e.g., 402 in FIG. 4; 502 in FIG. 5; 602 in FIG. 6; 806, 810 in FIG. 8; 906, 910 in FIG. 9) registration, if the AUE 702 (e.g., 402 in FIG. 4; 502 in FIG. 5; 602 in FIG. 6; 806, 810 in FIG. 8; 906, 910 in FIG. 9) subscription is for an aerial UE and the AMF (e.g., 605 in FIG. 6; 830 in FIG. 8; 930 in FIG. 9) successfully authenticates the AUE 702 (e.g., 402 in FIG. 4; 502 in FIG. 5; 602 in FIG. 6; 806, 810 in FIG. 8; 906, 910 in FIG. 9), then the AMF (e.g., 605 in FIG. 6; 830 in FIG. 8; 930 in FIG. 9) may indicate to the RAN (e.g., 404 in FIG. 4; 504 in FIG. 5; 604 in FIG. 6; 704 in FIG. 7; 818 in FIG. 8; 918 in FIG. 9) whether the LDS 705 (e.g., 812, 812′ in FIG. 8; 912, 912′ in FIG. 9) is authorized for the AUE 702. In aspects, the indication by the AMF (e.g., 605 in FIG. 6; 830 in FIG. 8; 930 in FIG. 9) of the LDS 705 (e.g., 812, 812′ in FIG. 8; 912, 912′ in FIG. 9) authorization for the AUE 702 (e.g., 402 in FIG. 4; 502 in FIG. 5; 602 in FIG. 6; 806, 810 in FIG. 8; 906, 910 in FIG. 9) may be based on a successful UUAA authentication/authorization, and/or if the AUE 702 (e.g., 402 in FIG. 4; 502 in FIG. 5; 602 in FIG. 6; 806, 810 in FIG. 8; 906, 910 in FIG. 9) has indicated in 5GMM capabilities that it supports the LDS 705 (e.g., 812, 812′ in FIG. 8; 912, 912′ in FIG. 9) service. In cases for which a UUAA-SM is performed, the SMF (e.g., 505 in FIG. 5; 832 in FIG. 8; 932 in FIG. 9) may be configured to indicate to the RAN (e.g., 404 in FIG. 4; 504 in FIG. 5; 604 in FIG. 6; 704 in FIG. 7; 818 in FIG. 8; 918 in FIG. 9) by adding a new indication in 5G access network (AN) (e.g., 404 in FIG. 4; 504 in FIG. 5; 604 in FIG. 6; 804 in FIG. 8; 904 in FIG. 9) to SMF (e.g., 505 in FIG. 5; 832 in FIG. 8; 932 in FIG. 9) (N2 SM) messaging whether the LDS 705 (e.g., 812, 812′ in FIG. 8; 912, 912′ in FIG. 9) is authorized for the AUE 702 (e.g., 402 in FIG. 4; 502 in FIG. 5; 602 in FIG. 6; 806, 810 in FIG. 8; 906, 910 in FIG. 9) after UUAA-SM completion. When the LDS 705 (e.g., 812, 812′ in FIG. 8; 912, 912′ in FIG. 9) service is activated in the RAN (e.g., 404 in FIG. 4; 504 in FIG. 5; 604 in FIG. 6; 704 in FIG. 7; 818 in FIG. 8; 918 in FIG. 9), the RAN (e.g., 404 in FIG. 4; 504 in FIG. 5; 604 in FIG. 6; 704 in FIG. 7; 818 in FIG. 8; 918 in FIG. 9) may generate information from sensors (e.g., 814 in FIG. 8; 914 in FIG. 9) and provide the information to the LDS 705 (e.g., 812, 812′ in FIG. 8; 912, 912′ in FIG. 9) based on an operations administration and maintenance (OAM) configuration. Sensors (e.g., 814 in FIG. 8; 914 in FIG. 9) may be RAN (e.g., 404 in FIG. 4; 504 in FIG. 5; 604 in FIG. 6; 704 in FIG. 7; 818 in FIG. 8; 918 in FIG. 9) sensing capabilities, BRID receivers, ADS-B receivers, DAA broadcast receivers, weather sensors, LIDAR, RADAR, SONAR, NR sensing capabilities, and/or the like. For layer 2 implementations, the RAN (e.g., 404 in FIG. 4; 504 in FIG. 5; 604 in FIG. 6; 704 in FIG. 7; 818 in FIG. 8; 918 in FIG. 9) may be preconfigured with the serving LDS information and have connectivity with the LDS 705 (e.g., 812, 812′ in FIG. 8; 912, 912′ in FIG. 9). In aspects, such a configuration may be performed by the OAM, where the OAM provides to each RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9) the address of the LDS 705 (e.g., 812, 812′ in FIG. 8; 912, 912′ in FIG. 9) to be used.

The LDS 705 (e.g., 812, 812′ in FIG. 8; 912, 912′ in FIG. 9) may be configured to create local awareness (e.g., local awareness information associated with the AUE 702 (e.g., 402 in FIG. 4; 502 in FIG. 5; 602 in FIG. 6; 806, 810 in FIG. 8; 906, 910 in FIG. 9)) based on RAN (e.g., 404 in FIG. 4; 504 in FIG. 5; 604 in FIG. 6; 704 in FIG. 7; 818 in FIG. 8; 918 in FIG. 9) sensing information from one or more of the sensors (e.g., 814 in FIG. 8; 914 in FIG. 9) noted herein, e.g., listening to DAA messages, BRID (Broadcast remote ID) messages, having access to other sensors (e.g., 814 in FIG. 8; 914 in FIG. 9) (e.g. ADS-B, RADAR, LIDAR, SONAR, AUE 702 (e.g., 402 in FIG. 4; 502 in FIG. 5; 602 in FIG. 6; 806, 810 in FIG. 8; 906, 910 in FIG. 9) positioning, NR) sensing information, etc.). In aspects, obtaining (at 706) the local awareness information by the LDS 705 (e.g., 812, 812′ in FIG. 8; 912, 912′ in FIG. 9) may include receiving information from the AUE 702 (e.g., 402 in FIG. 4; 502 in FIG. 5; 602 in FIG. 6; 806, 810 in FIG. 8; 906, 910 in FIG. 9). In other words, the local awareness (e.g., local awareness information associated with the AUE 702 (e.g., 402 in FIG. 4; 502 in FIG. 5; 602 in FIG. 6; 806, 810 in FIG. 8; 906, 910 in FIG. 9)) obtained (at 706) by the LDS 705 (e.g., 812, 812′ in FIG. 8; 912, 912′ in FIG. 9) may be a network-based aggregation of sensor (e.g., 814 in FIG. 8; 914 in FIG. 9) and other information from a wide variety of sources both within the mobile network 704 (e.g., 404 in FIG. 4; 504 in FIG. 5; 604 in FIG. 6; 804 in FIG. 8; 904 in FIG. 9) and outside of it.

At 1604, the at least one network entity identifies a confliction condition, associated with the NWDAA services, for the AUE based on the local awareness information. As an example, the identification may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 identifying such a confliction condition for an AUE (e.g., the AUE 702).

The mobile network 704 (e.g., 404 in FIG. 4; 504 in FIG. 5; 604 in FIG. 6; 804 in FIG. 8; 904 in FIG. 9) and the LDS 705 (e.g., 812, 812′ in FIG. 8; 912, 912′ in FIG. 9), and/or the AUE 702 (e.g., 402 in FIG. 4; 502 in FIG. 5; 602 in FIG. 6; 806, 810 in FIG. 8; 906, 910 in FIG. 9), may be configured to identify/detect (at 708) indicia of a conflict scenario (e.g., a confliction condition) associated with the AUE 702 (e.g., 402 in FIG. 4; 502 in FIG. 5; 602 in FIG. 6; 806, 810 in FIG. 8; 906, 910 in FIG. 9) and/or with a different AUE (e.g., 806, 808, 810 in FIG. 8; 906, 908, 910 in FIG. 9). That is, the LDS 705 (e.g., 812, 812′ in FIG. 8; 912, 912′ in FIG. 9) may be configured to identify a confliction condition, associated with the NWDAA services, for the AUE 702 (e.g., 402 in FIG. 4; 502 in FIG. 5; 602 in FIG. 6; 806, 810 in FIG. 8; 906, 910 in FIG. 9) based on the local awareness information. In one example, the AUE 702 (e.g., 402 in FIG. 4; 502 in FIG. 5; 602 in FIG. 6; 806, 810 in FIG. 8; 906, 910 in FIG. 9) may be configured to obtain local awareness information associated with the AUE 702 (e.g., 402 in FIG. 4; 502 in FIG. 5; 602 in FIG. 6; 806, 810 in FIG. 8; 906, 910 in FIG. 9) (e.g., from the LDS 705 (e.g., 812, 812′ in FIG. 8; 912, 912′ in FIG. 9) and/or from sensors (e.g., 814 in FIG. 8; 914 in FIG. 9), etc., of the AUE 702 (e.g., 402 in FIG. 4; 502 in FIG. 5; 602 in FIG. 6; 806, 810 in FIG. 8; 906, 910 in FIG. 9), and to identify a confliction condition, associated with the NWDAA services, for the AUE 702 (e.g., 402 in FIG. 4; 502 in FIG. 5; 602 in FIG. 6; 806, 810 in FIG. 8; 906, 910 in FIG. 9) based on the local awareness information.

For instance, the AUE 702 (e.g., 402 in FIG. 4; 502 in FIG. 5; 602 in FIG. 6; 806, 810 in FIG. 8; 906, 910 in FIG. 9) may be configured to trigger an early detection to the LDS 705 (e.g., 812, 812′ in FIG. 8; 912, 912′ in FIG. 9) of the mobile network 704 (e.g., 404 in FIG. 4; 504 in FIG. 5; 604 in FIG. 6; 804 in FIG. 8; 904 in FIG. 9). The AUE 702 (e.g., 402 in FIG. 4; 502 in FIG. 5; 602 in FIG. 6; 806, 810 in FIG. 8; 906, 910 in FIG. 9) may comprise onboard processing/intelligence (e.g., a computational function) for conflict/confliction detection and/or awareness, and may be configured to report such conflict/confliction detection and/or awareness to the LDS 705 (e.g., 812, 812′ in FIG. 8; 912, 912′ in FIG. 9). In aspects, the AUE 702 (e.g., 402 in FIG. 4; 502 in FIG. 5; 602 in FIG. 6; 806, 810 in FIG. 8; 906, 910 in FIG. 9) may perform continuous reporting or conditional reporting (e.g., the AUE 702 (e.g., 402 in FIG. 4; 502 in FIG. 5; 602 in FIG. 6; 806, 810 in FIG. 8; 906, 910 in FIG. 9) may be configured by the LDS 705 (e.g., 812, 812′ in FIG. 8; 912, 912′ in FIG. 9) to do one and/or the other, under what conditions, etc.). The AUE 702 (e.g., 402 in FIG. 4; 502 in FIG. 5; 602 in FIG. 6; 806, 810 in FIG. 8; 906, 910 in FIG. 9) may receive, from the LDS 705 (e.g., 812, 812′ in FIG. 8; 912, 912′ in FIG. 9), configuration information on reporting to the LDS 705 (e.g., 812, 812′ in FIG. 8; 912, 912′ in FIG. 9) when a session is established with the LDS 705 (e.g., 812, 812′ in FIG. 8; 912, 912′ in FIG. 9). Additionally, the AUE 702 (e.g., 402 in FIG. 4; 502 in FIG. 5; 602 in FIG. 6; 806, 810 in FIG. 8; 906, 910 in FIG. 9) may request deconfliction from the LDS 705 (e.g., 812, 812′ in FIG. 8; 912, 912′ in FIG. 9).

As another example, the LDS 705 (e.g., 812, 812′ in FIG. 8; 912, 912′ in FIG. 9) of the mobile network 704 (e.g., 404 in FIG. 4; 504 in FIG. 5; 604 in FIG. 6; 804 in FIG. 8; 904 in FIG. 9) may be configured to trigger warnings to the AUE 702 (e.g., 402 in FIG. 4; 502 in FIG. 5; 602 in FIG. 6; 806, 810 in FIG. 8; 906, 910 in FIG. 9). The LDS 705 (e.g., 812, 812′ in FIG. 8; 912, 912′ in FIG. 9) may be configured to create local awareness (e.g., local awareness information) based on RAN (e.g., 404 in FIG. 4; 504 in FIG. 5; 604 in FIG. 6; 704 in FIG. 7; 818 in FIG. 8; 918 in FIG. 9) sensing information, listening to DAA messages, BRID (Broadcast remote ID) messages, having access to sensors (e.g., 814 in FIG. 8; 914 in FIG. 9) (e.g. ADS-B, RADAR, LIDAR, SONAR, AUE 702 (e.g., 402 in FIG. 4; 502 in FIG. 5; 602 in FIG. 6; 806, 810 in FIG. 8; 906, 910 in FIG. 9) positioning, NR) sensing information, etc.). The LDS 705 (e.g., 812, 812′ in FIG. 8; 912, 912′ in FIG. 9) may send such information to the AUE 702 to enhance situational awareness of AUE 702 (e.g., 402 in FIG. 4; 502 in FIG. 5; 602 in FIG. 6; 806, 810 in FIG. 8; 906, 910 in FIG. 9), yet detection and deconfliction may be performed in AUE 702 (e.g., 402 in FIG. 4; 502 in FIG. 5; 602 in FIG. 6; 806, 810 in FIG. 8; 906, 910 in FIG. 9) for warnings (e.g., the LDS 705 (e.g., 812, 812′ in FIG. 8; 912, 912′ in FIG. 9) may provide deconfliction suggestions/strategies, and the AUE 702 (e.g., 402 in FIG. 4; 502 in FIG. 5; 602 in FIG. 6; 806, 810 in FIG. 8; 906, 910 in FIG. 9) chooses the appropriate one by implementation or configuration information/policies provided by either a UAS operator or a USS system (e.g., 828 in FIG. 8; 928 in FIG. 9), e.g., depending on geographic regulations).

As another example, the LDS 705 (e.g., 812, 812′ in FIG. 8; 912, 912′ in FIG. 9) may be configured to trigger emergency directives/path directives (e.g., deconfliction directives, generally) to the AUE 702 (e.g., 402 in FIG. 4; 502 in FIG. 5; 602 in FIG. 6; 806, 810 in FIG. 8; 906, 910 in FIG. 9) and/or a UAVC (or the AUE 702 (e.g., 402 in FIG. 4; 502 in FIG. 5; 602 in FIG. 6; 806, 810 in FIG. 8; 906, 910 in FIG. 9)) may inform the UAVC itself. In such aspects, the detection and deconfliction may be performed in the LDS 705 (e.g., 812, 812′ in FIG. 8; 912, 912′ in FIG. 9). In some aspects, detection may be based on the AUE 702 (e.g., 402 in FIG. 4; 502 in FIG. 5; 602 in FIG. 6; 806, 810 in FIG. 8; 906, 910 in FIG. 9) request for the deconfliction, or may be based on the intelligence (e.g., local awareness) of the LDS 705 (e.g., 812, 812′ in FIG. 8; 912, 912′ in FIG. 9), or both. In some aspects, the AUE 702 (e.g., 402 in FIG. 4; 502 in FIG. 5; 602 in FIG. 6; 806, 810 in FIG. 8; 906, 910 in FIG. 9) and the UAVC follow the command for deconfliction from the LDS 705 (e.g., 812, 812′ in FIG. 8; 912, 912′ in FIG. 9) in the case of an emergency directive.

At 1606, the at least one network entity communicates, with the AUE via a mobile network associated with the at least one network entity, information associated with the NWDAA services. As an example, the communication may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 communicating such information with an AUE (e.g., the AUE 702).

The mobile network 704 (e.g., 404 in FIG. 4; 504 in FIG. 5; 604 in FIG. 6; 804 in FIG. 8; 904 in FIG. 9) (e.g., by at least one instance of the LDS 705 (e.g., 812, 812′ in FIG. 8; 912, 912′ in FIG. 9)) and/or the AUE 702 (e.g., 402 in FIG. 4; 502 in FIG. 5; 602 in FIG. 6; 806, 810 in FIG. 8; 906, 910 in FIG. 9) may be configured to communicate communication information 710 associated with the NWDAA services. In aspects, the communication information 710 may be any information associated with the NWDAA services and/or the LDS 705 (e.g., 812, 812′ in FIG. 8; 912, 912′ in FIG. 9), as described herein. In aspects for AUE-LDS communications, the LDS 705 (e.g., 812, 812′ in FIG. 8; 912, 912′ in FIG. 9) may operate as a passive LDS receiver or as an active LDS receiver.

As a passive LDS receiver, LDS nodes such as the LDS 705 (e.g., 812, 812′ in FIG. 8; 912, 912′ in FIG. 9) may receive U2X information (e.g. DAA, BRID) sent by AUEs such as the AUE 702 (e.g., 402 in FIG. 4; 502 in FIG. 5; 602 in FIG. 6; 806, 810 in FIG. 8; 906, 910 in FIG. 9): sidelink receivers in a base station/gNB (e.g., 816, 816′ in FIG. 8; 916, 916′ in FIG. 9) may be configured to receive such information; a base station/gNB (e.g., 816, 816′ in FIG. 8; 916, 916′ in FIG. 9) (RAN (e.g., 404 in FIG. 4; 504 in FIG. 5; 604 in FIG. 6; 704 in FIG. 7; 818 in FIG. 8; 918 in FIG. 9)) may report received BRID (e.g., 814′ in FIG. 8; 914′ in FIG. 9) and/or DAA signaling sent by AUEs (e.g., 402 in FIG. 4; 502 in FIG. 5; 602 in FIG. 6; 806, 808, 810 in FIG. 8; 906, 908, 910 in FIG. 9) to the LDS 705 (e.g., 812, 812′ in FIG. 8; 912, 912′ in FIG. 9) covering the base station/gNB (e.g., 816, 816′ in FIG. 8; 916, 916′ in FIG. 9) area. In such aspects, a RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9) may be configured with the identity/address of the one or more of the LDS 705 (e.g., 812, 812′ in FIG. 8; 912, 912′ in FIG. 9) serving the area of the RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9). Such configurations may leverage information already available via LTE/NR aerial features (e.g., path reporting). The LDS 705 (e.g., 812, 812′ in FIG. 8; 912, 912′ in FIG. 9) may receive ADS-B information from manned aviation: this may leverage receivers in the base station/gNB (e.g., 816, 816′ in FIG. 8; 916, 916′ in FIG. 9) that report ADS-B traffic to the LDS 705 (e.g., 812, 812′ in FIG. 8; 912, 912′ in FIG. 9).

As an active LDS receiver, the AUE 702 (e.g., 402 in FIG. 4; 502 in FIG. 5; 602 in FIG. 6; 806, 810 in FIG. 8; 906, 910 in FIG. 9) may be configured to send information directly and explicitly to the LDS 705 (e.g., 812, 812′ in FIG. 8; 912, 912′ in FIG. 9) (e.g., location, flight path, etc.). The AUE 702 (e.g., 402 in FIG. 4; 502 in FIG. 5; 602 in FIG. 6; 806, 810 in FIG. 8; 906, 910 in FIG. 9) may be configured to trigger an early detection to the LDS 705 (e.g., 812, 812′ in FIG. 8; 912, 912′ in FIG. 9), e.g., the AUE 702 (e.g., 402 in FIG. 4; 502 in FIG. 5; 602 in FIG. 6; 806, 810 in FIG. 8; 906, 910 in FIG. 9) may be configured to detect locally a possible conflict and report it to the LDS 705 (e.g., 812, 812′ in FIG. 8; 912, 912′ in FIG. 9) (e.g., including information received from other AUEs e.g., 806, 808, 810 in FIG. 8; 906, 908, 910 in FIG. 9), including AUE ID(s), path, etc.), and either: (i) includes its planned deconfliction strategy (e.g., a trajectory change) that the UAS may compute autonomously, or (ii) includes a request for a “guided” trajectory change, which the LDS 705 (e.g., 812, 812′ in FIG. 8; 912, 912′ in FIG. 9) may compute and report back. The AUE 702 (e.g., 402 in FIG. 4; 502 in FIG. 5; 602 in FIG. 6; 806, 810 in FIG. 8; 906, 910 in FIG. 9) may also be configured to report to the LDS 705 (e.g., 812, 812′ in FIG. 8; 912, 912′ in FIG. 9) that the conflict is cleared subsequent to the conflict being cleared.

In aspects for LDS-AUE communications, the LDS 705 (e.g., 812, 812′ in FIG. 8; 912, 912′ in FIG. 9) may be configured to trigger warnings to the AUE 702 (e.g., 402 in FIG. 4; 502 in FIG. 5; 602 in FIG. 6; 806, 810 in FIG. 8; 906, 910 in FIG. 9). A potential conflict detection in the LDS 705 (e.g., 812, 812′ in FIG. 8; 912, 912′ in FIG. 9) may trigger a warning and potential de-escalation/de-conflictions instructions to the AUE 702 (e.g., 402 in FIG. 4; 502 in FIG. 5; 602 in FIG. 6; 806, 810 in FIG. 8; 906, 910 in FIG. 9), if requested, or if proximity thresholds are violated (e.g., are met). In aspects, the LDS 705 (e.g., 812, 812′ in FIG. 8; 912, 912′ in FIG. 9) may be configured to trigger an emergency directive to the AUE 702 (e.g., 402 in FIG. 4; 502 in FIG. 5; 602 in FIG. 6; 806, 810 in FIG. 8; 906, 910 in FIG. 9). A conflict/confliction detection (e.g., a critical conflict/confliction detection) in the LDS 705 (e.g., 812, 812′ in FIG. 8; 912, 912′ in FIG. 9) may trigger a path directive (e.g., a non-emergency deconfliction) or an emergency directive (e.g., an urgent emergency deconfliction) to the AUE 702 (e.g., 402 in FIG. 4; 502 in FIG. 5; 602 in FIG. 6; 806, 810 in FIG. 8; 906, 910 in FIG. 9). A path directive may include information associated with a new flight path that the LDS 705 (e.g., 812, 812′ in FIG. 8; 912, 912′ in FIG. 9) may have received from the UTM system (e.g., 826 in FIG. 8; 926 in FIG. 9)/the USS system (e.g., 828 in FIG. 8; 928 in FIG. 9). An emergency directive may include an imminent collision status message with basic metadata about the other aircraft(s)/UAV(s) and may include multiple deconfliction solutions/strategies that are presented. In aspects, such a set of deconfliction solutions/strategies may be scored (e.g., prioritized) and may be provided to the UAS. The UAS, or its controller, may then consider the options and execute one (or more) based on its own knowledge and sensor (e.g., 814 in FIG. 8; 914 in FIG. 9) status, by way of example.

Based on local policies or USS (e.g., 828 in FIG. 8; 928 in FIG. 9) configuration, a warning may be sent under specific conditions (e.g. an AUE category like drone AUE size or mission type, e.g. public safety versus package delivery), an AUE size, an AUE class, a mission type, a public safety priority, or a delivery priority. The LDS 705 (e.g., 812, 812′ in FIG. 8; 912, 912′ in FIG. 9) may be configured to receive configuration information for the specific AUE or class of AUE (e.g., either by the AUE 702 (e.g., 402 in FIG. 4; 502 in FIG. 5; 602 in FIG. 6; 806, 810 in FIG. 8; 906, 910 in FIG. 9) providing its AUE ID explicitly, or the LDS 705 (e.g., 812, 812′ in FIG. 8; 912, 912′ in FIG. 9), based on the received AUE ID broadcasted by the AUE, may derive the specific AUE information, or the LDS 705 (e.g., 812, 812′ in FIG. 8; 912, 912′ in FIG. 9) may receive the information from the UAS NF (e.g., 822 in FIG. 8; 922 in FIG. 9), which receives the information during the AUE 702 (e.g., 402 in FIG. 4; 502 in FIG. 5; 602 in FIG. 6; 806, 810 in FIG. 8; 906, 910 in FIG. 9) registration with the mobile network operator (MNO) from the USS (e.g., 828 in FIG. 8; 928 in FIG. 9)).

In aspects for LDS-AUE communications, model of communication may be direct or indirect. In a direct model, a C2 link may be sent by the LDS 705 (e.g., 812, 812′ in FIG. 8; 912, 912′ in FIG. 9) to the AUE 702 (e.g., 402 in FIG. 4; 502 in FIG. 5; 602 in FIG. 6; 806, 810 in FIG. 8; 906, 910 in FIG. 9). In an indirect model, if the LDS 705 (e.g., 812, 812′ in FIG. 8; 912, 912′ in FIG. 9) is aware of the UAVC, either the LDS 705 (e.g., 812, 812′ in FIG. 8; 912, 912′ in FIG. 9) informs UAVC, or the AUE 702 (e.g., 402 in FIG. 4; 502 in FIG. 5; 602 in FIG. 6; 806, 810 in FIG. 8; 906, 910 in FIG. 9) informs the UAVC over the C2 link.

In aspects for AUE-LDS connectivity, the LDS 705 (e.g., 812, 812′ in FIG. 8; 912, 912′ in FIG. 9) connectivity may be layer 3 connectivity at the application layer, e.g., the user plane. For example, the AUE 702 (e.g., 402 in FIG. 4; 502 in FIG. 5; 602 in FIG. 6; 806, 810 in FIG. 8; 906, 910 in FIG. 9) may be configured to establish a session with the LDS 705 (e.g., 812, 812′ in FIG. 8; 912, 912′ in FIG. 9) upon (i) discovering the LDS 705 (e.g., 812, 812′ in FIG. 8; 912, 912′ in FIG. 9) is supported, and (ii) discovering LDS 705 (e.g., 812, 812′ in FIG. 8; 912, 912′ in FIG. 9), as noted herein. The AUE 702 (e.g., 402 in FIG. 4; 502 in FIG. 5; 602 in FIG. 6; 806, 810 in FIG. 8; 906, 910 in FIG. 9) may be provided, in NAS registration messages, with information regarding the LDS 705 (e.g., 812, 812′ in FIG. 8; 912, 912′ in FIG. 9) server discovery (e.g., the server address), or the AUE 702 (e.g., 402 in FIG. 4; 502 in FIG. 5; 602 in FIG. 6; 806, 810 in FIG. 8; 906, 910 in FIG. 9) may be pre-configured with information regarding the LDS 705 (e.g., 812, 812′ in FIG. 8; 912, 912′ in FIG. 9) such as, but without limitation, an IP address, a URL, an FQDN, or an anycast address of the LDS 705 (e.g., 812, 812′ in FIG. 8; 912, 912′ in FIG. 9) (e.g., FQDNs may be used to discover the IP address of the LDS 705 (e.g., 812, 812′ in FIG. 8; 912, 912′ in FIG. 9)).

In aspects, an AMF (e.g., 605 in FIG. 6; 830 in FIG. 8; 930 in FIG. 9) may provide such information upon determining that the AUE 702 (e.g., 402 in FIG. 4; 502 in FIG. 5; 602 in FIG. 6; 806, 810 in FIG. 8; 906, 910 in FIG. 9) has an aerial subscription, has indicated its NWDAA/LDS 705 (e.g., 812, 812′ in FIG. 8; 912, 912′ in FIG. 9) capability, and is an authorized AUE (e.g., an UAS service supplier (USS) authentication and authorization (UUAA)/procedure has been performed successfully, when UUAA is supported and/or mandated). The LDS 705 (e.g., 812, 812′ in FIG. 8; 912, 912′ in FIG. 9) server address may be provided via a PDU session establishment/PDN connection establishment procedure upon successful UUAA-SM by an SMF (e.g., 505 in FIG. 5; 832 in FIG. 8; 932 in FIG. 9) when LDS 705 (e.g., 812, 812′ in FIG. 8; 912, 912′ in FIG. 9) information is in the UDM (e.g., provided by the LDS 705 (e.g., 812, 812′ in FIG. 8; 912, 912′ in FIG. 9) provider, whether it is the MNO or a third party, and is configured via an API via the NEF (e.g., 824 in FIG. 8; 924 in FIG. 9)). In aspects, the LDS 705 (e.g., 812, 812′ in FIG. 8; 912, 912′ in FIG. 9) server address may be configured by a policy control function (PCF), and the AUE 702 (e.g., 402 in FIG. 4; 502 in FIG. 5; 602 in FIG. 6; 806, 810 in FIG. 8; 906, 910 in FIG. 9) may be configured with an LDS (e.g., 705 in FIG. 7; 812, 812′ in FIG. 8; 912, 912′ in FIG. 9) anycast address that the AUE 702 (e.g., 402 in FIG. 4; 502 in FIG. 5; 602 in FIG. 6; 806, 810 in FIG. 8; 906, 910 in FIG. 9) may utilize to discover the LDS 705 (e.g., 812, 812′ in FIG. 8; 912, 912′ in FIG. 9).

In aspects, a session may be moved to a new LDS (e.g., an LDS instance similar to the LDS 705 (e.g., 812, 812′ in FIG. 8; 912, 912′ in FIG. 9)) based on edge server re-allocation procedures. In some aspects, a dedicated access point name (APN)/data network name (DNN) may be defined for this service, and/or the AUE 702 (e.g., 402 in FIG. 4; 502 in FIG. 5; 602 in FIG. 6; 806, 810 in FIG. 8; 906, 910 in FIG. 9) may be configured by the USS (e.g., 828 in FIG. 8; 928 in FIG. 9) and/or the MNO with respect to the APN/DNN to use upon successful authorization.

As described herein, the LDS 705 (e.g., 812, 812′ in FIG. 8; 912, 912′ in FIG. 9) may be deployed as an edge-node (e.g., as an edge application server), in aspects.

In aspects for AUE-LDS connectivity, the LDS 705 (e.g., 812, 812′ in FIG. 8; 912, 912′ in FIG. 9) connectivity may be layer 2 connectivity at the application layer, e.g., the user plane. For example, the LDS 705 (e.g., 812, 812′ in FIG. 8; 912, 912′ in FIG. 9) may be deployed as a RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9)/function (e.g., 505 in FIG. 5; 605 in FIG. 6; 822, 824, 830, 832 in FIG. 8; 922, 924, 930, 932 in FIG. 9). The AUE 702 (e.g., 402 in FIG. 4; 502 in FIG. 5; 602 in FIG. 6; 806, 810 in FIG. 8; 906, 910 in FIG. 9) may be configured to communicate with the LDS 705 (e.g., 812, 812′ in FIG. 8; 912, 912′ in FIG. 9) via RAN (e.g., 404 in FIG. 4; 504 in FIG. 5; 604 in FIG. 6; 704 in FIG. 7; 818 in FIG. 8; 918 in FIG. 9) signaling (e.g., by RRC transport messages) to report/warn, as well as to receive warnings and deconfliction directives. For RRC messages containing LDS-related data, the AUE 702 (e.g., 402 in FIG. 4; 502 in FIG. 5; 602 in FIG. 6; 806, 810 in FIG. 8; 906, 910 in FIG. 9) may be configured to send RRC signaling with an explicit indication for LDS 705 (e.g., 812, 812′ in FIG. 8; 912, 912′ in FIG. 9)/DWDAA services, so that the RAN (e.g., 404 in FIG. 4; 504 in FIG. 5; 604 in FIG. 6; 704 in FIG. 7; 818 in FIG. 8; 918 in FIG. 9) routes the signaling payload to the correct server (e.g., via a new value for “payload type” specific to this scenario for the AUE 702 (e.g., 402 in FIG. 4; 502 in FIG. 5; 602 in FIG. 6; 806, 810 in FIG. 8; 906, 910 in FIG. 9)).

In aspects for LDS-AUE communication with respect to a serving cell(s) (e.g., Cell 1, Cell 2, Cell 3 in FIGS. 8, 9), the LDS 705 (e.g., 812, 812′ in FIG. 8; 912, 912′ in FIG. 9) may be configured to determine the serving cell(s) (e.g., Cell 1, Cell 2, Cell 3 in FIGS. 8, 9) of the AUE 702 (e.g., 402 in FIG. 4; 502 in FIG. 5; 602 in FIG. 6; 806, 810 in FIG. 8; 906, 910 in FIG. 9). For layer 2 communications, in aspects, the LDS 705 (e.g., 812, 812′ in FIG. 8; 912, 912′ in FIG. 9) may be configured to utilize a “paging area” concept, e.g., the LDS 705 (e.g., 812, 812′ in FIG. 8; 912, 912′ in FIG. 9) may be configured to send the information to the AUE 702 (e.g., 402 in FIG. 4; 502 in FIG. 5; 602 in FIG. 6; 806, 810 in FIG. 8; 906, 910 in FIG. 9) in multiple cells (e.g., Cell 1, Cell 2, Cell 3 in FIGS. 8, 9), which may be identified based on configuration information or corresponding to the paging area. In other layer 2 aspects, as long as the LDS 705 (e.g., 812, 812′ in FIG. 8; 912, 912′ in FIG. 9) knows or is aware of the serving base station/gNB (e.g., 816, 816′ in FIG. 8; 916, 916′ in FIG. 9) of the AUE 702 (e.g., 402 in FIG. 4; 502 in FIG. 5; 602 in FIG. 6; 806, 810 in FIG. 8; 906, 910 in FIG. 9), the LDS 705 (e.g., 812, 812′ in FIG. 8; 912, 912′ in FIG. 9) may be configured to send the information to the base station/gNB (e.g., 816, 816′ in FIG. 8; 916, 916′ in FIG. 9) that sends the information to all the serving cells (e.g., Cell 1, Cell 2, Cell 3 in FIGS. 8, 9) (e.g., not a specific cell, but a specific RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9)).

In aspects for AUE-LDS connectivity, the LDS 705 (e.g., 812, 812′ in FIG. 8; 912, 912′ in FIG. 9) connectivity may be layer 3 connectivity at the control plane. For example, the LDS 705 (e.g., 812, 812′ in FIG. 8; 912, 912′ in FIG. 9) may be deployed as a local application server that is integrated with a local NEF (e.g., 824 in FIG. 8; 924 in FIG. 9). The AUE 702 (e.g., 402 in FIG. 4; 502 in FIG. 5; 602 in FIG. 6; 806, 810 in FIG. 8; 906, 910 in FIG. 9) may be configured to communicate with the LDS 705 (e.g., 812, 812′ in FIG. 8; 912, 912′ in FIG. 9) via control plane Cellular Internet of Things (CIoT) communications to report/warn, as well as to receive warning and deconfliction directives. As an example, the communications may start at the AUE 702 (e.g., 402 in FIG. 4; 502 in FIG. 5; 602 in FIG. 6; 806, 810 in FIG. 8; 906, 910 in FIG. 9) and be sent via the AMF (e.g., 605 in FIG. 6; 830 in FIG. 8; 930 in FIG. 9) to a local NEF (e.g., 824 in FIG. 8; 924 in FIG. 9)/the LDS 705 (e.g., 812, 812′ in FIG. 8; 912, 912′ in FIG. 9). In aspects, an existing NEF (e.g., 824 in FIG. 8; 924 in FIG. 9) API (e.g., a non-IP data delivery) may be utilized. The data payload may be defined, e.g., XML schema for DAA operation, and the local NEF (e.g., 824 in FIG. 8; 924 in FIG. 9) concept can be utilized, e.g., to reduce delay. In aspects, when a serving NEF (e.g., 824 in FIG. 8; 924 in FIG. 9)/LDS (e.g., 705 in FIG. 7; 812, 812′ in FIG. 8; 912, 912′ in FIG. 9) changes, a Non-IP Data Delivery (NIDD) connection path may be established with the serving AMF (e.g., 605 in FIG. 6; 830 in FIG. 8; 930 in FIG. 9).

In some aspects, the AMF (e.g., 605 in FIG. 6; 830 in FIG. 8; 930 in FIG. 9) may support control plane CIOT and NIDD APIs, and the NEF-LDS interface may not have to be specified, e.g., it may be integrated. Additionally, there may be no impact on L2 signaling in such aspects, which may be used for access by the AUE 702 (e.g., 402 in FIG. 4; 502 in FIG. 5; 602 in FIG. 6; 806, 810 in FIG. 8; 906, 910 in FIG. 9) to other services using data traffic, and hop-by-hop security may be guaranteed, in such aspects.

Aspects further provide for additional enhancements to the UAS NF (e.g., 822 in FIG. 8; 922 in FIG. 9)/NEF (e.g., 824 in FIG. 8; 924 in FIG. 9) services to support NWDAA and the LDS 705 (e.g., 812, 812′ in FIG. 8; 912, 912′ in FIG. 9). The AUE 702 (e.g., 402 in FIG. 4; 502 in FIG. 5; 602 in FIG. 6; 806, 810 in FIG. 8; 906, 910 in FIG. 9) may be capable of NWDAA support, and may provide an indication of its support at the application layer during a UUAA procedure to the USS system (e.g., 828 in FIG. 8; 928 in FIG. 9), as described herein, and the AUE 702 (e.g., 402 in FIG. 4; 502 in FIG. 5; 602 in FIG. 6; 806, 810 in FIG. 8; 906, 910 in FIG. 9) may be configured to include its LDS capability indication (e.g., 408 in FIG. 4; 508 in FIG. 5; 608 in FIG. 6) to the USS system (e.g., 828 in FIG. 8; 928 in FIG. 9). Upon a successful UUAA procedure, the USS system (e.g., 828 in FIG. 8; 928 in FIG. 9) may provide to the UAS NF (e.g., 822 in FIG. 8; 922 in FIG. 9) an indication that NWDAA services are authorized. The LDS 705 (e.g., 812, 812′ in FIG. 8; 912, 912′ in FIG. 9) may also interact with the USS system (e.g., 828 in FIG. 8; 928 in FIG. 9) to report detected UAS conflicts, e.g., as for the AUE 702 (e.g., 402 in FIG. 4; 502 in FIG. 5; 602 in FIG. 6; 806, 810 in FIG. 8; 906, 910 in FIG. 9), and corrective action to the USS system (e.g., 828 in FIG. 8; 928 in FIG. 9). An interface may be defined between the LDS 705 (e.g., 812, 812′ in FIG. 8; 912, 912′ in FIG. 9) to the NEF (e.g., 824 in FIG. 8; 924 in FIG. 9)/UAS NF (e.g., 822 in FIG. 8; 922 in FIG. 9) to trigger signaling to the USS system (e.g., 828 in FIG. 8; 928 in FIG. 9).

Even when the LDS 705 (e.g., 812, 812′ in FIG. 8; 912, 912′ in FIG. 9) is not aware of the serving USS system (e.g., 828 in FIG. 8; 928 in FIG. 9) (e.g., no information about the serving USS system (e.g., 828 in FIG. 8; 928 in FIG. 9) is provided to the LDS, nor has the LDS 705 (e.g., 812, 812′ in FIG. 8; 912, 912′ in FIG. 9) discovered the serving USS system (e.g., 828 in FIG. 8; 928 in FIG. 9)), and given that the USS system (e.g., 828 in FIG. 8; 928 in FIG. 9) may not be aware of the LDS 705 (e.g., 812, 812′ in FIG. 8; 912, 912′ in FIG. 9) serving a given AUE (e.g., the AUE 702 (e.g., 402 in FIG. 4; 502 in FIG. 5; 602 in FIG. 6; 806, 810 in FIG. 8; 906, 910 in FIG. 9)), the LDS 705 (e.g., 812, 812′ in FIG. 8; 912, 912′ in FIG. 9) may be configured to communicate with the UAS NF (e.g., 822 in FIG. 8; 922 in FIG. 9), which communicates with the USS system (e.g., 828 in FIG. 8; 928 in FIG. 9).

The AUE 702 (e.g., 402 in FIG. 4; 502 in FIG. 5; 602 in FIG. 6; 806, 810 in FIG. 8; 906, 910 in FIG. 9) may be configured to communicate with the LDS 705 (e.g., 812, 812′ in FIG. 8; 912, 912′ in FIG. 9) by providing the current clear channel assessment (CAA)-Level UAV ID for the AUE 702 (e.g., 402 in FIG. 4; 502 in FIG. 5; 602 in FIG. 6; 806, 810 in FIG. 8; 906, 910 in FIG. 9), and the LDS 705 (e.g., 812, 812′ in FIG. 8; 912, 912′ in FIG. 9) may be configured to utilize the CAA-Level UAV ID to discover the serving UAS NF (e.g., 822 in FIG. 8; 922 in FIG. 9) and provide the information together with the CAA-level UAV ID(s) of the AUEs in conflict, e.g., the AUE 702 (e.g., 402 in FIG. 4; 502 in FIG. 5; 602 in FIG. 6; 806, 810 in FIG. 8; 906, 910 in FIG. 9). The UAS NF (e.g., 822 in FIG. 8; 922 in FIG. 9) may then forward such information to the USS system(s) (e.g., 828 in FIG. 8; 928 in FIG. 9) serving the AUE 702 (e.g., 402 in FIG. 4; 502 in FIG. 5; 602 in FIG. 6; 806, 810 in FIG. 8; 906, 910 in FIG. 9) associated with the CAA-Level UAV ID(s) received from the LDS 705 (e.g., 812, 812′ in FIG. 8; 912, 912′ in FIG. 9). The USS system (e.g., 828 in FIG. 8; 928 in FIG. 9) may be configured to leverage the NEF (e.g., 824 in FIG. 8; 924 in FIG. 9) to push information and policies, and/or the like, to the LDS 705 (e.g., 812, 812′ in FIG. 8; 912, 912′ in FIG. 9). Accordingly, a new Nnef service (e.g., 824 in FIG. 8; 924 in FIG. 9) is introduced, in aspects.

Regarding the relationship between the LDS 705 (e.g., 812, 812′ in FIG. 8; 912, 912′ in FIG. 9) and the USS system (e.g., 828 in FIG. 8; 928 in FIG. 9), the USS system (e.g., 828 in FIG. 8; 928 in FIG. 9), upon authorization of a flight plan for the AUE 702 (e.g., 402 in FIG. 4; 502 in FIG. 5; 602 in FIG. 6; 806, 810 in FIG. 8; 906, 910 in FIG. 9) in a UUAA procedure, may provide the approved flight-related information to the MNO to the UAS NF (e.g., 822 in FIG. 8; 922 in FIG. 9) in the authorization response. The LDS 705 (e.g., 812, 812′ in FIG. 8; 912, 912′ in FIG. 9) may be configured, at any time, to retrieve at least a portion, or all, of the approved flight plan relevant to the LDS 705 coverage area, a wider portion thereof, to assist the LDS 705 (e.g., 812, 812′ in FIG. 8; 912, 912′ in FIG. 9) in obtaining a fuller awareness in addition to what the AUE 702 (e.g., 402 in FIG. 4; 502 in FIG. 5; 602 in FIG. 6; 806, 810 in FIG. 8; 906, 910 in FIG. 9) reports to the LDS 705 (e.g., 812, 812′ in FIG. 8; 912, 912′ in FIG. 9). The LDS 705 (e.g., 812, 812′ in FIG. 8; 912, 912′ in FIG. 9) may utilize an NEF service (e.g., 824 in FIG. 8; 924 in FIG. 9) to request the flight plan by providing, as examples, the AUE 702 (e.g., 402 in FIG. 4; 502 in FIG. 5; 602 in FIG. 6; 806, 810 in FIG. 8; 906, 910 in FIG. 9) location or an “area of interest” (e.g., expressed in serving Cell IDs or geographic coordinates (e.g., Cell 1, Cell 2, Cell 3 in FIGS. 8, 9), etc.) to retrieve the portion relevant to the AUE 702 (e.g., 402 in FIG. 4; 502 in FIG. 5; 602 in FIG. 6; 806, 810 in FIG. 8; 906, 910 in FIG. 9) location. In aspects, the LDS 705 (e.g., 812, 812′ in FIG. 8; 912, 912′ in FIG. 9) may be configured to report to the USS (e.g., 828 in FIG. 8; 928 in FIG. 9) if the LDS 705 (e.g., 812, 812′ in FIG. 8; 912, 912′ in FIG. 9) was not, but becomes, the serving LDS for the AUE 702 (e.g., 402 in FIG. 4; 502 in FIG. 5; 602 in FIG. 6; 806, 810 in FIG. 8; 906, 910 in FIG. 9). In aspects, the cardinality for the LDS: USS relationship associated with the AUE 702 (e.g., 402 in FIG. 4; 502 in FIG. 5; 602 in FIG. 6; 806, 810 in FIG. 8; 906, 910 in FIG. 9) may be N:1.

In aspects, the new Nnef service noted above may be associated with a service description. The service description may be to enable the consumer to report information or to subscribe to notification for the Service Level Device Identity. In case of UAS, the service is used report information or to subscribe to notification for the UAV identified by a CAA-Level UAV ID. The Nnef service may include service operations, such as but not limited to, an Nnef authentication report (“Nnef_Authentication_Report”) service operation and an Nnef authentication register (“Nnef_Authentication_Register”) service operation. In aspects, the Nnef authentication report service operation may have a service operation name: Nnef_Authentication_Report, and may provide the LDS-related information related to one or more Service Level Device Identity(s). As input, the Nnef authentication report service operation may receive one or more of: one or more <Service Level Device Identity (i.e. CAA-Level UAV ID), GPSI> pairs; an NF Type; conflict information; a notification endpoint (e.g., for an initial authentication request); a DNN; a S-NSSAI (e.g., in case the consumer NF is SMF (e.g., 832 in FIG. 8; 932 in FIG. 9)); an information container provided by UE; or a UAV location. As output, the Nnef authentication report service operation may provide: a success/failure indication. In aspects, the Nnef authentication register service operation may have a service operation name: Nnef_Authentication_Register, and may provide consumer registration with the NEF (e.g., 824 in FIG. 8; 924 in FIG. 9) for a service level device identity. As input, the Nnef authentication register service may receive one or more of: a service level device identity, a GPSI, or a registration reason (e.g. serving LDS (e.g., 705 in FIG. 7; 812, 812′ in FIG. 8; 912, 912′ in FIG. 9) registering first time). As output, the Nnef authentication register service may output an acknowledge indication.

In aspects for discovery of the LDS 705 (e.g., 812, 812′ in FIG. 8; 912, 912′ in FIG. 9) by the UAS NF (e.g., 822 in FIG. 8; 922 in FIG. 9), the UAS NF (e.g., 822 in FIG. 8; 922 in FIG. 9) may be configured to discover the LDS 705 (e.g., 812, 812′ in FIG. 8; 912, 912′ in FIG. 9) as the serving LDS for the AUE 702 (e.g., 402 in FIG. 4; 502 in FIG. 5; 602 in FIG. 6; 806, 810 in FIG. 8; 906, 910 in FIG. 9). This may be performed, by way of example, based on the AUE 702 (e.g., 402 in FIG. 4; 502 in FIG. 5; 602 in FIG. 6; 806, 810 in FIG. 8; 906, 910 in FIG. 9) location tracking, with mapping between the cell ID and the serving LDS; or when the LDS 705 (e.g., 812, 812′ in FIG. 8; 912, 912′ in FIG. 9) is serving the AUE 702 (e.g., 402 in FIG. 4; 502 in FIG. 5; 602 in FIG. 6; 806, 810 in FIG. 8; 906, 910 in FIG. 9), the LDS 705 (e.g., 812, 812′ in FIG. 8; 912, 912′ in FIG. 9), as the serving LDS, may be configured to register with the UAS NF (e.g., 822 in FIG. 8; 922 in FIG. 9) for a specific AUE, e.g., the AUE 702 (e.g., 402 in FIG. 4; 502 in FIG. 5; 602 in FIG. 6; 806, 810 in FIG. 8; 906, 910 in FIG. 9), (the AUE 702 (e.g., 402 in FIG. 4; 502 in FIG. 5; 602 in FIG. 6; 806, 810 in FIG. 8; 906, 910 in FIG. 9) may indicate to the LDS 705 (e.g., 812, 812′ in FIG. 8; 912, 912′ in FIG. 9) the Service Layer ID of the AUE 702 (e.g., 402 in FIG. 4; 502 in FIG. 5; 602 in FIG. 6; 806, 810 in FIG. 8; 906, 910 in FIG. 9), e.g. the CAA-Level UAV ID). In some aspects, if a UUAA is performed for the AUE 702 (e.g., 402 in FIG. 4; 502 in FIG. 5; 602 in FIG. 6; 806, 810 in FIG. 8; 906, 910 in FIG. 9), the entity running the UUAA procedure may provide the serving LDS (e.g., 812, 812′ in FIG. 8; 912, 912′ in FIG. 9) information (e.g., information associated with the LDS 705 (e.g., 812, 812′ in FIG. 8; 912, 912′ in FIG. 9)) to the UAS NF (e.g., 822 in FIG. 8; 922 in FIG. 9). For a UUAA-MM performed by an AMF (e.g., 605 in FIG. 6; 830 in FIG. 8; 930 in FIG. 9), the AMF (e.g., 605 in FIG. 6; 830 in FIG. 8; 930 in FIG. 9) may be configured to provide information associated with the LDS 705 (e.g., 812, 812′ in FIG. 8; 912, 912′ in FIG. 9), as the serving LDS, directly to the UAS NF (e.g., 822 in FIG. 8; 922 in FIG. 9). For a UUAA-SM, if the AMF (e.g., 605 in FIG. 6; 830 in FIG. 8; 930 in FIG. 9) selects the serving LDS, e.g., the LDS 705 (e.g., 812, 812′ in FIG. 8; 912, 912′ in FIG. 9), the AMF (e.g., 605 in FIG. 6; 830 in FIG. 8; 930 in FIG. 9) may provide such information to an SMF (e.g., 832 in FIG. 8; 932 in FIG. 9), and the SMF (e.g., 832 in FIG. 8; 932 in FIG. 9) may provide or relay the information in the UUAA-SM signaling to the UAS NF (e.g., 822 in FIG. 8; 922 in FIG. 9).

In aspects, USS (e.g., 828 in FIG. 8; 928 in FIG. 9) provisioning of LDS (e.g., 812, 812′ in FIG. 8; 912, 912′ in FIG. 9) information to a UDM may be configured/performed. For example, a new service may be provided for a USS system (e.g., 828 in FIG. 8; 928 in FIG. 9) to provide a drone/AUE “category” or “type” to the UDM, so that this information may be utilized, in addition to other mechanisms, to decide whether to activate the LDS 705 (e.g., 812, 812′ in FIG. 8; 912, 912′ in FIG. 9) or not. In aspects, this information may be propagated in the mobile network 704 (e.g., 404 in FIG. 4; 504 in FIG. 5; 604 in FIG. 6; 804 in FIG. 8; 904 in FIG. 9) (e.g., to an AMF (e.g., 605 in FIG. 6; 830 in FIG. 8; 930 in FIG. 9), to a RAN (e.g., 404 in FIG. 4; 504 in FIG. 5; 604 in FIG. 6; 704 in FIG. 7; 818 in FIG. 8; 918 in FIG. 9), to the LDS 705 (e.g., 812, 812′ in FIG. 8; 912, 912′ in FIG. 9), etc.) to enable the LDS 705 (e.g., 812, 812′ in FIG. 8; 912, 912′ in FIG. 9) to have the correct information when activating and executing DAA operations, as described herein.

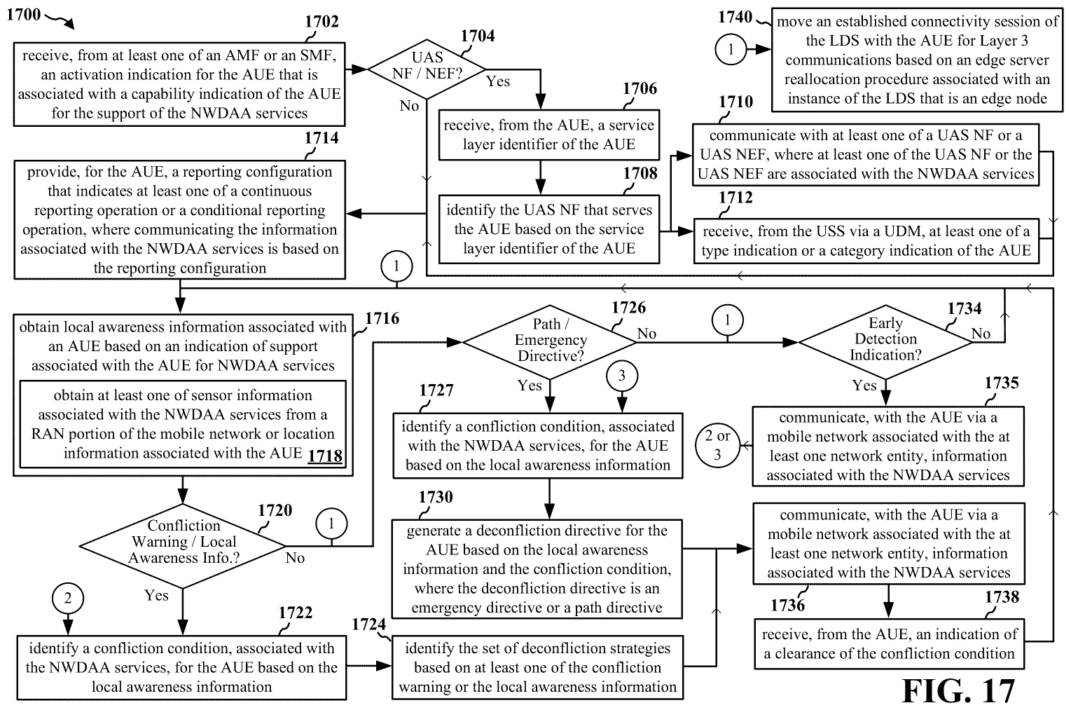

FIG. 17 is a flowchart 1700 of a method of wireless communication. The method may be performed by a network entity(ies)/a network node(s) (e.g., the base station 102, 816, 816′, 916, 916′; network entities of the mobile network 404; the SMF 162, 505, 832, 932; the AMF 161, 605, 830, 930; the LDS 705, 812, 812′, 912, 912′; the network entity 1902, 2060) of a mobile network. In some aspects, the method may include aspects described in connection with the communication flows in FIGS. 4, 5, 6, 7, and/or aspects described in FIGS. 8, 9. The method may be for network-assisted DAA for AUEs. The method may provide for improved DAA by enabling an AUE to report NWDAA capabilities and be authenticated for utilization of a network-based LDS with predictive deconfliction and multi-source information gathering capabilities.

At 1702, the at least one network entity receives, from at least one of an AMF or an SMF, an activation indication for the AUE that is associated with a capability indication of the AUE for the support of the NWDAA services. As an example, the reception may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 receiving such an activation indication from an AMF/SMF.

In the mobile network 704 (e.g., 404 in FIG. 4; 504 in FIG. 5; 604 in FIG. 6; 804 in FIG. 8; 904 in FIG. 9), for the CN (e.g., 820 in FIG. 8; 920 in FIG. 9) to RAN (e.g., 404 in FIG. 4; 504 in FIG. 5; 604 in FIG. 6; 704 in FIG. 7; 818 in FIG. 8; 918 in FIG. 9) communications associated with LDS/NWDAA services support, layer 2 communications may be utilized to activate RAN-LDS connectivity, and layer 2/layer 3 communications may be utilized to activate the RAN (e.g., 404 in FIG. 4; 504 in FIG. 5; 604 in FIG. 6; 704 in FIG. 7; 818 in FIG. 8; 918 in FIG. 9) to report to the LDS 705 (e.g., 812, 812′ in FIG. 8; 912, 912′ in FIG. 9). For instance, upon AUE 702 (e.g., 402 in FIG. 4; 502 in FIG. 5; 602 in FIG. 6; 806, 810 in FIG. 8; 906, 910 in FIG. 9) registration, if the AUE 702 (e.g., 402 in FIG. 4; 502 in FIG. 5; 602 in FIG. 6; 806, 810 in FIG. 8; 906, 910 in FIG. 9) subscription is for an aerial UE and the AMF (e.g., 605 in FIG. 6; 830 in FIG. 8; 930 in FIG. 9) successfully authenticates the AUE 702 (e.g., 402 in FIG. 4; 502 in FIG. 5; 602 in FIG. 6; 806, 810 in FIG. 8; 906, 910 in FIG. 9), then the AMF (e.g., 605 in FIG. 6; 830 in FIG. 8; 930 in FIG. 9) may indicate to the RAN (e.g., 404 in FIG. 4; 504 in FIG. 5; 604 in FIG. 6; 704 in FIG. 7; 818 in FIG. 8; 918 in FIG. 9) whether the LDS 705 (e.g., 812, 812′ in FIG. 8; 912, 912′ in FIG. 9) is authorized for the AUE 702. In aspects, the indication by the AMF (e.g., 605 in FIG. 6; 830 in FIG. 8; 930 in FIG. 9) of the LDS 705 (e.g., 812, 812′ in FIG. 8; 912, 912′ in FIG. 9) authorization for the AUE 702 (e.g., 402 in FIG. 4; 502 in FIG. 5; 602 in FIG. 6; 806, 810 in FIG. 8; 906, 910 in FIG. 9) may be based on a successful UUAA authentication/authorization, and/or if the AUE 702 (e.g., 402 in FIG. 4; 502 in FIG. 5; 602 in FIG. 6; 806, 810 in FIG. 8; 906, 910 in FIG. 9) has indicated in 5GMM capabilities that it supports the LDS 705 (e.g., 812, 812′ in FIG. 8; 912, 912′ in FIG. 9) service. In cases for which a UUAA-SM is performed, the SMF (e.g., 505 in FIG. 5; 832 in FIG. 8; 932 in FIG. 9) may be configured to indicate to the RAN (e.g., 404 in FIG. 4; 504 in FIG. 5; 604 in FIG. 6; 704 in FIG. 7; 818 in FIG. 8; 918 in FIG. 9) by adding a new indication in 5G access network (AN) (e.g., 404 in FIG. 4; 504 in FIG. 5; 604 in FIG. 6; 804 in FIG. 8; 904 in FIG. 9) to SMF (e.g., 505 in FIG. 5; 832 in FIG. 8; 932 in FIG. 9) (N2 SM) messaging whether the LDS 705 (e.g., 812, 812′ in FIG. 8; 912, 912′ in FIG. 9) is authorized for the AUE 702 (e.g., 402 in FIG. 4; 502 in FIG. 5; 602 in FIG. 6; 806, 810 in FIG. 8; 906, 910 in FIG. 9) after UUAA-SM completion. When the LDS 705 (e.g., 812, 812′ in FIG. 8; 912, 912′ in FIG. 9) service is activated in the RAN (e.g., 404 in FIG. 4; 504 in FIG. 5; 604 in FIG. 6; 704 in FIG. 7; 818 in FIG. 8; 918 in FIG. 9), the RAN (e.g., 404 in FIG. 4; 504 in FIG. 5; 604 in FIG. 6; 704 in FIG. 7; 818 in FIG. 8; 918 in FIG. 9) may generate information from sensors (e.g., 814 in FIG. 8; 914 in FIG. 9) and provide the information to the LDS 705 (e.g., 812, 812′ in FIG. 8; 912, 912′ in FIG. 9) based on an operations administration and maintenance (OAM) configuration.

At 1704, it is determined if communications comprise utilizing a UAS NF/NEF. If so, flowchart 1700 may continue to 1706; if not, flowchart 1700 may continue to 1716. As an example, the determination may be performed by one or more of the component 199, the transceiver 2146, and/or the antenna 2180 in FIG. 21, the network interface 2280 in FIG. 22.

At 1706, the at least one network entity receives, from the AUE, a service layer identifier of the AUE. As an example, the reception may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 receiving such an identifier from an AUE (e.g., the AUE 702).

In aspects for discovery of the LDS 705 (e.g., 812, 812′ in FIG. 8; 912, 912′ in FIG. 9) by the UAS NF (e.g., 822 in FIG. 8; 922 in FIG. 9), the UAS NF (e.g., 822 in FIG. 8; 922 in FIG. 9) may be configured to discover the LDS 705 (e.g., 812, 812′ in FIG. 8; 912, 912′ in FIG. 9) as the serving LDS for the AUE 702 (e.g., 402 in FIG. 4; 502 in FIG. 5; 602 in FIG. 6; 806, 810 in FIG. 8; 906, 910 in FIG. 9). This may be performed, by way of example, based on the AUE 702 (e.g., 402 in FIG. 4; 502 in FIG. 5; 602 in FIG. 6; 806, 810 in FIG. 8; 906, 910 in FIG. 9) location tracking, with mapping between the cell ID and the serving LDS; or when the LDS 705 (e.g., 812, 812′ in FIG. 8; 912, 912′ in FIG. 9) is serving the AUE 702 (e.g., 402 in FIG. 4; 502 in FIG. 5; 602 in FIG. 6; 806, 810 in FIG. 8; 906, 910 in FIG. 9), the LDS 705 (e.g., 812, 812′ in FIG. 8; 912, 912′ in FIG. 9), as the serving LDS, may be configured to register with the UAS NF (e.g., 822 in FIG. 8; 922 in FIG. 9) for a specific AUE, e.g., the AUE 702 (e.g., 402 in FIG. 4; 502 in FIG. 5; 602 in FIG. 6; 806, 810 in FIG. 8; 906, 910 in FIG. 9) (the AUE 702 (e.g., 402 in FIG. 4; 502 in FIG. 5; 602 in FIG. 6; 806, 810 in FIG. 8; 906, 910 in FIG. 9) may indicate to the LDS 705 (e.g., 812, 812′ in FIG. 8; 912, 912′ in FIG. 9) the Service Layer ID of the AUE 702 (e.g., 402 in FIG. 4; 502 in FIG. 5; 602 in FIG. 6; 806, 810 in FIG. 8; 906, 910 in FIG. 9), e.g. the CAA-Level UAV ID).

At 1708, the at least one network entity identifies the UAS NF that serves the AUE based on the service layer identifier of the AUE. As an example, the identification may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 identifying such a UAS NF.

The AUE 702 (e.g., 402 in FIG. 4; 502 in FIG. 5; 602 in FIG. 6; 806, 810 in FIG. 8; 906, 910 in FIG. 9) may be configured to communicate with the LDS 705 (e.g., 812, 812′ in FIG. 8; 912, 912′ in FIG. 9) by providing the current clear channel assessment (CAA)-Level UAV ID for the AUE 702 (e.g., 402 in FIG. 4; 502 in FIG. 5; 602 in FIG. 6; 806, 810 in FIG. 8; 906, 910 in FIG. 9), and the LDS 705 (e.g., 812, 812′ in FIG. 8; 912, 912′ in FIG. 9) may be configured to utilize the CAA-Level UAV ID to discover the serving UAS NF (e.g., 822 in FIG. 8; 922 in FIG. 9) and provide the information together with the CAA-level UAV ID(s) of the AUEs in conflict, e.g., the AUE 702 (e.g., 402 in FIG. 4; 502 in FIG. 5; 602 in FIG. 6; 806, 810 in FIG. 8; 906, 910 in FIG. 9). The UAS NF (e.g., 822 in FIG. 8; 922 in FIG. 9) may then forward such information to the USS system(s) (e.g., 828 in FIG. 8; 928 in FIG. 9) serving the AUE 702 (e.g., 402 in FIG. 4; 502 in FIG. 5; 602 in FIG. 6; 806, 810 in FIG. 8; 906, 910 in FIG. 9) associated with the CAA-Level UAV ID(s) received from the LDS 705 (e.g., 812, 812′ in FIG. 8; 912, 912′ in FIG. 9). The USS system (e.g., 828 in FIG. 8; 928 in FIG. 9) may be configured to leverage the NEF (e.g., 824 in FIG. 8; 924 in FIG. 9) to push information and policies, and/or the like, to the LDS 705 (e.g., 812, 812′ in FIG. 8; 912, 912′ in FIG. 9). Accordingly, a new Nnef service (e.g., 824 in FIG. 8; 924 in FIG. 9) is introduced, in aspects.

At 1710, the at least one network entity communicates with at least one of a UAS NF or a UAS NEF, where at least one of the UAS NF or the UAS NEF are associated with the NWDAA services. As an example, the communication may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 communicating with a UAS NF/UAS NEF.

Regarding the relationship between the LDS 705 (e.g., 812, 812′ in FIG. 8; 912, 912′ in FIG. 9) and the USS system (e.g., 828 in FIG. 8; 928 in FIG. 9), the USS system (e.g., 828 in FIG. 8; 928 in FIG. 9), upon authorization of a flight plan for the AUE 702 (e.g., 402 in FIG. 4; 502 in FIG. 5; 602 in FIG. 6; 806, 810 in FIG. 8; 906, 910 in FIG. 9) in a UUAA procedure, may provide the approved flight-related information to the MNO to the UAS NF (e.g., 822 in FIG. 8; 922 in FIG. 9) in the authorization response. The LDS 705 (e.g., 812, 812′ in FIG. 8; 912, 912′ in FIG. 9) may be configured, at any time, to retrieve at least a portion, or all, of the approved flight plan relevant to the LDS 705 coverage area, a wider portion thereof, to assist the LDS 705 (e.g., 812, 812′ in FIG. 8; 912, 912′ in FIG. 9) in obtaining a fuller awareness in addition to what the AUE 702 (e.g., 402 in FIG. 4; 502 in FIG. 5; 602 in FIG. 6; 806, 810 in FIG. 8; 906, 910 in FIG. 9) reports to the LDS 705 (e.g., 812, 812′ in FIG. 8; 912, 912′ in FIG. 9). The LDS 705 (e.g., 812, 812′ in FIG. 8; 912, 912′ in FIG. 9) may utilize an NEF service (e.g., 824 in FIG. 8; 924 in FIG. 9) to request the flight plan by providing, as examples, the AUE 702 (e.g., 402 in FIG. 4; 502 in FIG. 5; 602 in FIG. 6; 806, 810 in FIG. 8; 906, 910 in FIG. 9) location or an “area of interest” (e.g., expressed in serving Cell IDs or geographic coordinates (e.g., Cell 1, Cell 2, Cell 3 in FIGS. 8, 9), etc.) to retrieve the portion relevant to the AUE 702 (e.g., 402 in FIG. 4; 502 in FIG. 5; 602 in FIG. 6; 806, 810 in FIG. 8; 906, 910 in FIG. 9) location. In aspects, the LDS 705 (e.g., 812, 812′ in FIG. 8; 912, 912′ in FIG. 9) may be configured to report to the USS (e.g., 828 in FIG. 8; 928 in FIG. 9) if the LDS 705 (e.g., 812, 812′ in FIG. 8; 912, 912′ in FIG. 9) was not, but becomes, the serving LDS for the AUE 702 (e.g., 402 in FIG. 4; 502 in FIG. 5; 602 in FIG. 6; 806, 810 in FIG. 8; 906, 910 in FIG. 9). In aspects, the cardinality for the LDS: USS relationship associated with the AUE 702 (e.g., 402 in FIG. 4; 502 in FIG. 5; 602 in FIG. 6; 806, 810 in FIG. 8; 906, 910 in FIG. 9) may be N:1.

In aspects, the new Nnef service noted above may be associated with a service description. The service description may be to enable the consumer to report information or to subscribe to notification for the Service Level Device Identity. In case of UAS, the service is used report information or to subscribe to notification for the UAV identified by a CAA-Level UAV ID. The Nnef service may include service operations, such as but not limited to, an Nnef authentication report (“Nnef_Authentication_Report”) service operation and an Nnef authentication register (“Nnef_Authentication_Register”) service operation. In aspects, the Nnef authentication report service operation may have a service operation name: Nnef_Authentication_Report, and may provide the LDS-related information related to one or more Service Level Device Identity(s). As input, the Nnef authentication report service operation may receive one or more of: one or more <Service Level Device Identity (i.e. CAA-Level UAV ID), GPSI> pairs; an NF Type; conflict information; a notification endpoint (e.g., for an initial authentication request); a DNN; a S-NSSAI (e.g., in case the consumer NF is SMF (e.g., 832 in FIG. 8; 932 in FIG. 9)); an information container provided by UE; or a UAV location. As output, the Nnef authentication report service operation may provide: a success/failure indication. In aspects, the Nnef authentication register service operation may have a service operation name: Nnef_Authentication_Register, and may provide consumer registration with the NEF (e.g., 824 in FIG. 8; 924 in FIG. 9) for a service level device identity. As input, the Nnef authentication register service may receive one or more of: a service level device identity, a GPSI, or a registration reason (e.g. serving LDS (e.g., 705 in FIG. 7; 812, 812′ in FIG. 8; 912, 912′ in FIG. 9) registering first time). As output, the Nnef authentication register service may output an acknowledge indication.

In aspects for discovery of the LDS 705 (e.g., 812, 812′ in FIG. 8; 912, 912′ in FIG. 9) by the UAS NF (e.g., 822 in FIG. 8; 922 in FIG. 9), the UAS NF (e.g., 822 in FIG. 8; 922 in FIG. 9) may be configured to discover the LDS 705 (e.g., 812, 812′ in FIG. 8; 912, 912′ in FIG. 9) as the serving LDS for the AUE 702 (e.g., 402 in FIG. 4; 502 in FIG. 5; 602 in FIG. 6; 806, 810 in FIG. 8; 906, 910 in FIG. 9). This may be performed, by way of example, based on the AUE 702 (e.g., 402 in FIG. 4; 502 in FIG. 5; 602 in FIG. 6; 806, 810 in FIG. 8; 906, 910 in FIG. 9) location tracking, with mapping between the cell ID and the serving LDS; or when the LDS 705 (e.g., 812, 812′ in FIG. 8; 912, 912′ in FIG. 9) is serving the AUE 702 (e.g., 402 in FIG. 4; 502 in FIG. 5; 602 in FIG. 6; 806, 810 in FIG. 8; 906, 910 in FIG. 9), the LDS 705 (e.g., 812, 812′ in FIG. 8; 912, 912′ in FIG. 9), as the serving LDS, may be configured to register with the UAS NF (e.g., 822 in FIG. 8; 922 in FIG. 9) for a specific AUE, e.g., the AUE 702 (e.g., 402 in FIG. 4; 502 in FIG. 5; 602 in FIG. 6; 806, 810 in FIG. 8; 906, 910 in FIG. 9) (the AUE 702 (e.g., 402 in FIG. 4; 502 in FIG. 5; 602 in FIG. 6; 806, 810 in FIG. 8; 906, 910 in FIG. 9) may indicate to the LDS 705 (e.g., 812, 812′ in FIG. 8; 912, 912′ in FIG. 9) the Service Layer ID of the AUE 702 (e.g., 402 in FIG. 4; 502 in FIG. 5; 602 in FIG. 6; 806, 810 in FIG. 8; 906, 910 in FIG. 9), e.g. the CAA-Level UAV ID). In some aspects, if a UUAA is performed for the AUE 702 (e.g., 402 in FIG. 4; 502 in FIG. 5; 602 in FIG. 6; 806, 810 in FIG. 8; 906, 910 in FIG. 9), the entity running the UUAA procedure may provide the serving LDS (e.g., 812, 812′ in FIG. 8; 912, 912′ in FIG. 9) information (e.g., information associated with the LDS 705 (e.g., 812, 812′ in FIG. 8; 912, 912′ in FIG. 9)) to the UAS NF (e.g., 822 in FIG. 8; 922 in FIG. 9). For a UUAA-MM performed by an AMF (e.g., 605 in FIG. 6; 830 in FIG. 8; 930 in FIG. 9), the AMF (e.g., 605 in FIG. 6; 830 in FIG. 8; 930 in FIG. 9) may be configured to provide information associated with the LDS 705 (e.g., 812, 812′ in FIG. 8; 912, 912′ in FIG. 9), as the serving LDS, directly to the UAS NF (e.g., 822 in FIG. 8; 922 in FIG. 9). For a UUAA-SM, if the AMF (e.g., 605 in FIG. 6; 830 in FIG. 8; 930 in FIG. 9) selects the serving LDS, e.g., the LDS 705 (e.g., 812, 812′ in FIG. 8; 912, 912′ in FIG. 9), the AMF (e.g., 605 in FIG. 6; 830 in FIG. 8; 930 in FIG. 9) may provide such information to an SMF (e.g., 832 in FIG. 8; 932 in FIG. 9), and the SMF (e.g., 832 in FIG. 8; 932 in FIG. 9) may provide or relay the information in the UUAA-SM signaling to the UAS NF (e.g., 822 in FIG. 8; 922 in FIG. 9).

At 1712, the at least one network entity receives, from the USS via a UDM, at least one of a type indication or a category indication of the AUE. As an example, the reception may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 receiving such an indication(s) from a USS.

In aspects, USS (e.g., 828 in FIG. 8; 928 in FIG. 9) provisioning of LDS (e.g., 812, 812′ in FIG. 8; 912, 912′ in FIG. 9) information to a UDM may be configured/performed. For example, a new service may be provided for a USS system (e.g., 828 in FIG. 8; 928 in FIG. 9) to provide a drone/AUE “category” or “type” to the UDM, so that this information may be utilized, in addition to other mechanisms, to decide whether to activate the LDS 705 (e.g., 812, 812′ in FIG. 8; 912, 912′ in FIG. 9) or not. In aspects, this information may be propagated in the mobile network 704 (e.g., 404 in FIG. 4; 504 in FIG. 5; 604 in FIG. 6; 804 in FIG. 8; 904 in FIG. 9) (e.g., to an AMF (e.g., 605 in FIG. 6; 830 in FIG. 8; 930 in FIG. 9), to a RAN (e.g., 404 in FIG. 4; 504 in FIG. 5; 604 in FIG. 6; 704 in FIG. 7; 818 in FIG. 8; 918 in FIG. 9), to the LDS 705 (e.g., 812, 812′ in FIG. 8; 912, 912′ in FIG. 9), etc.) to enable the LDS 705 (e.g., 812, 812′ in FIG. 8; 912, 912′ in FIG. 9) to have the correct information when activating and executing DAA operations, as described herein.

At 1714, the at least one network entity provides, for the AUE, a reporting configuration that indicates at least one of a continuous reporting operation or a conditional reporting operation, where communicating the information associated with the NWDAA services is based on the reporting configuration. As an example, the provision may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 providing such a configuration for an AUE (e.g., the AUE 702).

The AUE 702 (e.g., 402 in FIG. 4; 502 in FIG. 5; 602 in FIG. 6; 806, 810 in FIG. 8; 906, 910 in FIG. 9) may receive, from the LDS 705 (e.g., 812, 812′ in FIG. 8; 912, 912′ in FIG. 9), configuration information on reporting to the LDS 705 (e.g., 812, 812′ in FIG. 8; 912, 912′ in FIG. 9) when a session is established with the LDS 705 (e.g., 812, 812′ in FIG. 8; 912, 912′ in FIG. 9). Additionally, the AUE 702 (e.g., 402 in FIG. 4; 502 in FIG. 5; 602 in FIG. 6; 806, 810 in FIG. 8; 906, 910 in FIG. 9) may request deconfliction from the LDS 705 (e.g., 812, 812′ in FIG. 8; 912, 912′ in FIG. 9). In aspects, the AUE 702 (e.g., 402 in FIG. 4; 502 in FIG. 5; 602 in FIG. 6; 806, 810 in FIG. 8; 906, 910 in FIG. 9) may perform continuous reporting or conditional reporting (e.g., the AUE 702 (e.g., 402 in FIG. 4; 502 in FIG. 5; 602 in FIG. 6; 806, 810 in FIG. 8; 906, 910 in FIG. 9) may be configured by the LDS 705 (e.g., 812, 812′ in FIG. 8; 912, 912′ in FIG. 9) to do one and/or the other, under what conditions, etc.).

At 1716, the at least one network entity obtains local awareness information associated with an AUE based on an indication of support associated with the AUE for NWDAA services. As an example, the obtainment may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 obtaining such local awareness information for an AUE (e.g., the AUE 702).

The LDS 705 (e.g., 812, 812′ in FIG. 8; 912, 912′ in FIG. 9) may be configured to obtain (at 706) local awareness information associated with the AUE 702 (e.g., 402 in FIG. 4; 502 in FIG. 5; 602 in FIG. 6; 806, 810 in FIG. 8; 906, 910 in FIG. 9) based on an indication of support associated with the AUE 702 (e.g., 402 in FIG. 4; 502 in FIG. 5; 602 in FIG. 6; 806, 810 in FIG. 8; 906, 910 in FIG. 9) for NWDAA services. As described herein, an AUE, e.g., the AUE 702 (e.g., 402 in FIG. 4; 502 in FIG. 5; 602 in FIG. 6; 806, 810 in FIG. 8; 906, 910 in FIG. 9), may be configured to establish a network connection with a mobile network, e.g., the mobile network 704 (e.g., 404 in FIG. 4; 504 in FIG. 5; 604 in FIG. 6; 804 in FIG. 8; 904 in FIG. 9), and be authenticated for an LDS/NWDAA services via an AMF (e.g., 605 in FIG. 6; 830 in FIG. 8; 930 in FIG. 9)/SMF (e.g., 505 in FIG. 5; 832 in FIG. 8; 932 in FIG. 9) based on a capability indication (e.g., 408 in FIG. 4; 508 in FIG. 5; 608 in FIG. 6).

At 1718, the at least one network entity obtains at least one of sensor information associated with the NWDAA services from a RAN portion of the mobile network or location information associated with the AUE. As an example, the obtainment may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 obtaining such sensor/location information. In aspects, obtaining (at 1718) the sensor/location information may be performed as part of obtaining the location awareness information (at 1716).

When the LDS 705 (e.g., 812, 812′ in FIG. 8; 912, 912′ in FIG. 9) service is activated in the RAN (e.g., 404 in FIG. 4; 504 in FIG. 5; 604 in FIG. 6; 704 in FIG. 7; 818 in FIG. 8; 918 in FIG. 9), the RAN (e.g., 404 in FIG. 4; 504 in FIG. 5; 604 in FIG. 6; 704 in FIG. 7; 818 in FIG. 8; 918 in FIG. 9) may generate information from sensors (e.g., 814 in FIG. 8; 914 in FIG. 9) and provide the information to the LDS 705 (e.g., 812, 812′ in FIG. 8; 912, 912′ in FIG. 9) based on an operations administration and maintenance (OAM) configuration. Sensors (e.g., 814 in FIG. 8; 914 in FIG. 9) may be RAN (e.g., 404 in FIG. 4; 504 in FIG. 5; 604 in FIG. 6; 704 in FIG. 7; 818 in FIG. 8; 918 in FIG. 9) sensing capabilities, BRID receivers, ADS-B receivers, DAA broadcast receivers, weather sensors, LIDAR, RADAR, SONAR, NR sensing capabilities, and/or the like. For layer 2 implementations, the RAN (e.g., 404 in FIG. 4; 504 in FIG. 5; 604 in FIG. 6; 704 in FIG. 7; 818 in FIG. 8; 918 in FIG. 9) may be preconfigured with the serving LDS information and have connectivity with the LDS 705 (e.g., 812, 812′ in FIG. 8; 912, 912′ in FIG. 9). In aspects, such a configuration may be performed by the OAM, where the OAM provides to each RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9) the address of the LDS 705 (e.g., 812, 812′ in FIG. 8; 912, 912′ in FIG. 9) to be used.

The LDS 705 (e.g., 812, 812′ in FIG. 8; 912, 912′ in FIG. 9) may be configured to create local awareness (e.g., local awareness information associated with the AUE 702 (e.g., 402 in FIG. 4; 502 in FIG. 5; 602 in FIG. 6; 806, 810 in FIG. 8; 906, 910 in FIG. 9)) based on RAN (e.g., 404 in FIG. 4; 504 in FIG. 5; 604 in FIG. 6; 704 in FIG. 7; 818 in FIG. 8; 918 in FIG. 9) sensing information from one or more of the sensors (e.g., 814 in FIG. 8; 914 in FIG. 9) noted herein, e.g., listening to DAA messages, BRID (Broadcast remote ID) messages, having access to other sensors (e.g., 814 in FIG. 8; 914 in FIG. 9) (e.g. ADS-B, RADAR, LIDAR, SONAR, AUE 702 (e.g., 402 in FIG. 4; 502 in FIG. 5; 602 in FIG. 6; 806, 810 in FIG. 8; 906, 910 in FIG. 9) positioning, NR) sensing information, etc.). In aspects, obtaining (at 706) the local awareness information by the LDS 705 (e.g., 812, 812′ in FIG. 8; 912, 912′ in FIG. 9) may include receiving information from the AUE 702 (e.g., 402 in FIG. 4; 502 in FIG. 5; 602 in FIG. 6; 806, 810 in FIG. 8; 906, 910 in FIG. 9). In other words, the local awareness (e.g., local awareness information associated with the AUE 702 (e.g., 402 in FIG. 4; 502 in FIG. 5; 602 in FIG. 6; 806, 810 in FIG. 8; 906, 910 in FIG. 9)) obtained (at 706) by the LDS 705 (e.g., 812, 812′ in FIG. 8; 912, 912′ in FIG. 9) may be a network-based aggregation of sensor (e.g., 814 in FIG. 8; 914 in FIG. 9) and other information from a wide variety of sources both within the mobile network 704 (e.g., 404 in FIG. 4; 504 in FIG. 5; 604 in FIG. 6; 804 in FIG. 8; 904 in FIG. 9) and outside of it.

At 1720, it is determined if a confliction warning and/or local awareness information will be issued for an AUE. If so, flowchart 1700 may continue to 1722; if not, flowchart 1700 may continue to 1726. As an example, the determination may be performed by one or more of the component 199, the transceiver 2146, and/or the antenna 2180 in FIG. 21, the network interface 2280 in FIG. 22.

At 1722, the at least one network entity identifies a confliction condition, associated with the NWDAA services, for the AUE based on the local awareness information. As an example, the identification may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 identifying such a confliction condition.

The mobile network 704 (e.g., 404 in FIG. 4; 504 in FIG. 5; 604 in FIG. 6; 804 in FIG. 8; 904 in FIG. 9) and the LDS 705 (e.g., 812, 812′ in FIG. 8; 912, 912′ in FIG. 9), and/or the AUE 702 (e.g., 402 in FIG. 4; 502 in FIG. 5; 602 in FIG. 6; 806, 810 in FIG. 8; 906, 910 in FIG. 9), may be configured to identify/detect (at 708) indicia of a conflict scenario (e.g., a confliction condition) associated with the AUE 702 (e.g., 402 in FIG. 4; 502 in FIG. 5; 602 in FIG. 6; 806, 810 in FIG. 8; 906, 910 in FIG. 9) and/or with a different AUE (e.g., 806, 808, 810 in FIG. 8; 906, 908, 910 in FIG. 9). That is, the LDS 705 (e.g., 812, 812′ in FIG. 8; 912, 912′ in FIG. 9) may be configured to identify a confliction condition, associated with the NWDAA services, for the AUE 702 (e.g., 402 in FIG. 4; 502 in FIG. 5; 602 in FIG. 6; 806, 810 in FIG. 8; 906, 910 in FIG. 9) based on the local awareness information. In one example, the AUE 702 (e.g., 402 in FIG. 4; 502 in FIG. 5; 602 in FIG. 6; 806, 810 in FIG. 8; 906, 910 in FIG. 9) may be configured to obtain local awareness information associated with the AUE 702 (e.g., 402 in FIG. 4; 502 in FIG. 5; 602 in FIG. 6; 806, 810 in FIG. 8; 906, 910 in FIG. 9) (e.g., from the LDS 705 (e.g., 812, 812′ in FIG. 8; 912, 912′ in FIG. 9) and/or from sensors (e.g., 814 in FIG. 8; 914 in FIG. 9), etc., of the AUE 702 (e.g., 402 in FIG. 4; 502 in FIG. 5; 602 in FIG. 6; 806, 810 in FIG. 8; 906, 910 in FIG. 9), and to identify a confliction condition, associated with the NWDAA services, for the AUE 702 (e.g., 402 in FIG. 4; 502 in FIG. 5; 602 in FIG. 6; 806, 810 in FIG. 8; 906, 910 in FIG. 9) based on the local awareness information.

At 1724, the at least one network entity identifies the set of deconfliction strategies based on at least one of the confliction warning or the local awareness information. As an example, the identification may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 identifying such a deconfliction strategy(ies).

As another example, the LDS 705 (e.g., 812, 812′ in FIG. 8; 912, 912′ in FIG. 9) of the mobile network 704 (e.g., 404 in FIG. 4; 504 in FIG. 5; 604 in FIG. 6; 804 in FIG. 8; 904 in FIG. 9) may be configured to trigger warnings to the AUE 702 (e.g., 402 in FIG. 4; 502 in FIG. 5; 602 in FIG. 6; 806, 810 in FIG. 8; 906, 910 in FIG. 9). The LDS 705 (e.g., 812, 812′ in FIG. 8; 912, 912′ in FIG. 9) may be configured to create local awareness (e.g., local awareness information) based on RAN (e.g., 404 in FIG. 4; 504 in FIG. 5; 604 in FIG. 6; 704 in FIG. 7; 818 in FIG. 8; 918 in FIG. 9) sensing information, listening to DAA messages, BRID (Broadcast remote ID) messages, having access to sensors (e.g., 814 in FIG. 8; 914 in FIG. 9) (e.g. ADS-B, RADAR, LIDAR, SONAR, AUE 702 (e.g., 402 in FIG. 4; 502 in FIG. 5; 602 in FIG. 6; 806, 810 in FIG. 8; 906, 910 in FIG. 9) positioning, NR) sensing information, etc.). The LDS 705 (e.g., 812, 812′ in FIG. 8; 912, 912′ in FIG. 9) may send such information to the AUE 702 to enhance situational awareness of AUE 702 (e.g., 402 in FIG. 4; 502 in FIG. 5; 602 in FIG. 6; 806, 810 in FIG. 8; 906, 910 in FIG. 9), yet detection and deconfliction may be performed in AUE 702 (e.g., 402 in FIG. 4; 502 in FIG. 5; 602 in FIG. 6; 806, 810 in FIG. 8; 906, 910 in FIG. 9) for warnings (e.g., the LDS 705 (e.g., 812, 812′ in FIG. 8; 912, 912′ in FIG. 9) may provide deconfliction suggestions/strategies, and the AUE 702 (e.g., 402 in FIG. 4; 502 in FIG. 5; 602 in FIG. 6; 806, 810 in FIG. 8; 906, 910 in FIG. 9) chooses the appropriate one by implementation or configuration information/policies provided by either a UAS operator or a USS system (e.g., 828 in FIG. 8; 928 in FIG. 9), e.g., depending on geographic regulations).

From 1724, flowchart 1700 may continue to 1736.

At 1726, it is determined if a path directive and/or an emergency directive will be issued for an AUE. If so, flowchart 1700 may continue to 1727 for confliction directives; if not, flowchart 1700 may continue to 1734. As an example, the determination may be performed by one or more of the component 199, the transceiver 2146, and/or the antenna 2180 in FIG. 21, the network interface 2280 in FIG. 22.

At 1727, e.g., for confliction directives, the at least one network entity identifies a confliction condition, associated with the NWDAA services, for the AUE based on the local awareness information. As an example, the identification may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 identifying such a confliction condition.

The mobile network 704 (e.g., 404 in FIG. 4; 504 in FIG. 5; 604 in FIG. 6; 804 in FIG. 8; 904 in FIG. 9) and the LDS 705 (e.g., 812, 812′ in FIG. 8; 912, 912′ in FIG. 9), and/or the AUE 702 (e.g., 402 in FIG. 4; 502 in FIG. 5; 602 in FIG. 6; 806, 810 in FIG. 8; 906, 910 in FIG. 9), may be configured to identify/detect (at 708) indicia of a conflict scenario (e.g., a confliction condition) associated with the AUE 702 (e.g., 402 in FIG. 4; 502 in FIG. 5; 602 in FIG. 6; 806, 810 in FIG. 8; 906, 910 in FIG. 9) and/or with a different AUE (e.g., 806, 808, 810 in FIG. 8; 906, 908, 910 in FIG. 9). That is, the LDS 705 (e.g., 812, 812′ in FIG. 8; 912, 912′ in FIG. 9) may be configured to identify a confliction condition, associated with the NWDAA services, for the AUE 702 (e.g., 402 in FIG. 4; 502 in FIG. 5; 602 in FIG. 6; 806, 810 in FIG. 8; 906, 910 in FIG. 9) based on the local awareness information. In one example, the AUE 702 (e.g., 402 in FIG. 4; 502 in FIG. 5; 602 in FIG. 6; 806, 810 in FIG. 8; 906, 910 in FIG. 9) may be configured to obtain local awareness information associated with the AUE 702 (e.g., 402 in FIG. 4; 502 in FIG. 5; 602 in FIG. 6; 806, 810 in FIG. 8; 906, 910 in FIG. 9) (e.g., from the LDS 705 (e.g., 812, 812′ in FIG. 8; 912, 912′ in FIG. 9) and/or from sensors (e.g., 814 in FIG. 8; 914 in FIG. 9), etc., of the AUE 702 (e.g., 402 in FIG. 4; 502 in FIG. 5; 602 in FIG. 6; 806, 810 in FIG. 8; 906, 910 in FIG. 9), and to identify a confliction condition, associated with the NWDAA services, for the AUE 702 (e.g., 402 in FIG. 4; 502 in FIG. 5; 602 in FIG. 6; 806, 810 in FIG. 8; 906, 910 in FIG. 9) based on the local awareness information.

In aspects for LDS-AUE communications, the LDS 705 (e.g., 812, 812′ in FIG. 8; 912, 912′ in FIG. 9) may be configured to trigger warnings to the AUE 702 (e.g., 402 in FIG. 4; 502 in FIG. 5; 602 in FIG. 6; 806, 810 in FIG. 8; 906, 910 in FIG. 9). A potential conflict detection in the LDS 705 (e.g., 812, 812′ in FIG. 8; 912, 912′ in FIG. 9) may trigger a warning and potential de-escalation/de-conflictions instructions to the AUE 702 (e.g., 402 in FIG. 4; 502 in FIG. 5; 602 in FIG. 6; 806, 810 in FIG. 8; 906, 910 in FIG. 9), if requested, or if proximity thresholds are violated (e.g., are met). In aspects, the LDS 705 (e.g., 812, 812′ in FIG. 8; 912, 912′ in FIG. 9) may be configured to trigger an emergency directive to the AUE 702 (e.g., 402 in FIG. 4; 502 in FIG. 5; 602 in FIG. 6; 806, 810 in FIG. 8; 906, 910 in FIG. 9). A conflict/confliction detection (e.g., a critical conflict/confliction detection) in the LDS 705 (e.g., 812, 812′ in FIG. 8; 912, 912′ in FIG. 9) may trigger a path directive (e.g., a non-emergency deconfliction) or an emergency directive (e.g., an urgent emergency deconfliction) to the AUE 702 (e.g., 402 in FIG. 4; 502 in FIG. 5; 602 in FIG. 6; 806, 810 in FIG. 8; 906, 910 in FIG. 9). A path directive may include information associated with a new flight path that the LDS 705 (e.g., 812, 812′ in FIG. 8; 912, 912′ in FIG. 9) may have received from the UTM system (e.g., 826 in FIG. 8; 926 in FIG. 9)/the USS system (e.g., 828 in FIG. 8; 928 in FIG. 9). An emergency directive may include an imminent collision status message with basic metadata about the other aircraft(s)/UAV(s) and may include multiple deconfliction solutions/strategies that are presented. In aspects, such a set of deconfliction solutions/strategies may be scored (e.g., prioritized) and may be provided to the UAS. The UAS, or its controller, may then consider the options and execute one (or more) based on its own knowledge and sensor (e.g., 814 in FIG. 8; 914 in FIG. 9) status, by way of example.

Based on local policies or USS (e.g., 828 in FIG. 8; 928 in FIG. 9) configuration, a warning may be sent under specific conditions (e.g. an AUE category like drone AUE size or mission type, e.g. public safety versus package delivery), an AUE size, an AUE class, a mission type, a public safety priority, or a delivery priority. The LDS 705 (e.g., 812, 812′ in FIG. 8; 912, 912′ in FIG. 9) may be configured to receive configuration information for the specific AUE or class of AUE (e.g., either by the AUE 702 (e.g., 402 in FIG. 4; 502 in FIG. 5; 602 in FIG. 6; 806, 810 in FIG. 8; 906, 910 in FIG. 9) providing its AUE ID explicitly, or the LDS 705 (e.g., 812, 812′ in FIG. 8; 912, 912′ in FIG. 9), based on the received AUE ID broadcasted by the AUE, may derive the specific AUE information, or the LDS 705 (e.g., 812, 812′ in FIG. 8; 912, 912′ in FIG. 9) may receive the information from the UAS NF (e.g., 822 in FIG. 8; 922 in FIG. 9), which receives the information during the AUE 702 (e.g., 402 in FIG. 4; 502 in FIG. 5; 602 in FIG. 6; 806, 810 in FIG. 8; 906, 910 in FIG. 9) registration with the mobile network operator (MNO) from the USS (e.g., 828 in FIG. 8; 928 in FIG. 9)).

At 1730, the at least one network entity generates a confliction directive for the AUE based on the local awareness information and the confliction condition, where the confliction directive is an emergency directive or a path directive. As an example, the generation may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 generating such a confliction directive for an AUE (e.g., the AUE 702).

The LDS 705 (e.g., 812, 812′ in FIG. 8; 912, 912′ in FIG. 9) may be configured to trigger emergency directives/path directives (e.g., deconfliction directives, generally) to the AUE 702 (e.g., 402 in FIG. 4; 502 in FIG. 5; 602 in FIG. 6; 806, 810 in FIG. 8; 906, 910 in FIG. 9) and/or a UAVC (or the AUE 702 (e.g., 402 in FIG. 4; 502 in FIG. 5; 602 in FIG. 6; 806, 810 in FIG. 8; 906, 910 in FIG. 9)) may inform the UAVC itself. In such aspects, the detection and deconfliction may be performed in the LDS 705 (e.g., 812, 812′ in FIG. 8; 912, 912′ in FIG. 9). In some aspects, detection may be based on the AUE 702 (e.g., 402 in FIG. 4; 502 in FIG. 5; 602 in FIG. 6; 806, 810 in FIG. 8; 906, 910 in FIG. 9) request for the deconfliction, or may be based on the intelligence (e.g., local awareness) of the LDS 705 (e.g., 812, 812′ in FIG. 8; 912, 912′ in FIG. 9), or both. In some aspects, the AUE 702 (e.g., 402 in FIG. 4; 502 in FIG. 5; 602 in FIG. 6; 806, 810 in FIG. 8; 906, 910 in FIG. 9) and the UAVC follow the command for deconfliction from the LDS 705 (e.g., 812, 812′ in FIG. 8; 912, 912′ in FIG. 9) in the case of an emergency directive.

As another example, the LDS 705 (e.g., 812, 812′ in FIG. 8; 912, 912′ in FIG. 9) of the mobile network 704 (e.g., 404 in FIG. 4; 504 in FIG. 5; 604 in FIG. 6; 804 in FIG. 8; 904 in FIG. 9) may be configured to trigger warnings to the AUE 702 (e.g., 402 in FIG. 4; 502 in FIG. 5; 602 in FIG. 6; 806, 810 in FIG. 8; 906, 910 in FIG. 9). The LDS 705 (e.g., 812, 812′ in FIG. 8; 912, 912′ in FIG. 9) may be configured to create local awareness (e.g., local awareness information) based on RAN (e.g., 404 in FIG. 4; 504 in FIG. 5; 604 in FIG. 6; 704 in FIG. 7; 818 in FIG. 8; 918 in FIG. 9) sensing information, listening to DAA messages, BRID (Broadcast remote ID) messages, having access to sensors (e.g., 814 in FIG. 8; 914 in FIG. 9) (e.g. ADS-B, RADAR, LIDAR, SONAR, AUE 702 (e.g., 402 in FIG. 4; 502 in FIG. 5; 602 in FIG. 6; 806, 810 in FIG. 8; 906, 910 in FIG. 9) positioning, NR) sensing information, etc.). The LDS 705 (e.g., 812, 812′ in FIG. 8; 912, 912′ in FIG. 9) may send such information to the AUE 702 to enhance situational awareness of AUE 702 (e.g., 402 in FIG. 4; 502 in FIG. 5; 602 in FIG. 6; 806, 810 in FIG. 8; 906, 910 in FIG. 9), yet detection and deconfliction may be performed in AUE 702 (e.g., 402 in FIG. 4; 502 in FIG. 5; 602 in FIG. 6; 806, 810 in FIG. 8; 906, 910 in FIG. 9) for warnings (e.g., the LDS 705 (e.g., 812, 812′ in FIG. 8; 912, 912′ in FIG. 9) may provide deconfliction suggestions/strategies, and the AUE 702 (e.g., 402 in FIG. 4; 502 in FIG. 5; 602 in FIG. 6; 806, 810 in FIG. 8; 906, 910 in FIG. 9) chooses the appropriate one by implementation or configuration information/policies provided by either a UAS operator or a USS system (e.g., 828 in FIG. 8; 928 in FIG. 9), e.g., depending on geographic regulations).

From 1730, flowchart 1700 may continue to 1736.

At 1734, if an early detection indication is received from an AUE, flowchart 1700 may continue to 1735; if not, flowchart 1700 may continue back to 1716, by way of example, or alternately to 1702 or 1714. As an example, the determination may be performed by one or more of the component 199, the transceiver 2146, and/or the antenna 2180 in FIG. 21, the network interface 2280 in FIG. 22.

For instance, the AUE 702 (e.g., 402 in FIG. 4; 502 in FIG. 5; 602 in FIG. 6; 806, 810 in FIG. 8; 906, 910 in FIG. 9) may be configured to trigger an early detection to the LDS 705 (e.g., 812, 812′ in FIG. 8; 912, 912′ in FIG. 9) of the mobile network 704 (e.g., 404 in FIG. 4; 504 in FIG. 5; 604 in FIG. 6; 804 in FIG. 8; 904 in FIG. 9). The AUE 702 (e.g., 402 in FIG. 4; 502 in FIG. 5; 602 in FIG. 6; 806, 810 in FIG. 8; 906, 910 in FIG. 9) may comprise onboard processing/intelligence (e.g., a computational function) for conflict/confliction detection and/or awareness, and may be configured to report such conflict/confliction detection and/or awareness to the LDS 705 (e.g., 812, 812′ in FIG. 8; 912, 912′ in FIG. 9).

At 1735, the at least one network entity communicates, with the AUE via a mobile network associated with the at least one network entity, information associated with the NWDAA services. As an example, the communication may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 communicating such information with an AUE (e.g., the AUE 702).

For instance, the AUE 702 (e.g., 402 in FIG. 4; 502 in FIG. 5; 602 in FIG. 6; 806, 810 in FIG. 8; 906, 910 in FIG. 9) may be configured to trigger an early detection to the LDS 705 (e.g., 812, 812′ in FIG. 8; 912, 912′ in FIG. 9) of the mobile network 704 (e.g., 404 in FIG. 4; 504 in FIG. 5; 604 in FIG. 6; 804 in FIG. 8; 904 in FIG. 9). The AUE 702 (e.g., 402 in FIG. 4; 502 in FIG. 5; 602 in FIG. 6; 806, 810 in FIG. 8; 906, 910 in FIG. 9) may comprise onboard processing/intelligence (e.g., a computational function) for conflict/confliction detection and/or awareness, and may be configured to report such conflict/confliction detection and/or awareness to the LDS 705 (e.g., 812, 812′ in FIG. 8; 912, 912′ in FIG. 9). In aspects, the AUE 702 (e.g., 402 in FIG. 4; 502 in FIG. 5; 602 in FIG. 6; 806, 810 in FIG. 8; 906, 910 in FIG. 9) may perform continuous reporting or conditional reporting (e.g., the AUE 702 (e.g., 402 in FIG. 4; 502 in FIG. 5; 602 in FIG. 6; 806, 810 in FIG. 8; 906, 910 in FIG. 9) may be configured by the LDS 705 (e.g., 812, 812′ in FIG. 8; 912, 912′ in FIG. 9) to do one and/or the other, under what conditions, etc.).

As an active LDS receiver, the AUE 702 (e.g., 402 in FIG. 4; 502 in FIG. 5; 602 in FIG. 6; 806, 810 in FIG. 8; 906, 910 in FIG. 9) may be configured to send information directly and explicitly to the LDS 705 (e.g., 812, 812′ in FIG. 8; 912, 912′ in FIG. 9) (e.g., location, flight path, etc.). The AUE 702 (e.g., 402 in FIG. 4; 502 in FIG. 5; 602 in FIG. 6; 806, 810 in FIG. 8; 906, 910 in FIG. 9) may be configured to trigger an early detection to the LDS 705 (e.g., 812, 812′ in FIG. 8; 912, 912′ in FIG. 9), e.g., the AUE 702 (e.g., 402 in FIG. 4; 502 in FIG. 5; 602 in FIG. 6; 806, 810 in FIG. 8; 906, 910 in FIG. 9) may be configured to detect locally a possible conflict and report it to the LDS 705 (e.g., 812, 812′ in FIG. 8; 912, 912′ in FIG. 9) (e.g., including information received from other AUEs e.g., 806, 808, 810 in FIG. 8; 906, 908, 910 in FIG. 9), including AUE ID(s), path, etc.), and either: (i) includes its planned deconfliction strategy (e.g., a trajectory change) that the UAS may compute autonomously, or (ii) includes a request for a “guided” trajectory change, which the LDS 705 (e.g., 812, 812′ in FIG. 8; 912, 912′ in FIG. 9) may compute and report back.

From 1735, flowchart 1700 may return to 1722 for confliction warnings, or may return to 1727 for path directives/emergency directives.

At 1736, the at least one network entity communicates, with the AUE via a mobile network associated with the at least one network entity, information associated with the NWDAA services. As an example, the communication may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 communicating such information with an AUE (e.g., the AUE 702).

The mobile network 704 (e.g., 404 in FIG. 4; 504 in FIG. 5; 604 in FIG. 6; 804 in FIG. 8; 904 in FIG. 9) (e.g., by at least one instance of the LDS 705 (e.g., 812, 812′ in FIG. 8; 912, 912′ in FIG. 9)) and/or the AUE 702 (e.g., 402 in FIG. 4; 502 in FIG. 5; 602 in FIG. 6; 806, 810 in FIG. 8; 906, 910 in FIG. 9) may be configured to communicate communication information 710 associated with the NWDAA services. In aspects, the communication information 710 may be any information associated with the NWDAA services and/or the LDS 705 (e.g., 812, 812′ in FIG. 8; 912, 912′ in FIG. 9), as described herein. In aspects for AUE-LDS communications, the LDS 705 (e.g., 812, 812′ in FIG. 8; 912, 912′ in FIG. 9) may operate as a passive LDS receiver or as an active LDS receiver.

As a passive LDS receiver, LDS nodes such as the LDS 705 (e.g., 812, 812′ in FIG. 8; 912, 912′ in FIG. 9) may receive U2X information (e.g. DAA, BRID) sent by AUEs such as the AUE 702 (e.g., 402 in FIG. 4; 502 in FIG. 5; 602 in FIG. 6; 806, 810 in FIG. 8; 906, 910 in FIG. 9): sidelink receivers in a base station/gNB (e.g., 816, 816′ in FIG. 8; 916, 916′ in FIG. 9) may be configured to receive such information; a base station/gNB (e.g., 816, 816′ in FIG. 8; 916, 916′ in FIG. 9) (RAN (e.g., 404 in FIG. 4; 504 in FIG. 5; 604 in FIG. 6; 704 in FIG. 7; 818 in FIG. 8; 918 in FIG. 9)) may report received BRID (e.g., 814′ in FIG. 8; 914′ in FIG. 9) and/or DAA signaling sent by AUEs (e.g., 402 in FIG. 4; 502 in FIG. 5; 602 in FIG. 6; 806, 808, 810 in FIG. 8; 906, 908, 910 in FIG. 9) to the LDS 705 (e.g., 812, 812′ in FIG. 8; 912, 912′ in FIG. 9) covering the base station/gNB (e.g., 816, 816′ in FIG. 8; 916, 916′ in FIG. 9) area. In such aspects, a RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9) may be configured with the identity/address of the one or more of the LDS 705 (e.g., 812, 812′ in FIG. 8; 912, 912′ in FIG. 9) serving the area of the RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9). Such configurations may leverage information already available via LTE/NR aerial features (e.g., path reporting). The LDS 705 (e.g., 812, 812′ in FIG. 8; 912, 912′ in FIG. 9) may receive ADS-B information from manned aviation: this may leverage receivers in the base station/gNB (e.g., 816, 816′ in FIG. 8; 916, 916′ in FIG. 9) that report ADS-B traffic to the LDS 705 (e.g., 812, 812′ in FIG. 8; 912, 912′ in FIG. 9).

In aspects for LDS-AUE communications, model of communication may be direct or indirect. In a direct model, a C2 link may be sent by the LDS 705 (e.g., 812, 812′ in FIG. 8; 912, 912′ in FIG. 9) to the AUE 702 (e.g., 402 in FIG. 4; 502 in FIG. 5; 602 in FIG. 6; 806, 810 in FIG. 8; 906, 910 in FIG. 9). In an indirect model, if the LDS 705 (e.g., 812, 812′ in FIG. 8; 912, 912′ in FIG. 9) is aware of the UAVC, either the LDS 705 (e.g., 812, 812′ in FIG. 8; 912, 912′ in FIG. 9) informs UAVC, or the AUE 702 (e.g., 402 in FIG. 4; 502 in FIG. 5; 602 in FIG. 6; 806, 810 in FIG. 8; 906, 910 in FIG. 9) informs the UAVC over the C2 link.

In aspects for AUE-LDS connectivity, the LDS 705 (e.g., 812, 812′ in FIG. 8; 912, 912′ in FIG. 9) connectivity may be layer 3 connectivity at the application layer, e.g., the user plane. For example, the AUE 702 (e.g., 402 in FIG. 4; 502 in FIG. 5; 602 in FIG. 6; 806, 810 in FIG. 8; 906, 910 in FIG. 9) may be configured to establish a session with the LDS 705 (e.g., 812, 812′ in FIG. 8; 912, 912′ in FIG. 9) upon (i) discovering the LDS 705 (e.g., 812, 812′ in FIG. 8; 912, 912′ in FIG. 9) is supported, and (ii) discovering LDS 705 (e.g., 812, 812′ in FIG. 8; 912, 912′ in FIG. 9), as noted herein. The AUE 702 (e.g., 402 in FIG. 4; 502 in FIG. 5; 602 in FIG. 6; 806, 810 in FIG. 8; 906, 910 in FIG. 9) may be provided, in NAS registration messages, with information regarding the LDS 705 (e.g., 812, 812′ in FIG. 8; 912, 912′ in FIG. 9) server discovery (e.g., the server address), or the AUE 702 (e.g., 402 in FIG. 4; 502 in FIG. 5; 602 in FIG. 6; 806, 810 in FIG. 8; 906, 910 in FIG. 9) may be pre-configured with information regarding the LDS 705 (e.g., 812, 812′ in FIG. 8; 912, 912′ in FIG. 9) such as, but without limitation, an IP address, a URL, an FQDN, or an anycast address of the LDS 705 (e.g., 812, 812′ in FIG. 8; 912, 912′ in FIG. 9) (e.g., FQDNs may be used to discover the IP address of the LDS 705 (e.g., 812, 812′ in FIG. 8; 912, 912′ in FIG. 9)).

In aspects, an AMF (e.g., 605 in FIG. 6; 830 in FIG. 8; 930 in FIG. 9) may provide such information upon determining that the AUE 702 (e.g., 402 in FIG. 4; 502 in FIG. 5; 602 in FIG. 6; 806, 810 in FIG. 8; 906, 910 in FIG. 9) has an aerial subscription, has indicated its NWDAA/LDS 705 (e.g., 812, 812′ in FIG. 8; 912, 912′ in FIG. 9) capability, and is an authorized AUE (e.g., an UAS service supplier (USS) authentication and authorization (UUAA)/procedure has been performed successfully, when UUAA is supported and/or mandated). The LDS 705 (e.g., 812, 812′ in FIG. 8; 912, 912′ in FIG. 9) server address may be provided via a PDU session establishment/PDN connection establishment procedure upon successful UUAA-SM by an SMF (e.g., 505 in FIG. 5; 832 in FIG. 8; 932 in FIG. 9) when LDS 705 (e.g., 812, 812′ in FIG. 8; 912, 912′ in FIG. 9) information is in the UDM (e.g., provided by the LDS 705 (e.g., 812, 812′ in FIG. 8; 912, 912′ in FIG. 9) provider, whether it is the MNO or a third party, and is configured via an API via the NEF (e.g., 824 in FIG. 8; 924 in FIG. 9)). In aspects, the LDS 705 (e.g., 812, 812′ in FIG. 8; 912, 912′ in FIG. 9) server address may be configured by a policy control function (PCF), and the AUE 702 (e.g., 402 in FIG. 4; 502 in FIG. 5; 602 in FIG. 6; 806, 810 in FIG. 8; 906, 910 in FIG. 9) may be configured with an LDS (e.g., 705 in FIG. 7; 812, 812′ in FIG. 8; 912, 912′ in FIG. 9) anycast address that the AUE 702 (e.g., 402 in FIG. 4; 502 in FIG. 5; 602 in FIG. 6; 806, 810 in FIG. 8; 906, 910 in FIG. 9) may utilize to discover the LDS 705 (e.g., 812, 812′ in FIG. 8; 912, 912′ in FIG. 9). As described herein, the LDS 705 (e.g., 812, 812′ in FIG. 8; 912, 912′ in FIG. 9) may be deployed as an edge-node (e.g., as an edge application server), in aspects. In aspects for AUE-LDS connectivity, the LDS 705 (e.g., 812, 812′ in FIG. 8; 912, 912′ in FIG. 9) connectivity may be layer 2 connectivity at the application layer, e.g., the user plane. For example, the LDS 705 (e.g., 812, 812′ in FIG. 8; 912, 912′ in FIG. 9) may be deployed as a RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9)/function (e.g., 505 in FIG. 5; 605 in FIG. 6; 822, 824, 830, 832 in FIG. 8; 922, 924, 930, 932 in FIG. 9). The AUE 702 (e.g., 402 in FIG. 4; 502 in FIG. 5; 602 in FIG. 6; 806, 810 in FIG. 8; 906, 910 in FIG. 9) may be configured to communicate with the LDS 705 (e.g., 812, 812′ in FIG. 8; 912, 912′ in FIG. 9) via RAN (e.g., 404 in FIG. 4; 504 in FIG. 5; 604 in FIG. 6; 704 in FIG. 7; 818 in FIG. 8; 918 in FIG. 9) signaling (e.g., by RRC transport messages) to report/warn, as well as to receive warnings and deconfliction directives. For RRC messages containing LDS-related data, the AUE 702 (e.g., 402 in FIG. 4; 502 in FIG. 5; 602 in FIG. 6; 806, 810 in FIG. 8; 906, 910 in FIG. 9) may be configured to send RRC signaling with an explicit indication for LDS 705 (e.g., 812, 812′ in FIG. 8; 912, 912′ in FIG. 9)/DWDAA services, so that the RAN (e.g., 404 in FIG. 4; 504 in FIG. 5; 604 in FIG. 6; 704 in FIG. 7; 818 in FIG. 8; 918 in FIG. 9) routes the signaling payload to the correct server (e.g., via a new value for “payload type” specific to this scenario for the AUE 702 (e.g., 402 in FIG. 4; 502 in FIG. 5; 602 in FIG. 6; 806, 810 in FIG. 8; 906, 910 in FIG. 9)).

In aspects for LDS-AUE communication with respect to a serving cell(s) (e.g., Cell 1, Cell 2, Cell 3 in FIGS. 8, 9), the LDS 705 (e.g., 812, 812′ in FIG. 8; 912, 912′ in FIG. 9) may be configured to determine the serving cell(s) (e.g., Cell 1, Cell 2, Cell 3 in FIGS. 8, 9) of the AUE 702 (e.g., 402 in FIG. 4; 502 in FIG. 5; 602 in FIG. 6; 806, 810 in FIG. 8; 906, 910 in FIG. 9). For layer 2 communications, in aspects, the LDS 705 (e.g., 812, 812′ in FIG. 8; 912, 912′ in FIG. 9) may be configured to utilize a “paging area” concept, e.g., the LDS 705 (e.g., 812, 812′ in FIG. 8; 912, 912′ in FIG. 9) may be configured to send the information to the AUE 702 (e.g., 402 in FIG. 4; 502 in FIG. 5; 602 in FIG. 6; 806, 810 in FIG. 8; 906, 910 in FIG. 9) in multiple cells (e.g., Cell 1, Cell 2, Cell 3 in FIGS. 8, 9), which may be identified based on configuration information or corresponding to the paging area. In other layer 2 aspects, as long as the LDS 705 (e.g., 812, 812′ in FIG. 8; 912, 912′ in FIG. 9) knows or is aware of the serving base station/gNB (e.g., 816, 816′ in FIG. 8; 916, 916′ in FIG. 9) of the AUE 702 (e.g., 402 in FIG. 4; 502 in FIG. 5; 602 in FIG. 6; 806, 810 in FIG. 8; 906, 910 in FIG. 9), the LDS 705 (e.g., 812, 812′ in FIG. 8; 912, 912′ in FIG. 9) may be configured to send the information to the base station/gNB (e.g., 816, 816′ in FIG. 8; 916, 916′ in FIG. 9) that sends the information to all the serving cells (e.g., Cell 1, Cell 2, Cell 3 in FIGS. 8, 9) (e.g., not a specific cell, but a specific RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9)).

In aspects for AUE-LDS connectivity, the LDS 705 (e.g., 812, 812′ in FIG. 8; 912, 912′ in FIG. 9) connectivity may be layer 3 connectivity at the control plane. For example, the LDS 705 (e.g., 812, 812′ in FIG. 8; 912, 912′ in FIG. 9) may be deployed as a local application server that is integrated with a local NEF (e.g., 824 in FIG. 8; 924 in FIG. 9). The AUE 702 (e.g., 402 in FIG. 4; 502 in FIG. 5; 602 in FIG. 6; 806, 810 in FIG. 8; 906, 910 in FIG. 9) may be configured to communicate with the LDS 705 (e.g., 812, 812′ in FIG. 8; 912, 912′ in FIG. 9) via control plane Cellular Internet of Things (CIoT) communications to report/warn, as well as to receive warning and deconfliction directives. As an example, the communications may start at the AUE 702 (e.g., 402 in FIG. 4; 502 in FIG. 5; 602 in FIG. 6; 806, 810 in FIG. 8; 906, 910 in FIG. 9) and be sent via the AMF (e.g., 605 in FIG. 6; 830 in FIG. 8; 930 in FIG. 9) to a local NEF (e.g., 824 in FIG. 8; 924 in FIG. 9)/the LDS 705 (e.g., 812, 812′ in FIG. 8; 912, 912′ in FIG. 9). In aspects, an existing NEF (e.g., 824 in FIG. 8; 924 in FIG. 9) API (e.g., a non-IP data delivery) may be utilized. The data payload may be defined, e.g., XML schema for DAA operation, and the local NEF (e.g., 824 in FIG. 8; 924 in FIG. 9) concept can be utilized, e.g., to reduce delay. In aspects, when a serving NEF (e.g., 824 in FIG. 8; 924 in FIG. 9)/LDS (e.g., 705 in FIG. 7; 812, 812′ in FIG. 8; 912, 912′ in FIG. 9) changes, a Non-IP Data Delivery (NIDD) connection path may be established with the serving AMF (e.g., 605 in FIG. 6; 830 in FIG. 8; 930 in FIG. 9).

In some aspects, the AMF (e.g., 605 in FIG. 6; 830 in FIG. 8; 930 in FIG. 9) may support control plane CIoT and NIDD APIs, and the NEF-LDS interface may not have to be specified, e.g., it may be integrated. Additionally, there may be no impact on L2 signaling in such aspects, which may be used for access by the AUE 702 (e.g., 402 in FIG. 4; 502 in FIG. 5; 602 in FIG. 6; 806, 810 in FIG. 8; 906, 910 in FIG. 9) to other services using data traffic, and hop-by-hop security may be guaranteed, in such aspects.

Aspects further provide for additional enhancements to the UAS NF (e.g., 822 in FIG. 8; 922 in FIG. 9)/NEF (e.g., 824 in FIG. 8; 924 in FIG. 9) services to support NWDAA and the LDS 705 (e.g., 812, 812′ in FIG. 8; 912, 912′ in FIG. 9). The AUE 702 (e.g., 402 in FIG. 4; 502 in FIG. 5; 602 in FIG. 6; 806, 810 in FIG. 8; 906, 910 in FIG. 9) may be capable of NWDAA support, and may provide an indication of its support at the application layer during a UUAA procedure to the USS system (e.g., 828 in FIG. 8; 928 in FIG. 9), as described herein, and the AUE 702 (e.g., 402 in FIG. 4; 502 in FIG. 5; 602 in FIG. 6; 806, 810 in FIG. 8; 906, 910 in FIG. 9) may be configured to include its LDS capability indication (e.g., 408 in FIG. 4; 508 in FIG. 5; 608 in FIG. 6) to the USS system (e.g., 828 in FIG. 8; 928 in FIG. 9). Upon a successful UUAA procedure, the USS system (e.g., 828 in FIG. 8; 928 in FIG. 9) may provide to the UAS NF (e.g., 822 in FIG. 8; 922 in FIG. 9) an indication that NWDAA services are authorized. The LDS 705 (e.g., 812, 812′ in FIG. 8; 912, 912′ in FIG. 9) may also interact with the USS system (e.g., 828 in FIG. 8; 928 in FIG. 9) to report detected UAS conflicts, e.g., as for the AUE 702 (e.g., 402 in FIG. 4; 502 in FIG. 5; 602 in FIG. 6; 806, 810 in FIG. 8; 906, 910 in FIG. 9), and corrective action to the USS system (e.g., 828 in FIG. 8; 928 in FIG. 9). An interface may be defined between the LDS 705 (e.g., 812, 812′ in FIG. 8; 912, 912′ in FIG. 9) to the NEF (e.g., 824 in FIG. 8; 924 in FIG. 9)/UAS NF (e.g., 822 in FIG. 8; 922 in FIG. 9) to trigger signaling to the USS system (e.g., 828 in FIG. 8; 928 in FIG. 9).

Even when the LDS 705 (e.g., 812, 812′ in FIG. 8; 912, 912′ in FIG. 9) is not aware of the serving USS system (e.g., 828 in FIG. 8; 928 in FIG. 9) (e.g., no information about the serving USS system (e.g., 828 in FIG. 8; 928 in FIG. 9) is provided to the LDS, nor has the LDS 705 (e.g., 812, 812′ in FIG. 8; 912, 912′ in FIG. 9) discovered the serving USS system (e.g., 828 in FIG. 8; 928 in FIG. 9)), and given that the USS system (e.g., 828 in FIG. 8; 928 in FIG. 9) may not be aware of the LDS 705 (e.g., 812, 812′ in FIG. 8; 912, 912′ in FIG. 9) serving a given AUE (e.g., the AUE 702 (e.g., 402 in FIG. 4; 502 in FIG. 5; 602 in FIG. 6; 806, 810 in FIG. 8; 906, 910 in FIG. 9)), the LDS 705 (e.g., 812, 812′ in FIG. 8; 912, 912′ in FIG. 9) may be configured to communicate with the UAS NF (e.g., 822 in FIG. 8; 922 in FIG. 9), which communicates with the USS system (e.g., 828 in FIG. 8; 928 in FIG. 9).

At 1738, the at least one network entity receives, from the AUE, an indication of a clearance of the confliction condition. As an example, the reception may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 receiving such an indication from an AUE (e.g., the AUE 702).

As an active LDS receiver, the AUE 702 (e.g., 402 in FIG. 4; 502 in FIG. 5; 602 in FIG. 6; 806, 810 in FIG. 8; 906, 910 in FIG. 9) may be configured to send information directly and explicitly to the LDS 705 (e.g., 812, 812′ in FIG. 8; 912, 912′ in FIG. 9) (e.g., location, flight path, etc.). The AUE 702 (e.g., 402 in FIG. 4; 502 in FIG. 5; 602 in FIG. 6; 806, 810 in FIG. 8; 906, 910 in FIG. 9) may be configured to trigger an early detection to the LDS 705 (e.g., 812, 812′ in FIG. 8; 912, 912′ in FIG. 9), e.g., the AUE 702 (e.g., 402 in FIG. 4; 502 in FIG. 5; 602 in FIG. 6; 806, 810 in FIG. 8; 906, 910 in FIG. 9) may be configured to detect locally a possible conflict and report it to the LDS 705 (e.g., 812, 812′ in FIG. 8; 912, 912′ in FIG. 9) (e.g., including information received from other AUEs e.g., 806, 808, 810 in FIG. 8; 906, 908, 910 in FIG. 9), including AUE ID(s), path, etc.), and either: (i) includes its planned deconfliction strategy (e.g., a trajectory change) that the UAS may compute autonomously, or (ii) includes a request for a “guided” trajectory change, which the LDS 705 (e.g., 812, 812′ in FIG. 8; 912, 912′ in FIG. 9) may compute and report back. The AUE 702 (e.g., 402 in FIG. 4; 502 in FIG. 5; 602 in FIG. 6; 806, 810 in FIG. 8; 906, 910 in FIG. 9) may also be configured to report to the LDS 705 (e.g., 812, 812′ in FIG. 8; 912, 912′ in FIG. 9) that the conflict is cleared subsequent to the conflict being cleared.

In aspects, subsequent to the reception at 1738, flowchart 1700 may continue back to 1716, or alternately to 1702 or 1714.

At 1740, the at least one network entity moves an established connectivity session of the LDS with the AUE for Layer 3 communications based on an edge server reallocation procedure associated with an instance of the LDS that is an edge node. As an example, the movement may be performed by one or more of the component 199, the transceiver 2146, and/or the antenna 2180 in FIG. 21, the network interface 2280 in FIG. 22. FIG. 7 illustrates, in the context of FIGS. 4,-6, 8, 9, an example of the LDS 705 moving such an established connectivity session for an AUE (e.g., the AUE 702).

In aspects, the movement at 1740 may be performed at various points during the flow of flowchart 1700, including, but not limited to, the illustrated instances (e.g., “1”). In some aspects, subsequent to the movement at 1740, flowchart 1700 may continue back to 1716, or alternately to 1702 or 1714.

In aspects for AUE-LDS connectivity, the LDS (e.g., 705 in FIG. 7; 812, 812′ in FIG. 8; 912, 912′ in FIG. 9) connectivity may be layer 3 connectivity at the application layer, e.g., the user plane. For example, the AUE 402 (e.g., 502 in FIG. 5; 602 in FIG. 6; 702 in FIG. 7; 806, 810 in FIG. 8; 906, 910 in FIG. 9) may be configured to establish a session with the LDS (e.g., 705 in FIG. 7; 812, 812′ in FIG. 8; 912, 912′ in FIG. 9) upon (i) discovering the LDS (e.g., 705 in FIG. 7; 812, 812′ in FIG. 8; 912, 912′ in FIG. 9) is supported, and (ii) discovering LDS (e.g., 705 in FIG. 7; 812, 812′ in FIG. 8; 912, 912′ in FIG. 9) information, as noted herein. The AUE 402 (e.g., 502 in FIG. 5; 602 in FIG. 6; 702 in FIG. 7; 806, 810 in FIG. 8; 906, 910 in FIG. 9) may be provided, in NAS registration messages, with information regarding the LDS (e.g., 705 in FIG. 7; 812, 812′ in FIG. 8; 912, 912′ in FIG. 9) server discovery (e.g., the server address), or the AUE 402 (e.g., 502 in FIG. 5; 602 in FIG. 6; 702 in FIG. 7; 806, 810 in FIG. 8; 906, 910 in FIG. 9) may be pre-configured with information regarding the LDS(s) (e.g., 705 in FIG. 7; 812, 812′ in FIG. 8; 912, 912′ in FIG. 9) such as, but without limitation, an IP address, a URL, a FQDN, or an anycast address of the LDS (e.g., 705 in FIG. 7; 812, 812′ in FIG. 8; 912, 912′ in FIG. 9) (e.g., FQDNs may be used to discover the IP address of the LDS (e.g., 705 in FIG. 7; 812, 812′ in FIG. 8; 912, 912′ in FIG. 9)).

In aspects, an AMF (e.g., 605 in FIG. 6; 830 in FIG. 8; 930 in FIG. 9) may provide such information upon determining that the AUE 402 (e.g., 502 in FIG. 5; 602 in FIG. 6; 702 in FIG. 7; 806, 810 in FIG. 8; 906, 910 in FIG. 9) has an aerial subscription, has indicated its NWDAA/LDS (e.g., 705 in FIG. 7; 812, 812′ in FIG. 8; 912, 912′ in FIG. 9) capability, and is an authorized AUE (e.g., an UAS service supplier (USS) authentication and authorization (UUAA)/procedure has been performed successfully, when UUAA is supported and/or mandated).

In aspects, a session may be moved to a new LDS (e.g., 705 in FIG. 7; 812, 812′ in FIG. 8; 912, 912′ in FIG. 9) (e.g., LDS instance) based on edge server re-allocation procedures. In some aspects, a dedicated access point name (APN)/data network name (DNN) may be defined for this service, and/or the AUE 402 (e.g., 502 in FIG. 5; 602 in FIG. 6; 702 in FIG. 7; 806, 810 in FIG. 8; 906, 910 in FIG. 9) may be configured by the USS (e.g., 828 in FIG. 8; 928 in FIG. 9) and/or the MNO with respect to the APN/DNN to use upon successful authorization. As described herein, the LDS (e.g., 705 in FIG. 7; 812, 812′ in FIG. 8; 912, 912′ in FIG. 9) may be deployed as an edge-node (e.g., as an edge application server), in aspects.

Aspects illustrated for FIG. 17 include connectors, shown as circles “1,” “2,” and “3,” for illustrative clarity of connections. For example, from 1720, flowchart 1700 may continue to 1740 (e.g., via connector “1”) and/or to 1726; from 1735, flowchart 1700 may continue to 1722 (e.g., via connector “2”) and/or to 1727 (e.g., via connector “3”); etc. In aspects, connector “1,” connector “2,” and connector “3” may be flowchart 1700 options based on scenarios and/or real-time environmental events associated with an AUE/UAV. In aspects, connector “1” and connector “2” may be disjunctive options, or may be concurrent/partially-concurrent options, based on such scenarios and/or real-time environmental events for the AUE/UAV.

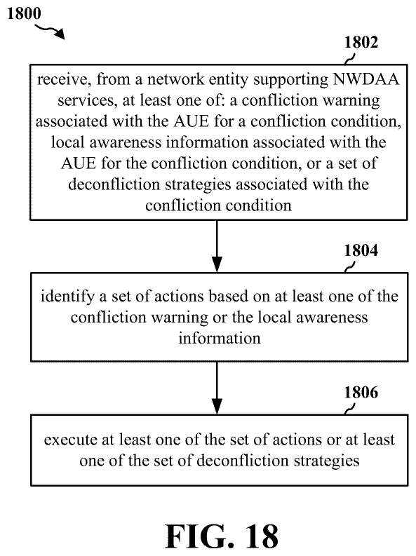

FIG. 18 is a flowchart 1800 of a method of wireless communication. The method may be performed by a UE and/or an AUE (e.g., the UE 104; the AUE 402, the AUE 502, the AUE 602, the AUE 502, the AUE 806, the AUE 808, the AUE 810, the AUE 906, the AUE 908, the AUE 910; the apparatus 2004). In some aspects, the method may include aspects described in connection with the communication flows in FIGS. 4, 5, 6, 7, and/or aspects described in FIGS. 8, 9. The method may be for network-assisted DAA for AUEs. The method may provide for improved DAA by enabling an AUE to report NWDAA capabilities and be authenticated for utilization of a network-based LDS with predictive deconfliction and multi-source information gathering capabilities.

At 1802, the AUE receives, from a network entity supporting NWDAA services, at least one of: a confliction warning associated with the AUE for a confliction condition, local awareness information associated with the AUE for the confliction condition, or a set of deconfliction strategies associated with the confliction condition. As an example, the reception may be performed by one or more of the component 198, the transceiver(s) 2022, and/or the antenna 2080 in FIG. 20. FIG. 4 illustrates, in the context of FIGS. 5-9, an example of the AUE 402 receiving such a confliction warning/local awareness information/set of deconfliction strategies from a mobile network (e.g., the mobile network 404 (e.g., from an LDS)).

The mobile network 404 (e.g., 504 in FIG. 5; 604 in FIG. 6; 704 in FIG. 7; 804 in FIG. 8; 904 in FIG. 9) and/or the AUE 402 (e.g., 502 in FIG. 5; 602 in FIG. 6; 702 in FIG. 7; 806, 810 in FIG. 8; 906, 910 in FIG. 9) may be configured to identify/detect (at 412) indicia of a conflict scenario (e.g., a confliction condition) associated with the AUE 402 (e.g., 502 in FIG. 5; 602 in FIG. 6; 702 in FIG. 7; 806, 810 in FIG. 8; 906, 910 in FIG. 9) and/or with a different AUE. In one example, the AUE 402 may be configured to obtain local awareness information associated with the AUE 402 (e.g., 502 in FIG. 5; 602 in FIG. 6; 702 in FIG. 7; 806, 810 in FIG. 8; 906, 910 in FIG. 9) (e.g., from the LDS (e.g., 705 in FIG. 7; 812, 812′ in FIG. 8; 912, 912′ in FIG. 9) and/or from sensors (e.g., 814 in FIG. 8; 914 in FIG. 9), etc., of the AUE 402 (e.g., 502 in FIG. 5; 602 in FIG. 6; 702 in FIG. 7; 806, 810 in FIG. 8; 906, 910 in FIG. 9), and to identify a confliction condition, associated with the NWDAA services, for the AUE 402 (e.g., 502 in FIG. 5; 602 in FIG. 6; 702 in FIG. 7; 806, 810 in FIG. 8; 906, 910 in FIG. 9) based on the local awareness information.

For instance, the AUE 402 (e.g., 502 in FIG. 5; 602 in FIG. 6; 702 in FIG. 7; 806, 810 in FIG. 8; 906, 910 in FIG. 9) may be configured to trigger an early detection to the LDS (e.g., 705 in FIG. 7; 812, 812′ in FIG. 8; 912, 912′ in FIG. 9) of the mobile network 404 (e.g., 504 in FIG. 5; 604 in FIG. 6; 704 in FIG. 7; 804 in FIG. 8; 904 in FIG. 9). The AUE 402 (e.g., 502 in FIG. 5; 602 in FIG. 6; 702 in FIG. 7; 806, 810 in FIG. 8; 906, 910 in FIG. 9) may comprise onboard processing/intelligence (e.g., a computational function) for conflict/confliction detection and/or awareness, and may be configured to report such conflict/confliction detection and/or awareness to the LDS (e.g., 705 in FIG. 7; 812, 812′ in FIG. 8; 912, 912′ in FIG. 9). In aspects, the AUE 402 (e.g., 502 in FIG. 5; 602 in FIG. 6; 702 in FIG. 7; 806, 810 in FIG. 8; 906, 910 in FIG. 9) may perform continuous reporting or conditional reporting (e.g., the AUE 402 (e.g., 502 in FIG. 5; 602 in FIG. 6; 702 in FIG. 7; 806, 810 in FIG. 8; 906, 910 in FIG. 9) may be configured by the LDS (e.g., 705 in FIG. 7; 812, 812′ in FIG. 8; 912, 912′ in FIG. 9) to do one and/or the other, under what conditions, etc.). The AUE 402 (e.g., 502 in FIG. 5; 602 in FIG. 6; 702 in FIG. 7; 806, 810 in FIG. 8; 906, 910 in FIG. 9) may receive, from the LDS (e.g., 705 in FIG. 7; 812, 812′ in FIG. 8; 912, 912′ in FIG. 9), configuration information on reporting to the LDS (e.g., 705 in FIG. 7; 812, 812′ in FIG. 8; 912, 912′ in FIG. 9) when a session is established with the LDS (e.g., 705 in FIG. 7; 812, 812′ in FIG. 8; 912, 912′ in FIG. 9). Additionally, the AUE 402 (e.g., 502 in FIG. 5; 602 in FIG. 6; 702 in FIG. 7; 806, 810 in FIG. 8; 906, 910 in FIG. 9) may request deconfliction from the LDS (e.g., 705 in FIG. 7; 812, 812′ in FIG. 8; 912, 912′ in FIG. 9).

As another example, the LDS (e.g., 705 in FIG. 7; 812, 812′ in FIG. 8; 912, 912′ in FIG. 9) of the mobile network 404 (e.g., 504 in FIG. 5; 604 in FIG. 6; 704 in FIG. 7; 804 in FIG. 8; 904 in FIG. 9) may be configured to trigger warnings to the AUE 402 (e.g., 502 in FIG. 5; 602 in FIG. 6; 702 in FIG. 7; 806, 810 in FIG. 8; 906, 910 in FIG. 9). The LDS (e.g., 705 in FIG. 7; 812, 812′ in FIG. 8; 912, 912′ in FIG. 9) may be configured to create local awareness (e.g., local awareness information) based on RAN (e.g., 404 in FIG. 4; 504 in FIG. 5; 604 in FIG. 6; 704 in FIG. 7; 818 in FIG. 8; 918 in FIG. 9) sensing information, listening to DAA messages, BRID (Broadcast remote ID) messages, having access to sensors (e.g., 814 in FIG. 8; 914 in FIG. 9) (e.g. ADS-B, RADAR, LIDAR, SONAR, AUE 402 (e.g., 502 in FIG. 5; 602 in FIG. 6; 702 in FIG. 7; 806, 810 in FIG. 8; 906, 910 in FIG. 9) positioning, NR) sensing information, etc.). The LDS (e.g., 705 in FIG. 7; 812, 812′ in FIG. 8; 912, 912′ in FIG. 9) may send such information to the AUE 402 (e.g., 502 in FIG. 5; 602 in FIG. 6; 702 in FIG. 7; 806, 810 in FIG. 8; 906, 910 in FIG. 9) to enhance situational awareness of AUE 402 (e.g., 502 in FIG. 5; 602 in FIG. 6; 702 in FIG. 7; 806, 810 in FIG. 8; 906, 910 in FIG. 9), yet detection and deconfliction may be performed in AUE 402 (e.g., 502 in FIG. 5; 602 in FIG. 6; 702 in FIG. 7; 806, 810 in FIG. 8; 906, 910 in FIG. 9) for warnings (e.g., the LDS (e.g., 705 in FIG. 7; 812, 812′ in FIG. 8; 912, 912′ in FIG. 9) may provide deconfliction suggestions/strategies, and the AUE 402 (e.g., 502 in FIG. 5; 602 in FIG. 6; 702 in FIG. 7; 806, 810 in FIG. 8; 906, 910 in FIG. 9) chooses the appropriate one by implementation or configuration information/policies provided by either a UAS operator or a USS system (e.g., 828 in FIG. 8; 928 in FIG. 9), e.g., depending on geographic regulations).

At 1804, the AUE identifies a set of actions based on at least one of the confliction warning or the local awareness information. As an example, the identification may be performed by one or more of the component 198, the transceiver(s) 2022, and/or the antenna 2080 in FIG. 20. FIG. 4 illustrates, in the context of FIGS. 5-9, an example of the AUE 402 identifying such an action(s).

As another example, the LDS (e.g., 705 in FIG. 7; 812, 812′ in FIG. 8; 912, 912′ in FIG. 9) of the mobile network 404 (e.g., 504 in FIG. 5; 604 in FIG. 6; 704 in FIG. 7; 804 in FIG. 8; 904 in FIG. 9) may be configured to trigger warnings to the AUE 402 (e.g., 502 in FIG. 5; 602 in FIG. 6; 702 in FIG. 7; 806, 810 in FIG. 8; 906, 910 in FIG. 9). The LDS (e.g., 705 in FIG. 7; 812, 812′ in FIG. 8; 912, 912′ in FIG. 9) may be configured to create local awareness (e.g., local awareness information) based on RAN (e.g., 404 in FIG. 4; 504 in FIG. 5; 604 in FIG. 6; 704 in FIG. 7; 818 in FIG. 8; 918 in FIG. 9) sensing information, listening to DAA messages, BRID (Broadcast remote ID) messages, having access to sensors (e.g., 814 in FIG. 8; 914 in FIG. 9) (e.g. ADS-B, RADAR, LIDAR, SONAR, AUE 402 (e.g., 502 in FIG. 5; 602 in FIG. 6; 702 in FIG. 7; 806, 810 in FIG. 8; 906, 910 in FIG. 9) positioning, NR) sensing information, etc.). The LDS (e.g., 705 in FIG. 7; 812, 812′ in FIG. 8; 912, 912′ in FIG. 9) may send such information to the AUE 402 (e.g., 502 in FIG. 5; 602 in FIG. 6; 702 in FIG. 7; 806, 810 in FIG. 8; 906, 910 in FIG. 9) to enhance situational awareness of AUE 402 (e.g., 502 in FIG. 5; 602 in FIG. 6; 702 in FIG. 7; 806, 810 in FIG. 8; 906, 910 in FIG. 9), yet detection and deconfliction may be performed in AUE 402 (e.g., 502 in FIG. 5; 602 in FIG. 6; 702 in FIG. 7; 806, 810 in FIG. 8; 906, 910 in FIG. 9) for warnings (e.g., the LDS (e.g., 705 in FIG. 7; 812, 812′ in FIG. 8; 912, 912′ in FIG. 9) may provide deconfliction suggestions/strategies, and the AUE 402 (e.g., 502 in FIG. 5; 602 in FIG. 6; 702 in FIG. 7; 806, 810 in FIG. 8; 906, 910 in FIG. 9) chooses the appropriate one by implementation or configuration information/policies provided by either a UAS operator or a USS system (e.g., 828 in FIG. 8; 928 in FIG. 9), e.g., depending on geographic regulations).

At 1806, the AUE executes at least one of the set of actions or at least one of the set of deconfliction strategies. As an example, the execution may be performed by one or more of the component 198, the transceiver(s) 2022, and/or the antenna 2080 in FIG. 20. FIG. 4 illustrates, in the context of FIGS. 5-9, an example of the AUE 402 executing such a strategy(ies).

As another example, the LDS (e.g., 705 in FIG. 7; 812, 812′ in FIG. 8; 912, 912′ in FIG. 9) may be configured to trigger emergency directives/path directives (e.g., deconfliction directives, generally) to the AUE 402 (e.g., 502 in FIG. 5; 602 in FIG. 6; 702 in FIG. 7; 806, 810 in FIG. 8; 906, 910 in FIG. 9) and/or a UAVC (or the AUE 402 (e.g., 502 in FIG. 5; 602 in FIG. 6; 702 in FIG. 7; 806, 810 in FIG. 8; 906, 910 in FIG. 9)) may inform the UAVC itself. In such aspects, the detection and deconfliction may be performed in the LDS (e.g., 705 in FIG. 7; 812, 812′ in FIG. 8; 912, 912′ in FIG. 9). In some aspects, detection may be based on the AUE 402 (e.g., 502 in FIG. 5; 602 in FIG. 6; 702 in FIG. 7; 806, 810 in FIG. 8; 906, 910 in FIG. 9) request for the deconfliction, or may be based on the LDS's (e.g., 705 in FIG. 7; 812, 812′ in FIG. 8; 912, 912′ in FIG. 9) intelligence (e.g., local awareness), or both. In some aspects, the AUE 402 (e.g., 502 in FIG. 5; 602 in FIG. 6; 702 in FIG. 7; 806, 810 in FIG. 8; 906, 910 in FIG. 9) and the UAVC follow the command for deconfliction from the LDS (e.g., 705 in FIG. 7; 812, 812′ in FIG. 8; 912, 912′ in FIG. 9) in the case of an emergency directive.

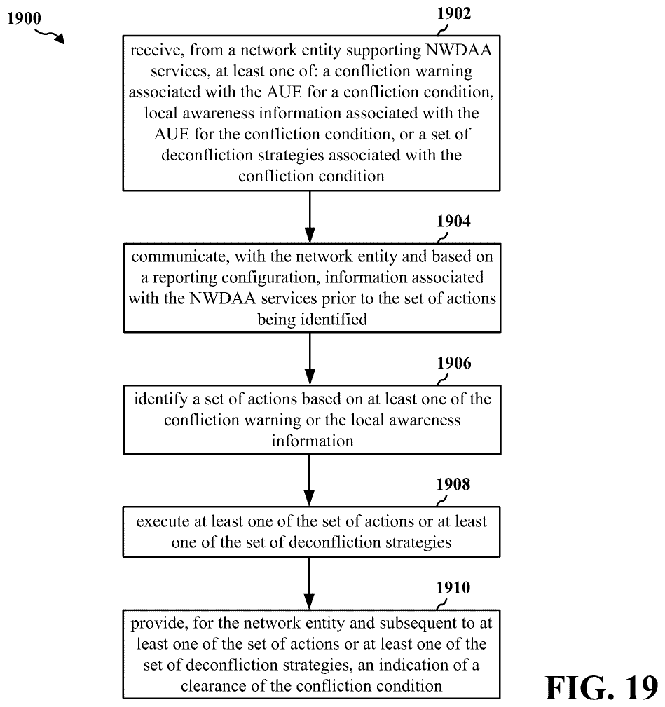

FIG. 19 is a flowchart 1900 of a method of wireless communication. The method may be performed by a UE and/or an AUE (e.g., the UE 104; the AUE 402, the AUE 502, the AUE 602, the AUE 502, the AUE 806, the AUE 808, the AUE 810, the AUE 906, the AUE 908, the AUE 910; the apparatus 2004). In some aspects, the method may include aspects described in connection with the communication flows in FIGS. 4, 5, 6, 7, and/or aspects described in FIGS. 8, 9. The method may be for network-assisted DAA for AUEs. The method may provide for improved DAA by enabling an AUE to report NWDAA capabilities and be authenticated for utilization of a network-based LDS with predictive deconfliction and multi-source information gathering capabilities.

At 1902, the AUE receives, from a network entity supporting NWDAA services, at least one of: a confliction warning associated with the AUE for a confliction condition, local awareness information associated with the AUE for the confliction condition, or a set of deconfliction strategies associated with the confliction condition. As an example, the reception may be performed by one or more of the component 198, the transceiver(s) 2022, and/or the antenna 2080 in FIG. 20. FIG. 4 illustrates, in the context of FIGS. 5-9, an example of the AUE 402 receiving such a confliction warning/local awareness information/set of deconfliction strategies from a mobile network (e.g., the mobile network 404 (e.g., from an LDS)).

The mobile network 404 (e.g., 504 in FIG. 5; 604 in FIG. 6; 704 in FIG. 7; 804 in FIG. 8; 904 in FIG. 9) and/or the AUE 402 (e.g., 502 in FIG. 5; 602 in FIG. 6; 702 in FIG. 7; 806, 810 in FIG. 8; 906, 910 in FIG. 9) may be configured to identify/detect (at 412) indicia of a conflict scenario (e.g., a confliction condition) associated with the AUE 402 (e.g., 502 in FIG. 5; 602 in FIG. 6; 702 in FIG. 7; 806, 810 in FIG. 8; 906, 910 in FIG. 9) and/or with a different AUE. In one example, the AUE 402 may be configured to obtain local awareness information associated with the AUE 402 (e.g., 502 in FIG. 5; 602 in FIG. 6; 702 in FIG. 7; 806, 810 in FIG. 8; 906, 910 in FIG. 9) (e.g., from the LDS (e.g., 705 in FIG. 7; 812, 812′ in FIG. 8; 912, 912′ in FIG. 9) and/or from sensors (e.g., 814 in FIG. 8; 914 in FIG. 9), etc., of the AUE 402 (e.g., 502 in FIG. 5; 602 in FIG. 6; 702 in FIG. 7; 806, 810 in FIG. 8; 906, 910 in FIG. 9), and to identify a confliction condition, associated with the NWDAA services, for the AUE 402 (e.g., 502 in FIG. 5; 602 in FIG. 6; 702 in FIG. 7; 806, 810 in FIG. 8; 906, 910 in FIG. 9) based on the local awareness information.

For instance, the AUE 402 (e.g., 502 in FIG. 5; 602 in FIG. 6; 702 in FIG. 7; 806, 810 in FIG. 8; 906, 910 in FIG. 9) may be configured to trigger an early detection to the LDS (e.g., 705 in FIG. 7; 812, 812′ in FIG. 8; 912, 912′ in FIG. 9) of the mobile network 404 (e.g., 504 in FIG. 5; 604 in FIG. 6; 704 in FIG. 7; 804 in FIG. 8; 904 in FIG. 9). The AUE 402 (e.g., 502 in FIG. 5; 602 in FIG. 6; 702 in FIG. 7; 806, 810 in FIG. 8; 906, 910 in FIG. 9) may comprise onboard processing/intelligence (e.g., a computational function) for conflict/confliction detection and/or awareness, and may be configured to report such conflict/confliction detection and/or awareness to the LDS (e.g., 705 in FIG. 7; 812, 812′ in FIG. 8; 912, 912′ in FIG. 9). In aspects, the AUE 402 (e.g., 502 in FIG. 5; 602 in FIG. 6; 702 in FIG. 7; 806, 810 in FIG. 8; 906, 910 in FIG. 9) may perform continuous reporting or conditional reporting (e.g., the AUE 402 (e.g., 502 in FIG. 5; 602 in FIG. 6; 702 in FIG. 7; 806, 810 in FIG. 8; 906, 910 in FIG. 9) may be configured by the LDS (e.g., 705 in FIG. 7; 812, 812′ in FIG. 8; 912, 912′ in FIG. 9) to do one and/or the other, under what conditions, etc.). The AUE 402 (e.g., 502 in FIG. 5; 602 in FIG. 6; 702 in FIG. 7; 806, 810 in FIG. 8; 906, 910 in FIG. 9) may receive, from the LDS (e.g., 705 in FIG. 7; 812, 812′ in FIG. 8; 912, 912′ in FIG. 9), configuration information on reporting to the LDS (e.g., 705 in FIG. 7; 812, 812′ in FIG. 8; 912, 912′ in FIG. 9) when a session is established with the LDS (e.g., 705 in FIG. 7; 812, 812′ in FIG. 8; 912, 912′ in FIG. 9). Additionally, the AUE 402 (e.g., 502 in FIG. 5; 602 in FIG. 6; 702 in FIG. 7; 806, 810 in FIG. 8; 906, 910 in FIG. 9) may request deconfliction from the LDS (e.g., 705 in FIG. 7; 812, 812′ in FIG. 8; 912, 912′ in FIG. 9).

As another example, the LDS (e.g., 705 in FIG. 7; 812, 812′ in FIG. 8; 912, 912′ in FIG. 9) of the mobile network 404 (e.g., 504 in FIG. 5; 604 in FIG. 6; 704 in FIG. 7; 804 in FIG. 8; 904 in FIG. 9) may be configured to trigger warnings to the AUE 402 (e.g., 502 in FIG. 5; 602 in FIG. 6; 702 in FIG. 7; 806, 810 in FIG. 8; 906, 910 in FIG. 9). The LDS (e.g., 705 in FIG. 7; 812, 812′ in FIG. 8; 912, 912′ in FIG. 9) may be configured to create local awareness (e.g., local awareness information) based on RAN (e.g., 404 in FIG. 4; 504 in FIG. 5; 604 in FIG. 6; 704 in FIG. 7; 818 in FIG. 8; 918 in FIG. 9) sensing information, listening to DAA messages, BRID (Broadcast remote ID) messages, having access to sensors (e.g., 814 in FIG. 8; 914 in FIG. 9) (e.g. ADS-B, RADAR, LIDAR, SONAR, AUE 402 (e.g., 502 in FIG. 5; 602 in FIG. 6; 702 in FIG. 7; 806, 810 in FIG. 8; 906, 910 in FIG. 9) positioning, NR) sensing information, etc.). The LDS (e.g., 705 in FIG. 7; 812, 812′ in FIG. 8; 912, 912′ in FIG. 9) may send such information to the AUE 402 (e.g., 502 in FIG. 5; 602 in FIG. 6; 702 in FIG. 7; 806, 810 in FIG. 8; 906, 910 in FIG. 9) to enhance situational awareness of AUE 402 (e.g., 502 in FIG. 5; 602 in FIG. 6; 702 in FIG. 7; 806, 810 in FIG. 8; 906, 910 in FIG. 9), yet detection and deconfliction may be performed in AUE 402 (e.g., 502 in FIG. 5; 602 in FIG. 6; 702 in FIG. 7; 806, 810 in FIG. 8; 906, 910 in FIG. 9) for warnings (e.g., the LDS (e.g., 705 in FIG. 7; 812, 812′ in FIG. 8; 912, 912′ in FIG. 9) may provide deconfliction suggestions/strategies, and the AUE 402 (e.g., 502 in FIG. 5; 602 in FIG. 6; 702 in FIG. 7; 806, 810 in FIG. 8; 906, 910 in FIG. 9) chooses the appropriate one by implementation or configuration information/policies provided by either a UAS operator or a USS system (e.g., 828 in FIG. 8; 928 in FIG. 9), e.g., depending on geographic regulations).

At 1904, the AUE communicates, with the network entity and based on a reporting configuration, information associated with the NWDAA services prior to the set of actions being identified. As an example, the communication may be performed by one or more of the component 198, the transceiver(s) 2022, and/or the antenna 2080 in FIG. 20. FIG. 4 illustrates, in the context of FIGS. 5-9, an example of the AUE 402 communicating with such a network entity (e.g., of the mobile network 404).

The mobile network 404 (e.g., 504 in FIG. 5; 604 in FIG. 6; 704 in FIG. 7; 804 in FIG. 8; 904 in FIG. 9) (e.g., by an LDS(s) (e.g., 705 in FIG. 7; 812, 812′ in FIG. 8; 912, 912′ in FIG. 9) thereof) and/or the AUE 402 (e.g., 502 in FIG. 5; 602 in FIG. 6; 702 in FIG. 7; 806, 810 in FIG. 8; 906, 910 in FIG. 9) may be configured to communicate communication information 414 associated with the NWDAA services. In aspects, the communication information 414 may be any information associated with the NWDAA services and/or an LDS (e.g., 705 in FIG. 7; 812, 812′ in FIG. 8; 912, 912′ in FIG. 9), as described herein. In aspects for AUE-LDS communications, an LDS (e.g., 705 in FIG. 7; 812, 812′ in FIG. 8; 912, 912′ in FIG. 9) may operate as a passive LDS receiver or as an active LDS receiver.

As a passive LDS receiver, LDS nodes (e.g., 705 in FIG. 7; 812, 812′ in FIG. 8; 912, 912′ in FIG. 9) may receive U2X information (e.g. DAA, BRID) sent by AUEs such as the AUE 402 (e.g., 502 in FIG. 5; 602 in FIG. 6; 702 in FIG. 7; 806, 810 in FIG. 8; 906, 910 in FIG. 9): sidelink receivers in a base station/gNB (e.g., 816, 816′ in FIG. 8; 916, 916′ in FIG. 9) may be configured to receive such information; a base station/gNB (e.g., 816, 816′ in FIG. 8; 916, 916′ in FIG. 9) (RAN (e.g., 404 in FIG. 4; 504 in FIG. 5; 604 in FIG. 6; 704 in FIG. 7; 818 in FIG. 8; 918 in FIG. 9)) may report received BRID and/or DAA signaling sent by AUEs (e.g., 502 in FIG. 5; 602 in FIG. 6; 702 in FIG. 7; 806, 810 in FIG. 8; 906, 910 in FIG. 9) to the LDS(s) (e.g., 705 in FIG. 7; 812, 812′ in FIG. 8; 912, 912′ in FIG. 9) covering the base station/gNB (e.g., 816, 816′ in FIG. 8; 916, 916′ in FIG. 9) area. In such aspects, a RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9) may be configured with the identity/address of the one or more LDS(s) (e.g., 705 in FIG. 7; 812, 812′ in FIG. 8; 912, 912′ in FIG. 9) serving the area of the RAN (e.g., 404 in FIG. 4; 504 in FIG. 5; 604 in FIG. 6; 704 in FIG. 7; 818 in FIG. 8; 918 in FIG. 9) node (e.g., 816, 816′ in FIG. 8; 916, 916′ in FIG. 9). Such configurations may leverage information already available via LTE/NR aerial features (e.g., path reporting). The LDS (e.g., 705 in FIG. 7; 812, 812′ in FIG. 8; 912, 912′ in FIG. 9) may receive ADS-B information from manned aviation: this may leverage receivers in the base station/gNB (e.g., 816, 816′ in FIG. 8; 916, 916′ in FIG. 9) that report ADS-B traffic to the LDS (e.g., 705 in FIG. 7; 812, 812′ in FIG. 8; 912, 912′ in FIG. 9).

As an active LDS receiver, the AUE 402 (e.g., 502 in FIG. 5; 602 in FIG. 6; 702 in FIG. 7; 806, 810 in FIG. 8; 906, 910 in FIG. 9) may be configured to send information directly and explicitly to the LDS (e.g., 705 in FIG. 7; 812, 812′ in FIG. 8; 912, 912′ in FIG. 9) (e.g., location, flight path, etc.). The AUE 402 (e.g., 502 in FIG. 5; 602 in FIG. 6; 702 in FIG. 7; 806, 810 in FIG. 8; 906, 910 in FIG. 9) may be configured to trigger an early detection to the LDS (e.g., 705 in FIG. 7; 812, 812′ in FIG. 8; 912, 912′ in FIG. 9), e.g., the AUE 402 (e.g., 502 in FIG. 5; 602 in FIG. 6; 702 in FIG. 7; 806, 810 in FIG. 8; 906, 910 in FIG. 9) may be configured to detect locally a possible conflict and report it to the LDS (e.g., 705 in FIG. 7; 812, 812′ in FIG. 8; 912, 912′ in FIG. 9) (e.g., including information received from other AUEs (e.g., 806, 808, 810 in FIG. 8; 906, 908, 910 in FIG. 9), including AUE ID(s), path, etc.), and either: (i) includes its planned deconfliction strategy (e.g., a trajectory change) that the UAS may compute autonomously, or (ii) includes a request for a “guided” trajectory change, which the LDS (e.g., 705 in FIG. 7; 812, 812′ in FIG. 8; 912, 912′ in FIG. 9) may compute and report back. The AUE 402 (e.g., 502 in FIG. 5; 602 in FIG. 6; 702 in FIG. 7; 806, 810 in FIG. 8; 906, 910 in FIG. 9) may also be configured to report to the LDS (e.g., 705 in FIG. 7; 812, 812′ in FIG. 8; 912, 912′ in FIG. 9) that the conflict is cleared subsequent to the conflict being cleared.

In aspects for LDS-AUE communications, the LDS (e.g., 705 in FIG. 7; 812, 812′ in FIG. 8; 912, 912′ in FIG. 9) may be configured to trigger warnings to the AUE 402 (e.g., 502 in FIG. 5; 602 in FIG. 6; 702 in FIG. 7; 806, 810 in FIG. 8; 906, 910 in FIG. 9). A potential conflict detection in the LDS (e.g., 705 in FIG. 7; 812, 812′ in FIG. 8; 912, 912′ in FIG. 9) may trigger a warning and potential de-escalation/de-conflictions instructions to the AUE 402 (e.g., 502 in FIG. 5; 602 in FIG. 6; 702 in FIG. 7; 806, 810 in FIG. 8; 906, 910 in FIG. 9), if requested, or if proximity thresholds are violated (e.g., are met). In aspects, the LDS (e.g., 705 in FIG. 7; 812, 812′ in FIG. 8; 912, 912′ in FIG. 9) may be configured to trigger an emergency directive to the AUE 402 (e.g., 502 in FIG. 5; 602 in FIG. 6; 702 in FIG. 7; 806, 810 in FIG. 8; 906, 910 in FIG. 9). A conflict/confliction detection (e.g., a critical conflict/confliction detection) in the LDS (e.g., 705 in FIG. 7; 812, 812′ in FIG. 8; 912, 912′ in FIG. 9) may trigger a path directive (e.g., a non-emergency deconfliction) or an emergency directive (e.g., an urgent emergency deconfliction) to the AUE 402 (e.g., 502 in FIG. 5; 602 in FIG. 6; 702 in FIG. 7; 806, 810 in FIG. 8; 906, 910 in FIG. 9). A path directive may include information associated with a new flight path that the LDS (e.g., 705 in FIG. 7; 812, 812′ in FIG. 8; 912, 912′ in FIG. 9) may have received from the UTM system (e.g., 826 in FIG. 8; 926 in FIG. 9)/the USS system (e.g., 828 in FIG. 8; 928 in FIG. 9). An emergency directive may include an imminent collision status message with basic metadata about the other aircraft(s)/UAV(s) and may include multiple deconfliction solutions/strategies that are presented. In aspects, such a set of deconfliction solutions/strategies may be scored (e.g., prioritized) and may be provided to the UAS. The UAS, or its controller, may then consider the options and execute one (or more) based on its own knowledge and sensor (e.g., 814 in FIG. 8; 914 in FIG. 9) status, by way of example.

Based on local policies or USS (e.g., 828 in FIG. 8; 928 in FIG. 9) configuration, a warning may be sent under specific conditions (e.g. an AUE category like drone AUE size or mission type, e.g. public safety versus package delivery), an AUE size, an AUE class, a mission type, a public safety priority, or a delivery priority. The LDS (e.g., 705 in FIG. 7; 812, 812′ in FIG. 8; 912, 912′ in FIG. 9) may be configured to receive configuration information for the specific AUE or class of AUE (e.g., either by the AUE 402 (e.g., 502 in FIG. 5; 602 in FIG. 6; 702 in FIG. 7; 806, 810 in FIG. 8; 906, 910 in FIG. 9) providing its AUE ID explicitly, or the LDS (e.g., 705 in FIG. 7; 812, 812′ in FIG. 8; 912, 912′ in FIG. 9), based on the received AUE ID broadcasted by the AUE, may derive the specific AUE information, or the LDS (e.g., 705 in FIG. 7; 812, 812′ in FIG. 8; 912, 912′ in FIG. 9) may receive the information from the UAS NF (e.g., 822 in FIG. 8; 922 in FIG. 9), which receives the information during the AUE 402 (e.g., 502 in FIG. 5; 602 in FIG. 6; 702 in FIG. 7; 806, 810 in FIG. 8; 906, 910 in FIG. 9) registration with the mobile network operator (MNO) from the USS (e.g., 828 in FIG. 8; 928 in FIG. 9)).

In aspects for LDS-AUE communications, a model of communication may be direct or indirect. In a direct model, a C2 link may be sent by the LDS (e.g., 705 in FIG. 7; 812, 812′ in FIG. 8; 912, 912′ in FIG. 9) to the AUE 402 (e.g., 502 in FIG. 5; 602 in FIG. 6; 702 in FIG. 7; 806, 810 in FIG. 8; 906, 910 in FIG. 9). In an indirect model, if the LDS (e.g., 705 in FIG. 7; 812, 812′ in FIG. 8; 912, 912′ in FIG. 9) is aware of the UAVC, either the LDS (e.g., 705 in FIG. 7; 812, 812′ in FIG. 8; 912, 912′ in FIG. 9) informs UAVC, or the AUE 402 (e.g., 502 in FIG. 5; 602 in FIG. 6; 702 in FIG. 7; 806, 810 in FIG. 8; 906, 910 in FIG. 9) informs the UAVC over the C2 link.

At 1906, the AUE identifies a set of actions based on at least one of the confliction warning or the local awareness information. As an example, the identification may be performed by one or more of the component 198, the transceiver(s) 2022, and/or the antenna 2080 in FIG. 20. FIG. 4 illustrates, in the context of FIGS. 5-9, an example of the AUE 402 identifying such an action(s).

As another example, the LDS (e.g., 705 in FIG. 7; 812, 812′ in FIG. 8; 912, 912′ in FIG. 9) of the mobile network 404 (e.g., 504 in FIG. 5; 604 in FIG. 6; 704 in FIG. 7; 804 in FIG. 8; 904 in FIG. 9) may be configured to trigger warnings to the AUE 402 (e.g., 502 in FIG. 5; 602 in FIG. 6; 702 in FIG. 7; 806, 810 in FIG. 8; 906, 910 in FIG. 9). The LDS (e.g., 705 in FIG. 7; 812, 812′ in FIG. 8; 912, 912′ in FIG. 9) may be configured to create local awareness (e.g., local awareness information) based on RAN (e.g., 404 in FIG. 4; 504 in FIG. 5; 604 in FIG. 6; 704 in FIG. 7; 818 in FIG. 8; 918 in FIG. 9) sensing information, listening to DAA messages, BRID (Broadcast remote ID) messages, having access to sensors (e.g., 814 in FIG. 8; 914 in FIG. 9) (e.g. ADS-B, RADAR, LIDAR, SONAR, AUE 402 (e.g., 502 in FIG. 5; 602 in FIG. 6; 702 in FIG. 7; 806, 810 in FIG. 8; 906, 910 in FIG. 9) positioning, NR) sensing information, etc.). The LDS (e.g., 705 in FIG. 7; 812, 812′ in FIG. 8; 912, 912′ in FIG. 9) may send such information to the AUE 402 (e.g., 502 in FIG. 5; 602 in FIG. 6; 702 in FIG. 7; 806, 810 in FIG. 8; 906, 910 in FIG. 9) to enhance situational awareness of AUE 402 (e.g., 502 in FIG. 5; 602 in FIG. 6; 702 in FIG. 7; 806, 810 in FIG. 8; 906, 910 in FIG. 9), yet detection and deconfliction may be performed in AUE 402 (e.g., 502 in FIG. 5; 602 in FIG. 6; 702 in FIG. 7; 806, 810 in FIG. 8; 906, 910 in FIG. 9) for warnings (e.g., the LDS (e.g., 705 in FIG. 7; 812, 812′ in FIG. 8; 912, 912′ in FIG. 9) may provide deconfliction suggestions/strategies, and the AUE 402 (e.g., 502 in FIG. 5; 602 in FIG. 6; 702 in FIG. 7; 806, 810 in FIG. 8; 906, 910 in FIG. 9) chooses the appropriate one by implementation or configuration information/policies provided by either a UAS operator or a USS system (e.g., 828 in FIG. 8; 928 in FIG. 9), e.g., depending on geographic regulations).

At 1908, the AUE executes at least one of the set of actions or at least one of the set of deconfliction strategies. As an example, the execution may be performed by one or more of the component 198, the transceiver(s) 2022, and/or the antenna 2080 in FIG. 20. FIG. 4 illustrates, in the context of FIGS. 5-9, an example of the AUE 402 executing such a strategy(ies).

As another example, the LDS (e.g., 705 in FIG. 7; 812, 812′ in FIG. 8; 912, 912′ in FIG. 9) may be configured to trigger emergency directives/path directives (e.g., deconfliction directives, generally) to the AUE 402 (e.g., 502 in FIG. 5; 602 in FIG. 6; 702 in FIG. 7; 806, 810 in FIG. 8; 906, 910 in FIG. 9) and/or a UAVC (or the AUE 402 (e.g., 502 in FIG. 5; 602 in FIG. 6; 702 in FIG. 7; 806, 810 in FIG. 8; 906, 910 in FIG. 9)) may inform the UAVC itself. In such aspects, the detection and deconfliction may be performed in the LDS (e.g., 705 in FIG. 7; 812, 812′ in FIG. 8; 912, 912′ in FIG. 9). In some aspects, detection may be based on the AUE 402 (e.g., 502 in FIG. 5; 602 in FIG. 6; 702 in FIG. 7; 806, 810 in FIG. 8; 906, 910 in FIG. 9) request for the deconfliction, or may be based on the LDS's (e.g., 705 in FIG. 7; 812, 812′ in FIG. 8; 912, 912′ in FIG. 9) intelligence (e.g., local awareness), or both. In some aspects, the AUE 402 (e.g., 502 in FIG. 5; 602 in FIG. 6; 702 in FIG. 7; 806, 810 in FIG. 8; 906, 910 in FIG. 9) and the UAVC follow the command for deconfliction from the LDS (e.g., 705 in FIG. 7; 812, 812′ in FIG. 8; 912, 912′ in FIG. 9) in the case of an emergency directive.

At 1910, the AUE provides, for the network entity and subsequent to at least one of the set of actions or at least one of the set of deconfliction strategies, an indication of a clearance of the confliction condition. As an example, the provision may be performed by one or more of the component 198, the transceiver(s) 2022, and/or the antenna 2080 in FIG. 20. FIG. 4 illustrates, in the context of FIGS. 5-9, an example of the AUE 402 providing with such an indication to a second network entity (e.g., an LDS).

As noted herein, the AUE 402 (e.g., 502 in FIG. 5; 602 in FIG. 6; 702 in FIG. 7; 806, 810 in FIG. 8; 906, 910 in FIG. 9) may also be configured to report to the LDS (e.g., 705 in FIG. 7; 812, 812′ in FIG. 8; 912, 912′ in FIG. 9) that the conflict is cleared subsequent to the conflict being cleared. In aspects, provision of the clearance may be performed as a subsequent aspect of the communication at 1904 (e.g., as similarly described at 1130 of flowchart 1100 in FIG. 11). FIG. 20 is a diagram 2000 illustrating an example of a hardware implementation for an apparatus 2004. The apparatus 2004 may be a UE, a component of a UE, or may implement UE functionality. In some aspects, the apparatus 1504 may include at least one cellular baseband processor 2024 (also referred to as a modem) coupled to one or more transceivers 2022 (e.g., cellular RF transceiver). The cellular baseband processor(s) 2024 may include at least one on-chip memory 2024′. In some aspects, the apparatus 2004 may further include one or more subscriber identity modules (SIM) cards 2020 and at least one application processor 2006 coupled to a secure digital (SD) card 2008 and a screen 2010. The application processor(s) 2006 may include on-chip memory 2006′. In some aspects, the apparatus 2004 may further include a Bluetooth module 2012, a WLAN module 2014, an SPS module 2016 (e.g., GNSS module), one or more sensor modules 2018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2026, a power supply 2030, and/or a camera 2032. The Bluetooth module 2012, the WLAN module 2014, and the SPS module 2016 may include an on-chip transceiver (TRX) (or in some cases, just a receiver (RX)). The Bluetooth module 2012, the WLAN module 2014, and the SPS module 2016 may include their own dedicated antennas and/or utilize the antennas 2080 for communication. The cellular baseband processor(s) 2024 communicates through the transceiver(s) 2022 via one or more antennas 2080 with the UE 104 and/or with an RU associated with a network entity 2002. The cellular baseband processor(s) 2024 and the application processor(s) 2006 may each include a computer-readable medium/memory 2024′, 2006′, respectively. The additional memory modules 2026 may also be considered a computer-readable medium/memory. Each computer-readable medium/memory 2024′, 2006′, 2026 may be non-transitory. The cellular baseband processor(s) 2024 and the application processor(s) 2006 are each responsible for general processing, including the execution of software stored on the computer-readable medium/memory. The software, when executed by the cellular baseband processor(s) 2024/application processor(s) 2006, causes the cellular baseband processor(s) 2024/application processor(s) 2006 to perform the various functions described supra. The cellular baseband processor(s) 2024 and the application processor(s) 2006 are configured to perform the various functions described supra based at least in part of the information stored in the memory. That is, the cellular baseband processor(s) 2024 and the application processor(s) 2006 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 2024/application processor(s) 2006 when executing software. The cellular baseband processor(s) 2024/application processor(s) 2006 may be a component of the UE 350 and may include the at least one memory 360 and/or at least one of the TX processor 368, the RX processor 356, and the controller/processor 359. In one configuration, the apparatus 2004 may be at least one processor chip (modem and/or application) and include just the cellular baseband processor(s) 2024 and/or the application processor(s) 2006, and in another configuration, the apparatus 2004 may be the entire UE (e.g., see UE 350 of FIG. 3) and include the additional modules of the apparatus 2004.

As discussed supra, the component 198 may be configured to establish a connection with a mobile network. The component 198 may also be configured to provide, for a first network entity of the mobile network, a capability indication of the AUE for support of NWDAA services. The component 198 may also be configured to communicate, with a second network entity of the mobile network, information associated with the NWDAA services. The component 198 may be configured to receive, from the first network entity and prior to communicating the information associated with the NWDAA services, an NWDAA services indication that is indicative of an availability of the NWDAA services at the mobile network. The component 198 may be configured to receive an AUE authorization for an UAS service supplier (USS) authentication and authorization (UUAA) procedure based at least in part on the capability indication. The component 198 may be configured to receive, from a network node and prior to the communicating, an additional NWDAA services indication that is indicative of an availability of the NWDAA services at the mobile network, where the additional NWDAA services indication comprises at least one of a system information block (SIB) or radio resource control (RRC) establishment signaling. The component 198 may be configured to obtain local awareness information associated with the AUE. The component 198 may be configured to identify a confliction condition, associated with the NWDAA services, for the AUE based on the local awareness information. The component 198 may be configured to receive, from the second network entity, a reporting configuration that indicates at least one of a continuous reporting operation or a conditional reporting operation, where communicating the information associated with the NWDAA services is based on the reporting configuration. The component 198 may be configured to identify a set of actions based on at least one of the confliction warning or the local awareness information. The component 198 may be configured to execute the planned deconfliction strategy or the guided deconfliction strategy. The component 198 may be configured to provide, subsequently for the second network entity, an indication of a clearance of the confliction condition. The component 198 may be configured to establish a connectivity session with the LDS for the Layer 3 communications based on an LDS discovery procedure. The component 198 may be configured to move an established connectivity session with the LDS for the Layer 3 communications based on an edge server reallocation procedure associated with an instance of LDS that is an edge node. The component 198 may be configured to receive, from a network entity supporting NWDAA services in a mobile network, at least one of: a confliction warning associated with the AUE for a confliction condition, local awareness information associated with the AUE for the confliction condition, or a set of deconfliction strategies associated with the confliction condition. The component 198 may be configured to identify a set of actions based on at least one of the confliction warning or the local awareness information. The component 198 may be configured to execute at least one of the set of actions or at least one of the set of deconfliction strategies. The component 198 may be configured to communicate, with the network entity and based on a reporting configuration, information associated with the NWDAA services prior to the set of actions being identified. The component 198 may be configured to provide, for the network entity and subsequent to at least one of the set of actions or at least one of the set of deconfliction strategies, an indication of a clearance of the confliction condition. The component 198 may be further configured to perform any of the aspects described in connection with the flowcharts in any of FIG. 10 or 11, and/or any of the aspects performed by a UE/an AUE for any of FIGS. 4-9. The component 198 may be within the cellular baseband processor(s) 2024, the application processor(s) 2006, or both the cellular baseband processor(s) 2024 and the application processor(s) 2006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 2004 may include a variety of components configured for various functions. In one configuration, the apparatus 2004, and in particular the cellular baseband processor(s) 2024 and/or the application processor(s) 2006, may include means for establishing a connection with a mobile network. In the configuration, the apparatus 2004, and in particular the cellular baseband processor(s) 2024 and/or the application processor(s) 2006, may include means for providing, for a first network entity of the mobile network, a capability indication of the AUE for support of NWDAA services. In the configuration, the apparatus 2004, and in particular the cellular baseband processor(s) 2024 and/or the application processor(s) 2006, may include means for communicating, with a second network entity of the mobile network, information associated with the NWDAA services. In one configuration, the apparatus 2004, and in particular the cellular baseband processor(s) 2024 and/or the application processor(s) 2006, may include means for receiving, from the first network entity and prior to communicating the information associated with the NWDAA services, an NWDAA services indication that is indicative of an availability of the NWDAA services at the mobile network. In one configuration, the apparatus 2004, and in particular the cellular baseband processor(s) 2024 and/or the application processor(s) 2006, may include means for receiving an AUE authorization for an UAS service supplier (USS) authentication and authorization (UUAA) procedure based at least in part on the capability indication. In one configuration, the apparatus 2004, and in particular the cellular baseband processor(s) 2024 and/or the application processor(s) 2006, may include means for receiving, from a network node and prior to the communicating, an additional NWDAA services indication that is indicative of an availability of the NWDAA services at the mobile network, where the additional NWDAA services indication comprises at least one of a system information block (SIB) or radio resource control (RRC) establishment signaling. In one configuration, the apparatus 2004, and in particular the cellular baseband processor(s) 2024 and/or the application processor(s) 2006, may include means for obtaining local awareness information associated with the AUE. In one configuration, the apparatus 2004, and in particular the cellular baseband processor(s) 2024 and/or the application processor(s) 2006, may include means for identifying a confliction condition, associated with the NWDAA services, for the AUE based on the local awareness information. In one configuration, the apparatus 2004, and in particular the cellular baseband processor(s) 2024 and/or the application processor(s) 2006, may include means for receiving, from the second network entity, a reporting configuration that indicates at least one of a continuous reporting operation or a conditional reporting operation, where communicating the information associated with the NWDAA services is based on the reporting configuration. In one configuration, the apparatus 2004, and in particular the cellular baseband processor(s) 2024 and/or the application processor(s) 2006, may include means for identifying a set of actions based on at least one of the confliction warning or the local awareness information. In one configuration, the apparatus 2004, and in particular the cellular baseband processor(s) 2024 and/or the application processor(s) 2006, may include means for executing the planned deconfliction strategy or the guided deconfliction strategy. In one configuration, the apparatus 2004, and in particular the cellular baseband processor(s) 2024 and/or the application processor(s) 2006, may include means for providing, subsequently for the second network entity, an indication of a clearance of the confliction condition. In one configuration, the apparatus 2004, and in particular the cellular baseband processor(s) 2024 and/or the application processor(s) 2006, may include means for establishing a connectivity session with the LDS for the Layer 3 communications based on an LDS discovery procedure. In one configuration, the apparatus 2004, and in particular the cellular baseband processor(s) 2024 and/or the application processor(s) 2006, may include means for moving an established connectivity session with the LDS for the Layer 3 communications based on an edge server reallocation procedure associated with an instance of LDS that is an edge node. In one configuration, the apparatus 2004, and in particular the cellular baseband processor(s) 2024 and/or the application processor(s) 2006, may include means for receiving, from a network entity supporting NWDAA services in a mobile network, at least one of: a confliction warning associated with the AUE for a confliction condition, local awareness information associated with the AUE for the confliction condition, or a set of deconfliction strategies associated with the confliction condition. In one configuration, the apparatus 2004, and in particular the cellular baseband processor(s) 2024 and/or the application processor(s) 2006, may include means for identifying a set of actions based on at least one of the confliction warning or the local awareness information. In one configuration, the apparatus 2004, and in particular the cellular baseband processor(s) 2024 and/or the application processor(s) 2006, may include means for executing at least one of the set of actions or at least one of the set of deconfliction strategies. In one configuration, the apparatus 2004, and in particular the cellular baseband processor(s) 2024 and/or the application processor(s) 2006, may include means for communicating, with the network entity and based on a reporting configuration, information associated with the NWDAA services prior to the set of actions being identified. In one configuration, the apparatus 2004, and in particular the cellular baseband processor(s) 2024 and/or the application processor(s) 2006, may include means for providing, for the network entity and subsequent to at least one of the set of actions or at least one of the set of deconfliction strategies, an indication of a clearance of the confliction condition. The apparatus 2004 may further include means for performing any of the aspects described in connection with the flowcharts in any of FIG. 10 or 11, and/or any of the aspects performed by a UE/an AUE for any of FIGS. 4-9. The means may be the component 198 of the apparatus 2004 configured to perform the functions recited by the means. As described supra, the apparatus 2004 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 21 is a diagram 2100 illustrating an example of a hardware implementation for a network entity 2102. The network entity 2102 may be a BS, a component of a BS, or may implement BS functionality. The network entity 2102 may include at least one of a CU 2110, a DU 2130, or an RU 2140. For example, depending on the layer functionality handled by the component 199, the network entity 2102 may include the CU 2110; both the CU 2110 and the DU 2130; each of the CU 2110, the DU 2130, and the RU 2140; the DU 2130; both the DU 2130 and the RU 2140; or the RU 2140. The CU 2110 may include at least one CU processor 2112. The CU processor(s) 2112 may include on-chip memory 2112′. In some aspects, the CU 2110 may further include additional memory modules 2114 and a communications interface 2118. The CU 2110 communicates with the DU 2130 through a midhaul link, such as an F1 interface. The DU 2130 may include at least one DU processor 2132. The DU processor(s) 2132 may include on-chip memory 2132′. In some aspects, the DU 2130 may further include additional memory modules 2134 and a communications interface 2138. The DU 2130 communicates with the RU 2140 through a fronthaul link. The RU 2140 may include at least one RU processor 2142. The RU processor(s) 2142 may include on-chip memory 2142′. In some aspects, the RU 2140 may further include additional memory modules 2144, one or more transceivers 2146, antennas 2180, and a communications interface 2148. The RU 2140 communicates with the UE 104. The on-chip memory 2112′, 2132′, 2142′ and the additional memory modules 2114, 2134, 2144 may each be considered a computer-readable medium/memory. Each computer-readable medium/memory may be non-transitory. Each of the processors 2112, 2132, 2142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to establish, with an AUE, a connection to a mobile network associated with the at least one network entity. The component 199 may also be configured to receive, from the AUE, a capability indication of the AUE for support of NWDAA services. The component 199 may also be configured to provide, for the AUE and based on the capability indication, an NWDAA services indication that is indicative of an availability of the NWDAA services at the mobile network. The component 199 may also be configured to communicate, with the AUE via the mobile network, information associated with the NWDAA services. The component 199 may be configured to provide, for the AUE and prior to communicate the information associated with the NWDAA services, the NWDAA services indication that is indicative of the availability of the NWDAA services at the mobile network. The component 199 may be configured to provide an AUE authorization for an UAS service supplier (USS) authentication and authorization (UUAA) procedure based at least in part on the capability indication. The component 199 may be configured to provide, for at least one network node in a RAN portion of the mobile network and based on the AUE authorization, an additional indication that is indicative of an authorization of the LDS for the AUE, where the additional indication comprises a 5G access network (AN) to SMF (N2 SM) message. The component 199 may also be configured to establish, with an AUE, a connection to a mobile network associated with the at least one network entity. The component 199 may also be configured to receive, from the AUE, a capability indication of the AUE for support of NWDAA services. The component 199 may also be configured to provide, for the AUE and based on the capability indication, an NWDAA services indication that is indicative of an availability of the NWDAA services at the mobile network. The component 199 may be configured to authenticate the AUE in association with an LDS of the mobile network based on at least one of the mobility management registration of the AUE or an AUE subscription associated with the NWDAA services. The component 199 may also be configured to obtain local awareness information associated with an AUE based on an indication of support associated with the AUE for NWDAA services. The component 199 may also be configured to identify a confliction condition, associated with the NWDAA services, for the AUE based on the local awareness information. The component 199 may also be configured to communicate, with the AUE via a mobile network associated with the at least one network entity, information associated with the NWDAA services. The component 199 may be configured to receive, from at least one of an AMF or a SMF, an activation indication for the AUE that is associated with a capability indication of the AUE for support of the NWDAA services. The component 199 may be configured to provide, for the AUE, a reporting configuration that indicates at least one of a continuous reporting operation or a conditional reporting operation, where communicating the information associated with the NWDAA services is based on the reporting configuration. The component 199 may be configured to obtain at least one of sensor information associated with the NWDAA services from a RAN portion of the mobile network or location information associated with the AUE, where obtaining the local awareness information includes generating the local awareness information based on at least one of the sensor information or the location information. The component 199 may be configured to identify the set of deconfliction strategies based on at least one of the confliction warning or the local awareness information. The component 199 may be configured to detect the confliction condition based on the local awareness information, where the confliction condition is based on a threshold condition associated with a severity of the confliction condition. The component 199 may be configured to generate a deconfliction directive for the AUE based on the local awareness information and the confliction condition, where the deconfliction directive is an emergency directive or a path directive. The component 199 may be configured to receive, from the AUE, an indication of a clearance of the confliction condition. The component 199 may be configured to move an established connectivity session of the LDS with the AUE for Layer 3 communications based on an edge server reallocation procedure associated with an instance of the LDS that is an edge node. The component 199 may be configured to communicate with at least one of an UAS NF or a UAS NEF, where at least one of the UAS NF or the UAS NEF are associated with the NWDAA services. The component 199 may be configured to receive, from the AUE, a service layer identifier of the AUE. The component 199 may be configured to identify the UAS NF that serves the AUE based on the service layer identifier of the AUE. The component 199 may be configured to receive, from the USS via a UDM, at least one of a type indication or a category indication of the AUE. The component 199 may be further configured to perform any of the aspects described in connection with the flowcharts in any of FIGS. 12, 13, 14, 15, 16, 17 and/or any of the aspects performed by a network entity/network node for any of FIGS. 4-9. The component 199 may be within one or more processors of one or more of the CU 2110, DU 2130, and the RU 2140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2102 may include a variety of components configured for various functions. In one configuration, the network entity 2102 may include means for establishing, with an AUE, a connection to a mobile network associated with the at least one network entity. In the configuration, the network entity 2102 may include means for receiving, from the AUE, a capability indication of the AUE for support of NWDAA services. In the configuration, the network entity 2102 may include means for providing, for the AUE and based on the capability indication, an NWDAA services indication that is indicative of an availability of the NWDAA services at the mobile network. In the configuration, the network entity 2102 may include means for communicating, with the AUE via the mobile network, information associated with the NWDAA services. In one configuration, the network entity 2102 may include means for providing, for the AUE and prior to communicate the information associated with the NWDAA services, the NWDAA services indication that is indicative of the availability of the NWDAA services at the mobile network. In one configuration, the network entity 2102 may include means for providing an AUE authorization for an UAS service supplier (USS) authentication and authorization (UUAA) procedure based at least in part on the capability indication. In one configuration, the network entity 2102 may include means for providing, for at least one network node in a RAN portion of the mobile network and based on the AUE authorization, an additional indication that is indicative of an authorization of the LDS for the AUE, where the additional indication comprises a 5G access network (AN) to SMF (N2 SM) message. In one configuration, the network entity 2102 may include means for establishing, with an AUE, a connection to a mobile network associated with the at least one network entity. In one configuration, the network entity 2102 may include means for receiving, from the AUE, a capability indication of the AUE for support of NWDAA services. In one configuration, the network entity 2102 may include means for providing, for the AUE and based on the capability indication, an NWDAA services indication that is indicative of an availability of the NWDAA services at the mobile network. In one configuration, the network entity 2102 may include means for authenticating the AUE in association with an LDS of the mobile network based on at least one of the mobility management registration of the AUE or an AUE subscription associated with the NWDAA services. In one configuration, the network entity 2102 may include means for obtaining local awareness information associated with an AUE based on an indication of support associated with the AUE for NWDAA services. In one configuration, the network entity 2102 may include means for identifying a confliction condition, associated with the NWDAA services, for the AUE based on the local awareness information. In one configuration, the network entity 2102 may include means for communicating, with the AUE via a mobile network associated with the at least one network entity, information associated with the NWDAA services. In one configuration, the network entity 2102 may include means for receiving, from at least one of an AMF or a SMF, an activation indication for the AUE that is associated with a capability indication of the AUE for support of the NWDAA services. In one configuration, the network entity 2102 may include means for providing, for the AUE, a reporting configuration that indicates at least one of a continuous reporting operation or a conditional reporting operation, where communicating the information associated with the NWDAA services is based on the reporting configuration. In one configuration, the network entity 2102 may include means for obtaining at least one of sensor information associated with the NWDAA services from a RAN portion of the mobile network or location information associated with the AUE, where obtaining the local awareness information includes generating the local awareness information based on at least one of the sensor information or the location information. In one configuration, the network entity 2102 may include means for identifying the set of deconfliction strategies based on at least one of the confliction warning or the local awareness information. In one configuration, the network entity 2102 may include means for detecting the confliction condition based on the local awareness information, where the confliction condition is based on a threshold condition associated with a severity of the confliction condition. In one configuration, the network entity 2102 may include means for generating a deconfliction directive for the AUE based on the local awareness information and the confliction condition, where the deconfliction directive is an emergency directive or a path directive. In one configuration, the network entity 2102 may include means for receiving, from the AUE, an indication of a clearance of the confliction condition. In one configuration, the network entity 2102 may include means for moving an established connectivity session of the LDS with the AUE for Layer 3 communications based on an edge server reallocation procedure associated with an instance of the LDS that is an edge node. In one configuration, the network entity 2102 may include means for communicating with at least one of an UAS NF or a UAS NEF, where at least one of the UAS NF or the UAS NEF are associated with the NWDAA services. In one configuration, the network entity 2102 may include means for receiving, from the AUE, a service layer identifier of the AUE. In one configuration, the network entity 2102 may include means for identifying the UAS NF that serves the AUE based on the service layer identifier of the AUE. In one configuration, the network entity 2102 may include means for receiving, from the USS via a UDM, at least one of a type indication or a category indication of the AUE. The network entity 2102 may further include means for performing any of the aspects described in connection with the flowcharts in any of FIGS. 12, 13, 14, 15, 16, 17 and/or any of the aspects performed by a network entity/network node for any of FIGS. 4-9. The means may be the component 199 of the network entity 2102 configured to perform the functions recited by the means. As described supra, the network entity 2102 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 22 is a diagram 2200 illustrating an example of a hardware implementation for a network entity 2260. In one example, the network entity 2260 may be within the core network 120. The network entity 2260 may include at least one network processor 2212. The network processor(s) 2212 may include on-chip memory 2212′. In some aspects, the network entity 2260 may further include additional memory modules 2214. The network entity 2260 communicates via the network interface 2280 directly (e.g., backhaul link) or indirectly (e.g., through a RIC) with the CU 2202. The on-chip memory 2212′ and the additional memory modules 2214 may each be considered a computer-readable medium/memory. Each computer-readable medium/memory may be non-transitory. The network processor(s) 2212 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to establish, with an AUE, a connection to a mobile network associated with the at least one network entity. The component 199 may also be configured to receive, from the AUE, a capability indication of the AUE for support of NWDAA services. The component 199 may also be configured to provide, for the AUE and based on the capability indication, an NWDAA services indication that is indicative of an availability of the NWDAA services at the mobile network. The component 199 may also be configured to communicate, with the AUE via the mobile network, information associated with the NWDAA services. The component 199 may be configured to provide, for the AUE and prior to communicate the information associated with the NWDAA services, the NWDAA services indication that is indicative of the availability of the NWDAA services at the mobile network. The component 199 may be configured to provide an AUE authorization for an UAS service supplier (USS) authentication and authorization (UUAA) procedure based at least in part on the capability indication. The component 199 may be configured to provide, for at least one network node in a RAN portion of the mobile network and based on the AUE authorization, an additional indication that is indicative of an authorization of the LDS for the AUE, where the additional indication comprises a 5G access network (AN) to SMF (N2 SM) message. The component 199 may also be configured to establish, with an AUE, a connection to a mobile network associated with the at least one network entity. The component 199 may also be configured to receive, from the AUE, a capability indication of the AUE for support of NWDAA services. The component 199 may also be configured to provide, for the AUE and based on the capability indication, an NWDAA services indication that is indicative of an availability of the NWDAA services at the mobile network. The component 199 may be configured to authenticate the AUE in association with a localized detect and avoid (DAA) server (LDS) of the mobile network based on at least one of the mobility management registration of the AUE or an AUE subscription associated with the NWDAA services. The component 199 may also be configured to obtain local awareness information associated with an AUE based on an indication of support associated with the AUE for NWDAA services. The component 199 may also be configured to identify a confliction condition, associated with the NWDAA services, for the AUE based on the local awareness information. The component 199 may also be configured to communicate, with the AUE via a mobile network associated with the at least one network entity, information associated with the NWDAA services. The component 199 may be configured to receive, from at least one of an AMF or a SMF, an activation indication for the AUE that is associated with a capability indication of the AUE for support of the NWDAA services. The component 199 may be configured to provide, for the AUE, a reporting configuration that indicates at least one of a continuous reporting operation or a conditional reporting operation, where communicating the information associated with the NWDAA services is based on the reporting configuration. The component 199 may be configured to obtain at least one of sensor information associated with the NWDAA services from a RAN portion of the mobile network or location information associated with the AUE, where obtaining the local awareness information includes generating the local awareness information based on at least one of the sensor information or the location information. The component 199 may be configured to identify the set of deconfliction strategies based on at least one of the confliction warning or the local awareness information. The component 199 may be configured to detect the confliction condition based on the local awareness information, where the confliction condition is based on a threshold condition associated with a severity of the confliction condition. The component 199 may be configured to generate a deconfliction directive for the AUE based on the local awareness information and the confliction condition, where the deconfliction directive is an emergency directive or a path directive. The component 199 may be configured to receive, from the AUE, an indication of a clearance of the confliction condition. The component 199 may be configured to move an established connectivity session of the LDS with the AUE for Layer 3 communications based on an edge server reallocation procedure associated with an instance of the LDS that is an edge node. The component 199 may be configured to communicate with at least one of an UAS NF or a UAS NEF, where at least one of the UAS NF or the UAS NEF are associated with the NWDAA services. The component 199 may be configured to receive, from the AUE, a service layer identifier of the AUE. The component 199 may be configured to identify the UAS NF that serves the AUE based on the service layer identifier of the AUE. The component 199 may be configured to receive, from the USS via a UDM, at least one of a type indication or a category indication of the AUE. The component 199 may be further configured to perform any of the aspects described in connection with the flowcharts in any of FIGS. 12, 13, 14, 15, 16, 17 and/or any of the aspects performed by a network entity/network node for any of FIGS. 4-9. The component 199 may be within the network processor(s) 2212. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2260 may include a variety of components configured for various functions. In one configuration, the network entity 2260 may include means for establishing, with an AUE, a connection to a mobile network associated with the at least one network entity. In the configuration, the network entity 2260 may include means for receiving, from the AUE, a capability indication of the AUE for support of NWDAA services. In the configuration, the network entity 2260 may include means for providing, for the AUE and based on the capability indication, an NWDAA services indication that is indicative of an availability of the NWDAA services at the mobile network. In the configuration, the network entity 2260 may include means for communicating, with the AUE via the mobile network, information associated with the NWDAA services. In one configuration, the network entity 2260 may include means for providing, for the AUE and prior to communicate the information associated with the NWDAA services, the NWDAA services indication that is indicative of the availability of the NWDAA services at the mobile network. In one configuration, the network entity 2260 may include means for providing an AUE authorization for an UAS service supplier (USS) authentication and authorization (UUAA) procedure based at least in part on the capability indication. In one configuration, the network entity 2260 may include means for providing, for at least one network node in a RAN portion of the mobile network and based on the AUE authorization, an additional indication that is indicative of an authorization of the LDS for the AUE, where the additional indication comprises a 5G access network (AN) to SMF (N2 SM) message. In one configuration, the network entity 2260 may include means for establishing, with an AUE, a connection to a mobile network associated with the at least one network entity. In one configuration, the network entity 2260 may include means for receiving, from the AUE, a capability indication of the AUE for support of NWDAA services. In one configuration, the network entity 2260 may include means for providing, for the AUE and based on the capability indication, an NWDAA services indication that is indicative of an availability of the NWDAA services at the mobile network. In one configuration, the network entity 2260 may include means for authenticating the AUE in association with an LDS of the mobile network based on at least one of the mobility management registration of the AUE or an AUE subscription associated with the NWDAA services. In one configuration, the network entity 2260 may include means for obtaining local awareness information associated with an AUE based on an indication of support associated with the AUE for NWDAA services. In one configuration, the network entity 2260 may include means for identifying a confliction condition, associated with the NWDAA services, for the AUE based on the local awareness information. In one configuration, the network entity 2260 may include means for communicating, with the AUE via a mobile network associated with the at least one network entity, information associated with the NWDAA services. In one configuration, the network entity 2260 may include means for receiving, from at least one of an AMF or a SMF, an activation indication for the AUE that is associated with a capability indication of the AUE for support of the NWDAA services. In one configuration, the network entity 2260 may include means for providing, for the AUE, a reporting configuration that indicates at least one of a continuous reporting operation or a conditional reporting operation, where communicating the information associated with the NWDAA services is based on the reporting configuration. In one configuration, the network entity 1760 may include means for obtaining at least one of sensor information associated with the NWDAA services from a RAN portion of the mobile network or location information associated with the AUE, where obtaining the local awareness information includes generating the local awareness information based on at least one of the sensor information or the location information. In one configuration, the network entity 2260 may include means for identifying the set of deconfliction strategies based on at least one of the confliction warning or the local awareness information. In one configuration, the network entity 2260 may include means for detecting the confliction condition based on the local awareness information, where the confliction condition is based on a threshold condition associated with a severity of the confliction condition. In one configuration, the network entity 2260 may include means for generating a deconfliction directive for the AUE based on the local awareness information and the confliction condition, where the deconfliction directive is an emergency directive or a path directive. In one configuration, the network entity 2260 may include means for receiving, from the AUE, an indication of a clearance of the confliction condition. In one configuration, the network entity 2260 may include means for moving an established connectivity session of the LDS with the AUE for Layer 3 communications based on an edge server reallocation procedure associated with an instance of the LDS that is an edge node. In one configuration, the network entity 2260 may include means for communicating with at least one of an UAS NF or a UAS NEF, where at least one of the UAS NF or the UAS NEF are associated with the NWDAA services. In one configuration, the network entity 2260 may include means for receiving, from the AUE, a service layer identifier of the AUE. In one configuration, the network entity 2260 may include means for identifying the UAS NF that serves the AUE based on the service layer identifier of the AUE. In one configuration, the network entity 2260 may include means for receiving, from the USS via a UDM, at least one of a type indication or a category indication of the AUE. The network entity 2260 may further include means for performing any of the aspects described in connection with the flowcharts in any of FIGS. 12, 13, 14, 15, 16, 17 and/or any of the aspects performed by a network entity/network node for any of FIGS. 4-9. The means may be the component 199 of the network entity 2260 configured to perform the functions recited by the means.

Communications wireless networks may be between mobile networks (e.g., base stations, gNBs, CN entities, etc.) and UEs, such as AUEs. For instance, SAA or DAA systems are technologies that allow UAVs and drones to integrate safely into civilian airspace, avoiding collisions with other aircraft, buildings, power lines, birds and other obstacles. These systems observe the environment surrounding the drone, decide whether a collision is imminent, and generate a new flight path in order to avoid collision. UAV sense and avoid systems may combine data from a number of sensors, using sensor fusion algorithms, image recognition and artificial intelligence to provide the best outcome. Data is fed back to the drone on-board computer and/or drone flight controller, which can then decide on the best evasive maneuver or flight path correction to avoid collision. A reliable onboard DAA system can be a basis for obtaining a waiver for flight operations in many jurisdictions that otherwise require human observers or ground-based observation systems along the entire flight path. DAA systems may thus be utilized to unlock commercially viable BVLOS drone operations that provide services such as inspection and cargo delivery over extremely long distances. Common DAA solutions may include sensor-based implementations, e.g., having two main types of sensors: active and passive. Passive sensors may include electro-optical sensors (e.g., cameras), acoustic sensors, etc. Active sensors may include LIDAR, RADAR, SONAR, etc. Some solutions may be communication based. For instance, an AUE may, in theory, use systems originally designed for manned aviation, such as TCAS or ADS-B, that periodically broadcast and receive identity, position and other information. ACAS may be associated with standards that define DAA policies/regulations. For a UAS, ACAS may include different versions that are defined or in development for fixed wing UAS (ACAS-Xu), for rotorcraft (ACAS-Xr), and for DAA systems of small UAS (ACAS-sXu). However, such DAA policies/regulations target narrow/specific scenarios and do not provide an overall, network-assisted solution for AUE DAA.

Aspects herein for network-assisted DAA for AUEs provide improved DAA by enabling an AUE to report NWDAA capabilities and be authenticated for utilization of a network-based LDS with predictive deconfliction and multi-source information gathering capabilities. Aspects enable DAA for AUEs that is independent of a RPS, a UAVC, a GCS, a human pilot, and/or the like, enable DAA for AUEs that utilizes a degree of automation in an AUE, but does not rely solely on AUE awareness of surrounding traffic, and enable DAA for AUEs to leverage ground network ability to have higher spatial awareness of air traffic, by providing NWDAA services via an LDS.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F.

Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1. A method of wireless communication at an AUE, comprising: establishing a connection with a mobile network; providing, for a first network entity of the mobile network, a capability indication of the AUE for support of NWDAA services; and communicating, with a second network entity of the mobile network, information associated with the NWDAA services.

Aspect 2. The method of aspect 1, wherein the NWDAA services are associated with an LDS of the mobile network, wherein the second network entity is the LDS, wherein the first network entity is an AMF or a SMF.

Aspect 3. The method of any of aspects 1 and 2, wherein providing the capability indication includes providing the capability indication via NAS signaling.

Aspect 4. The method of aspect 3, wherein the NAS signaling is at least one of: mobility management signaling indicative of a registration request associated with the capability indication; or session management signaling indicative of at least one of a packet data unit (PDU) session request for Layer 3 communications or an express indication of the support of the NWDAA services.

Aspect 5. The method of any of aspects 1 to 4, further comprising: receiving, from the first network entity and prior to communicating the information associated with the NWDAA services, an NWDAA services indication that is indicative of an availability of the NWDAA services at the mobile network.

Aspect 6. The method of aspect 5, wherein the NWDAA services indication is based on at least one of a mobility management registration of the AUE or an establishment of a PDU session for Layer 3 communications.

Aspect 7. The method of aspect 5, wherein the NWDAA services indication is indicative of the availability of the NWDAA services, respectively, for at least one of a set of public land mobile networks (PLMNs), a set of registration areas, a set of tracking areas, a set of cells, or a geographical area.

Aspect 8. The method of aspect 7, wherein one or more registration areas in the set of registration areas are associated with a registration area generation for uniform provision of the NWDAA services; or wherein the NWDAA services indication is indicative of a service restriction area associated with one or more tracking areas in the set of tracking areas in which the NWDAA services are unavailable for the AUE.

Aspect 9. The method of aspect 5, wherein receiving the NWDAA services indication includes: obtaining addressing information, associated with the NWDAA services and an LDS of the mobile network, via at least one of: a pre-configuration, a policy control function configuration, a registration acceptance indication, a PDU session establishment acceptance indication, or an AUE configuration update procedure, wherein the addressing information includes at least one of an IP address, a URL, an FQDN, or an anycast address of the LDS.

Aspect 10. The method of aspect 9, further comprising: receiving an AUE authorization for an UAS service supplier (USS) authentication and authorization (UUAA) procedure based at least in part on the capability indication.

Aspect 11. The method of any of aspects 1 to 10, further comprising: receiving, from a network node and prior to the communicating, an additional NWDAA services indication that is indicative of an availability of the NWDAA services at the mobile network, wherein the additional NWDAA services indication comprises at least one of a SIB or RRC establishment signaling.

Aspect 12. The method of any of aspects 1 to 11, further comprising: obtaining local awareness information associated with the AUE; and identifying a confliction condition, associated with the NWDAA services, for the AUE based on the local awareness information; wherein communicating the information associated with the NWDAA services includes providing an early detection indication of the confliction condition and a request for a deconfliction directive.

Aspect 13. The method of aspect 12, wherein identifying the confliction condition is based on a computational function associated with NWDAA at the AUE; or wherein the method further comprises: receiving, from the second network entity, a reporting configuration that indicates at least one of a continuous reporting operation or a conditional reporting operation, wherein communicating the information associated with the NWDAA services is based on the reporting configuration.

Aspect 14. The method of aspect 13, wherein the reporting configuration further indicates at least one of a reporting periodicity associated with the continuous reporting operation or a set of reporting conditions associated with the conditional reporting operation.

Aspect 15. The method of any of aspects 1 to 11, wherein communicating the information associated with the NWDAA services includes receiving at least one of a confliction warning or local awareness information associated with the AUE for a confliction condition; the method further comprising: identifying a set of actions based on at least one of the confliction warning or the local awareness information.

Aspect 16. The method of aspect 15, wherein identifying the set of actions is further based on at least one of configuration information or a configuration policy associated with at least one of an UAS operator or a USS system.

Aspect 17. The method of aspect 15, wherein the confliction condition comprises an identified locational proximity threshold condition.

Aspect 18. The method of any of aspects 1 to 11, wherein communicating the information associated with the NWDAA services includes receiving an emergency directive or a path directive associated with a confliction condition for the AUE; and wherein the emergency directive or the path directive includes a set of actions, associated with a deconfliction of the confliction condition, for execution at the AUE, or wherein receiving the emergency directive includes identifying the set of actions at the AUE.

Aspect 19. The method of aspect 18, wherein receiving the emergency directive includes at least one of: providing a request for the emergency directive prior to receiving the emergency directive; or providing an indication of the emergency directive to an UAS operator associated with the AUE.

Aspect 20. The method of aspect 18, wherein the emergency directive comprises at least one of an imminent collision status indication, metadata for a different AUE associated with the emergency directive, or a set of deconfliction strategies.

Aspect 21. The method of aspect 20, wherein the set of deconfliction strategies includes a priority score for each deconfliction strategy thereof; wherein the set of actions is associated with one of the set of deconfliction strategies based on the priority score; or wherein the set of actions is based on a sensor status or local awareness information associated with the AUE.

Aspect 22. The method of aspect 18, wherein at least one of the emergency directive or the path directive are based on an AUE configuration or a service supplier (USS) system configuration that indicates at least one directive condition, wherein the at least one directive condition is associated with one or more of an AUE size, an AUE class, a mission type, a public safety priority, or a delivery priority.

Aspect 23. The method of aspect 18, wherein receiving the emergency directive or the path directive associated with the confliction condition for the AUE includes at least one of: receiving the emergency directive or the path directive via a C2 link; or providing the emergency directive or the path directive via the C2 link to a controller of the AUE.

Aspect 24. The method of aspect 18, wherein the path directive comprises flight path information associated with a change to a current flight path of the AUE, wherein the path directive is based on at least one of (i) AUE information comprising at least one of a location of the AUE, a velocity of the AUE or a flight path of the AUE, or (ii) an indication of a new flight path for the AUE from at least one of a UTM system or a USS system.

Aspect 25. The method of any of aspects 1 to 24, wherein the information associated with the NWDAA services is U2X information that comprises at least one of a DAA message or a broadcast remote identifier (BRID) message.

Aspect 26. The method of any of aspects 1 to 24, wherein communicating the information associated with the NWDAA services includes providing the information associated with the NWDAA services as specified for the second network entity, wherein the information associated with the NWDAA services includes at least one of: AUE information comprising at least one of a location of the AUE, a velocity of the AUE, or a flight path of the AUE; or a confliction condition for the AUE based on local awareness information associated with the AUE.

Aspect 27. The method of aspect 26, wherein the information associated with the NWDAA services includes: a planned deconfliction strategy, associated with the confliction condition, identified by the AUE and to be executed by the AUE or a request for a guided deconfliction strategy from the second network entity to be executed by the AUE; and additional information associated with at least one different AUE associated with the confliction condition, the additional information comprising at least one of an identifier of the at least one different AUE or a another flight path of the at least one different AUE.

Aspect 28. The method of aspect 27, further comprising: executing the planned deconfliction strategy or the guided deconfliction strategy; and providing, subsequently for the second network entity, an indication of a clearance of the confliction condition.

Aspect 29. The method of aspect 28, wherein executing the planned deconfliction strategy or the guided deconfliction strategy is based on a computational function associated with NWDAA at the AUE.

Aspect 30. The method of any of aspects 1 to 29, wherein the NWDAA services are associated with an LDS of the mobile network, wherein the second network entity is the LDS, wherein the first network entity is an AMF, wherein an NWDAA services indication is based on an establishment of a PDU session for Layer 3 communications from the AMF; the method further comprising at least one of: establishing a connectivity session with the LDS for the Layer 3 communications based on an LDS discovery procedure; or moving an established connectivity session with the LDS for the Layer 3 communications based on an edge server reallocation procedure associated with an instance of LDS that is an edge node.

Aspect 31. The method of any of aspects 1 to 29, wherein the NWDAA services are associated with an LDS of the mobile network, wherein communicating the information associated with the NWDAA services includes communicating with the LDS via a radio resource control (RRC) transport message for Layer 2 communications, wherein the RRC transport message for the Layer 2 communications includes a payload type value associated with the AUE and the LDS.

Aspect 32. The method of aspect 31, wherein the RRC transport message for the Layer 2 communications is associated with: a paging area transmission over a set of cells from the LDS via a network node of the mobile network; or a transmission, via the network node, for a set of serving cells associated with the AUE.

Aspect 33. A method of wireless communication at least one network entity, comprising: establishing, with an AUE, a connection to a mobile network associated with the at least one network entity; receiving, from the AUE, a capability indication of the AUE for support of NWDAA services; providing, for the AUE and based on the capability indication, an NWDAA services indication that is indicative of an availability of the NWDAA services at the mobile network; and communicating, with the AUE via the mobile network, information associated with the NWDAA services.

Aspect 34. The method of aspect 33, wherein the NWDAA services are associated with an LDS of the mobile network, wherein the at least one network entity comprises a SMF.

Aspect 35. The method of any of aspects 33 and 34, wherein receiving the capability indication includes receiving the capability indication via NAS signaling.

Aspect 36. The method of aspect 35, wherein the NAS signaling includes session management signaling indicative of at least one of a PDU session request for Layer 3 communications or an express indication of the support of the NWDAA services.

Aspect 37. The method of any of aspects 33 to 36, wherein providing the NWDAA services indication that is indicative of the availability of the NWDAA services at the mobile network includes providing the NWDAA services indication based on a registration or a PDU session.

Aspect 38. The method of aspect 37, wherein the NWDAA services indication is based on an establishment of the PDU session for Layer 3 communications.

Aspect 39. The method of aspect 37, wherein the NWDAA services indication is indicative of the availability of the NWDAA services, respectively, for at least one of a set of PLMNs, a set of registration areas, a set of tracking areas, a set of cells, or a geographical area.

Aspect 40. The method of aspect 39, wherein one or more registration areas in the set of registration areas are associated with a registration area generation for uniform provision of the NWDAA services; or wherein the NWDAA services indication is indicative of a service restriction area associated with one or more tracking areas in the set of tracking areas in which the NWDAA services are unavailable for the AUE.

Aspect 41. The method of aspect 37, wherein providing the NWDAA services indication includes: providing addressing information, associated with the NWDAA services and an LDS of the mobile network, via at least one of: a pre-configuration, a policy control function configuration, a registration acceptance indication, a PDU session establishment acceptance indication, or an AUE configuration update procedure, wherein the addressing information includes at least one of an Internet Protocol (IP) address, a URL, an FQDN, or an anycast address of the LDS.

Aspect 42. The method of aspect 41, further comprising: providing an AUE authorization for an UAS service supplier (USS) authentication and authorization (UUAA) procedure based at least in part on the capability indication.

Aspect 43. The method of aspect 42, further comprising: providing, for at least one network node in a RAN portion of the mobile network and based on the AUE authorization, an additional indication that is indicative of an authorization of the LDS for the AUE, wherein the additional indication comprises a 5G access network (AN) to SMF (N2 SM) message.

Aspect 44. A method of wireless communication at least one network entity, comprising: establishing, with an AUE, a connection to a mobile network associated with the at least one network entity; receiving, from the AUE, a capability indication of the AUE for support of NWDAA services; and providing, for the AUE and based on the capability indication, an NWDAA services indication that is indicative of an availability of the NWDAA services at the mobile network.

Aspect 45. The method of aspect 44, wherein the NWDAA services are associated with an LDS of the mobile network, wherein the at least one network entity is an AMF.

Aspect 46. The method of aspect 44, wherein providing the capability indication includes providing the capability indication via NAS signaling.

Aspect 47. The method of aspect 46, wherein the NAS signaling includes mobility management signaling indicative of a registration request associated with the capability indication.

Aspect 48. The method of aspect 44, wherein the NWDAA services indication is based on at least one of a mobility management registration of the AUE.

Aspect 49. The method of aspect 48, wherein the NWDAA services indication is indicative of the availability of the NWDAA services, respectively, for at least one of a set of PLMNs, a set of registration areas, a set of tracking areas, a set of cells, or a geographical area.

Aspect 50. The method of aspect 49, wherein one or more registration areas in the set of registration areas are associated with a registration area generation for uniform provision of the NWDAA services.

Aspect 51. The method of aspect 49, wherein the NWDAA services indication is indicative of a service restriction area associated with one or more tracking areas in the set of tracking areas in which the NWDAA services are unavailable for the AUE.

Aspect 52. The method of aspect 48, further comprising: authenticating the AUE in association with an LDS of the mobile network based on at least one of the mobility management registration of the AUE or an AUE subscription associated with the NWDAA services.

Aspect 53. The method of aspect 52, wherein authenticating the AUE in association with the LDS is based on at least one of (i) an AUE authorization for an UAS service supplier (USS) authentication and authorization (UUAA) procedure or (ii) the capability indication.

Aspect 54. A method of wireless communication at least one network entity, comprising: obtaining local awareness information associated with an AUE based on an indication of support associated with the AUE for NWDAA services; identifying a confliction condition, associated with the NWDAA services, for the AUE based on the local awareness information; and communicating, with the AUE via a mobile network associated with the at least one network entity, information associated with the NWDAA services.

Aspect 55. The method of aspect 54, wherein the NWDAA services are associated with an LDS of the mobile network, wherein the at least one network entity comprises the LDS.

Aspect 56. The method of any of aspects 54 and 55, further comprising: receiving, from at least one of an AMF or a SMF, an activation indication for the AUE that is associated with a capability indication of the AUE for support of the NWDAA services.

Aspect 57. The method of aspect 56, wherein the activation indication is based on at least one of an AUE authorization for an UAS service supplier (USS) authentication and authorization (UUAA) procedure or an AMF authentication.

Aspect 58. The method of any of aspects 54 to 57, wherein the NWDAA services are associated with at least one of a set of PLMNs, a set of registration areas, a set of tracking areas, a set of cells, or a geographical area.

Aspect 59. The method of aspect 58, wherein one or more registration areas in the set of registration areas are associated with a registration area generation for uniform provision of the NWDAA services; or wherein the NWDAA services indication is indicative of a service restriction area associated with one or more tracking areas in the set of tracking areas in which the NWDAA services are unavailable for the AUE.

Aspect 60. The method of any of aspects 54 to 59, wherein communicating the information associated with the NWDAA services includes receiving an early detection indication of the confliction condition a based on the confliction condition, associated with the NWDAA services, for the AUE and a request for a deconfliction directive.

Aspect 61. The method of aspect 60, further comprising: providing, for the AUE, a reporting configuration that indicates at least one of a continuous reporting operation or a conditional reporting operation, wherein communicating the information associated with the NWDAA services is based on the reporting configuration.

Aspect 62. The method of aspect 61, wherein the reporting configuration further indicates at least one of a reporting periodicity associated with the continuous reporting operation or a set of reporting conditions associated with the conditional reporting operation.

Aspect 63. The method of any of aspects 54 to 62, further comprising: obtaining at least one of sensor information associated with the NWDAA services from a RAN portion of the mobile network or location information associated with the AUE; wherein obtaining the local awareness information includes generating the local awareness information based on at least one of the sensor information or the location information.

Aspect 64. The method of aspect 63, wherein communicating the information associated with the NWDAA services includes providing at least one of: a confliction warning associated with the AUE for the confliction condition based on the local awareness information; the local awareness information associated with the AUE for the confliction condition; or a set of deconfliction strategies associated with the confliction condition.

Aspect 65. The method of aspect 64, the method further comprising: identifying the set of deconfliction strategies based on at least one of the confliction warning or the local awareness information.

Aspect 66. The method of aspect 64, wherein at least one of the confliction warning, the confliction condition, or the set of deconfliction strategies is based on a computational function associated with NWDAA.

Aspect 67. The method of aspect 63, wherein the confliction condition comprises an identified locational proximity threshold condition.

Aspect 68. The method of aspect 63, wherein identifying the confliction condition includes identifying the confliction condition based on the local awareness information, wherein the confliction condition is based on a threshold condition associated with a severity of the confliction condition; wherein the method further comprises: generating a deconfliction directive for the AUE based on the local awareness information and the confliction condition, wherein the deconfliction directive is an emergency directive or a path directive; wherein communicating the information associated with the NWDAA services includes providing the emergency directive or the path directive associated with the confliction condition for the AUE.

Aspect 69. The method of aspect 68, wherein at least one of identifying the confliction condition or generating the deconfliction directive is based on a computational function associated with NWDAA.

Aspect 70. The method of aspect 68, wherein providing the emergency directive includes at least one of: receiving a request for the emergency directive from the AUE; or providing an directive indication of the emergency directive to an UAS operator associated with the AUE.

Aspect 71. The method of aspect 68, wherein the emergency directive comprises at least one of an imminent collision status indication, metadata for a different AUE associated with the emergency directive, or a set of deconfliction strategies.

Aspect 72. The method of aspect 71, wherein the set of deconfliction strategies includes a priority score for each deconfliction strategy thereof.

Aspect 73. The method of aspect 68, wherein at least one of the emergency directive or the path directive are based on an AUE configuration or a service supplier (USS) system configuration that indicates at least one directive condition, wherein the at least one directive condition is associated with one or more of an AUE size, an AUE class, a mission type, a public safety priority, or a delivery priority.

Aspect 74. The method of aspect 68, wherein providing the emergency directive or the path directive associated with the confliction condition for the AUE includes at least one of: providing the emergency directive or the path directive via a C2 link; or providing the emergency directive or the path directive via the C2 link to a controller of the AUE.

Aspect 75. The method of aspect 68, wherein the path directive comprises flight path information associated with a change to a current flight path of the AUE, wherein the path directive is based on at least one of (i) AUE information comprising at least one of a location of the AUE, a velocity of the AUE or a flight path of the AUE, or (ii) a new flight path indication indicative of a new flight path for the AUE from at least one of a UTM system or a UAS service supplier (USS) system.

Aspect 76. The method of aspect 63, wherein the sensor information includes at least one of RAN sensing information, DAA broadcast information, a BRID information, automatic dependent surveillance-broadcast (ADS-B) information, weather information, light detection and ranging (LIDAR) information, radio assisted detection and ranging (RADAR) information, or new radio (NR) sensing information.

Aspect 77. The method of aspect 63, wherein obtaining the sensor information associated with the NWDAA services is based on an operations administration and maintenance (OAM) configuration.

Aspect 78. The method of any of aspects 54 to 77, wherein the information associated with the NWDAA services is aircraft to everything (U2X) information that comprises at least one of a detect and avoid (DAA) message or a BRID message.

Aspect 79. The method of any of aspects 54 to 77, wherein communicating the information associated with the NWDAA services includes receiving the information associated with the NWDAA services as specified for an LDS of the at least one network entity, wherein the information associated with the NWDAA services includes at least one of: AUE information comprising at least one of a location of the AUE, a velocity of the AUE, or a flight path of the AUE; or the confliction condition for the AUE based on the local awareness information associated with the AUE.

Aspect 80. The method of aspect 79, wherein the information associated with the NWDAA services includes: a planned deconfliction strategy, associated with the confliction condition, identified by the AUE and to be executed by the AUE or a request for a guided deconfliction strategy from the AUE to be executed by the AUE; and additional information associated with at least one different AUE associated with the confliction condition, the additional information comprising at least one of an identifier of the at least one different AUE or a another flight path of the at least one different AUE.

Aspect 81. The method of aspect 80, further comprising: receiving, from the AUE, an indication of a clearance of the confliction condition.

Aspect 82. The method of any of aspects 54 to 81, wherein the NWDAA services are associated with an LDS of the mobile network, wherein the at least one network entity comprises the LDS; the method further comprising: moving an established connectivity session of the LDS with the AUE for Layer 3 communications based on an edge server reallocation procedure associated with an instance of the LDS that is an edge node.

Aspect 83. The method of any of aspects 54 to 82, wherein the NWDAA services are associated with an LDS of the mobile network, wherein the at least one network entity comprises the LDS, wherein the LDS comprises an edge node or an edge application server.

Aspect 84. The method of any of aspects 54 to 83, wherein the NWDAA services are associated with an LDS of the mobile network, wherein communicating the information associated with the NWDAA services includes communicating with the AUE via a radio resource control (RRC) transport message for Layer 2 communications, wherein the RRC transport message for the Layer 2 communications includes a payload type value associated with the AUE and the LDS.

Aspect 85. The method of aspect 84, wherein the RRC transport message for the Layer 2 communications is associated with: a paging area transmission over a set of cells from the LDS via a network node of the mobile network; or a transmission, via the network node, for a set of serving cells associated with the AUE.

Aspect 86. The method of any of aspects 54 to 85, wherein the NWDAA services are associated with an LDS of the mobile network, wherein the at least one network entity comprises the LDS; the method further comprising: communicating with at least one of an UAS NF or a UAS NEF, wherein at least one of the UAS NF or the UAS NEF are associated with the NWDAA services.

Aspect 87. The method of aspect 86, wherein communicating with at least one of the UAS NF or the UAS NEF includes communicating via a triggering interface for at least one of the UAS NF or the UAS NEF for signaling to an UAS service supplier (USS).

Aspect 88. The method of aspect 87, wherein communicating with at least one of the UAS NF or the UAS NEF includes providing confliction indicia, wherein the confliction indicia is associated with at least one of an identified confliction condition, a confliction warning, or a deconfliction directive associated with the AUE.

Aspect 89. The method of aspect 88, further comprising: receiving, from the AUE, a service layer identifier of the AUE; and identifying the UAS NF that serves the AUE based on the service layer identifier of the AUE; wherein providing the confliction indicia includes providing, for the USS via the UAS NF that serves the AUE, the confliction indicia and the service layer identifier of the AUE.

Aspect 90. The method of aspect 87, wherein communicating with at least one of the UAS NF or the UAS NEF includes receiving, from the USS via at least one of the UAS NF or the UAS NEF, one or more of a policy associated with the AUE or AUE-associated information.

Aspect 91. The method of aspect 87, wherein communicating with at least one of the UAS NF or the UAS NEF is based on at least one of: a location tracking of the AUE and a mapping between a cell identifier and the LDS, wherein the LDS is a serving LDS for the AUE; a registration of the serving LDS with the UAS NF the AUE; or an AUE authorization for a USS authentication and authorization (UUAA) procedure associated with at least one of an AMF or a SMF of the mobile network.

Aspect 92. The method of aspect 91, wherein communicating with at least one of the UAS NF or the UAS NEF includes receiving, from the USS via at least one of the UAS NF or the UAS NEF, at least a portion of a flight plan of the AUE.

Aspect 93. The method of aspect 92, wherein at least the portion of the flight plan of the AUE is associated with at least one of a coverage area for the AUE by the LDS or an additional area outside of the coverage area.

Aspect 94. The method of aspect 92, wherein communicating with at least one of the UAS NF or the UAS NEF includes providing, for the USS via at least one of the UAS NF or the UAS NEF, a flight plan request for the flight plan of the AUE, wherein the flight plan request includes at least one of a location of the AUE, a first area of interest associated with a serving cell identifier for the AUE, or a second area of interest associated with a geographic coordinates related to the AUE.

Aspect 95. The method of aspect 87, wherein communicating with at least one of the UAS NF or the UAS NEF includes providing, for the USS via at least one of the UAS NF or the UAS NEF, a serving indication that indicates the LDS is or has become a serving LDS for the AUE.

Aspect 96. The method of aspect 87, further comprising: receiving, from the USS via a UDM, at least one of a type indication or a category indication of the AUE; wherein communicating with at least one of the UAS NF or the UAS NEF includes is based on at least one of the type indication or the category indication of the AUE.

Aspect 97. An apparatus for wireless communication at an AUE or at least one network entity, comprising: at least one memory; and at least one processor coupled to the at least one memory and, based at least in part on information stored in the at least one memory, the at least one processor is configured to: perform a method according to any of aspects 1 to 96.

Aspect 98. A computer-readable medium storing computer executable code at an AUE or at least one network entity, the code when executed by at least one processor causes the at least one processor to: perform a method according to any of aspects 1 to 96.

Aspect 99 is an apparatus for wireless communication at an AUE, comprising: at least one memory; and at least one processor coupled to the at least one memory, the at least one processor is configured to perform the method of any of aspects 1 to 32.

Aspect 100 is an apparatus for wireless communication at an AUE, comprising means for performing each step in the method of any of aspects 1 to 32.

Aspect 101 is the apparatus of any of aspects 99 and 100, further comprising a transceiver configured to receive or to transmit in association with the method of any of aspects 1 to 32.

Aspect 102 is a computer-readable medium (e.g., a non-transitory computer-readable medium) storing computer executable code at an AUE, the code when executed by at least one processor causes the at least one processor to perform the method of any of aspects 1 to 32.

Aspect 103 is an apparatus for wireless communication at least one network entity, comprising: at least one memory; and at least one processor coupled to the at least one memory, the at least one processor is configured to perform the method of any of aspects 33 to 43.

Aspect 104 is an apparatus for wireless communication at least one network entity, comprising means for performing each step in the method of any of aspects 33 to 43.

Aspect 105 is the apparatus of any of aspects 103 and 104, further comprising a transceiver configured to receive or to transmit in association with the method of any of aspects 33 to 43.

Aspect 106 is a computer-readable medium (e.g., a non-transitory computer-readable medium) storing computer executable code at least one network entity, the code when executed by at least one processor causes the at least one processor to perform the method of any of aspects 33 to 43.

Aspect 107 is an apparatus for wireless communication at least one network entity, comprising: at least one memory; and at least one processor coupled to the at least one memory, the at least one processor is configured to perform the method of any of aspects 44 to 53.

Aspect 108 is an apparatus for wireless communication at least one network entity, comprising means for performing each step in the method of any of aspects 44 to 53.

Aspect 109 is the apparatus of any of aspects 107 and 108, further comprising a transceiver configured to receive or to transmit in association with the method of any of aspects 44 to 53.

Aspect 110 is a computer-readable medium (e.g., a non-transitory computer-readable medium) storing computer executable code at least one network entity, the code when executed by at least one processor causes the at least one processor to perform the method of any of aspects 44 to 53.

Aspect 111 is an apparatus for wireless communication at least one network entity, comprising: at least one memory; and at least one processor coupled to the at least one memory, the at least one processor is configured to perform the method of any of aspects 54 to 96.

Aspect 112 is an apparatus for wireless communication at least one network entity, comprising means for performing each step in the method of any of aspects 54 to 96.

Aspect 113 is the apparatus of any of aspects 111 and 112, further comprising a transceiver configured to receive or to transmit in association with the method of any of aspects 54 to 96.

Aspect 114 is a computer-readable medium (e.g., a non-transitory computer-readable medium) storing computer executable code at least one network entity, the code when executed by at least one processor causes the at least one processor to perform the method of any of aspects 54 to 96.

Aspect 115 is a method of wireless communication at an aerial user equipment (AUE), comprising: receiving, from a network entity supporting network-based detect and avoid (NWDAA) services, at least one of: a confliction warning associated with the AUE for a confliction condition, local awareness information associated with the AUE for the confliction condition, or a set of deconfliction strategies associated with the confliction condition; identifying a set of actions based on at least one of the confliction warning or the local awareness information; and executing at least one of the set of actions or at least one of the set of deconfliction strategies.

Aspect 116 is a method of aspect 115, wherein to identify the confliction condition, the at least one processor is configured to identify the confliction condition based on a computational function associated with NWDAA at the AUE.

Aspect 117 is a method of aspect 116, wherein the AUE is associated with an identifier (ID) thereof, wherein the confliction warning associated with the AUE for the confliction condition is based on a set of broadcast remote ID (BRID) messages, wherein the set of BRID messages includes at least one of the ID, a vector of movement of the AUE, or a position of the AUE.

Aspect 118 is a method of any of aspects 115 and 117, further comprising: communicating, with the network entity and based on a reporting configuration, information associated with the NWDAA services prior to the set of actions being identified.

Aspect 119 is a method of any of aspects 115 to 118, further comprising: providing, for the network entity and subsequent to at least one of the set of actions or at least one of the set of deconfliction strategies, an indication of a clearance of the confliction condition.

Aspect 120 is a method of any of aspects 115 to 119, wherein the NWDAA services are associated with a localized detect and avoid (DAA) server (LDS) of the mobile network, wherein the network entity is a is the LDS.

Aspect 121 is an apparatus for wireless communication at an aerial user equipment (AUE), comprising: at least one memory; and at least one processor coupled to the at least one memory, the at least one processor is configured to perform the method of any of aspects 115 to 120.

Aspect 122 is an apparatus for wireless communication at least one network entity, comprising means for performing each step in the method of any of aspects 115 to 120.

Aspect 123 is the apparatus of any of aspects 121 and 122, further comprising a transceiver configured to receive or to transmit in association with the method of any of aspects 115 to 120.

Aspect 124 is a computer-readable medium (e.g., a non-transitory computer-readable medium) storing computer executable code at an aerial user equipment (AUE), the code when executed by at least one processor causes the at least one processor to perform the method of any of aspects 115 to 120.

What is claimed is:

1. An apparatus for wireless communication at an aerial user equipment (AUE), comprising:
at least one memory; and
at least one processor coupled to the at least one memory and, based at least in part on stored information that is stored in the at least one memory, the at least one processor is configured to:
establish a connection with a mobile network;
provide, for a first network entity of the mobile network, a capability indication of the AUE for support of network-based detect and avoid (NWDAA) services; and
communicate, with a second network entity of the mobile network, information associated with the NWDAA services.

2. The apparatus of claim 1, wherein the NWDAA services are associated with a localized detect and avoid (DAA) server (LDS) of the mobile network, wherein the second network entity is the LDS, wherein the first network entity is an access and mobility management function (AMF) or a session management function (SMF).

3. The apparatus of claim 1, wherein to provide the capability indication, the at least one processor is configured to provide the capability indication via non-access stratum (NAS) signaling.

4. The apparatus of claim 3, wherein the NAS signaling is at least one of:
mobility management signaling indicative of a registration request associated with the capability indication; or
session management signaling indicative of at least one of a packet data unit (PDU) session request for Layer 3 communications or an express indication of the support of the NWDAA services.

5. The apparatus of claim 1, wherein the at least one processor is further configured to:
receive, from the first network entity and prior to communicating the information associated with the NWDAA services, an NWDAA services indication that is indicative of an availability of the NWDAA services at the mobile network.

6. The apparatus of claim 5, wherein the NWDAA services indication is based on at least one of a mobility management registration of the AUE or an establishment of a packet data unit (PDU) session for Layer 3 communications.

7. The apparatus of claim 5, wherein the NWDAA services indication is indicative of the availability of the NWDAA services, respectively, for at least one of a set of public land mobile networks (PLMNs), a set of registration areas, a set of tracking areas, a set of cells, or a geographical area.

8. The apparatus of claim 7, wherein one or more registration areas in the set of registration areas are associated with a registration area generation for uniform provision of the NWDAA services; or
wherein the NWDAA services indication is indicative of a service restriction area associated with one or more tracking areas in the set of tracking areas in which the NWDAA services are unavailable for the AUE.

9. The apparatus of claim 5, wherein to receive the NWDAA services indication, the at least one processor is configured to:
obtain addressing information, associated with the NWDAA services and a localized detect and avoid (DAA) server (LDS) of the mobile network, via at least one of: a pre-configuration, a policy control function configuration, a registration acceptance indication, a packet data unit (PDU) session establishment acceptance indication, or an AUE configuration update procedure, wherein the addressing information includes at least one of an Internet Protocol (IP) address, a uniform resource locator (URL), a fully qualified domain name (FQDN), or an anycast address of the LDS.

10. The apparatus of claim 9, wherein the at least one processor is further configured to:
receive an AUE authorization for an unmanned aircraft system (UAS) service supplier (USS) authentication and authorization (UUAA) procedure based at least in part on the capability indication.

11. The apparatus of claim 1, wherein the at least one processor is further configured to:
receive, from a network node and prior to the communicating, an additional NWDAA services indication that is indicative of an availability of the NWDAA services at the mobile network, wherein the additional NWDAA services indication comprises at least one of a system information block (SIB) or radio resource control (RRC) establishment signaling.

12. The apparatus of claim 1, wherein the at least one processor is further configured to:
obtain local awareness information associated with the AUE; and
identify a confliction condition, associated with the NWDAA services, for the AUE based on the local awareness information;
wherein to communicate the information associated with the NWDAA services, the at least one processor is configured to provide an early detection indication of the confliction condition and a request for a deconfliction directive.

13. The apparatus of claim 12, wherein to identify the confliction condition, the at least one processor is configured to identify the confliction condition based on a computational function associated with NWDAA at the AUE; or
wherein the at least one processor is further configured to:
receive, from the second network entity, a reporting configuration that indicates at least one of a continuous reporting operation or a conditional reporting operation, wherein communicating the information associated with the NWDAA services is based on the reporting configuration.

14. The apparatus of claim 13, wherein the reporting configuration further indicates at least one of a reporting periodicity associated with the continuous reporting operation or a set of reporting conditions associated with the conditional reporting operation.

15. The apparatus of claim 1, wherein to communicate the information associated with the NWDAA services, the at least one processor is configured to receive at least one of a confliction warning or local awareness information associated with the AUE for a confliction condition;
wherein the at least one processor is further configured to:
identify a set of actions based on at least one of the confliction warning or the local awareness information.

16. The apparatus of claim 15, wherein to identify the set of actions, the at least one processor is configured to identify the set of actions further based on at least one of configuration information or a configuration policy associated with at least one of an unmanned aircraft system (UAS) operator or a UAS service supplier (USS) system.

17. The apparatus of claim 15, wherein the confliction condition comprises an identified locational proximity threshold condition.

18. The apparatus of claim 1, wherein to communicate the information associated with the NWDAA services, the at least one processor is configured to receive an emergency directive or a path directive associated with a confliction condition for the AUE; and
wherein the emergency directive or the path directive includes a set of actions, associated with a deconfliction of the confliction condition, for execution at the AUE, or
wherein receiving the emergency directive includes identifying the set of actions at the AUE.

19. The apparatus of claim 18, wherein to receive the emergency directive, the at least one processor is configured to perform at least one of:
provide a request for the emergency directive prior to receiving the emergency directive; or
provide an indication of the emergency directive to an unmanned aircraft system (UAS) operator associated with the AUE.

20. The apparatus of claim 18, wherein the emergency directive comprises at least one of an imminent collision status indication, metadata for a different AUE associated with the emergency directive, or a set of deconfliction strategies.

21. The apparatus of claim 20, wherein the set of deconfliction strategies includes a priority score for each deconfliction strategy thereof;
wherein the set of actions is associated with one of the set of deconfliction strategies based on the priority score; or
wherein the set of actions is based on a sensor status or local awareness information associated with the AUE.

22. The apparatus of claim 18, wherein at least one of the emergency directive or the path directive are based on an AUE configuration or a service supplier (USS) system configuration that indicates at least one directive condition, wherein the at least one directive condition is associated with one or more of an AUE size, an AUE class, a mission type, a public safety priority, or a delivery priority.

23. The apparatus of claim 18, wherein to receive the emergency directive or the path directive associated with the confliction condition for the AUE, the at least one processor is configured to perform at least one of:
receive the emergency directive or the path directive via a command and control (C2) link; or
provide the emergency directive or the path directive via the C2 link to a controller of the AUE.

24. The apparatus of claim 18, wherein the path directive comprises flight path information associated with a change to a current flight path of the AUE, wherein the path directive is based on at least one of (i) AUE information comprising at least one of a location of the AUE, a velocity of the AUE or a flight path of the AUE, or (ii) an indication of a new flight path for the AUE from at least one of a unmanned aerial vehicle (UAV) traffic management (UTM) system or a UAS service supplier (USS) system.

25. The apparatus of claim 1, wherein the information associated with the NWDAA services is aircraft to everything (U2X) information that comprises at least one of a detect and avoid (DAA) message or a broadcast remote identifier (BRID) message.

26. The apparatus of claim 1, wherein to communicate the information associated with the NWDAA services, the at least one processor is configured to provide the information associated with the NWDAA services as specified for the second network entity, wherein the information associated with the NWDAA services includes at least one of:
AUE information comprising at least one of a location of the AUE, a velocity of the AUE, or a flight path of the AUE; or
a confliction condition for the AUE based on local awareness information associated with the AUE.

27. The apparatus of claim 26, wherein the information associated with the NWDAA services includes:
a planned deconfliction strategy, associated with the confliction condition, identified by the AUE and to be executed by the AUE or a request for a guided deconfliction strategy from the second network entity to be executed by the AUE; and
additional information associated with at least one different AUE associated with the confliction condition, the additional information comprising at least one of an identifier of the at least one different AUE or a another flight path of the at least one different AUE.

28. The apparatus of claim 27, wherein the at least one processor is further configured to:
execute the planned deconfliction strategy or the guided deconfliction strategy; and
provide, subsequently for the second network entity, an indication of a clearance of the confliction condition.

29. The apparatus of claim 28, wherein to execute the planned deconfliction strategy or the guided deconfliction strategy, the at least one processor is configured to execute based on a computational function associated with NWDAA at the AUE.

30. The apparatus of claim 1, wherein the NWDAA services are associated with a localized detect and avoid (DAA) server (LDS) of the mobile network, wherein the second network entity is the LDS, wherein the first network entity is an access and mobility management function (AMF), wherein an NWDAA services indication is based on an establishment of a packet data unit (PDU) session for Layer 3 communications from the AMF;
wherein the at least one processor is further configured to perform at least one of:
establish a connectivity session with the LDS for the Layer 3 communications based on an LDS discovery procedure; or
move an established connectivity session with the LDS for the Layer 3 communications based on an edge server reallocation procedure associated with an instance of the LDS that is an edge node.

31. The apparatus of claim 1, wherein the NWDAA services are associated with a localized detect and avoid (DAA) server (LDS) of the mobile network, wherein communicating the information associated with the NWDAA services includes communicating with the LDS via a radio resource control (RRC) transport message for Layer 2 communications, wherein the RRC transport message for the Layer 2 communications includes a payload type value associated with the AUE and the LDS.

32. The apparatus of claim 31, wherein the RRC transport message for the Layer 2 communications is associated with:
a paging area transmission over a set of cells from the LDS via a network node of the mobile network; or
a transmission, via the network node, for a set of serving cells associated with the AUE.

33. An apparatus for wireless communication at least one network entity, comprising:
at least one memory; and
at least one processor coupled to the at least one memory and, based at least in part on stored information that is stored in the at least one memory, the at least one processor is configured to:
establish, with an aerial user equipment (AUE), a connection to a mobile network associated with the at least one network entity;
receive, from the AUE, a capability indication of the AUE for support of network-based detect and avoid (NWDAA) services;
provide, for the AUE and based on the capability indication, an NWDAA services indication that is indicative of an availability of the NWDAA services at the mobile network; and
communicate, with the AUE via the mobile network, information associated with the NWDAA services.

34. The apparatus of claim 33, wherein the NWDAA services are associated with a localized detect and avoid (DAA) server (LDS) of the mobile network, wherein the at least one network entity comprises a session management function (SMF).

35. The apparatus of claim 33, wherein to receive the capability indication, the at least one processor is configured to receive the capability indication via non-access stratum (NAS) signaling.

36. The apparatus of claim 35, wherein the NAS signaling includes session management signaling indicative of at least one of a packet data unit (PDU) session request for Layer 3 communications or an express indication of the support of the NWDAA services.

37. The apparatus of claim 33, wherein to provide the NWDAA services indication that is indicative of the availability of the NWDAA services at the mobile network, the at least one processor is configured to provide the NWDAA services indication based on a registration or a packet data unit (PDU) session.

38. The apparatus of claim 37, wherein the NWDAA services indication is based on an establishment of the PDU session for Layer 3 communications.

39. The apparatus of claim 37, wherein the NWDAA services indication is indicative of the availability of the NWDAA services, respectively, for at least one of a set of public land mobile networks (PLMNs), a set of registration areas, a set of tracking areas, a set of cells, or a geographical area.

40. The apparatus of claim 39, wherein one or more registration areas in the set of registration areas are associated with a registration area generation for uniform provision of the NWDAA services; or
wherein the NWDAA services indication is indicative of a service restriction area associated with one or more tracking areas in the set of tracking areas in which the NWDAA services are unavailable for the AUE.

41. The apparatus of claim 37, wherein to provide the NWDAA services indication, the at least one processor is configured to:
provide addressing information, associated with the NWDAA services and a localized detect and avoid (DAA) server (LDS) of the mobile network, via at least one of: a pre-configuration, a policy control function configuration, a registration acceptance indication, a packet data unit (PDU) session establishment acceptance indication, or an AUE configuration update procedure, wherein the addressing information includes at least one of an Internet Protocol (IP) address, a uniform resource locator (URL), a fully qualified domain name (FQDN), or an anycast address of the LDS.

42. The apparatus of claim 41, wherein the at least one processor is further configured to:
provide an AUE authorization for an unmanned aircraft system (UAS) service supplier (USS) authentication and authorization (UUAA) procedure based at least in part on the capability indication.

43. The apparatus of claim 42, wherein the at least one processor is further configured to:
provide, for at least one network node in a radio access network (RAN) portion of the mobile network and based on the AUE authorization, an additional indication that is indicative of an authorization of the LDS for the AUE, wherein the additional indication comprises a 5G access network (AN) to SMF (N2 SM) message.

44. An apparatus for wireless communication at least one network entity, comprising:
at least one memory; and
at least one processor coupled to the at least one memory and, based at least in part on information stored in the at least one memory, the at least one processor is configured to:
establish, with an aerial user equipment (AUE), a connection to a mobile network associated with the at least one network entity;
receive, from the AUE, a capability indication of the AUE for support of network-based detect and avoid (NWDAA) services; and
provide, for the AUE and based on the capability indication, an NWDAA services indication that is indicative of an availability of the NWDAA services at the mobile network.

45. The apparatus of claim 44, wherein the NWDAA services are associated with a localized detect and avoid (DAA) server (LDS) of the mobile network, wherein the at least one network entity is an access and mobility management function (AMF).

46. The apparatus of claim 44, wherein to provide the capability indication, the at least one processor is configured to provide the capability indication via non-access stratum (NAS) signaling.

47. The apparatus of claim 46, wherein the NAS signaling includes mobility management signaling indicative of a registration request associated with the capability indication.

48. The apparatus of claim 44, wherein the NWDAA services indication is based on at least one of a mobility management registration of the AUE.

49. The apparatus of claim 48, wherein the NWDAA services indication is indicative of the availability of the NWDAA services, respectively, for at least one of a set of public land mobile networks (PLMNs), a set of registration areas, a set of tracking areas, a set of cells, or a geographical area.

50. The apparatus of claim 49, wherein one or more registration areas in the set of registration areas are associated with a registration area generation for uniform provision of the NWDAA services.

51. The apparatus of claim 49, wherein the NWDAA services indication is indicative of a service restriction area associated with one or more tracking areas in the set of tracking areas in which the NWDAA services are unavailable for the AUE.

52. The apparatus of claim 48, wherein the at least one processor is further configured to:
authenticate the AUE in association with a localized detect and avoid (DAA) server (LDS) of the mobile network based on at least one of the mobility management registration of the AUE or an AUE subscription associated with the NWDAA services.

53. The apparatus of claim 52, wherein to authenticate the AUE in association with the LDS, the at least one processor is configured to authenticate based on at least one of (i) an AUE authorization for an unmanned aircraft system (UAS) service supplier (USS) authentication and authorization (UUAA) procedure or (ii) the capability indication.

54. An apparatus for wireless communication at least one network entity, comprising:
at least one memory; and
at least one processor coupled to the at least one memory and, based at least in part on stored information that is stored in the at least one memory, the at least one processor is configured to:
obtain local awareness information associated with an aerial user equipment (AUE) based on an indication of support associated with the AUE for network-based detect and avoid (NWDAA) services;
identify a confliction condition, associated with the NWDAA services, for the AUE based on the local awareness information; and
communicate, with the AUE via a mobile network associated with the at least one network entity, information associated with the NWDAA services.

55. The apparatus of claim 54, wherein the NWDAA services are associated with a localized detect and avoid (DAA) server (LDS) of the mobile network, wherein the at least one network entity comprises the LDS.

56. The apparatus of claim 54, wherein the at least one processor is further configured to:
receive, from at least one of an access and mobility management function (AMF) or a session management function (SMF), an activation indication for the AUE that is associated with a capability indication of the AUE for the support of the NWDAA services.

57. The apparatus of claim 56, wherein the activation indication is based on at least one of an AUE authorization for an unmanned aircraft system (UAS) service supplier (USS) authentication and authorization (UUAA) procedure or an AMF authentication.

58. The apparatus of claim 54, wherein the NWDAA services are associated with at least one of a set of public land mobile networks (PLMNs), a set of registration areas, a set of tracking areas, a set of cells, or a geographical area.

59. The apparatus of claim 58, wherein one or more registration areas in the set of registration areas are associated with a registration area generation for uniform provision of the NWDAA services; or
wherein the NWDAA services indication is indicative of a service restriction area associated with one or more tracking areas in the set of tracking areas in which the NWDAA services are unavailable for the AUE.

60. The apparatus of claim 54, wherein to communicate the information associated with the NWDAA services includes receiving an early detection indication of the confliction condition, the at least one processor is configured to communicate based on the confliction condition, associated with the NWDAA services, for the AUE and a request for a deconfliction directive.

61. The apparatus of claim 60, wherein the at least one processor is configured to further configured to:
provide, for the AUE, a reporting configuration that indicates at least one of a continuous reporting operation or a conditional reporting operation, wherein communicating the information associated with the NWDAA services is based on the reporting configuration.

62. The apparatus of claim 61, wherein the reporting configuration further indicates at least one of a reporting periodicity associated with the continuous reporting operation or a set of reporting conditions associated with the conditional reporting operation.

63. The apparatus of claim 54, wherein the at least one processor is further configured to:
obtain at least one of sensor information associated with the NWDAA services from a radio access network (RAN) portion of the mobile network or location information associated with the AUE;
wherein to obtain the local awareness information, the at least one processor is configured to generate the local awareness information based on at least one of the sensor information or the location information.

64. The apparatus of claim 63, wherein to communicate the information associated with the NWDAA services, the at least one processor is configured to provide at least one of:
a confliction warning associated with the AUE for the confliction condition based on the local awareness information;
the local awareness information associated with the AUE for the confliction condition; or
a set of deconfliction strategies associated with the confliction condition.

65. The apparatus of claim 64, wherein the at least one processor is further configured to:
identify the set of deconfliction strategies based on at least one of the confliction warning or the local awareness information.

66. The apparatus of claim 64, wherein at least one of the confliction warning, the confliction condition, or the set of deconfliction strategies is based on a computational function associated with NWDAA.

67. The apparatus of claim 63, wherein the confliction condition comprises an identified locational proximity threshold condition.

68. The apparatus of claim 63, wherein to identify the confliction condition, the at least one processor is configured to: identify the confliction condition based on the local awareness information, wherein the confliction condition is based on a threshold condition associated with a severity of the confliction condition;
wherein the at least one processor is further configured to:
generate a deconfliction directive for the AUE based on the local awareness information and the confliction condition, wherein the deconfliction directive is an emergency directive or a path directive;
wherein to communicate the information associated with the NWDAA services, the at least one processor is configured to provide the emergency directive or the path directive associated with the confliction condition for the AUE.

69. The apparatus of claim 68, wherein at least one of identifying the confliction condition or generating the deconfliction directive is based on a computational function associated with NWDAA.

70. The apparatus of claim 68, wherein to provide the emergency directive, the at least one processor is configured to perform at least one of:
receive a request for the emergency directive from the AUE; or
provide an directive indication of the emergency directive to an unmanned aircraft system (UAS) operator associated with the AUE.

71. The apparatus of claim 68, wherein the emergency directive comprises at least one of an imminent collision status indication, metadata for a different AUE associated with the emergency directive, or a set of deconfliction strategies.

72. The apparatus of claim 71, wherein the set of deconfliction strategies includes a priority score for each deconfliction strategy thereof.

73. The apparatus of claim 68, wherein at least one of the emergency directive or the path directive are based on an AUE configuration or a service supplier (USS) system configuration that indicates at least one directive condition, wherein the at least one directive condition is associated with one or more of an AUE size, an AUE class, a mission type, a public safety priority, or a delivery priority.

74. The apparatus of claim 68, wherein to provide the emergency directive or the path directive associated with the confliction condition for the AUE, the at least one processor is configured to perform at least one of:
provide the emergency directive or the path directive via a command and control (C2) link; or
provide the emergency directive or the path directive via the C2 link to a controller of the AUE.

75. The apparatus of claim 68, wherein the path directive comprises flight path information associated with a change to a current flight path of the AUE, wherein the path directive is based on at least one of (i) AUE information comprising at least one of a location of the AUE, a velocity of the AUE or a flight path of the AUE, or (ii) a new flight path indication indicative of a new flight path for the AUE from at least one of a unmanned aerial vehicle (UAV) traffic management (UTM) system or a UAS service supplier (USS) system.

76. The apparatus of claim 63, wherein the sensor information includes at least one of RAN sensing information, DAA broadcast information, a broadcast remote identifier (BRID) information, automatic dependent surveillance-broadcast (ADS-B) information, weather information, light detection and ranging (LIDAR) information, radio assisted detection and ranging (RADAR) information, or new radio (NR) sensing information.

77. The apparatus of claim 63, wherein to obtain the sensor information associated with the NWDAA services, the at least one processor is configured to obtain based on an operations administration and maintenance (OAM) configuration.

78. The apparatus of claim 54, wherein the information associated with the NWDAA services is aircraft to everything (U2X) information that comprises at least one of a detect and avoid (DAA) message or a broadcast remote identifier (BRID) message.

79. The apparatus of claim 54, wherein to communicate the information associated with the NWDAA services, the at least one processor is configured to receive the information associated with the NWDAA services as specified for an LDS of the at least one network entity, wherein the information associated with the NWDAA services includes at least one of:
AUE information comprising at least one of a location of the AUE, a velocity of the AUE, or a flight path of the AUE; or
the confliction condition for the AUE based on the local awareness information associated with the AUE.

80. The apparatus of claim 79, wherein the information associated with the NWDAA services includes:
a planned deconfliction strategy, associated with the confliction condition, identified by the AUE and to be executed by the AUE or a request for a guided deconfliction strategy from the AUE to be executed by the AUE; and
additional information associated with at least one different AUE associated with the confliction condition, the additional information comprising at least one of an identifier of the at least one different AUE or a another flight path of the at least one different AUE.

81. The apparatus of claim 80, wherein the at least one processor is further configured to:
receive, from the AUE, an additional indication of a clearance of the confliction condition.

82. The apparatus of claim 54, wherein the NWDAA services are associated with a localized detect and avoid (DAA) server (LDS) of the mobile network, wherein the at least one network entity comprises the LDS;
wherein the at least one processor is further configured to:
move an established connectivity session of the LDS with the AUE for Layer 3 communications based on an edge server reallocation procedure associated with an instance of the LDS that is an edge node.

83. The apparatus of claim 54, wherein the NWDAA services are associated with a localized detect and avoid (DAA) server (LDS) of the mobile network, wherein the at least one network entity comprises the LDS, wherein the LDS comprises an edge node or an edge application server.

84. The apparatus of claim 54, wherein the NWDAA services are associated with a localized detect and avoid (DAA) server (LDS) of the mobile network, wherein communicating the information associated with the NWDAA services includes communicating with the AUE via a radio resource control (RRC) transport message for Layer 2 communications, wherein the RRC transport message for the Layer 2 communications includes a payload type value associated with the AUE and the LDS.

85. The apparatus of claim 84, wherein the RRC transport message for the Layer 2 communications is associated with:
a paging area transmission over a set of cells from the LDS via a network node of the mobile network; or
a transmission, via the network node, for a set of serving cells associated with the AUE.

86. The apparatus of claim 54, wherein the NWDAA services are associated with a localized detect and avoid (DAA) server (LDS) of the mobile network, wherein the at least one network entity comprises the LDS;
wherein the at least one processor is further configured to:
communicate with at least one of an unmanned aircraft system (UAS) network function (NF) or a UAS network exposure function (NEF), wherein at least one of the UAS NF or the UAS NEF are associated with the NWDAA services.

87. The apparatus of claim 86, wherein to communicate with at least one of the UAS NF or the UAS NEF, the at least one processor is configured to communicate via a triggering interface for at least one of the UAS NF or the UAS NEF for signaling to an unmanned aircraft system (UAS) service supplier (USS).

88. The apparatus of claim 87, wherein to communicate with at least one of the UAS NF or the UAS NEF, the at least one processor is configured to provide confliction indicia, wherein the confliction indicia is associated with at least one of an identified confliction condition, a confliction warning, or a deconfliction directive associated with the AUE.

89. The apparatus of claim 88, wherein the at least one processor is further configured to:
receive, from the AUE, a service layer identifier of the AUE; and
identify the UAS NF that serves the AUE based on the service layer identifier of the AUE;
wherein to provide the confliction indicia, the at least one processor is configured to provide, for the USS via the UAS NF that serves the AUE, the confliction indicia and the service layer identifier of the AUE.

90. The apparatus of claim 87, wherein to communicate with at least one of the UAS NF or the UAS NEF, the at least one processor is configured to receive, from the USS via at least one of the UAS NF or the UAS NEF, one or more of a policy associated with the AUE or AUE-associated information.

91. The apparatus of claim 87, wherein to communicate with at least one of the UAS NF or the UAS NEF, the at least one processor is configured to communicate based on at least one of:
a location tracking of the AUE and a mapping between a cell identifier and the LDS, wherein the LDS is a serving LDS for the AUE;
a registration of the serving LDS with the UAS NF the AUE; or
an AUE authorization for a USS authentication and authorization (UUAA) procedure associated with at least one of an access and mobility management function (AMF) or a session management function (SMF) of the mobile network.

92. The apparatus of claim 91, wherein to communicate with at least one of the UAS NF or the UAS NEF, the at least one processor is configured to receive, from the USS via at least one of the UAS NF or the UAS NEF, at least a portion of a flight plan of the AUE.

93. The apparatus of claim 92, wherein at least the portion of the flight plan of the AUE is associated with at least one of a coverage area for the AUE by the LDS or an additional area outside of the coverage area.

94. The apparatus of claim 92, wherein to communicate with at least one of the UAS NF or the UAS NEF, the at least one processor is configured to provide, for the USS via at least one of the UAS NF or the UAS NEF, a flight plan request for the flight plan of the AUE, wherein the flight plan request includes at least one of a location of the AUE, a first area of interest associated with a serving cell identifier for the AUE, or a second area of interest associated with a geographic coordinates related to the AUE.

95. The apparatus of claim 87, wherein to communicate with at least one of the UAS NF or the UAS NEF, the at least one processor is configured to provide, for the USS via at least one of the UAS NF or the UAS NEF, a serving indication that indicates the LDS is or has become a serving LDS for the AUE.

96. The apparatus of claim 87, wherein the at least one processor is further configured to:
receive, from the USS via a Unified Data Management (UDM), at least one of a type indication or a category indication of the AUE;
wherein to communicate with at least one of the UAS NF or the UAS NEF includes, the at least one processor is configured to communicate based on at least one of the type indication or the category indication of the AUE.

97. An apparatus for wireless communication at an aerial user equipment (AUE), comprising:
at least one memory; and
at least one processor coupled to the at least one memory and, based at least in part on stored information that is stored in the at least one memory, the at least one processor is configured to:
receive, from a network entity supporting network-based detect and avoid (NWDAA) services in a mobile network, at least one of:
a confliction warning associated with the AUE for a confliction condition;
local awareness information associated with the AUE for the confliction condition; or
a set of deconfliction strategies associated with the confliction condition;
identify a set of actions based on at least one of the confliction warning or the local awareness information; and
execute at least one of the set of actions or at least one of the set of deconfliction strategies.

98. The apparatus of claim 97, wherein to identify the confliction condition, the at least one processor is configured to identify the confliction condition based on a computational function associated with NWDAA at the AUE.

99. The apparatus of claim 98, wherein the AUE is associated with an identifier (ID) thereof, wherein the confliction warning associated with the AUE for the confliction condition is based on a set of broadcast remote ID (BRID) messages, wherein the set of BRID messages includes at least one of the ID, a vector of movement of the AUE, or a position of the AUE.

100. The apparatus of claim 97, wherein the at least one processor is further configured to:
communicate, with the network entity and based on a reporting configuration, information associated with the NWDAA services prior to the set of actions being identified.

101. The apparatus of claim 97, wherein the at least one processor is further configured to:
provide, for the network entity and subsequent to at least one of the set of actions or at least one of the set of deconfliction strategies, an indication of a clearance of the confliction condition.

102. The apparatus of claim 97, wherein the NWDAA services are associated with a localized detect and avoid (DAA) server (LDS) of the mobile network, wherein the network entity is a is the LDS.
